(19) United States
(12) Patent Application Publication
(10) Pub. No.: US 2012/0200683 A1
(43) Pub. Date: Aug. 9, 2012

(54) SYSTEM FOR RECORDING AND REPRODUCING IMAGES

(76) Inventors: Ryu Oshima, Tokyo (JP); Takashi SAITO, Tokyo (JP); Takeshi URASAKI, Tokyo (JP)

(21) Appl. No.: 13/367,463

(22) Filed: Feb. 7, 2012

Related U.S. Application Data
(63) Continuation of application No. PCT/JP2011/064142, filed on Jun. 21, 2011.

(30) Foreign Application Priority Data
Jul. 9, 2010 (JP) 2010-157107

(51) Int. Cl. H04N 7/18

(52) U.S. Cl. 348/65; 348/E07.085

(57) ABSTRACT

An image recording and reproducing system that records and reproduces a combined image of images input from plural input sources outputs a combined image data group including component images forming the combined image, information related to the combined image, and image layout information of the combined image, records the output combined image data group, changes reproduction image designation information including information for designating component images forming a reproduction image, information related to the reproduction image, and image layout information of the reproduction image, forms a reproduction image from the recorded combined image data group on the basis of the changed reproduction image designation information, outputs the formed reproduction image, and receives the output reproduction image and reproduces the reproduction image.

### CROSS-REFERENCE TO RELATED APPLICATIONS

This application is based upon and claims the benefit of priority of the prior Japanese Patent Application No. 2010-157107, filed on Jul. 9, 2010, the entire contents of which are incorporated herein by reference.

This is a Continuation Application of PCT Application No. PCT/JP2011/064142, filed Jun. 21, 2011, which was not published under PCT Article 21(2) in English.

### FIELD

The present invention relates to an image recording and reproducing system and, more particularly, to an image recording and reproducing system that can select an image compressing method for an acquired medical image.

### BACKGROUND

An endoscope system including an endoscope and a medical image processing apparatus has been widely used in the medical field and the like in the past. In particular, the endoscope system in the medical field is mainly used in an application in which a surgeon or the like performs, for example, an in-vivo observation. As an apparatus used in such an endoscope system, for example, a medical image processing apparatus disclosed in Japanese Patent Application Laid-Open Publication No. 2008-86667 is proposed.

The medical image processing apparatus disclosed in Japanese Patent Application Laid-Open Publication No. 2008-86667 applies compression processing to a medical image using a first image compressing method or a second image compressing method. When the medical image processing apparatus detects a first instruction issued by a first recording instructing section, the medical image processing apparatus outputs a medical image compressed by the first image compressing method to an image recording section. At the same time, when the medical image processing apparatus detects a second instruction issued by a second recording instructing section, the medical image processing apparatus outputs the medical image compressed by the second image compressing method to the image recording section. This makes it possible to perform, even while a user is performing an observation, recording of an endoscopic image without interrupting the observation.

### SUMMARY

An image recording and reproducing system according to the present invention that records and reproduces a combined image of images input from plural input sources includes: a combined image data group output section that outputs a combined image data group including component images forming the combined image, information related to the combined image, and image layout information of the combined image; a combined image data group recording section that records the output combined image data group; a reproduction image designation information changing section for performing re-operation for changing reproduction image designation information including information for designating at least one or more component images forming a reproduction image, information related to the reproduction image, and image layout information of the reproduction image; a reproduction image forming section that forms a reproduction image from the recorded combined image data group on the basis of the changed reproduction image designation information; a reproduction image output section that outputs the formed reproduction image; and a reproducing section that receives the output reproduction image and reproduces the reproduction image.

The image recording and reproducing system includes: an endoscope system connected to an external device for inputting an external image and connected to an endoscope; and an image recording apparatus. The endoscope system includes: the combined image data group output section; the reproduction image designation information changing section; a transmitting section that transmits the reproduction image designation information; and the reproducing section. The image recording apparatus includes: the combined image data group recording section; a receiving section that receives the reproduction image designation information; the reproduction image forming section; and the reproduction image output section.

The image recording and reproducing system includes: an endoscope system connected town external device for inputting an external image and connected to an endoscope; an image recording apparatus; and an image reproducing apparatus. The endoscope system includes the combined image data group output section. The image recording apparatus includes: the combined image data group recording section; a receiving section that receives the reproduction image designation information; the reproduction image forming section; and the reproduction image output section. The image reproducing apparatus includes: the reproduction image designation information changing section; a transmitting section that transmits the reproduction image designation information; and the reproducing section.

The information related to the combined image and the information related to the reproduction image include at least one of a number for examination management, an examination region, examination date and time, a patient ID, a patient name, a patient sex, and a patient age.

The image layout information of the combined image and the image layout information of the reproduction image include at least one of a type of an image, the width of the image, and the height of the image.

The image layout information of the reproduction image further includes at least one of information for discriminating, concerning each image, whether to display the image and a display disclosure position of the image.

The component images forming the combined image and the information related to the combined image included in the combined image data group are independent from each other.

### BRIEF DESCRIPTION OF DRAWINGS

FIG. 1 is a diagram showing an example of the configuration of a main part of an endoscope system according to an embodiment of the present invention.

FIG. 2 is a diagram showing an example of the configuration of an endoscope 2A included in the endoscope system shown in FIG. 1.

FIG. 3 is a diagram showing an example of the configuration of an endoscope 2B included in the endoscope system shown in FIG. 1.

FIG. 4 is a diagram showing an example of the configuration of an endoscope 2C included in the endoscope system shown in FIG. 1.

FIG. 5 is a diagram showing an example of the configuration of a light source device included in the endoscope system shown in FIG. 1.

FIG. 6 is a diagram showing an example of the configuration of a processor included in the endoscope system shown in FIG. 1.

FIGS. 7A, 7B and 7C are a diagram showing an example of the configuration of an image processing section included in the processor shown in FIG. 6.

FIG. 8 is a diagram showing an example of a screen displayed when both the endoscope shown in FIG. 2 and the endoscope shown in FIG. 3 are connected to the processor shown in FIG. 6.

FIG. 9 is a diagram showing an example of the configuration of a main control section included in the processor shown in FIG. 6.

FIG. 10 is a diagram showing an example of the configuration of one extension control section connected to the processor shown in FIG. 6.

FIG. 11 is a diagram showing an example of the configuration of another extension control section different from the extension control section shown in FIG. 10 connected to the processor shown in FIG. 6.

FIG. 12 is a flowchart for explaining an example of processing performed by the main control section shown in FIG. 9 when the main control section detects (and has detected) connection of the extension control section.

FIG. 13 is a diagram showing an example of the configuration of a front panel 76 included in the processor shown in FIG. 6.

FIG. 14 is a diagram showing a modification of the configuration of an SIO 142 included in the main control section shown in FIG. 9.

FIG. 15 is a diagram showing an example of peripheral devices that could be connected to the processor shown in FIG. 6.

FIG. 16 is a diagram showing an example different from FIG. 15 of the peripheral devices that could be connected to the processor shown in FIG. 6.

FIG. 17 is a diagram showing an example different from FIGS. 15 and 16 of the peripheral devices that could be connected to the processor shown in FIG. 6.

FIG. 18 is a diagram showing an example different from FIGS. 15, 16, and 17 of the peripheral devices that could be connected to the processor shown in FIG. 6.

FIG. 19 is a diagram showing an example different from FIGS. 15, 16, 17, and 18 of the peripheral devices that could be connected to the processor shown in FIG. 6.

FIG. 20 is a diagram showing an example of the configuration of a keyboard that could be connected to the processor shown in FIG. 6.

FIG. 21 is a diagram showing an example of a display size (an output size) (16:9) of an image.

FIG. 22 is a diagram showing an example of a display size (an output size) (4:3) of an image.

FIG. 23 is a diagram showing an example of the configuration of an image compressing and expanding section included in the processor shown in FIG. 6.

FIG. 24 shows a configuration example of a synchronization signal check circuit 631 included in the image compressing and expanding section shown in FIG. 23.

FIG. 25 is a diagram showing an example of an endoscopic combined image generated by the image processing section shown in FIGS. 7A-7C.

FIG. 26 shows details of time information 308 shown in FIG. 25.

FIG. 27 shows a display form of a thumbnail image in the case of an HDTV.

FIG. 28 shows a display form of a thumbnail image in the case of an SDTV.

FIG. 29 is a diagram showing an example of a setting screen of the processor shown in FIG. 6.

FIG. 30 is a diagram showing an example of another setting screen, which is a screen after transition from the setting screen shown in FIG. 29, in the setting screen of the processor shown in FIG. 6.

FIG. 31 is a diagram for explaining storage of an image according to a display size, an image size, and a type of an endoscope (an endoscope connection detection signal).

FIG. 32 is a diagram showing an example of a directory structure used in recording an image in filing devices, optical recording devices, and the like shown in FIGS. 15 to 19.

FIGS. 33A and 33B are a diagram for explaining a DCIM folder, an examination information storage folder, and an annotation storage folder shown in FIG. 32.

FIG. 34 is a diagram for explaining details of the examination information storage folder.

FIGS. 35A, 35B, 35C are a diagram for explaining details of a photographing information management file.

FIGS. 36A and 36B show an example of the examination information management file and the photographing information management file concerning an endoscopic combined image 300-1 generated in a combining circuit 108H or 108S.

FIG. 37 shows an example of the endoscopic combined image 300-1 corresponding to the examination information management file and the photographing information management file shown in FIGS. 36A and 36B.

FIG. 38 is a diagram showing an example of data structures of an image file of a thumbnail image and an image file of an image serving as a base of the thumbnail image among files in the directory structure shown in FIG. 32.

FIG. 39 is a diagram showing an example different from FIG. 38 of the data structures of the image file of the thumbnail image and the image file of the image serving as the base of the thumbnail image among the files in the directory structure shown in FIG. 32.

FIG. 40 is a diagram showing an example of directory names and file names displayed on a monitor or the like as a display form associated with the directory structure.

FIG. 41A is a flowchart (No. 1) for explaining an example of control and processing performed by the main control section shown in FIG. 9 when still images recorded in the peripheral devices and the like shown in FIGS. 15 to 19 are displayed.

FIG. 41B is a flowchart (No. 2) for explaining the example of the control and the processing performed by the main control section shown in FIG. 9 when the still images recorded in the peripheral devices and the like shown in FIGS. 15 to 19 are displayed.

FIG. 42 is a diagram showing a display example of a screen displayed when an HDTV image is stored.

FIG. 43 is a diagram showing error display indicating that no recorded image is present concerning an SDTV image when only the HDTV image is recorded.

FIG. 44 is a diagram showing an example of a multi-image generated by the processing shown in FIGS. 41A and 41B.

FIG. 45 is a diagram showing an example of a page change performed when plural multi-images are generated by the processing shown in FIGS. 41A and 41B.

FIG. 46 is a diagram showing an example of transition of a screen performed when one selected image is displayed in the multi-image shown in FIG. 44.

FIG. 47 is a diagram showing an example of processing performed by the processor shown in FIG. 6 when a recording instruction is performed.

FIG. 48 is a diagram showing an example of processing performed by the processor shown in FIG. 6 following the processing shown in FIG. 47 when the recording instruction is performed.

FIG. 49 is a diagram showing an example different from FIG. 48 of the processing performed by the processor shown in FIG. 6 following the processing shown in FIG. 47 when the recording instruction is performed.

FIG. 50 is a diagram showing an example different from FIGS. 48 and 49 of the processing performed by the processor shown in FIG. 6 following the processing shown in FIG. 47 when the recording instruction is performed.

FIG. 51 is a diagram showing an example different from FIGS. 48, 49, and 50 of the processing performed by the processor shown in FIG. 6 following the processing shown in FIG. 47 when the recording instruction is performed.

FIG. 52 is a flowchart for explaining an example of compression processing and recording processing included in the processing shown in FIG. 48 (FIGS. 49 and 50).

FIG. 53 is a flowchart for explaining an example of processing performed when an image of a format of a low compression ratio stored in a buffer by the processing shown in FIG. 52 is recorded in a peripheral device or the like.

FIG. 54 is a flowchart for explaining an example different from FIG. 53 of the processing performed when the image of the format of the low compression ratio stored in the buffer by the processing shown in FIG. 52 is recorded in the peripheral device or the like.

FIG. 55 is a diagram showing an example of a multi-image generated in order to select a recording target image out of images stored in the buffer in the processing shown in FIG. 53.

FIG. 56 shows a screen example for managing contents of image data stored in a buffer 166.

FIGS. 57A, 57B and 57C show a multi-image displayed using an annotate function.

FIG. 58 is a diagram for explaining a change of a display form of an endoscopic combined image.

FIGS. 59A and 59B, and FIGS. 59C and 59D show an example of an examination information management file and a photographing information management file before and after the change of the display form of the endoscopic combined image.

FIG. 60 is a diagram for explaining an example of variations of the change of the display form of the endoscopic combined image.

FIGS. 61A, 61B and 61C are a diagram for explaining that a reset circuit 140 is started by a watchdog timer and a part of image processing is initialized.

FIG. 62 shows a display example (a modification) of a setting screen of the processor.

FIG. 63 shows a display example (a modification) of the setting screen of the processor.

FIG. 64 is a diagram (No. 1) showing a state in which the display form of the endoscopic combined image is switched every time a “display form” key is pressed during the selection of PinP display.

FIG. 65 is a diagram (No. 2) showing the state in which the display form of the endoscopic combined image is switched every time the “display form” key is pressed during the selection of the PinP display.

FIG. 66 is a diagram (No. 1) showing a state in which the display form of the endoscopic combined image is switched every time the “display form” key is pressed during the selection of PoutP display.

FIG. 67 is a diagram (No. 2) showing a state in which the display form of the endoscopic combined image is switched every time the “display form” key is pressed during the selection of the PoutP display.

FIG. 68 shows a message display example for warning that the PoutP display cannot be performed in the case of an SDTV image.

### DESCRIPTION OF EMBODIMENTS

When plural images such as an image picked up by an endoscope, an image of an endoscope shape detecting device, and an image obtained by an ultrasonic device, character information, and the like are displayed on a display device using a medical image processing apparatus, a combined image obtained by combining the images and the character information is displayed and recorded.

However, for example, when a portion desired to be observed is displayed overlapping other images and characters, image and character information is recorded as an image in the overlapping state. Therefore, once recorded, thereafter, since the overlapping portion cannot be eliminated, the overlapping portion cannot be checked. A user is forced to bear a heavy burden.

When an image is displayed in a state of a small size, the image of the small size is recorded. Therefore, the image cannot be enlarged to observe details later. As a result, the user cannot easily and freely move the image and change the size. The user is forced to bear a heavy burden.

Therefore, in an embodiment of the present invention, an image recording and reproducing system is provided that enables a layout change of an endoscopic combined image displayed on a display device and enables such a layout change not only in a processor but also in a device other than the processor.

The embodiment of the present invention is explained below with reference to the drawings.

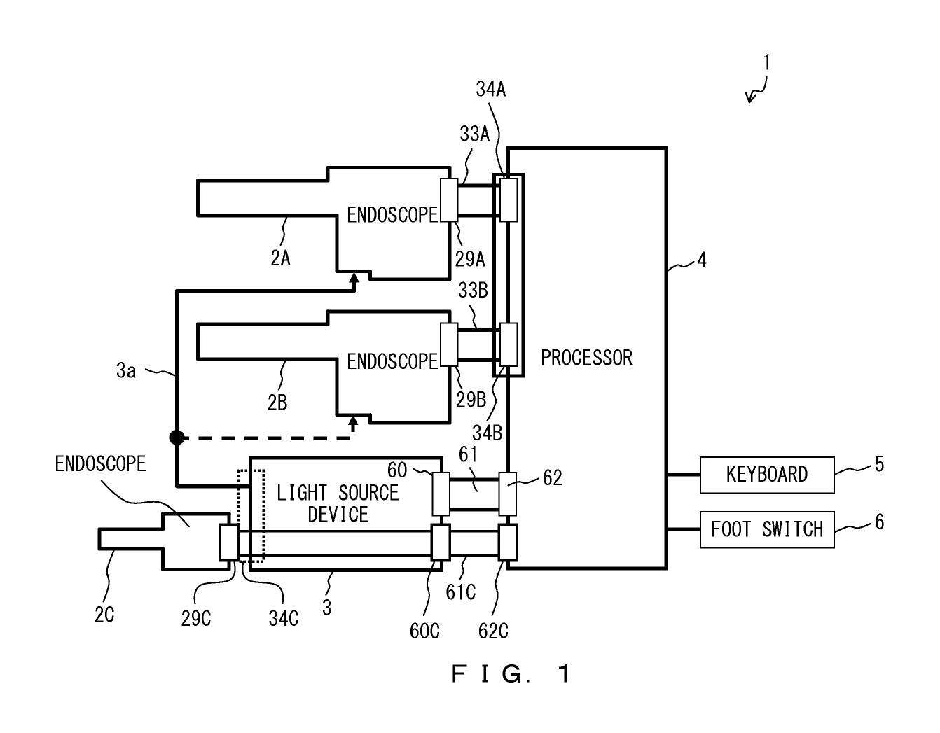

An endoscope system 1 includes, as shown in FIG. 1, endoscopes 2A, 2B, and 2C, a light source device 3, and a processor 4. The endoscopes 2A, 2B, and 2C can be inserted into a body cavity of a patient and pick up images of a subject in the body cavity. The endoscopes 2A and 2B are connected to the processor 4. The endoscope 2A is detachably connected to the processor 4 by a connector 34A provided on the other end side of a cable 33A extending from a connector 29A. The endoscope 2B is detachably connected to the processor 4 by a connector 34B provided on the other end side of a cable 33B extending from a connector 29B. The endoscope 2C is connected to the processor 4 via the light source device 3.

The connectors 34A and 34B may be one (common) connector. In this case, when the cables 33A and 33B of the endoscopes 2A and 2B are connected to the common connector, among plural pins in the connector, pins in use are different depending on the types of the endoscopes (the endoscopes 2A and 2B).

The light source device 3 supplies illumination light for illuminating the subject to the endoscopes 2A and 2B via a light guide cable 3a. The endoscope 2C is detachably connected to the light source device 3 by a connector 29C and a connector 34C. The light source device 3 is detachably connected to the processor 4 by a connector 62 provided on the other end side of a cable 61 for dimming signal transmission extending from a connector 60. The light source device 3 is detachably connected to the processor 4 by a connector 62C provided on the other end side of a cable 61C for endoscopic image signal transmission extending from the connector 60C.

The light source device 3 includes a light guide connector (not shown), to which the light guide cable 3a is detachably attachable, in the center portion of the connector 34C. Pins for performing electric connection to the endoscope 2C are arranged around the light guide connector. When the connector 29C is connected to the connector 34C, the pins for electric connection are also connected together with the light guide connector. Consequently, the light guide connector and a signal of the endoscope 2C can be connected by one connector to save labor and time for attachment and detachment by the user.

The processor 4 performs control and the like for sections included in the endoscope system 1. A keyboard 5 and a foot switch 6 functioning as operation devices capable of performing operation instructions to the sections included in the endoscope system 1 are detachably (or integrally) connected to the processor 4 functioning as a medical image processing apparatus. It is assumed that FIG. 1 shows a case in which the light guide cable 3a is connected to the endoscope 2A. The connector 62C connected to the endoscope 2C via the light source device 3 may be provided on the back of the processor 4.

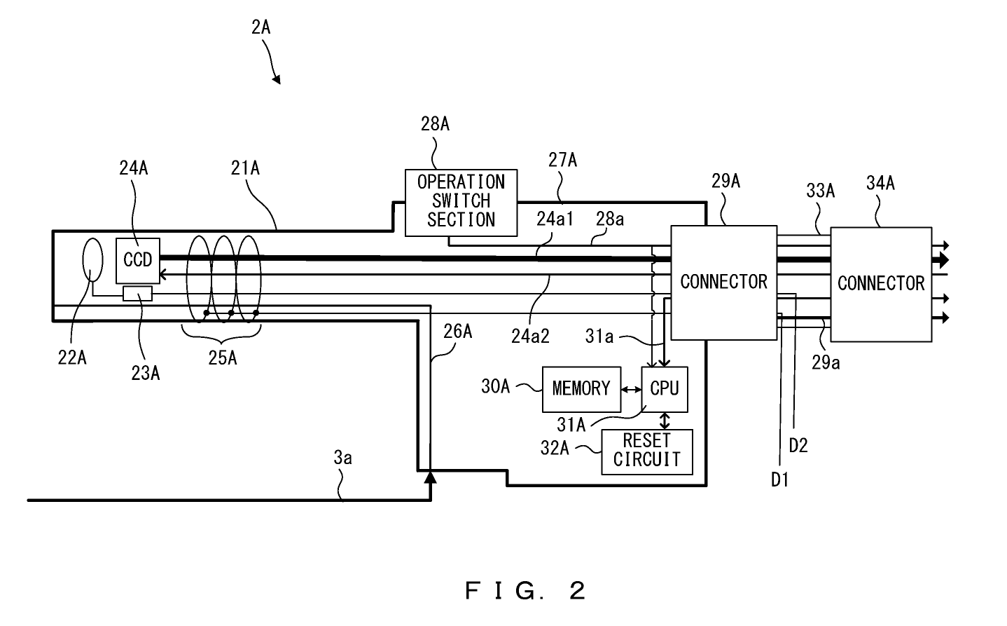

The endoscope 2A includes, as shown in FIG. 2, an insertion section 21A, an object optical system 22A, an actuator 23A, a CCD (charge coupled device) 24A, and plural source coils 25A. The insertion section 21A can be inserted into a body cavity of a patient. The object optical system 22A is provided at the distal end portion of the insertion section 21A and focuses an image of a subject. The actuator 23A moves the object optical system 22A in the axis direction of the insertion section 21A on the basis of a driving signal output from an extension board connected to the processor 4. The CCD 24A is provided in a focusing position of the object optical system 22A. The plural source coils 25A are arranged over substantially the entire insertion section 21A and generate a magnetic field on the basis of a driving signal output from an endoscope shape detecting device explained later.

The endoscope 2A includes a light guide 26A, an operation section 27A, an operation switch section 28A, the connector 29A, a memory 30A, a CPU 31A, and a reset circuit 32A. The light guide 26A guides the illumination light, which is supplied from the light source device 3 via the light guide cable 3a, to the distal end portion of the insertion section 21A. The operation section 27A is used for performing an operation instruction to the endoscope 2A and the like. The operation switch section 28A is an operation device including one or plural switches provided in the operation section 27A. The memory 30A stores a program, endoscope peculiar information data, and the like.

Further, the endoscope 2A is detachably connected to the processor 4 by the connector 34A provided on the other end side of the cable 33A extending from the connector 29A. The connector 29A outputs an endoscope connection detection signal indicating that the endoscope 2A is connected to the processor 4 to the processor 4 via the signal line 29a. The signal line 29a is connected to the connector 29A on one end side and arranged to be inserted through the inside of the cable 33A. The signal line 29a is connected to an internal circuit of the processor 4 on the other end side.

The CCD 24A picks up an image of a subject focused by the object optical system 22A. The CCD 24A outputs the picked-up image of the subject to the processor 4 via a signal line 24a1 as an image pickup signal. The signal line 24a1 is connected to the CCD 24A on one end side and arranged to be inserted through the inside of the cable 33A. The signal line 24a1 is connected to the internal circuit of the processor 4 on the other end side. The CCD 24A is driven according to a CCD driving signal generated in the processor 4 and then input via a signal line 24a2. The signal line 24a2 is connected to the CCD 24A on one end side and arranged to be inserted through the inside of the cable 33A. The signal line 24a2 is connected to the internal circuit of the processor 4 on the other end side.

The memory 30A includes any one of an EEPROM, a FLASH ROM, an FRAM (registered trademark), an FeRAM, an MRAM, an OUM, an SRAM with battery, and the like, which are nonvolatile memories. The memory 30A has stored therein, as the endoscope peculiar information data, for example, a type of the CCD 24A, a type of the endoscope 2A, a serial number of the endoscope 2A, (one or plural) white balance data, the number of forceps channels (not shown) and the diameter of the channels of the endoscope 2A, the number of times of energization to the CPU 31A, the number of times of pressing of the switches provided in the operation switch section 28A, a bending characteristic of the insertion section 21A, a value of the diameter of the insertion section 21A, a value of the diameter of the distal end portion of the insertion section 21A, an expansion scale of the object lens system 22A, forceps position information on an endoscopic combined image, inspection instruction information, first data of use of the endoscope 2A, the number of times of inspection, service information, a manufacturer comment, a service comment, a repair record, an inspection record, comment information, a version of a program of the CPU 31A, rental information, the number of source coils 25A, a driving current for the source coils 25A, a driving voltage for the source coils 25A, and information concerning whether the endoscope 2A is a direct view or a side view.

Although not shown in the figure, the CPU 31A includes an interface circuit (a serial interface circuit or a parallel interface circuit), a watchdog timer, a timer, an SRAM, and a FLASH ROM. The CPU 31A performs control of reading of the various data stored in the memory 30A and writing of various data in the memory 30A via a not-shown interface circuit.

Further, the CPU 31A performs arithmetic processing of, for example, the number of times of connection of the endoscope 2A, the number of times of pressing of the switches provided in the operation switch section 28A, and the number of times of energization to the CPU 31A.

The CPU 31A performs transmission and reception of a result of the arithmetic processing performed by the CPU 31A itself and transmission and reception of various data stored in the memory 30A to and from the processor 4 via a signal line 31a. The signal line 31a is connected to the CPU 31A on one end side and arranged to be inserted through the inside of the cable 33A. The signal line 31a is connected to the internal circuit of the processor 4 on the other end side.

The reset circuit 32A performs reset processing according to timing when a power supply supplied from the processor 4 fluctuates or timing based on the watchdog timer in the CPU 31A.

A switch ON/OFF signal generated by the operation of the switches of the operation switch section 28A is output to the processor 4 via a signal line 28a. The endoscope connection detection signal generated in the connector 29A is output to the processor 4 via the signal line 28a. The signal line 28a is connected to the switches of the operation switch section 28A on one end side and arranged to be inserted through the inside of the cable 33A. The signal line 28a is connected to the internal circuit of the processor 4 on the other end side. It is assumed that the switch ON/OFF signal generated by the operation of the switches of the operation switch section 28A and the endoscope connection detection signal generated in the connector 29A are generated using a driving voltage supplied from a driving circuit 71 of the processor 4.

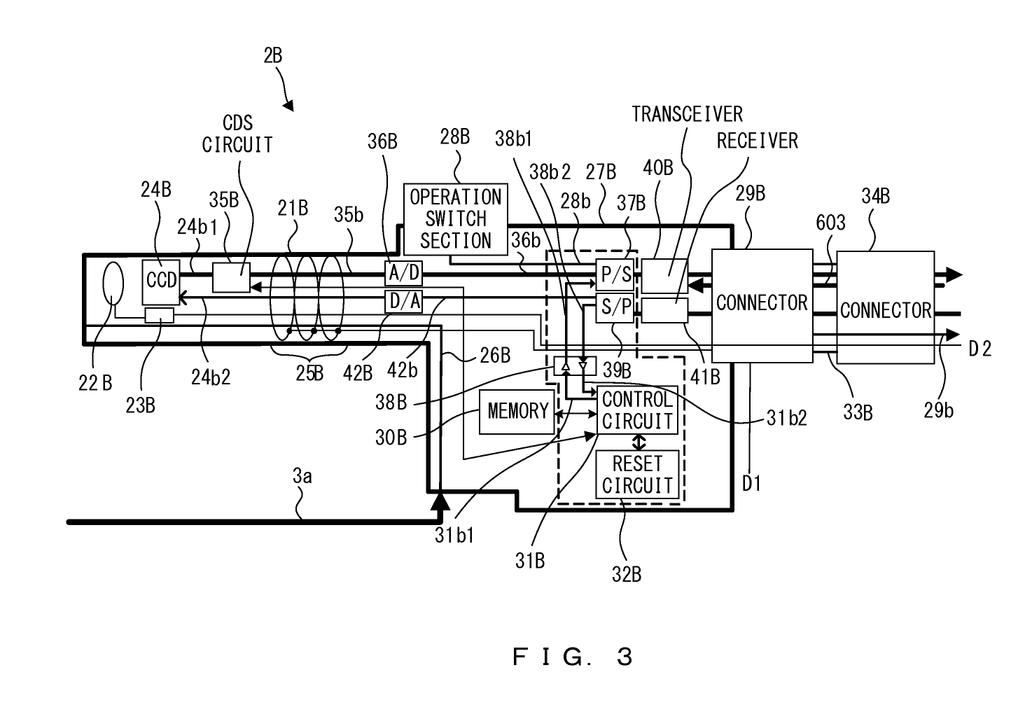

The endoscope 2B includes, as shown in FIG. 3, an insertion section 21B, an object optical system 22B, an actuator 23B, a CCD (charge coupled device) 24B, and plural source coils 25B. The insertion section 21B can be inserted into a body cavity of a patient. The object optical system 22B is provided at the distal end portion of the insertion section 21B and focuses an image of a subject. The actuator 23B moves the object optical system 22B in the axis direction of the insertion section 21B on the basis of a driving signal output from a driving circuit 602 of the processor 4. The CCD 24B is provided in a focusing position of the object optical system 22B. Plural source coils 25B are arranged over substantially the entire insertion section 21B and generate a magnetic field on the basis of a driving signal output from the endoscope shape detecting device explained later.

The endoscope 2B includes a light guide 26B, an operation section 27B, an operation switch section 28B, a connector 29B, a memory 30B, a control circuit 31B, and a reset circuit 32B. The light guide 26B guides the illumination light, which is supplied from the light source device 3 via the light guide cable 3a, to the distal end portion of the insertion section 21B. The operation section 27B is used for performing an operation instruction to the endoscope 2B and the like. The operation switch section 28B is an operation device including one or plural switches provided in the operation section 27B. The memory 30B stores a program, endoscope peculiar information data, and the like.

Further, the endoscope 2B is detachably connected to the processor 4. The connector 34B is provided on the other end side of the cable 33B extending from the connector 29B.

The CCD 24B picks up an image of a subject focused by the object optical system 22B. The CCD 24B outputs the picked-up image of the subject to a CDS (correlated double sampling) circuit 35B via a signal line 24b1 as an image pickup signal.

The CDS circuit 35B applies correlated double sampling processing to the image pickup signal output from the CCD 24B. The CDS circuit 35B outputs the image pickup signal subjected to the correlated double sampling processing to an analog/digital (A/D) conversion section (hereinafter and in the figures, abbreviated as A/D) 36B via a signal line 35b.

The A/D 36B converts an analog image pickup signal output from the CDS circuit 35B into a digital signal. The A/D 36B outputs the digital signal obtained by converting the analog image pickup signal to a P/S 37B via a signal line 36b.

The memory 30B includes any one of an EEPROM, a FLASH ROM, an FRAM, an FeRAM, an MRAM, an OUM, an SRAM with battery, and the like, which are nonvolatile memories. The memory 30B has stored therein, as the endoscope peculiar information data, for example, a type of the CCD 24B, a type of the endoscope 2B, a serial number of the endoscope 2B, (one or plural) white balance data, the number of forceps channels (not shown) and the diameter of the channels of the endoscope 2B, the number of times of energization to the control circuit 31B, the number of times of pressing of the switches provided in the operation switch section 28B, a bending characteristic of the insertion section 21B, a value of the diameter of the insertion section 21B, a value of the diameter of the distal end portion of the insertion section 21B, an expansion scale of the object lens system 22B, forceps position information on an endoscopic combined image, inspection instruction information, first data of use of the endoscope 2B, the number of times of inspection, service information, a manufacturer comment, a service comment, a repair record, an inspection record, comment information, a version of a program of the control circuit 31B, rental information, the number of source coils 25B, a driving current for the source coils 25B, a driving voltage for the source coils 25B, and information concerning whether the endoscope 2B is a direct view or a side view.

Although not shown in the figure, the control circuit 31B includes an interface circuit (a serial interface circuit or a parallel interface circuit), a watchdog timer, a timer, an SRAM, and a FLASH ROM. The control circuit 31B performs control of reading of the various data stored in the memory 30B and writing of various data in the memory 30B via a not-shown interface circuit.

Further, the control circuit 31B performs arithmetic processing of, for example, the number of times of connection of the endoscope 2B, the number of times of pressing of the switches provided in the operation switch section 28B, and the number of times of energization to the control circuit 31B.

The control circuit 31B outputs a result of the arithmetic operation performed by the control circuit 31B itself and various data stored in the memory 30B to the P/S 37B via a signal line 31b1, a driver 38B, and a signal line 38b1. Various signals and data output from an S/P conversion section (hereinafter and in the figures, abbreviated as S/P) 39B are input to the control circuit 31B via a signal line 38b2, the driver 38B, and a signal line 31b2.

The control circuit 31B controls a threshold and a determination range of the CDS circuit 35B.

The reset circuit 32B performs reset processing according to timing when a power supply supplied from the processor 4 fluctuates or timing based on the watchdog timer in the control circuit 31B.

A switch ON/OFF signal generated by the operation of the switches of the operation switch section 28B is output to the P/S 37B via a signal line 28b. It is assumed that the switch ON/OFF signal generated by the operation of the switches of the operation switch section 28B is generated using a driving voltage supplied from the driving circuit 71 of the processor 4.

The P/S 37B applies parallel/serial conversion to the switch ON/OFF signal input via the signal line 28b, the digital signal input via the signal line 36b, and the various data and the arithmetic processing result input via the signal line 38b1. Consequently, the P/S 37B generates a serial signal. The P/S 37B outputs the generated serial signal to the processor 4 via a transceiver 40B and a signal line arranged to be inserted through the inside of the cable 33B.

The S/P 39B applies serial/parallel conversion to the various signals and data input as the serial signal via the signal line arranged to be inserted through the inside of the cable 33B and a receiver 41B after being output from the processor 4. Thereafter, the S/P 39B outputs the parallelized various signals and data to the driver 38B via the signal line 38b2. The S/P 39B outputs the parallelized various signals and data to a D/A conversion section (hereinafter and in the figures, abbreviated as D/A) 42B via a signal line 42b.

The D/A 42B converts, among the various signals and data output from the S/P 39B, a CCD driving signal generated in the processor 4 on the basis of the endoscope connection detection signal into an analog signal. Thereafter, the D/A 42B outputs the analog signal to the CCD 24B via a signal line 24b2. The CCD 24B is driven according to the CCD driving signal input via the signal line 24b2.

The connector 29B outputs an endoscope connection detection signal indicating that the endoscope 2B is connected to the processor 4 to the processor 4 via a signal line 29b. The signal line 29b is connected to the connector 29B on one end side and arranged to be inserted through the inside of the cable 34B. The signal line 29b is connected to the internal circuit of the processor 4 on the other end side.

For the purpose of realizing a reduction in the size of the endoscope 2B, the P/S 37B, the S/P 39B, the driver 38B, the control circuit 31B, and the reset circuit 32B (in FIG. 3, a portion surrounded by a broken line) may include an FPGA (Field Programmable Gate Array), an ASIC (Application Specific Integrated Circuit), a DSP (Digital Signal Processor), or the like.

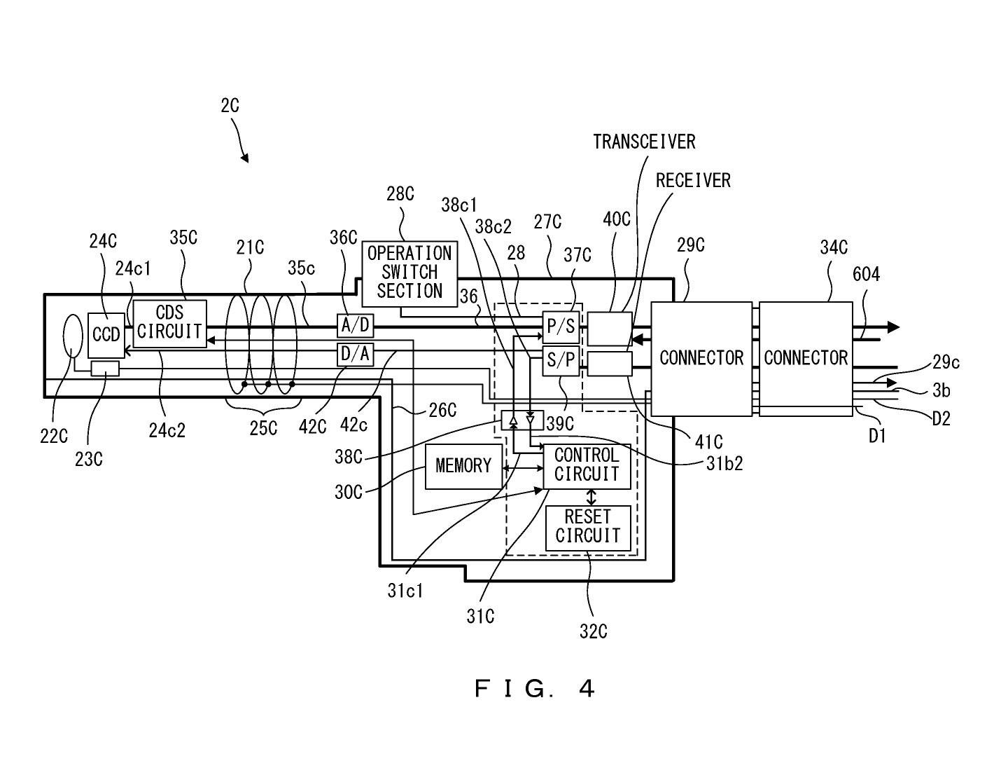

The endoscope 2C includes, as shown in FIG. 4, an insertion section 21C, an object optical system 22C, an actuator 23C, a CCD (charge coupled device) 24C, and plural source coils 25C. The insertion section 21C can be inserted into a body cavity of a patient. The object optical system 22C is provided at the distal end portion of the insertion section 21C and focuses an image of a subject. The actuator 23C moves the object optical system 22C in the axis direction of the insertion section 21C on the basis of a driving signal output from the driving circuit 602 of the processor 4. The CCD (charge coupled device) 24C is provided in a focusing position of the object optical system 22C. The plural source coils 25C are arranged over substantially the entire insertion section 21C and generate a magnetic field on the basis of a driving signal output from the endoscope shape detecting device explained later.

The endoscope 2C includes a light guide 26C, an operation section 27C, an operation switch section 28C, a connector 29C, a memory 30C a control circuit 31C, and a reset circuit 32C. The light guide 26C guides illumination light supplied from the light source device 3 via the light guide cable 3a to the distal end portion of the insertion section 21C. The operation section 27C is used for performing an operation instruction to the endoscope 2C and the like. The operation switch section 28C is an operation device including one or plural switches provided in the operation section 27C. The memory 30C stores a program, endoscope peculiar information data, and the like.

Further, the endoscope 2C is detachably connected to the processor 4 by the connector 34C connected to the connector 29C.

The CCD 24C picks up an image of a subject focused by the object optical system 22C. The CCD 24C outputs the picked-up image of the subject to a CDS (correlated double sampling) circuit 35C via a signal line 24c1 as an image pickup signal.

The CDS circuit 35C applies correlated double sampling processing to the image pickup signal output from the CCD 24C. The CDS circuit 35C outputs the image pickup signal subjected to the correlated double sampling processing to an A/D conversion section (hereinafter and in the figures, abbreviated as A/D) 36C via a signal line 35c.

The A/D 36C converts an analog image pickup signal output from the CDS circuit 35C into a digital signal. The A/D 36C outputs the digital signal obtained by converting the analog image pickup signal to the P/S 37C via a signal line 36c.

The memory 30C includes any one of an EEPROM, a FLASH ROM, an FRAM, an FeRAM, an MRAM, an OUM, an SRAM with battery, and the like, which are nonvolatile memories. The memory 30C has stored therein, as the endoscope peculiar information data, for example, a type of the CCD 24C, a type of the endoscope 2C, a serial number of the endoscope 2C, (one or plural) white balance data, the number of forceps channels (not shown) and the diameter of the channels of the endoscope 2C, the number of times of energization to the control circuit 31C, the number of times of pressing of the switches provided in the operation switch section 28C, a bending characteristic of the insertion section 21C, a value of the diameter of the insertion section 21C, a value of the diameter of the distal end portion of the insertion section 21C, an expansion scale of the object lens system 22C, forceps position information on an endoscopic combined image, inspection instruction information, first data of use of the endoscope 2C, the number of times of inspection, service information, a manufacturer comment, a service comment, a repair record, an inspection record, comment information, a version of a program of the control circuit 31C, rental information, the number of source coils 25C, a driving current for the source coils 25C, a driving voltage for the source coils 25C, and information concerning whether the endoscope 2C is a direct view or a side view.

Although not shown in the figure, the control circuit 31C includes an interface circuit (a serial interface circuit or a parallel interface circuit), a watchdog timer, a timer, an SRAM, and a FLASH ROM. The control circuit 31C performs control of reading of the various data stored in the memory 30C and writing of various data in the memory 30C via a not-shown interface circuit.

Further, the control circuit 31C performs arithmetic processing of, for example, the number of times of connection of the endoscope 2C, the number of times of pressing of the switches provided in the operation switch section 28C, and the number of times of energization to the control circuit 31C.

The control circuit 31C outputs a result of the arithmetic operation performed by the control circuit 31C itself and various data stored in the memory 30C to the P/S 37C via a signal line 31c1, a driver 38C, and a signal line 38c1. Various signals and data output from an S/P conversion section (hereinafter and in the figures, abbreviated as S/P) 39C are input to the control circuit 31C via a signal line 38c2, the driver 38C, and a signal line 31c2.

The control circuit 31C controls a threshold and a determination range of the CDS circuit 35C.

The reset circuit 32C performs reset processing according to timing when a power supply supplied from the processor 4 fluctuates or timing based on the watchdog timer in the control circuit 31C.

A switch ON/OFF signal generated by the operation of the switches of the operation switch section 28C is output to the P/S 37C via a signal line 28c. It is assumed that the switch ON/OFF signal generated by the operation of the switches of the operation switch section 28C is generated using a driving voltage supplied from the driving circuit 71 of the processor 4. The P/S 37C applies parallel/serial conversion to the switch ON/OFF signal input via the signal line 28c, the digital signal input via the signal line 36c, and the various data and the arithmetic processing result input via the signal line 38c1. Consequently, the P/S 37C generates a serial signal. The P/S 37C outputs the generated serial signal to the processor 4 via a transceiver 40C and connectors 29C and 34C.

The S/P 39C applies serial/parallel conversion to the various signals and data input as the serial signal via the connectors 34C and 29C and a receiver 41C after being output from the processor 4. Thereafter, the S/P 39C outputs the parallelized various signals and data to the driver 38C via the signal line 38c2. The S/P 39C outputs the parallelized various signals and data to a D/A conversion section (hereinafter and in the figures, abbreviated as D/A) 42C via a signal line 42c.

The D/A 42C converts, among the various signals and data output from the S/P 39C, a CCD driving signal generated in the processor 4 on the basis of the endoscope connection detection signal into an analog signal. Thereafter, the D/A 42C outputs the analog signal obtained by converting the CCD driving signal to the CCD 24C via a signal line 24c2. The CCD 24C is driven according to the CCD driving signal input via the signal line 24c2.

The connector 29C outputs an endoscope connection detection signal indicating that the endoscope 2C is connected to the processor 4 to the processor 4 via a signal line 29c. The signal line 29c is connected to the connector 29C on one end side. The signal line 29c is connected to the internal circuit of the processor 4 on the other end side through the connector 34C, the light source device 3, and the connectors 60C and 62C.

For the purpose of realizing a reduction in the size of the endoscope 2C, the P/S 37C, the S/P 39C, the driver 38C, the control circuit 31C, and the reset circuit 32C (in FIG. 4, a portion surrounded by a broken line) may include an FPGA (Field Programmable Gate Array), an ASIC (Application Specific Integrated Circuit), a DSP (Digital Signal Processor), or the like.

The endoscope 2C is detachably connected to the light source device 3 by the connector 29C and the connector 34C provided on the other end side not via the light guide 3a. As explained above, the endoscope 2C leads in not only a signal to the endoscope but also illumination light through the connector 34C. In this case, the illumination light passes through the light guide 3b on the inside of the endoscope 2C, passes through the connectors 34C and 29C, and is irradiated from the distal end of the endoscope 2C.

The connector 29C outputs the endoscope connection detection signal indicating that the endoscope 2C is connected to the processor 4 to the processor 4 via the signal line 29c. The signal line 29c is connected to the connector 29C on one end side. The signal line 29c is connected to the connector 34C of the light source device 3 on the other end side.

Fluctuation correction information of the actuator 23C may be stored in the memory 30C. In that case, the fluctuation correction information may be stored in association with a serial number of the processor 4 or a serial number of a substrate that realizes a receiver 78 and a transceiver 81 of the processor 4.

The endoscopes 2A, 2B, and 2C may be respectively configured as flexible mirrors or may be respectively configured as rigid mirrors.

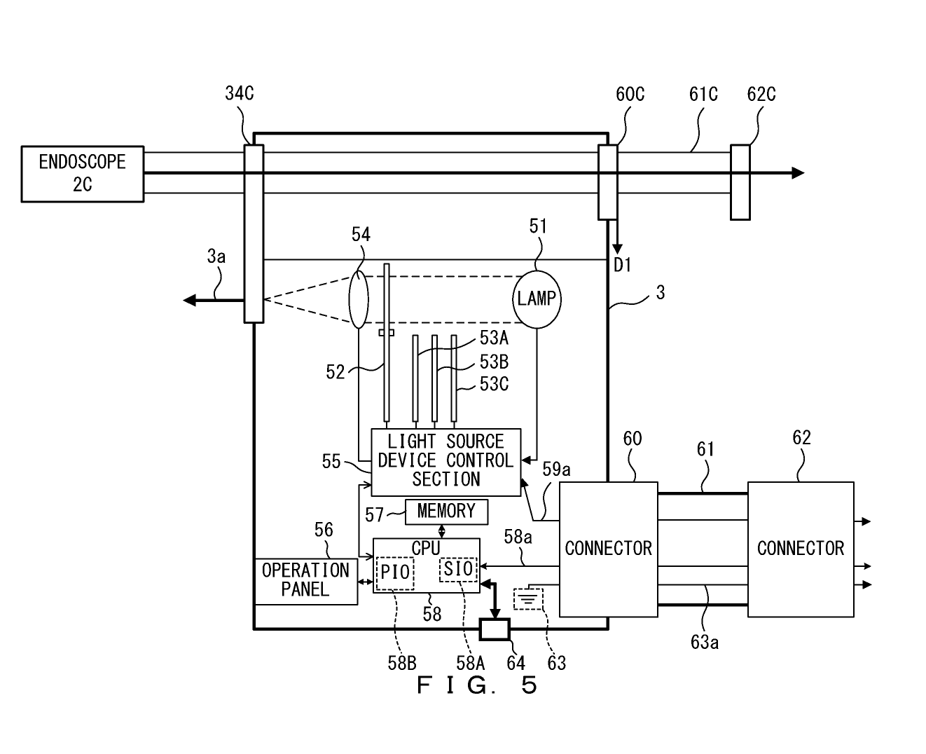

The light source device 3 includes, as shown in FIG. 5, a lamp 51, an RGB filter 52, plural (e.g., three) special light filters 53A, 53B, and 53C, an aperture 54, an RGB filter 52, and a light source device control section 55. The lamp 51 emits white light. The RGB filter 52 converts the white light emitted from the lamp 51 into surface sequential light of RGB. The plural (e.g., three) special light filters 53A, 53B, and 53C cut a wavelength in a predetermined band in the white light emitted from the lamp 51 to thereby generate narrow-band light. The aperture 54 controls a light amount of the white light emitted from the lamp 51. The light source device control section 55 inserts and removes the special light filters 53A, 53B, and 53C with respect to an emission optical axis of the white light emitted from the lamp 51 according to a dimming signal explained later.

The light source device 3 includes, as shown in FIG. 5, an operation panel 56, a memory 57, a CPU 58, a connector 60, and a connector 64. With the operation panel 56, it is possible to perform various kinds of setting and operation instructions such as adjustment of a light amount of illumination light to be emitted, power on and off of the device, lighting and lighting out of the lamp 51, transmissive illumination, and filter switching. The memory 57 stores a program and various data.

Further, the light source device 3 is detachably connected to the processor 4 by the connector 62 provided on the other end side of the cable 61 extending from the connector 60. The connector 64 can perform communication with other devices via a serial interface. The serial interface may include any one of a start-stop synchronization system, a clock synchronization system, USB (registered trademark), HOST/DEVICE, CAN, FLEX RAY, and I2C.

The light source device control section 55 detects light amount information, which is information concerning the light amount of the white light emitted from the lamp 51, and inputs and outputs the detected light amount information to the processor 4 via a signal line 59a as a light amount detection signal.

The memory 57 includes any one of an EEPROM, a FLASH ROM, an FRAM, an FeRAM, an MRAM, an OUM, an SRAM with battery, and the like, which are nonvolatile memories. The memory 57 has stored therein, as the various data, for example, light amount adjustment data, the life of the lamp 51, a serial number of the device, the types of the RGB filter 52 and the special light filters 53A, 53B, and 53C, and maintenance information.

The CPU 58 includes, on the inside, an SIO (Serial Input/Output) 58A and a PIO (Parallel input/output) 58B. The CPU 58 performs control of reading of the various data stored in the memory 57 and writing of various data in the memory 57 via the SIO 58A or the PIO 58B. The CPU 58 performs control of the light source device control section 55 and the operation panel 56. Either a parallel interface or a serial interface may be used for the writing and the reading of data performed between the CPU 58 and the memory 57. It is assumed that such a configuration is the same between the control circuit 31B and the memory 30B, between the control circuit 31C and the memory 30C, and between the CPU 31A and the memory 30A.

The CPU 58 performs transmission and reception of a result of the arithmetic processing performed by the CPU 58 itself and the various data stored in the memory 57 to and from the processor 4 via a signal line 58a. The signal line 58a is connected to the CPU 58 on one end side and arranged to be inserted through the inside of the cable 61. The signal line 58a is connected to the internal circuit of the processor 4 on the other end side.

Further, the CPU 58 outputs various signals and data from the SIO 58A to the signal line 58a. The various signals and data output to the signal line 58a are input to the internal circuit of the processor 4.

A grounding point provided in the light source device 3 is connected to a signal line 63a. When the connector 62 is connected to the processor 4, for example, a light source detection signal for discriminating whether the light source device 3 is a model capable of performing communication with the processor 4 is output from the grounding point 63 to the processor 4 via the signal line 63a.

When the light source device 3 is connected to the processor 4, various kinds of setting, operation instructions, and the like performed on the operation panel 56 are output to the processor 4 via the SIO 58A of the CPU 58.

All signals output from the endoscope 2C pass through the inside of the light source device 3.

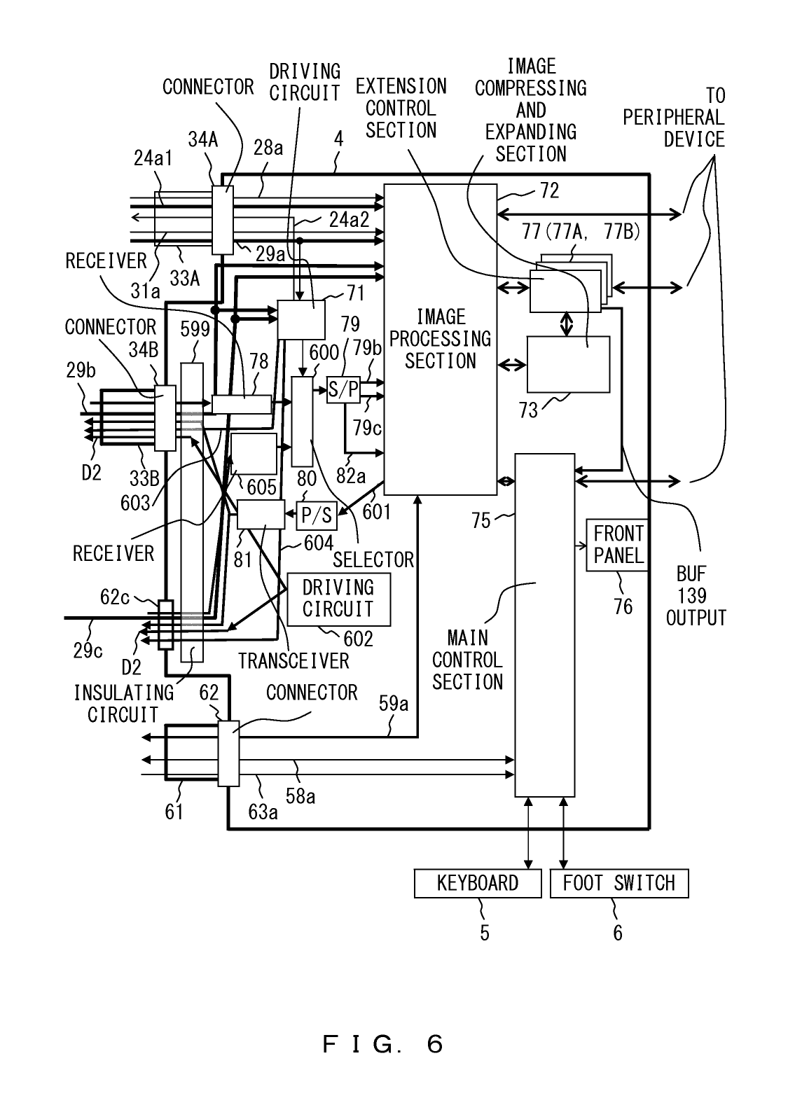

The processor 4 includes, as shown in FIG. 6, a driving circuit 71, an image processing section 72, an image compressing and expanding section 73, a main control section 75, a front panel 76, an extension control section 77, and an insulating circuit 599. The image processing section 72 performs various kinds of processing for images corresponding to images of a subject picked up by the endoscopes 2A, 2B, and 2C. The main control section 75 performs control of the sections of the processor 4 and the like. With the front panel 76, it is possible to perform various kinds of setting and operation instructions for the processor 4 and the like. The extension control section 77 is configured detachably attachable to the processor 4 as one or plural extension boards interchangeable with other substrates having a desired function.

The driving circuit 71 discriminates, on the basis of endoscope connection detection signals generated in the connector 29A, the connector 29B, and the connector 29C, which of the endoscopes 2A, 2B, and 2C are connected. The driving circuit 71 generates a CCD driving signal for driving any one of the CCDs 24A, 24B, and 24C. The driving circuit 71 outputs the generated CCD driving signal to the endoscopes 2A, 2B, and 2C via signal lines 24a2, 603, and 604. The driving circuit 71 supplies a driving power supply for causing ICs of the endoscopes 2A, 2B, and 2C to operate.

The driving circuit 71 controls a selector 600 to select a receiver input that is input from the driven endoscope. For example, when the endoscope including the driven CCD is the endoscope 2C, the driving circuit 71 controls the selector 600 to select an input of a receiver input from the endoscope 2C. When the driven endoscope is the endoscope 2A, for example, the driving circuit 71 controls the selector 600 to select a signal input through the endoscope 2A and the receiver to prevent the operation from becoming unstable.

The memory 30A, the CPU 31A, and the reset circuit 32A of the endoscope 2A, the memory 30B, the control circuit 31B, the driver 38B, the P/S 37B, the S/P conversion section 39B, the reset circuit 32B, the transceiver 40B, and the receiver 41B of the endoscope 2B, or the memory 30C, the control circuit 31C, the driver 38C, the P/S 37C, the S/P conversion section 39C, the reset circuit 32C, the transceiver 40C, and the receiver 41C of the endoscope 2C may be driven by the CCD driving signal.

When all the endoscopes 2A, 2B, and 2C are unconnected, the driving circuit 71 discriminates that the endoscopes are unconnected and does not output the CCD driving signal.

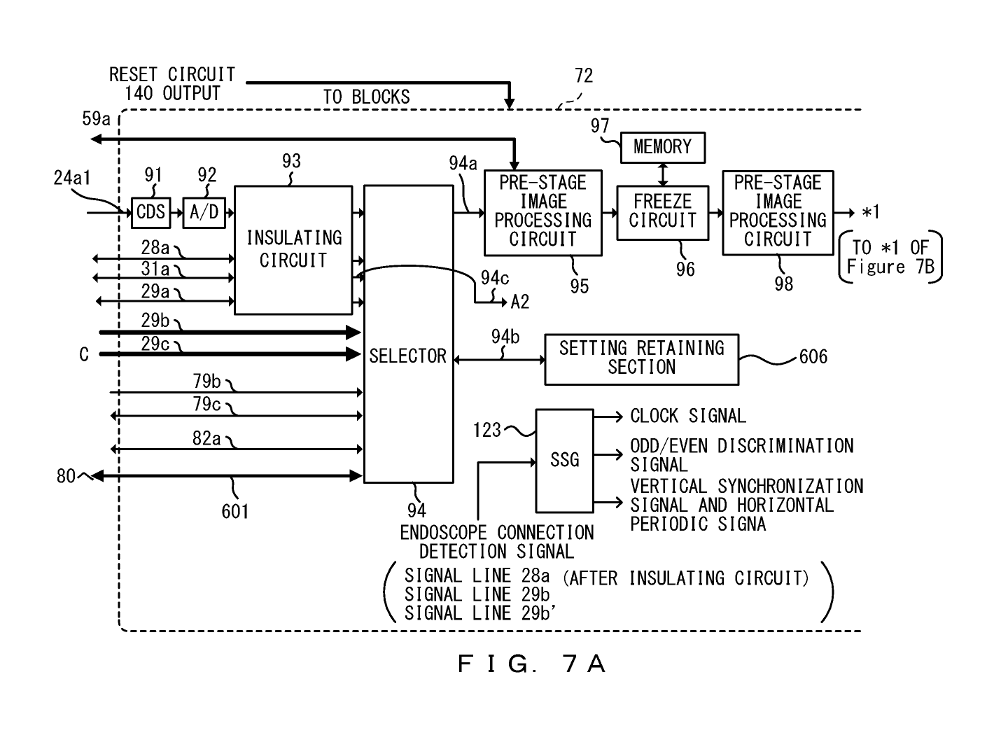

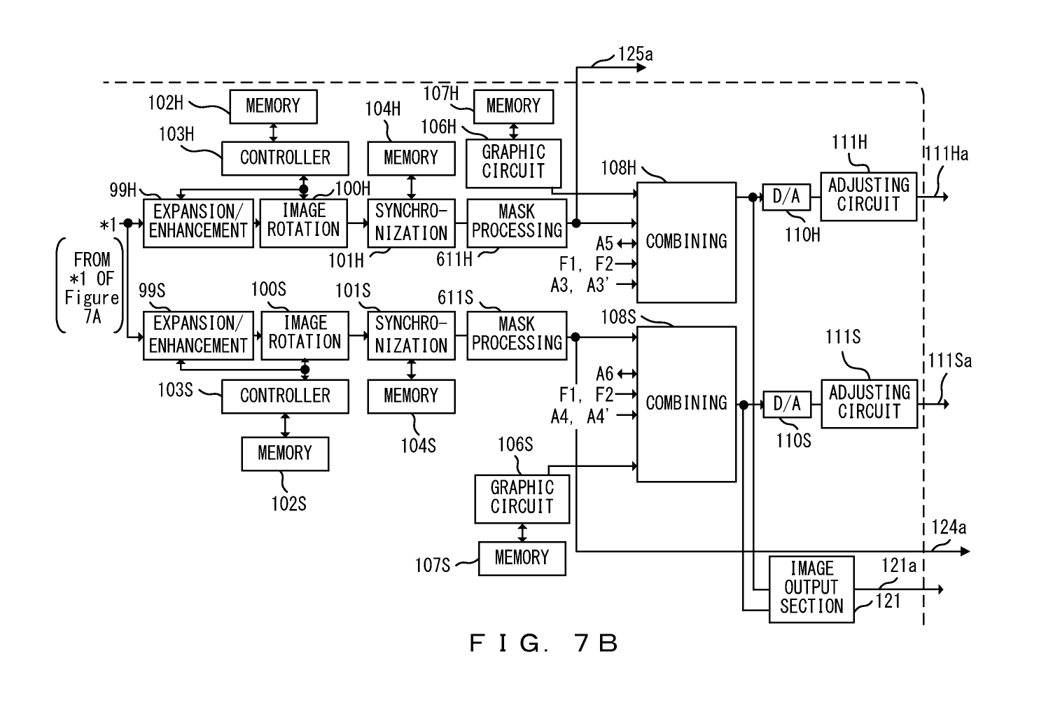

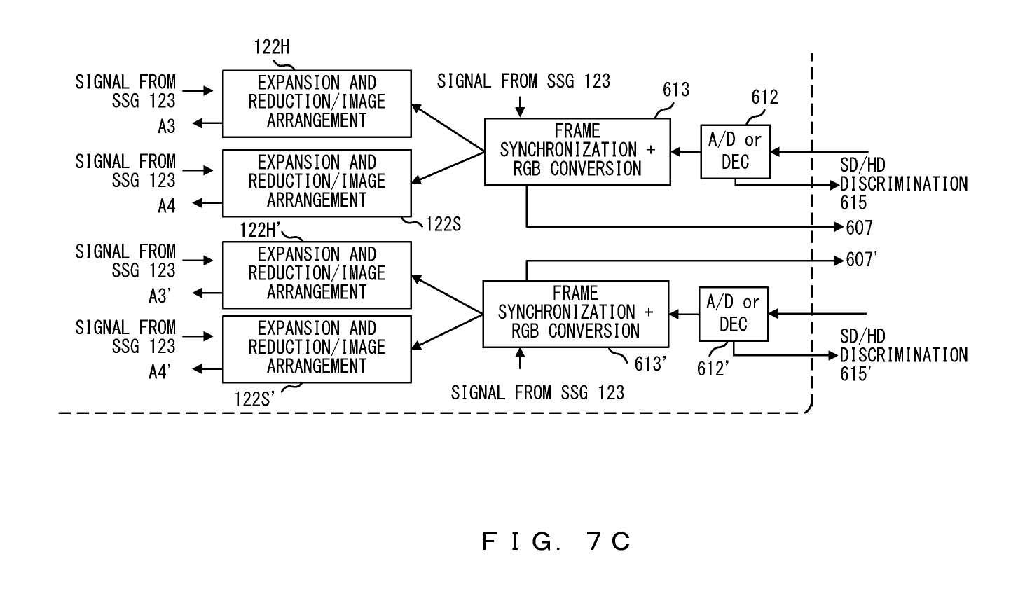

When two or all of the endoscopes 2A, 2B, and 2C are connected, the driving circuit 71 performs operation explained below. The driving circuit 71 generates, on the basis of a priority order determined in advance (a switching order by a selector 94 explained later with reference to FIGS. 7A-7C) and on the basis of endoscope connection detection signals generated in the connectors 29A, 29B, and 29C, a CCD driving signal for driving any one of the CCDs 24A, 24B, and 24C.

The priority order including the switching order by the selector 94 explained later with reference to FIGS. 7A-7C can be changed by a CPU 131 explained later.

Details of the configurations of the sections of the image processing section 72, the image compressing and expanding section 73, the main control section 75, and the extension control section 77 in the processor 4 are explained and shown later. Each of the image processing section 72, the image compressing and expanding section 73, and the main control section 75 in the processor 4 may be provided on one substrate and, like the extension control section 77, may include a configuration interchangeable with other substrates.

For signal transmission among the sections included in the processor 4, a parallel system may be used. Alternatively, for a reduction in noise and a reduction in size, a differential serial system such as LVDS (Low voltage differential signaling), RSDS (reduced swing differential signaling), or LVPECL (low voltage positive emitter coupled logic) may be used. Further, when transmission of signals among the sections included in the processor 4 is performed, the signals may be transmitted in an encrypted state. Consequently, when the transmission of the signals among the sections included in the processor 4 is performed, contents of the signals are not easily checked from the outside of the substrate. As a result, security of the processor 4 is improved.

An S/P 79 applies serial/parallel conversion to various signals and data input as a serial signal by the S/P 79 via a signal line arranged to be inserted through the inside of the cable 33B and the receiver 78 after being output from the endoscope 2B. Thereafter, the S/P 79 outputs the parallelized various signal and data to the image processing section 72.

The P/S 80 applies parallel/serial conversion to a signal output from the image processing section 72 to thereby generate a serial signal and outputs the serial signal to the transceiver 81. The transceiver 81 outputs the signal output from the P/S 80 to the endoscope 2B via a signal line arranged to be inserted through the inside of the cable 33B and outputs the signal to the endoscope 2C via a signal line arranged to be inserted through the inside of the cable 61C.

A signal transmitted through the connectors 34B and 62C of the processor 4 according to this embodiment is insulated via the insulating circuit 599.

The image processing section 72 of the processor 4 specifically includes, for example, a configuration shown in FIGS. 7A-7C (explained below).

An image pickup signal output via the signal line 24a1 is subjected to CDS processing by a CDS circuit 91 of the image processing section 72. Thereafter, the image pickup signal subjected to the CDS processing is subjected to digital conversion by an A/D conversion section (hereinafter and in the figures, abbreviated as A/D) 92. The image pickup signal subjected to the digital conversion is converted into a predetermined frequency (e.g., 13.5 MHz) by a not-shown frequency converter. Thereafter, the image pickup signal converted into the predetermined frequency is input to the selector 94 through an insulating circuit 93 including a photo-coupler.

An endoscope connection detection signal output via the signal line 29a is input to the selector 94 through the insulating circuit 93. Various signals and data output via the signal line 31a are input to the selector 94 through the insulating circuit 93. A switch ON/OFF signal output via the signal line 28a is input to the selector 94 through the insulating circuit 93.

Further, an image pickup signal, which is an output signal of the S/P 79, is input to the selector 94 via a signal line 79b. A switch ON/OFF signal is input to the selector 94 via a signal line 79c. Various signals and data are input to the selector 94 via a driver 82 and a signal line 82a. Endoscope connection detection signals from the endoscopes 2A, 2B, and 2C are respectively input to the selector 94 via the signal lines 29a, 29b, and 29c.

The selector 94 detects connection states of the endoscopes 2A, 2B, and 2C on the basis of the endoscope connection detection signal input via the signal line 29a, the endoscope connection detection signal from the endoscope 2B input via the signal line 29b, and the endoscope connection detection signal from the endoscope 2C input via the signal line 29c among the input signals.

In any one of four cases explained below, the selector 94 determines that the endoscope 2C is connected. In a first case, all the endoscopes 2A, 2B, and 2C are connected to the processor 4. In a second case, the endoscopes 2B and 2C are connected to the processor. In a third case, the endoscopes 2A and 2C are connected to the processor. In a fourth case, only the endoscope 2C is connected to the processor. When it is determined that the endoscope 2C is connected in any one of the cases, the selector 94 outputs the image pickup signal input via the signal line 79b to the signal line 94a through the receiver 605, the selector 600, and the S/P 79. The selector 94 outputs the switch ON/OFF signal input via the signal line 79c to the signal line 94b and stores the switch ON/OFF signal in a setting retaining section 606. The selector 94 outputs the endoscope connection detection signal from the endoscope 2C via the signal line 29c to the signal line 94b and stores the endoscope connection detection signal in the setting retaining section 606. The selector 94 outputs the various signals and data input via the signal line 82a and stored in the memory 30C in the endoscope 2C to the signal line 94b and stores the various signals and data in the setting retaining section 606.

When the endoscope 2A and the endoscope 2B are connected to the processor 4 or when only the endoscope 2B is connected to the processor, the selector 94 determines that the endoscope 2B is connected. In this case, the selector 94 outputs the image pickup signal input via the signal line 79b through the receiver 78, the selector 600, and the S/P 79 to the signal line 94a. The selector 94 outputs the switch ON/OFF signal input via the signal line 79c to the signal line 94b and stores the switch ON/OFF signal in the setting retaining section 606. The selector 94 outputs the endoscope connection detection signal from the endoscope 2B input via the signal line 29b to the signal line 94b and stores the endoscope connection detection signal in the setting retaining section 606. The selector 94 outputs the various signals and data input via the signal line 82a and stored in the memory 30B in the endoscope 2B to the signal line 94b and stores the various signals and data in the setting retaining section 606.

When only the endoscope 2A is connected to the processor, the selector 94 outputs the image pickup signal input via the selector 94 and the insulating circuit 93 to the signal line 94a. The selector 94 outputs the endoscope connection detection signal input via the signal line 29a and the insulating circuit 93 to the signal line 94b and stores the endoscope connection detection signal in the setting retaining section 606. The selector 94 outputs the switch ON/OFF signal input via the signal line 28a and the insulating circuit 93 to the signal line 94b and stores the switch ON/OFF signal in the setting retaining section 606.

The various signals and data input via the signal line 31a and the insulating circuit 93 and stored in the memory 30A in the endoscope 2A are input and output to the signal line 94c not through the selector 94.

When the selector 94 detects that all the endoscopes 2A and 2B and the endoscope 2C are not connected to the processor 4, the selector 94 prevents the operation from becoming unstable by performing processing same as the processing performed when the endoscope 2C is connected.

The setting retaining section 606 may include a logic circuit such as a flip-flop or may include a memory such as an FIFO or a Dual Port RAM.

The setting retaining section 606 also retains the endoscope connection detection signals of the endoscopes 2A and 2B and the endoscope 2C and a result of discrimination concerning which endoscope is connected. When the endoscopes are unconnected, the setting retaining section 606 retains a result of discrimination that the endoscopes are unconnected.

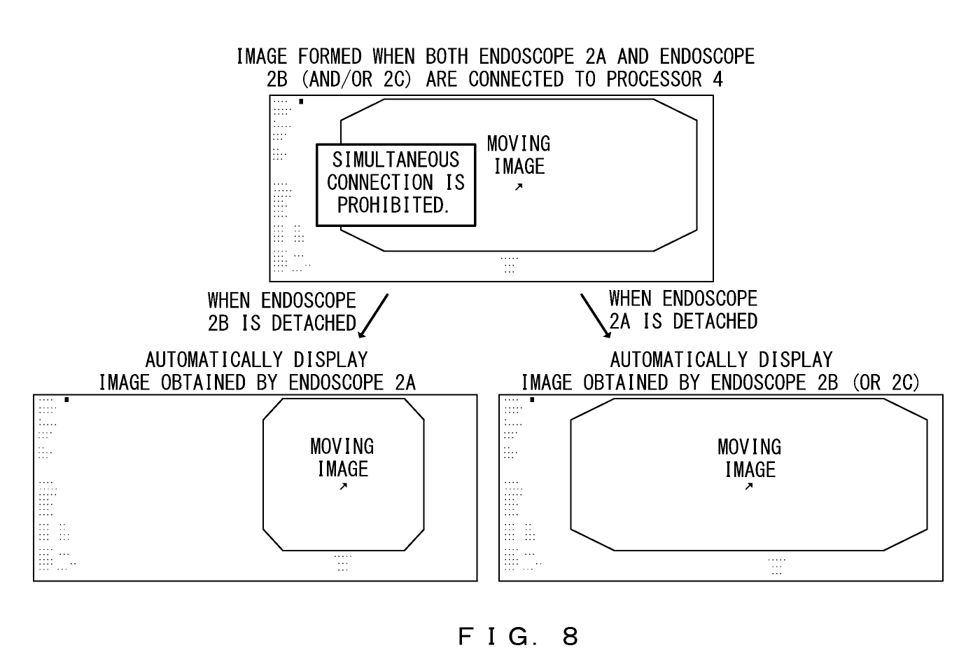

As the switching processing by the selector 94, processing for, when two or more of the endoscopes 2A and 2B and the endoscope 2C are connected, outputting a signal obtained by one endoscope connected first and displaying an image (on a display section such as a monitor) may be performed. When two or more of the endoscopes 2A and 2B and the endoscope 2C are connected to the processor 4, processing may be performed as explained below. A graphic circuit 106H (or 106S) explained later among sections arranged at the post stage of the selector 94 in the processor 4 may be, for example, a circuit that generates and outputs a warning indication image indicating simultaneous connection as shown in FIG. 8. When the selector 94 detects that one endoscope is detached, the selector 94 may automatically output an image obtained by the other endoscope.

According to the action explained above, when two or more of the endoscopes 2A and 2B and the endoscope 2C are connected to the processor 4, the processor 4 can promptly notify the user that one of the endoscopes is detached.

According to the action explained above, when one endoscope is detached, the processor 4 automatically displays an image of the other connected endoscope. As a result, the user can easily and quickly perform an examination, improve examination efficiency, and reduce an examination time.

Further, when two or more of the endoscopes 2A, 2B, and 2C are connected to the processor 4, the sections arranged at the post stage of the selector 94 in the processor 4 indicate a warning in a not-shown LED provided in the front panel 76 and/or the keyboard 5. Therefore, the sections may perform processing for lighting or blinking the LED or may perform processing for sounding a warning sound by a not-shown buzzer.

The CPU 131 can store other various signals and data in the setting retaining section 606 via the CPU 131 and a BUF 139. The stored various signals and data can be stored in the respective memories 30B and 30C in the endoscopes 2B and 2C through the selector 94, the signal line 601, the P/S 80, and the transceiver 81.

The image pickup signal output from the selector 94 to the signal line 94a is subjected to OB (Optical Black) clamp processing, frequency conversion (e.g., 27 MHz) processing, white balance processing, and AGC (Automatic Gain Control) processing by a pre-stage image processing circuit 95. Thereafter, the image pickup signal subjected to those kinds of processing is output to a freeze circuit 96 as an image signal. The endoscope connection detection signals, the switch ON/OFF signals, and the various signals and data output from the selector 94 to the signal line 94b are stored in the setting retaining section 606. The main control section 75 inputs and outputs the stored information of the setting retaining section through the BUF 139. Further, the various signals and data output from the insulating circuit 93 to the signal line 94c are input and output to the main control section 75 (an SIO 142 explained later of the main control section 75) (indicated as A2 in the figure).

The image signal output from the pre-stage processing circuit 95 is input to the freeze circuit 96. When a first freeze switch (hereinafter referred to as freeze switch) is operated and a first freeze instruction (hereinafter referred to as freeze instruction) is performed in any one of the operation devices, the freeze circuit 96 outputs a freeze image to a memory 97. In the following explanation, a first freeze image acquired when the freeze instruction is issued is referred to as freeze image. Freeze switches provided in the operation devices may be capable of performing a toggle operation (repeating actions of freeze ON→OFF→ON every time the switches are pressed). In this embodiment, the operation devices indicate the keyboard 5, the front switch 6, the front panel 76, the operation switch sections 28A and 28B, and HIDs (Human Interface Devices) explained later. Further, the freeze circuit 96 may be a circuit that outputs a pre-freeze image other than the freeze image.

The image signal output from the freeze circuit 96 is input to a post-stage image processing circuit 98. The image signal input to the post-stage image processing circuit 98 is output in a state in which the image signal is subjected to processing such as IHb chroma enhancement processing, moving image color drift correction processing, tone adjustment processing for R (red) or B (blue), and γ correction processing.

The image signal output from the post-stage image processing circuit 98 is output to each of a processing system for generating an image in an SDTV (Standard Definition TeleVision) system, which is a standard image, and a processing system for generating an image of an HDTV (High Definition TeleVision) system, which is a high-quality image. Consequently, the processor 4 can output images by both output systems of SDTV output (in the case of the NTSC, an output equivalent to 720×480 and, in the case of the PAL, an output equivalent to 720×576) and HDTV output (an output equivalent to 1920×1080).

The processing system for generating an image of the SDTV system in the processor 4 is explained.

According to operation, setting, and the like in the operation devices, processing such as expansion/reduction processing (processing such as electronic expansion/reduction processing and image size changing processing), contour enhancement processing, and structure enhancement processing is applied by an expanding/enhancing circuit 99S to the image signal output from the post-stage image processing circuit 98. Processing such as up down and left and right reversal processing and 90 degrees rotation processing is applied to the image signal by an image rotation processing circuit 100S. Thereafter, synchronization processing is applied to the image signal by a synchronizing circuit 101S. In this embodiment, it is assumed that, for example, the synchronizing circuit 101S performs an operation at 27 MHz during image signal input and performs an operation at 13.5 NHz during image signal output.

A memory 102S includes a nonvolatile memory such as a FLASH ROM, an FRAM, an FeRAM (Ferroelectric Random Access Memory), an MRAM (Megnetoresistive Random Access Memory), or an OUM (Ovonic Unified Memory). The memory 102S has stored therein processing parameters such as an expansion (reduction) coefficient, an enhancement coefficient, and an image rotation parameter as parameters concerning processing by the expanding/enhancing circuit 99S and the image rotation processing circuit 100S. The controller 103S controls the processing by the expanding/enhancing circuit 99S and the image rotation processing circuit 100S according to the processing parameters stored in the memory 102S.

The memory 102S may be configured as a volatile memory such as an SRAM (Static Random Access Memory), an SDRAM (Synchronous Dynamic Random Access Memory), an EDORAM (Extended Data Out Random Access Memory), a DRAM (Dynamic Random Access Memory), or an RDRAM (Rambus Dynamic Random Access Memory). The memory 102S may be configured as a memory in which necessary parameters are written by the main control section 75 every time a main power supply for the processor 4 is turned on. In the following explanation, it is assumed that a configuration substantially the same as the memory 1025 can be applied to all the memories of the image processing section 72.

A memory 104S stores frame images of R, G (green), and B such that the frame images are simultaneously output by synchronization processing by the synchronizing circuit 101S.

A mask processing circuit 611S applies mask processing to an image signal output in a synchronized state by the synchronizing circuit 101S.

The graphic circuit 106S generates and outputs character and graphic information indicating information related to an image (hereinafter referred to as endoscope related information) corresponding to the image signal subjected to the mask processing by the mask processing circuit 611S. It is assumed that the graphic information is information concerning images such as error display, menu display, a HELP image, a GUI, and a CUI.

A memory 107S is a memory used when the graphic circuit 106S generates the character and graphic information indicating the endoscope related information.

The combining circuit 108S combines the character and graphic information generated by the graphic circuit 106S and outputs from sections of an expanding and reducing/image arranging circuit 122S explained later and the image compressing and expanding section 73 and the extension control section 77 with the image signal subjected to the mask processing by the mask processing circuit 611S. The combining circuit 108S outputs the image signal after the combination as an endoscopic combined image.

The endoscopic combined image output from the combining circuit 108S is subjected to analog conversion by a D/A conversion section (hereinafter and in the figures, referred to as D/A) 110S and, after being subjected to level adjustment by an adjusting circuit 111S, output via a signal line 111Sa.

The processing system for generating an image of the HDTV system in the processor 4 is explained.

Frequency conversion (e.g., 74 MHz) is applied by a not-shown frequency converting section to the image signal output from the post-stage image processing circuit 98. Thereafter, according to operation, setting, and the like in the operation devices, processing such as expansion/reduction processing, contour enhancement processing, and structure enhancement processing is applied to the image signal subjected to the frequency conversion processing. Then, processing such as up down and left right reversal processing and 90 degrees rotation processing is applied by an image rotation processing circuit 100H to the image signal subjected to those kinds of processing. Thereafter, synchronization processing is applied by a synchronizing circuit 101H to the image signal subjected to those kinds of processing.

A memory 102H has stored therein processing parameters such as an expansion (reduction) coefficient, an enhancement coefficient, and an image rotation parameter as parameters concerning the processing by the expanding/enhancing circuit 99H and the image rotation processing circuit 100H. A controller 103H controls the processing by the expanding/enhancing circuit 99H and the image rotation processing circuit 100H according to the processing parameters stored in the memory 102H.

A memory 104H stores frame images of R, G (green), and B such that the frame images are simultaneously output by the synchronization processing by the synchronizing circuit 101H.

A mask processing circuit 611H applies mask processing to the image signal output in a synchronized state by the synchronizing circuit 101H.

The graphic circuit 106H generates and outputs character and graphic information indicating information related to an image (hereinafter endoscope related information) corresponding to the image signal subjected to the mask processing by the mask processing circuit 611H. It is assumed that the graphic information is information concerning images such as error display, menu display, a HELP image, a GUI, and a CUI.

A memory 107H is a memory used when the graphic circuit 106H generates the character and graphic information indicating the endoscope related information.

The combining circuit 108H combines the character and graphic information generated in the graphic circuit 106H and outputs from sections of an expanding and reducing/image arranging circuit 122H, the image compressing and expanding section 73, and the extension control section 77 with the image signal subjected to the mask processing by the mask processing circuit 611H and outputs an image signal after the combination as an endoscopic combined image.

The endoscopic combined image output from the combining circuit 108H is subjected to analog conversion by an D/A conversion section (hereinafter and in the figures, abbreviated as D/A) 110H and, after being subjected to level adjustment by an adjusting circuit 111H, output via a signal line 111Ha.

An image output section 121 applies encode processing to one of the endoscopic combined image output from the combining circuit 108S and the endoscopic combined image output from the combining circuit 108H and then outputs the endoscopic combined image via a signal line 121a. Consequently, an image can be output (as a digital image or an analog image) via an interface such as LVDS, SDI, H-SDI, DV (IEEE1394), DVI, D1 D2, D3, D4, D5, D6, D9, or HDMI.

When an A/D or DEC circuit 612, a frame synchronizing and RGB conversion circuit 613, expansion and reduction/image arrangement S, and expansion and reduction/image arrangement H are set as one set, there are a pair of the sets.

A/D or DEC circuits 612 and 612′ respectively receive input of signals output from, among peripheral devices explained later, a device that can perform output of an analog signal in the SDTV system (e.g., a monitor 201A, a printer 202A, a VTR 203A, a filing device 204A, and a photographing device 205A), a device that can output an analog signal in the HDTV system (e.g., a monitor 201B, a printer 202B1, a VTR 203B1, a filing device 204B1, and a photographing device 205B1), or a device that can output an analog signal in the SDTV system and the HDTV system or a digital signal (an interface such as LVDS, SDI, H-SDI, DV (IEEE1394), DVI, D1, D2, D3, D4, D5, D6, D9, or HDMI) (e.g., a monitor 201C1, a printer 202C1, a VTR 203C1, a filing device 204C1, a photographing device 205C1, an endoscope shape detecting device 206C1 and an ultrasonic device 207C1, a monitor 201C2, a printer 202C2, a VTR 203C2, a filing device 204C2, a photographing device 205C2, an endoscope shape detecting device 206C2, and an ultrasonic device 207C2). The A/D or DEC circuits apply decode processing (including processing of digitization by A/D conversion) to the signals. At this point, the A/D or DEC circuits 612 and 612′ discriminate whether the input images are images of the HDTV system or images of the SDTV system and output SD/HD discrimination signals 615 and 615′ indicating a result of the discrimination.

Frame synchronizing and RGB conversion circuits 613 and 613′ respectively perform frame synchronization processing on the basis of a signal output from a synchronization signal generating circuit (hereinafter abbreviated as SSG) 123. Consequently, the image signal subjected to the decode processing by the A/D or DEC circuit 612 is combined at appropriate timing by the combining circuit 108S or 108H on the basis of discrimination signals of the SD/HD discrimination 615 and 615′. Further, the frame synchronizing and RGB conversion circuit 613 (or 613′) performs RGB conversion concerning the image signal. Thereafter, an RGB signal (or a YCrCb signal) obtained by the conversion by the frame synchronizing and RGB conversion circuit 613 (or 613′) is output to the image compressing and expanding section 73 via the expanding and reducing/image arranging circuits 122S and 122H (or 122S′ and 122H′) and signal lines 607 and 607′.

The expanding and reducing/image arranging circuits 122S and 122S′ respectively apply processing for adjustment of expansion and reduction of an image and arrangement of the image to RGB signals output from the frame synchronizing and RGB conversion circuits 613 and 613′. Consequently, the RGB images are combined by the combining circuit 108S at appropriate timing. The image is appropriately arranged in an endoscopic combined image on the basis of a synchronization signal output from the synchronization signal generating circuit (hereinafter abbreviated as SSG) 123 explained later. After applying the processing for adjustment of expansion and reduction of an image and arrangement of the image, the expanding and reducing/image arranging circuits 122S and 122S′ respectively output the RGB signals to the combining circuit 1085 (indicated as A4 and A4′ in FIGS. 7A-7C).

The expanding and reducing/image arranging circuits 122H and 122H′ respectively apply the processing for adjustment of expansion and reduction of an image and arrangement of the image to the RGB signals output from the frame synchronizing and RGB conversion circuits 613 and 613′. Consequently, the RGB signals are combined by the combining circuit 108H at appropriate timing. The image is appropriately arranged in an endoscopic combined image on the basis of a synchronization signal output from the SSG 123 explained later. After applying the processing for adjustment of expansion and reduction of an image and arrangement of the image, the expanding and reducing/image arranging circuits 122H and 122H′ respectively output the RGB signals subjected to the HDTV synchronization processing to the combining circuit 108H (indicated as A3 and A3′ in the figure).

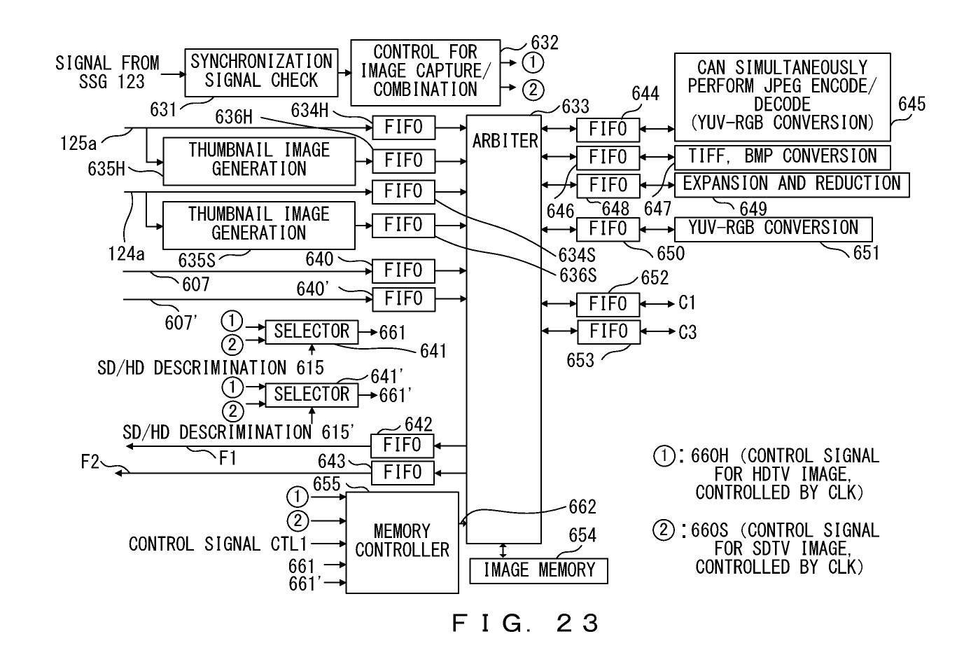

The “74 MHz” is accurately shown as (74.25/1.001) MHz or 74.25 MHz. The same applies to “74 MHz” in the following explanation. Further, in that case, the image compressing and expanding section 73 is configured as a programmable circuit such as an FPGA, a DSP, or a dynamic reconfigurable processor. The image compressing and expanding section 73 may be configured to be capable of switching a function as a circuit having a function of compression processing for a still image or a circuit having a function of compression processing for a moving image. (Details of the image compressing and expanding section 73 used in the processor 4 according to this embodiment are described as explanation concerning FIG. 23).

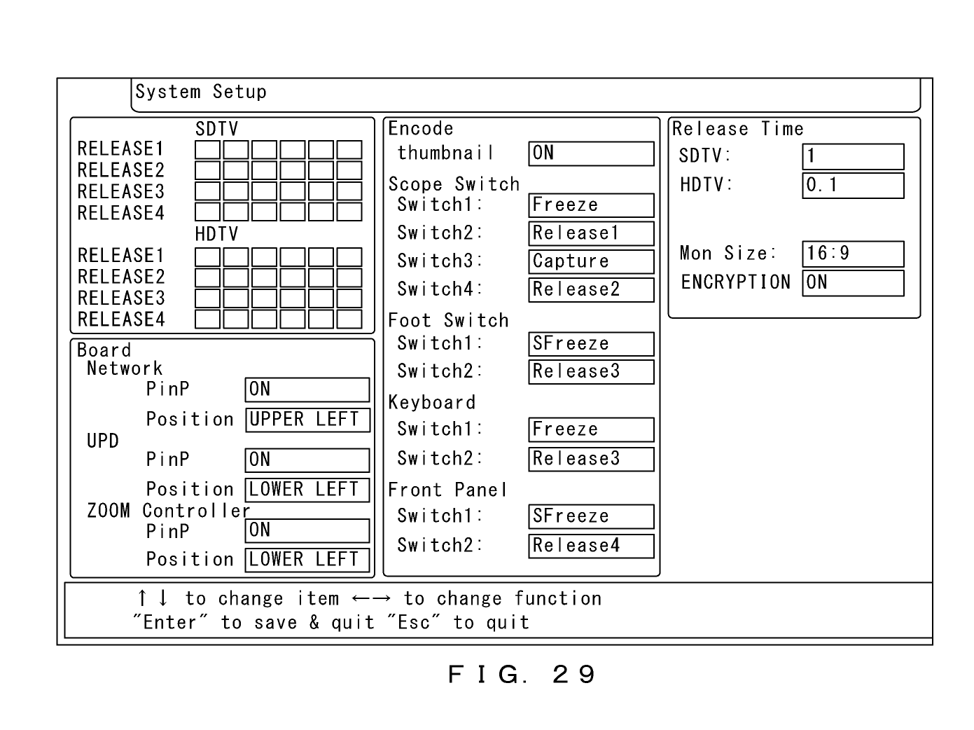

When the image compressing and expanding section 73 is configured as the programmable circuit, for example, on a setting screen or the like shown in FIG. 29 explained later, a compression form may be selected (one compression form may be selected out of JPEG JPEG2000, TIFF, BMP, AVI, MPEG, H.264, and WMV). A block (firmware or configuration data) corresponding to a selection result may be downloaded. The download of the block may be either performed by a CPU 151 of an extension control section 77A via a bus bridge 163 or performed from a not-shown ROM or the like provided in the image compressing and expanding section 73. Further, in the download of the block, an error message indicating that the download is being performed may be displayed on an endoscopic combined image. A not-shown predetermined LED included in an operation device may be lit (or blinked). When the download of the block is normally completed, a message indicating the normal completion may be displayed on a screen.

The SSG 123 provided in the processor 4 outputs plural vertical synchronization signals and horizontal synchronization signals, ODD/EVEN discrimination signals, and clocks as signals corresponding to the types of the endoscopes 2A, 2B, and 2C on the basis of an endoscope connection detection signal output from the endoscope 2A via the signal line 29a and the insulating circuit 93, an endoscope connection detection signal output from the endoscope 2B via the signal line 29b, or an endoscope connection detection signal output from the endoscope 2C via the signal line 29c.

Among the signals output from the SSG 123, a vertical synchronization signal VD1 (e.g., 60 Hz) and a horizontal synchronization signal HD1 (e.g., 15.75 kHz) are output to the sections from the CDS circuit 91 to the post-stage image processing circuit 98, the sections from the expanding/enhancing circuit 99S to the memory 104S, and the sections from the expanding/enhancing circuit 99H to the memory 104H. Among the signals output from the SSG 123, a vertical synchronization signal VD2 (e.g., 50 Hz or 60 Hz), a vertical synchronization signal VD3 (e.g., 50 Hz or 60 Hz), an ODD/EVEN discrimination signal ODD2, an ODD/EVEN discrimination signal ODD3, a horizontal synchronization signal HD2 (e.g., 15.75 kHz or 15.625 kHz), and a horizontal synchronization signal HD3 (e.g., 33.75 kHz or 28.125 kHz) are output to the synchronizing circuit 101S, the sections from the memory 104S to the combining circuit 108S, the expanding and reducing/image arranging circuit 122S, the synchronizing circuit 101H, the sections from the memory 104H to the combining circuit 108H, the expanding and reducing/image arranging circuit 122H, and the image output section 121.

The SSG 123 outputs, as clock signals mainly used in image processing, clock signals of 13.5 MHz, which is a standard clock in the SDTV system, 27 MHz, which is a clock having a double frequency of the standard clock, and 74 MHz, which is a standard clock in the HDTV system, respectively.

Among the clock signals, for example, the clock signal of 13.5 MHz is output to the sections from the A/D 92 to the pre-stage image processing circuit 95, the sections from the expanding/enhancing circuit 99S to the memory 104S, the D/A 110S, the image output section 121, the frame synchronizing and RGB conversion circuits 613 and 613′, and the expanding and reducing/image arranging circuits 122S and 122S′. Among the clock signals, for example, the clock signal of 27 MHz is output to the sections from the pre-stage image processing circuit 95 to the post-stage image processing circuit 98, the sections from the expanding/enhancing circuit 99S to the controller 103S, and the image output section 121. Further, among the clock signals, for example, the clock signal of 74 MHz is output to the sections from the expanding/enhancing circuit 99H to the D/A 110H, the image output section 121, the frame synchronizing and RGB conversion circuits 613 and 613′, and the expanding and reducing/image arranging circuits 122H and 122H′.

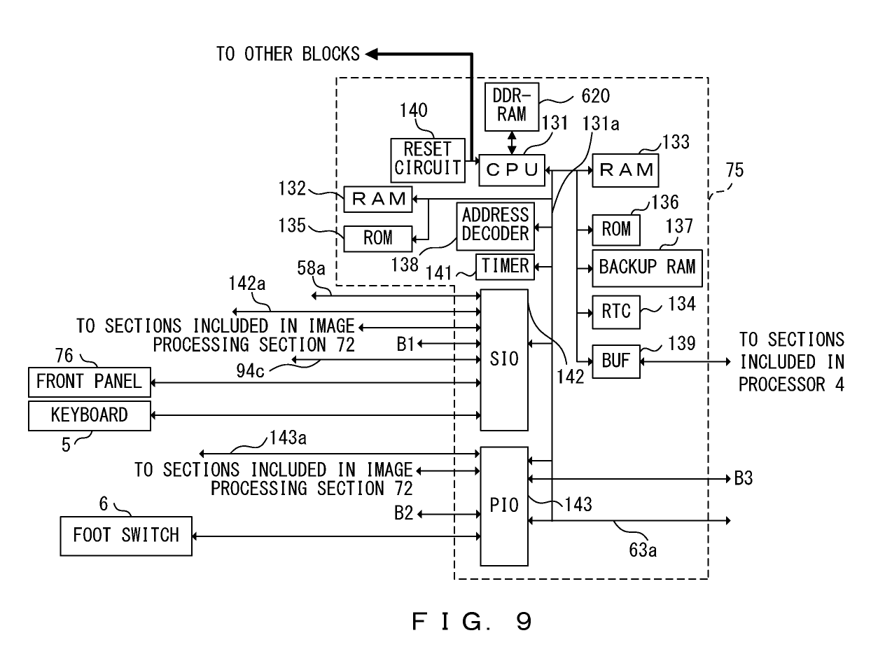

The main control section 75 of the processor 4 specifically includes, for example, a configuration shown in FIG. 9.

The CPU 131 of the main control section 75 controls writing and reading of data in the RAMs 132 and 133 via a not-shown parallel interface (or serial interface) and a system bus 131a.

The RAMs 132 and 133 are configured as volatile memories such as SRAMs, SDRAMs, DRAMs, or RDRAMs. The RAMs 132 and 133 can store program related data, endoscope information data, endoscopic image data, and the like. The RAMs 132 and 133 can also be used as caches.

The CPU 131 of the main control section 75 controls, via the system bus 131a, a real time clock (hereinafter in the figures, abbreviated as RTC) 134 that includes a clock and performs management of time.

The CPU 131 of the main control section 75 performs, via the system bus 131a, control of the ROMs 135 and 136 that store data such as program data and version data of a program.

The CPU 131 of the main control section 75 performs control of a backup RAM 137 via the system bus 131a.

The backup RAM 137 includes an EEPROM (Electrically Erasable and Programmable Read Only Memory), a FLASH ROM, an FRAM, an FeRAM, an MRAM, an OUM, or an SRAM with battery. The backup RAM 137 has stored therein endoscope related information serving as information that should be retained even after the power supply for the processor 4 is turned off such as a log of a program operation, maintenance information, setting information in the front panel 69 and the keyboard 14, various kinds of setting screen information, and white balance data.

The CPU 131 of the main control section 75 performs control of an address decoder 138 and the bus driver (hereinafter and in the figures, abbreviated as BUF) 139 via the system bus 131a. The address decoder 138 outputs a chip select signal to the sections included in the processor 4. The BUF 139 performs control for supplying a signal of the system bus 131a to the sections included in the processor 4.

The CPU 131 of the main control section 75 controls a RESET circuit 140 and performs, via the system bus 131a, control of a timer 141 for performing time management.

The RESET circuit 140 includes a not-shown watchdog timer. When the RESET circuit 140 detects that the power supply for the processor 4 is turned on or a program being executed in the processor 4 is hung up, the RESET circuit 140 performs reset processing.

The CPU 131 of the main control section 75 performs control of the SIO 142 and the PIO 143 via the system bus 131a.

The SIO 142 can perform communication with sections (an SIO included in the extension control section 77, the sections included in the front panel 76 and the image processing section 72, etc.) included in the processor 4, peripheral devices connected to the processor 4, the keyboard 5, the CPU 31A of the endoscope 2A, the SIO 58A included in the CPU 58 of the light source device 3, and the like via a serial interface. The serial interface may include any one of a start-stop synchronization system, a clock synchronization system, USB (Universal Serial Bus) (registered trademark), HOST/DEVICE, CAN (Controller Area Network), FLEX RAY, and I2C. Connection of the SIO 142 and the SIO included in the extension control section 77 is shown as B1 in the figure. A signal line for connecting the SIO 142 and the peripheral devices is shown as 142a in the figure.

The PIO 143 can perform communication with sections included in the processor 4 (a PIO and a board connection information storing circuit included in the extension control section 77, the sections of the image processing section 72, etc.), peripheral devices connected to the processor 4, the foot switch 6, and the like via a parallel interface. Connection of the PIO 143 and the PIO included in the extension control section 77 is shown as B2 in the figure. A signal line for connecting the PIO 143 and the peripheral devices is shown as 143a in the figure.

The PIO 143 outputs a light source detection signal input via the signal line 63a to the CPU 131 via the system bus 131a. An endoscope connection detection signal, a switch ON/OFF signal, and various signals and data are input to the CPU 131 via the system bus 131a through the setting retaining section 606 and the BUF 139. A dimming signal generated and output in the pre-stage image processing circuit 95 is output to the light source device control section 55 via the signal line 59a. Further, the PIO 143 outputs a board connection detection signal output from the extension control section 77 to the CPU 131 via the system bus 131a. Connection of a route through which the board connection detection signal is transmitted from the extension control section 77 to the PIO 143 is shown as B3 in the figure.

The CPU 131 of the main control section 75 performs control of a DDR-RAM (Double-Data-Rate Random Access Memory) 620 connected via a dedicated line.

In this embodiment, the sections such as the CPU 131, the RAM 132, the ROM 135, the address decoder 138, the reset circuit 140, the timer 141, the SIO 142, and the PIO 143 included in the main control section 75 include dedicated ICs. However, this is not a limitation. For example, these sections may include programmable ICs such as FPGAs, DSPs, or reconfigurable processors. Among the sections included in the image processing section 72, the image compressing and expanding section 73, and the extension control section 77, sections having the same functions as the sections included in the main control section 75 are not limited to sections including dedicated ICs and may be sections including programmable ICs.

When the CPU 131 of the main control section 75 detects, on the basis of the light source detection signal 63a input via the PIO 143, for example, that a signal level of the light source detection signal is an L level, the CPU 131 discriminates that communication with the light source device 3 is possible (the light source device 3 is a model having a communication function). When the CPU 131 of the main control section 75 detects, on the basis of a light source detection signal input via the PIO 134, for example, that a signal level of the light source detection signal is an H level, the CPU 131 discriminates that communication with the light source device 3 is impossible (the light source device 3 is a model not having the communication function).

The operations performed by the selector 94 on the basis of the endoscope connection detection signal may be performed by the CPU 131 of the main control section 75 on the basis of table data stored in the ROM 135 when the endoscope connection detection signal is input via the signal line 29a, the signal line 29b, or the signal line 29c.

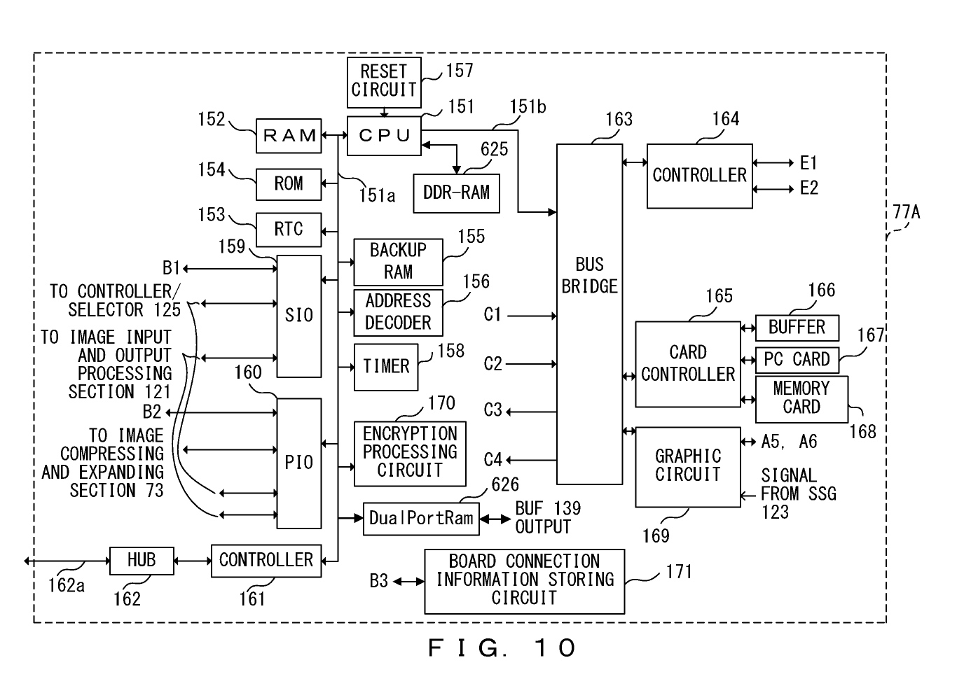

The extension control section 77 configured as the extension board detachably connected to the processor 4 is specifically configured as, for example, an extension control section 77A having a network communication function shown in FIG. 10 (explained blow).

The CPU 151 of the extension control section 77A controls writing and reading of data in a RAM 152 via a not-shown parallel interface (or serial interface) and a system bus 151a.

The RAM 152 is configured as a nonvolatile memory such as an SRAM, an SDRAM, a DRAM, or an RDRAM. The RAM 152 can store program related data, endoscope information data, endoscopic image data, and the like. The RAM 152 can also be used as a cache.

The CPU 151 of the extension control section 77A controls, via the system bus 151a, a real time clock (hereinafter and in the figures, abbreviated as RTC) 153 that includes a clock and performs management of time.

The CPU 151 of the extension control section 77A performs, via the system bus 151a, control of a ROM 154 that stores data such as program data, version data of a program, and an MAC address and an IP address of an Ethernet (registered trademark).

The CPU 151 of the extension control section 77A performs control of a backup RAM 155 via the system bus 151a.

The ROM 154 and the backup RAM 155 include EEPROMs, FLASH ROMs, FRAMs, FeRAMs, MRAMs, OUMs, or SRAMs with battery. The backup RAM 155 has stored therein endoscope related information serving as information that should be retained even after the power supply for the processor 4 is turned off such as a log of a program operation, maintenance information, setting information in the front panel 69 and the keyboard 14, various kinds of setting screen information, white balance data, and the like.

The CPU 151 of the extension control section 77A performs, via the system bus 151a, control of an address decoder 156 that outputs a chip select signal to the sections included in the processor 4.

The CPU 151 of the extension control section 77A controls a RESET circuit 157 and performs, via the system bus 151a, control of a timer 158 for performing time management.

The RESET circuit 157 includes a not-shown watchdog timer and performs reset processing when the RESET circuit 157 detects that the power supply for the processor 4 is turned on or a program being executed in the processor 4 is hung up.

The CPU 151 of the extension control section 77A performs control of an SIO 159 and a PIO 160 via the system bus 151a.

The SIO 159 can communicate with, via a serial interface, the sections (the image output section 121, the SIO included in the main control section 75, etc.) included in the processor 4, the peripheral devices connected to the processor 4, and the like. The serial interface may include any one of a start-stop synchronization system, a clock synchronization system, USB (registered trademark), HOST/DEVICE, CAN, FLEX RAY, and I2C.

The PIO 160 can perform, via a parallel interface, communication with the sections (the image compressing and expanding section 73, the image output section 121, the PIO included in the main control section 75, etc.) included in the processor 4, the peripheral devices connected to the processor 4, and the like.

The CPU 151 of the extension control section 77A controls writing and reading of data in a DDR-RAM 625 connected via a dedicated line.

The CPU 151 of the extension control section 77A performs control of a Dual Port RAM 626 via the system bus 151a. The Dual Port RAM 626 is used for performing input and output of endoscope related information via the BUF 139. This makes it possible to perform transmission and reception of the endoscope related information between the CPU 151 and the CPU 131.

The CPU 151 of the extension control section 77A performs control of a controller 161 and a HUB 162 via the system bus 151a.

The controller 161 is configured to be capable of performing communication by an Ethernet (registered trademark) and includes circuits of an MAC layer, a physical layer, and the like and middleware of the Ethernet (registered trademark). The controller 161 can perform, via the HUB 162 and a signal line 162a connected to the HUB 162, communication with the peripheral devices connected to the processor 4.

The CPU 151 of the extension control section 77A performs control of the bus bridge 163 via a system bus 151b. The system bus 151b may include any one of PCI (Peripheral Component Interconnect), RAPIDIO, PCI-X, PCI EXPRESS, COMPACT PCI, ISA (Industry Standard Architecture), and the like. Connection of the bus bridge 163 and the image compressing and expanding section 73 is shown as C1 and C2 in the figure. Connection of the bus bridge 163 and the image compressing and expanding section 73 is shown as C3 and C4 in the figure.

The CPU 151 of the extension control section 77A performs, via the system bus 151b and the bus bridge 163, control of a controller 164 functioning as a USB (registered trademark) interface.

The CPU 151 of the extension control section 77A performs control of a card controller 165 via the system bus 151b and the bus bridge 163.

The card controller 165 applies control to a PC card 167 and a memory card 168 functioning as image recording sections connected to a not-shown slot. The memory card 168 may be any one of compact flash (registered trademark), smart media (registered trademark), an SD card, a mini SD (registered trademark) card, a memory card of a PC card form, a flash drive, a HDD, a multimedia card, an xDPicture card, and a memory stick (registered trademark).

The card controller 165 performs control of the buffer 166. The buffer 166 functioning as an image recording section can store data before reception not to disappear even when, for example, the power supply for the processor 4 is turned off before completion of transmission and reception of the data in communication between the controller 161 and a peripheral device. The buffer 166 may be any one of compact flash (registered trademark), smart media (registered trademark), an SD card, a mini SD (registered trademark) card, a memory card of a PC card form, a flash drive, a HDD, a multimedia card, an xDPicture card, a memory stick (registered trademark), and a PC card. Further, a not-shown USB (registered trademark) memory connected to the controller 164 may be used instead of the buffer 166.

By storing information concerning a recording state in the backup RAM 137 of the main control section 75 or the backup RAM 155 of the extension control section 77A, the CPU 131 of the main control section 75 and the CPU 151 of the extension control section 77A can determine whether the buffer 166 is being recorded.

The CPU 151 of the extension control section 77A applies control to a graphic circuit 169 via the system bus 151b and the bus bridge 163.

The graphic circuit 169 performs graphic processing concerning a moving image, a still image, WEB display, and the like on the basis of a synchronization signal output from the SSG 123 of the image processing section 72. Connection of the graphic circuit 169 and the combining circuit 108H and the combining circuit 108S of the image processing section 72 is shown as A5 and A6 in the figure.

The CPU 151 of the extension control section 77A applies control to an encryption processing circuit 170 via the system bus 151b and the bus bridge 163.

The encryption processing circuit 170 is configured as a circuit that can perform addition and detection of security information and perform encryption and decryption in communication with a peripheral device. An encryption system used by the encryption processing circuit 170 in the encryption may be either a 3DES SSL RSA system or an elliptic encryption system. Further, the encryption system may be applicable to a protocol of either IPsec or SSL.

The extension control section 77A includes a board connection information storing circuit 171 that outputs a board connection detection signal to the PIO of the main control section 75 when the extension control section 77A is connected thereto.

The board connection detection signal output from the board connection information storing circuit 171 may be formed of a pull-down signal to plural GNDs or a pull-up signal to the power supply. Further, the board connection information storing circuit 171 may be configured as a nonvolatile memory in which information concerning the type of the extension control section 77A is stored. The board connection information storing circuit 171 may output the board connection detection signal to the SIO of the main control section 75 via a not-shown serial interface.

Further, for example, when any one of the bus bridge 163, the controller 164, and the slot into which the PC card 167 and the memory card 168 are inserted includes a connectable radio control circuit, the extension control section 77A can perform, by radio, communication with the peripheral devices connected to the processor 4. An antenna, a memory, and an encryption circuit corresponding to the radio control circuit are mounted on the sections such as the endoscope 2A, the endoscope 2B, the endoscope 2C, and a not-shown endoscope treatment instrument, whereby the extension control section 77A can also perform exchange of endoscope related information with the sections by radio.

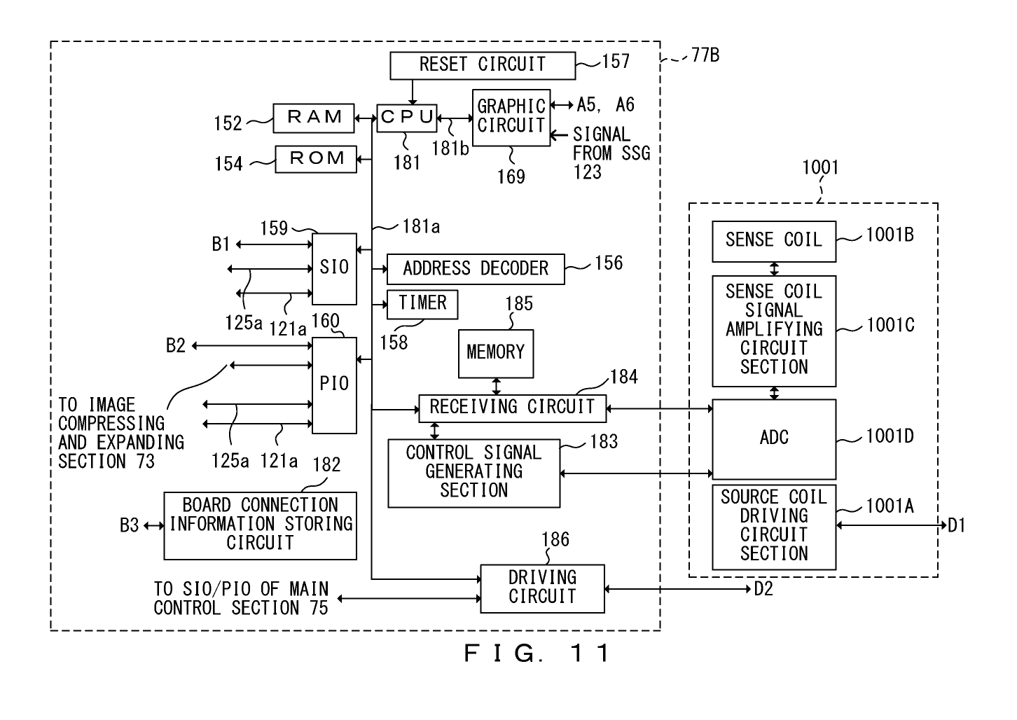

The extension control section 77 configured as one or plural extension boards detachably connected to the processor 4 is not limited to only the extension control section 77A. For example, an extension control section 77B having a zoom control function and a function of a part of the endoscope shape detecting device shown in FIG. 11 (explained below) may also be connected to the processor 4.

A CPU 181 of the extension control section 77B controls, via a system bus 181a, the RAM 152, the ROM 154, the address decoder 156, the reset circuit 157, the timer 158, the SIO 159, and the PIO 160, which are sections having configurations same as the configurations explained above. The CPU 181 of the extension control section 77B performs, via a system bus 181b, control of the graphic circuit 169 having a configuration same as the configuration explained above.

The extension control section 77B includes a board connection information storing circuit 182 that outputs a board connection detection signal (different from the board connection information storing circuit 171) to the PIO of the main control section 75 when the extension control section 77B is connected thereto.

The configuration, the functions, and the like of an endoscope shape detecting device 1001 shown in FIG. 11 are explained.

The endoscope shape detecting device 1001 includes a source coil driving circuit 1001A, a sense coil 1001B, a sense coil signal amplifying circuit 1001C, and an A/D converter (hereinafter and in the figures, abbreviated as ADC) 1001D.

The source coil driving circuit 1001A outputs sine wave driving signal currents having different frequencies to plural source coils 25A included in the endoscope 2A, plural source coils 25B included in the endoscope 2B, and plural source coils 25C included in the endoscope 2C to thereby generate magnetic fields in the plural source coils 25A and the plural source coils 25B. The frequencies of the driving signal currents are set on the basis of driving frequency setting data (also referred to as driving frequency data) stored in a not-shown driving frequency setting data storage section or driving frequency setting data storing section included in the source coil driving circuit 1001A. Connection of the source coil driving circuit 1001A and the endoscope 2A, the endoscope 2B, and the endoscope 2C is shown as D1 in the figure.

The magnetic fields generated from the plural source coils 25A included in the endoscope 2A, the plural source coils 25B included in the endoscope 2B, and the plural source coils 25C included in the endoscope 2C are received by the sense coil 1001B. After being amplified by the sense coil signal amplifying circuit 1001C, the magnetic fields are converted into digital data by the ADC 1001D.

The digital data generated by the ADC 1001D is input to a memory 185 via a receiving circuit 184 after being output from the ADC 1001D according to the control performed by a control signal generating section 183 of the extension control section 77B. The digital data input to the memory 185 is read from the memory 185 according to the control by the CPU 181.

The CPU 181 applies frequency extraction processing (Fourier transform: FFT) to the digital data read from the memory 185. The CPU 181 separates and extracts magnetic field detection information of a frequency component corresponding to the driving frequencies of the plural source coils 25A, the plural source coils 25B, and the plural source coils 25C. The CPU 181 calculates space position coordinates of the plural source coils 25A, the plural source coils 25B, and the plural source coils 25C. The CPU 181 estimates insertion states of the insertion section 21A of the endoscope 2A, the insertion section 21B of the endoscope 2B, and the insertion section 21C of the endoscope 2C on the basis of the space position coordinate. Display data forming an endoscope shape image is generated by the graphic circuit on the basis of an estimation result of the CPU 181. After the display data is subjected to mask combination in the combining circuit 108H and the combining circuit 108S, the display data is output and displayed (on the display section such as the monitor).

The zoom control function of the extension control section 77B is explained.

A driving circuit 186 is controlled by the CPU 131 via the SIO 142 and the PIO 143 included in the main control section 75 and drives the actuator 23A on the basis of the control. Consequently, the object optical system 22A is moved in the axis direction of the insertion section 21A according to, for example, modes of expansion (tele) and wide angle (wide). On the other hand, the driving circuit 602 is controlled by the CPU 131 via the setting retaining section 606 (although there is no connection line). The driving circuit 602 drives the actuators 23B and 23C on the basis of the control. Consequently, the object optical systems 22B and 22C are moved in the axis directions of the insertion section 21B and the insertion section 21C according to, for example, the modes of expansion (tele) and wide angle (wide).

Connection of the driving circuit 186 or the driving circuit 602 and the endoscope 2A or the endoscope 2B and the endoscope 2C is shown as D2 in the figure.

The CPU 131 of the main control section 75 controls the graphic circuits 106S and 106H. The CPU 131 acquires, from the driving circuit 186 or the driving circuit 602 of the extension control section 77B, zoom control information, which is information concerning a zoom state (expansion or wide angle) at the time when the endoscopes 2A, 2B, and 2C pick up images of a subject. The zoom control information acquired by the CPU 131 is converted into images by the graphic circuits 106S and 106H, combined in the combining circuit 108H and the combining circuit 108S, and then output and displayed (on the display section of the monitor or the like).

Components for realizing the zoom control function and components for realizing a part of functions of an endoscope shape detecting device included in the extension control section 77B are not limited to components integrally provided in one extension control section as explained above and may be provided in separate extension control sections, respectively. Further, the separate extension control sections may output different board connection detection signals, respectively.

Since the extension control section 77 has the configuration including one or plural extension boards explained above, the processor 4 can easily realize plural functions and can easily and inexpensively set a variety of functions.

D1 may be connected to the endoscope shape detecting devices 206C1 and 206C2 rather than to the extension control section 77B.

The CPU 131 of the main control section 75 determines, on the basis of the board connection detection signals output from the board connection information storing circuit 171 and the board connection information storing circuit 182, that only the extension control section 77A is connected, for example, if acquired binary data is “000”. The CPU 131 automatically displays (an image based on) network related information of a predetermined image size. (The image based on) the network related information of the predetermined image size is output to a predetermined position (any one of upper left, lower left, upper right, and lower right of a screen) set on the setting screen shown in FIG. 29 explained later from the graphic circuit 169 of the extension control section 77A via the connection indicated by A5 and A6 in the figure.

The CPU 131 of the main control section 75 determines, on the basis of the board connection detection signals output from the board connection information storing circuit 171 and the board connection information storing circuit 182, that only the extension control section 77B is connected, for example, if the acquired binary data is “001”. The CPU 131 automatically displays an endoscope shape detection image and zoom control information in a predetermined position (any one of upper left, lower left, upper right, and lower right of the screen) set on the setting screen shown in FIG. 29 explained later. The endoscope shape detection image is output from the graphic circuit 169 of the extension control section 77B via the connection indicated by A5 and A6 in the figure. The zoom control information is converted into an image in the graphic circuits 106S and 106H. The endoscope shape detection image and the zoom control information may be output in a state in which the positions and the image sizes thereof are adjusted by the CPU 131 such that the endoscope shape detection image and the zoom control information do not overlap each other. The endoscope shape detection image and the zoom control information may be output in a state in which priority in outputting the endoscope shape detection image and the zoom control information overlapping each other is set (e.g., a state in which the zoom control information is displayed in the front).

The CPU 131 of the main control section 75 determines, on the basis of the board connection detection signals output from the board connection information storing circuit 171 and the board connection information storing circuit 182, that both the extension control section 77A and the extension control section 77B are connected, for example, if the acquired binary data is “100”. The CPU 131 automatically displays (an image based on) network related information output from the extension control sections 77A and 77B, an endoscope shape detection image, and zoom control information in a predetermined position (any one of upper left, lower left, upper right, and lower right of the screen) set on the setting screen shown in FIG. 29 explained later.

(The image based on) the network related information, the endoscope shape detection image, and the zoom control information may be output in a state in which the positions and the image sizes thereof are adjusted by the CPU 131 such that (the image based on) the network related information, the endoscope shape detection image, and the zoom control information do not overlap one another. (The image based on) the network related information, the endoscope shape detection image, and the zoom control information may be output in a state in which priority in outputting (the image based on) the network related information, the endoscope shape detection image, and the zoom control information overlapping one another is set (e.g., a state in which the endoscope shape detection image is displayed in the forefront).

Information and the like output from the extension control sections 77A and 77B can also be set to be not displayed on the setting screen shown in FIG. 29 explained later.

The CPU 131 of the main control section 75 determines that both the board connection detection signals output from the board connection information storing circuit 171 and the board connection information storing circuit 182 cannot be detected, i.e., both the extension control section 77A and the extension control section 77B are not connected, for example, if the acquired binary data is “111”. Therefore, the CPU 131 does not display (an image based on) network related information output from the extension control sections 77A and 77B, an endoscope shape detection image, and zoom control information.

In the explanation of this embodiment, it is assumed that both the extension control sections 77A and 77B are connected to the processor 4 as the extension control section 77.

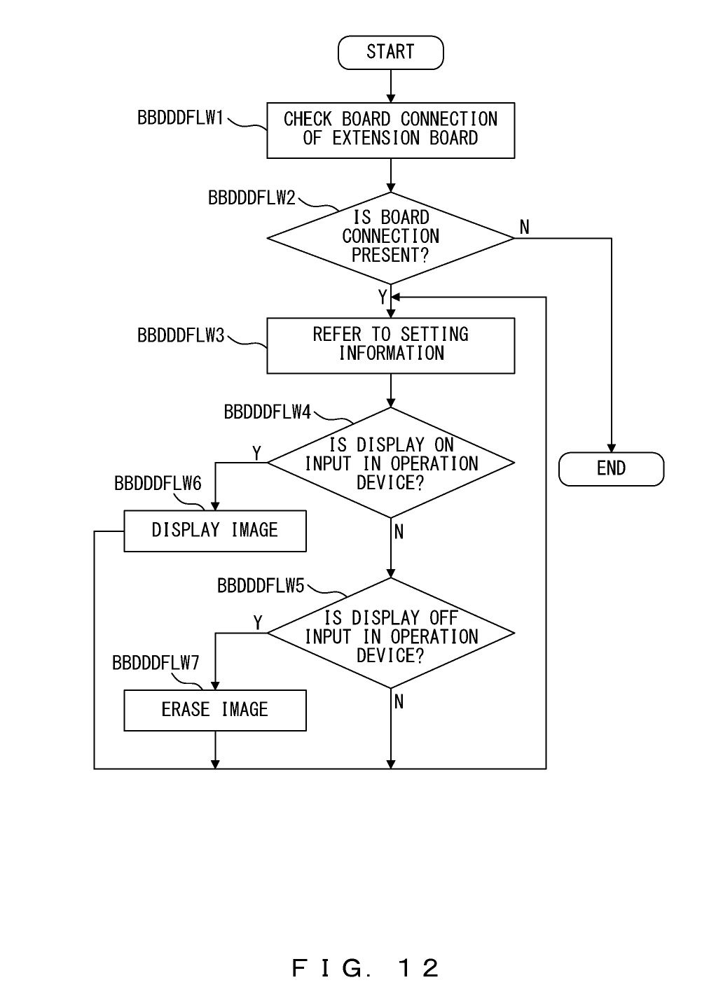

Processing performed by the CPU 131 of the main control section 75 when the CPU 131 detects (has detected) substrates connected to the extension control section 77 when the power supply for the processor 4 is switched from OFF to ON or when the processor 4 is reset is explained with reference to a flowchart shown in FIG. 12.

The CPU 131 of the main control section 75 detects, on the basis of board connection detection signals output from the board connection information storing circuit 171 (and the board connection information storing circuit 182), which extension board of the extension control section 77A and the extension control section 77B is connected as the extension control section 77 (step DDDFLW1 in FIG. 12). When the CPU 131 detects that no extension board is connected (step DDDFLW2 in FIG. 12), the CPU 131 ends the processing without displaying images, information, and the like output from the extension control sections 77A and 77B on the monitor or the like.

When the CPU 131 detects that any one of the extension board is connected, the CPU 131 performs, referring to setting information corresponding to the connected extension board among setting items of a “Board” space in a setting screen shown in FIG. 29 explained later, setting corresponding to the setting information (step DDDFLW3 in FIG. 12).

Thereafter, the CPU 131 detects whether an input for turning on or off the display of information or an image concerning the connected extension board is performed in the operation device (step DDDFLW4 and step DDDFLW5 in FIG. 12).

When an input for turning on the display of information or an image output from the connected extension board is performed in the operation device, the CPU 131 performs control for displaying the information or the image (step DDDFLW6 in FIG. 12). When an input for turning off the display of information or an image output from the connected extension board is performed in the operation device, the CPU 131 performs control for erasing the information or the image (step DDDFLW7 in FIG. 12).

Among the kinds of processing explained above as the processing in FIG. 12, the processing from step DDDFLW4 to step DDDFLW7 indicates processing performed when a key or the like to which any one of a function of “UPD”, a function of “ZScale”, and a function of “NET” explained later is allocated is operated in the operation device.

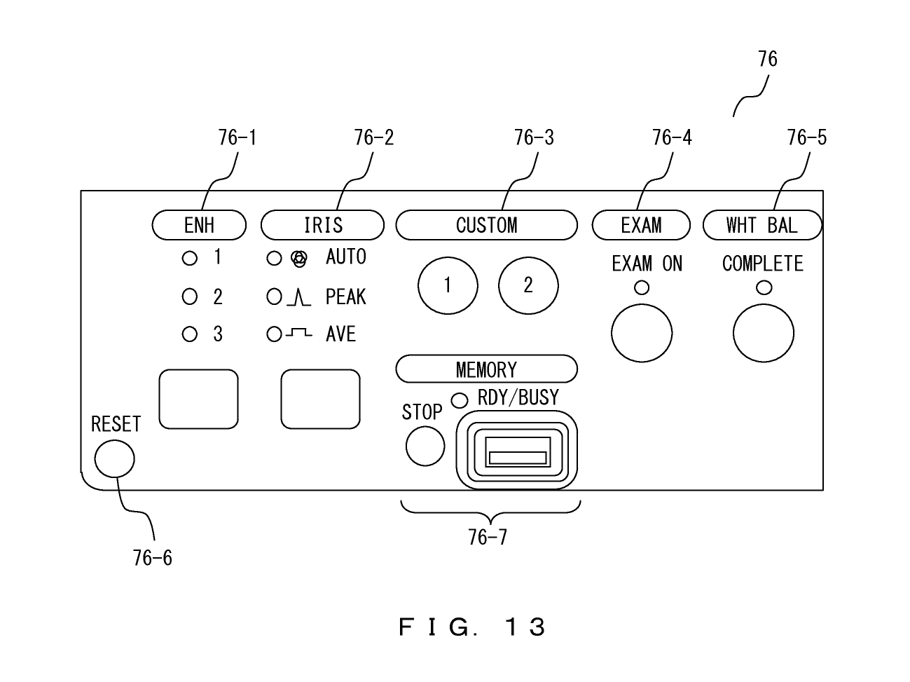

FIG. 13 is a diagram showing an example of the configuration of the front panel 76 included in the processor shown in FIG. 6. “ENH” (Enhancement) 76-1 is an item for performing enhancement switching. “IRIS” 76-2 is an item for performing photometry (dimming) switching. “CUSTOM” 76-3 is an item for registering setting customized by the operator.

“EXAM” 76-4 is a switch (also provided on the keyboard 5) for notifying a server 212 of the start and the end of an examination. A switch or an LED may be lit when the examination is started and lit out when the examination is ended. A function of the switch for the start and the end of an examination may be able to be turned on and off in a menu screen (not shown). When the function is turned off, the switch or the LED may be lit out. When the examination start switch is pressed, a predetermined menu screen may be displayed to make it possible to select character information or a PinP (Picture in Picture) or PoutP (Picture out Picture) image displayed on a screen during the examination. The PinP image or the PoutP image is an image of a reference numeral 330 or 331 or an image indicated by a signal A5, F1, F2, A3, A3′, A6, A4, or A4′ input to the combining circuit 108H or the combining circuit 108S.

“WHT BAL” 76-5 is an item for adjusting white balance. “Reset” 76-6 is an item for resetting the processor 4. “MEMORY” 76-7 is an item used for connection to a USB memory 210.

When the USB memory 210 is connected to a connector of the “MEMORY” 76-7, “RDY/BUSY” is lit to indicate that the USB memory 210 is connected. An LED provided on the left of the “RDY/BUSY” is lit in green.

When transmission and reception is performed with the USB memory 210, the LED on the left of the “RDY/BUSY” is blinked in orange.

When transmission and reception is performed with the USB memory 210, the transmission and reception is suspended and the LED on the left of the “RDY/BUSY” is lit in green when a STOP switch is pressed.

When the USB memory 210 is removed and disconnected, the “RDY/BUSY” is lit out and the LED on the left of the “RDY/BUSY” is lit out.

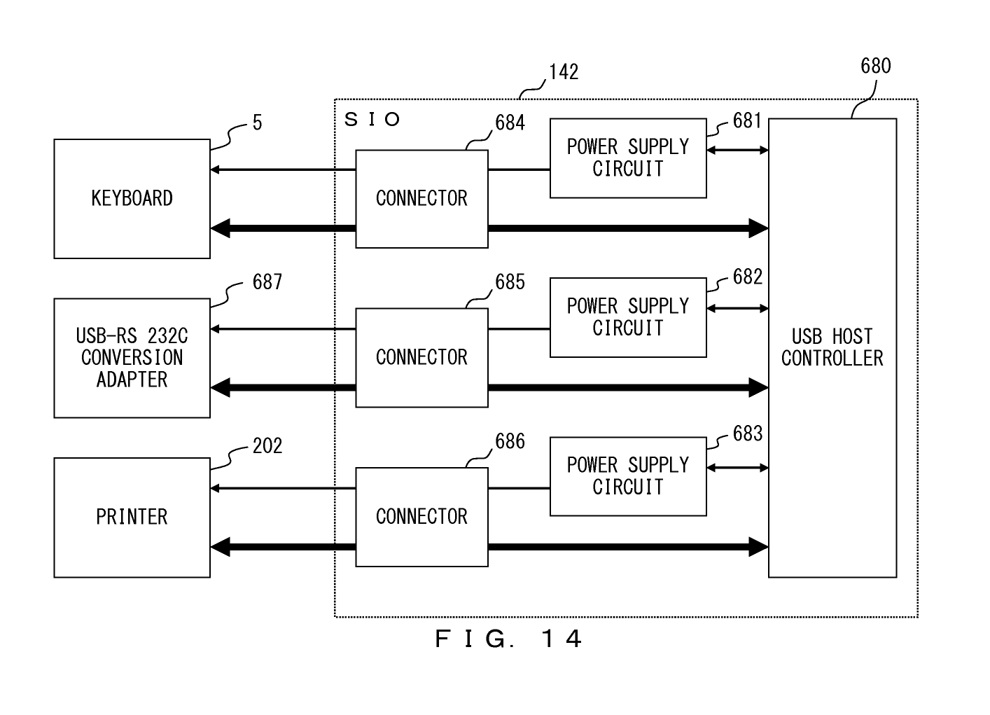

A modification of the SIO 142 is explained with reference to FIG. 14. The CPU 131 controls, in a USB interface, through a USB host controller 680 in the SIO 142, the keyboard 5, a USB-RS232C conversion adapter 687, and a printer 202.

Since the keyboard 5 and the USB-RS232C conversion adapter 687 is bus power-driven (power supply is supplied from the processor 4), the CPU 131 supplies power supply from a power supply circuit after tuning on the power supply through the USB host controller 680.

The CPU 131 periodically (e.g., every 1 [sec]) outputs a command and receives normal responses from the keyboard 5 and the USB-RS232C conversion adapter 687 to confirm that the keyboard 5 and the USB-RS232C conversion adapter 687 normally operate.

When normal responses are not received, for example, when the keyboard 5 and the USB-RS232C conversion adapter 687 are hung up because of external noise or noise from peripheral devices (including those not shown), the CPU 131 performs operation explained below. The CPU 131 may change the power supply from the power supply circuit from OFF to ON to thereby perform initialization processing for the keyboard 5 and the USB-RS232C conversion adapter 687.

Since the printer 202 operates with self-power, when the printer 202 is hung up because of external noise or noise from peripheral devices (including those not shown), the CPU 131 performs operation explained below. The CPU 131 may perform only initialization of a command (bus reset processing) without changing the power supply from the power supply circuit from OFF to ON.

A USB connector conforming to the USB standard is used as a connector 684, a connector 685, and a connector 686. However, the connector 684, the connector 685, and the connector 686 may be respectively dedicated to the keyboard 5, the USB-RS232C conversion adapter 687, and the printer 202. In that case, error display or warning may be emitted when a device except a device dedicated to a connector is connected (e.g., when a device (the USB-RS232C conversion adapter 687 or the printer 202) other than the keyboard is connected to the connector 684). A buzzer for emitting warning may be mounted on the front panel 76.

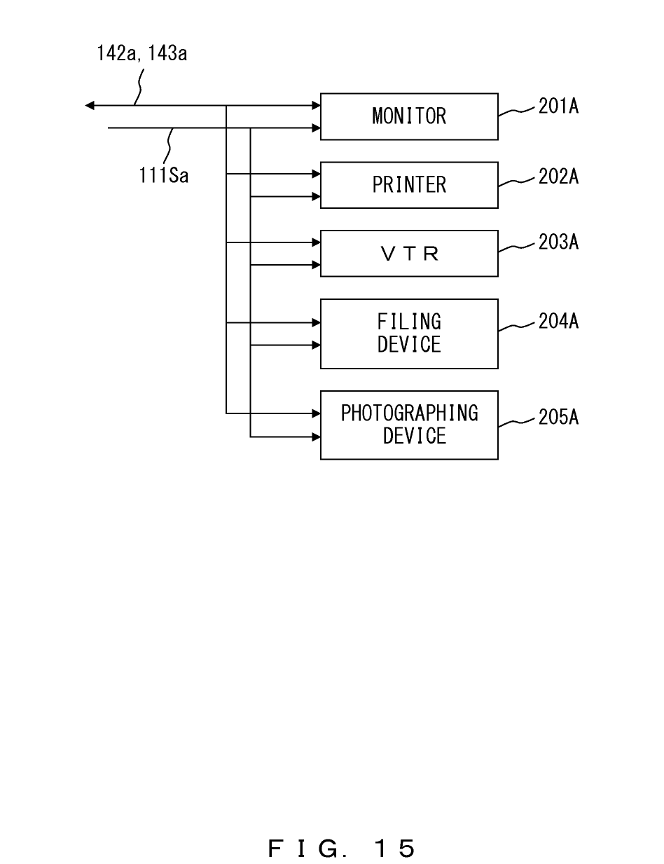

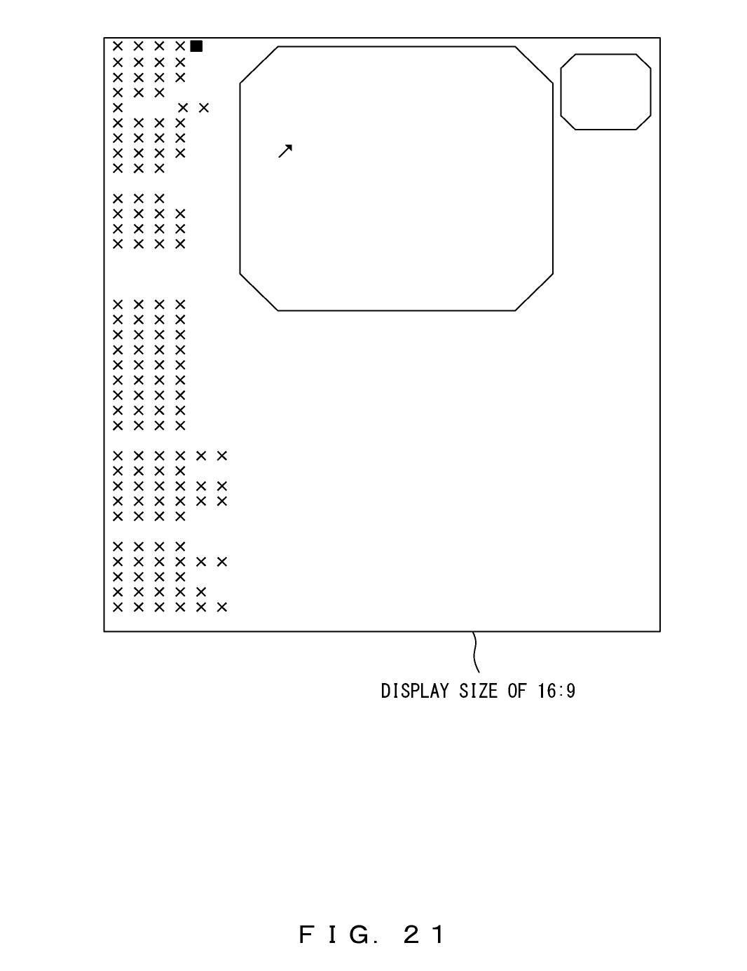

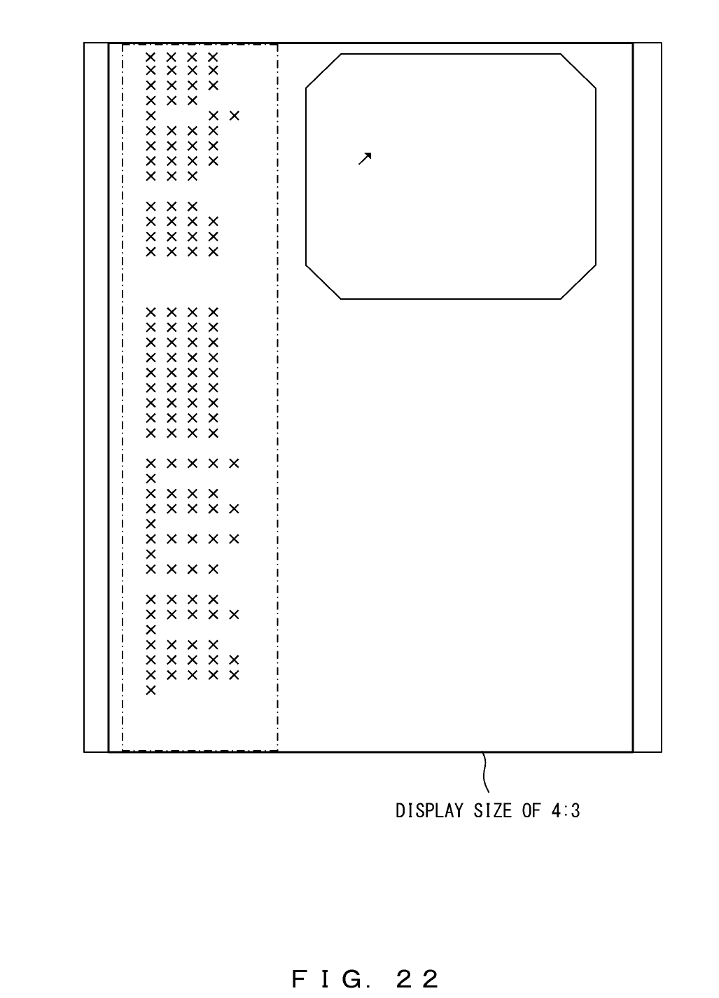

FIGS. 15 to 20 are diagrams showing schematic configurations of peripheral devices that could be connected (connectable) to the processor 4. As the peripheral devices that could be connected to the processor 4, it is assumed that there are a device adapted to only a display size (an output size) 4:3 and a device adaptable to both display sizes (output sizes) 16:9 and 4:3. Examples of the display sizes are shown in FIGS. 21 and 22. Among the devices shown in FIGS. 15 to 19, it is assumed that the devices such as a filing device that can record an input signal (image) include a configuration of an image recording section and the devices such as a monitor that can display an input signal (image) include a configuration of a display section.

A monitor 201A, a printer 202A, a VTR 203A, a filing device 204A, and a photographing device 205A functioning as the peripheral devices shown in FIG. 15 are devices that can perform at least one of input and output, recording, and the display of an analog signal in the SDTV system. The peripheral devices shown in FIG. 15 are connected to the image processing section 72 via the signal line 111Sa and also connected to the SIO 142 and the PIO 143 of the main control section 75.

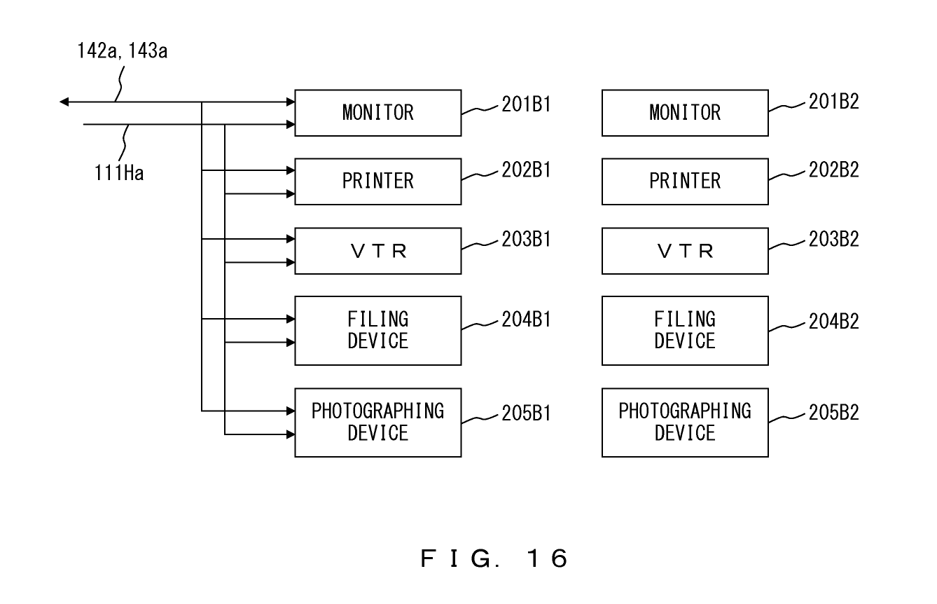

Among the peripheral devices shown in FIG. 16, a monitor 201B1, a printer 202B1, a VTR 203B1, a filing device 204B1, and a photographing device 205B1 are devices that can perform at least one of input and output, recording, and the display of an analog signal in the HDTV system and are adapted to only the display size 4:3. Among the peripheral devices shown in FIG. 16, a monitor 201B2, the printer 202B2, a VTR 203B2, a filing device 204B2, and a photographing device 205B2 are devices that can perform at least one of input and output, recording, and the display of an analog signal in the HDTV system and are adaptable to both the display sizes 16:9 and 4:3. The peripheral devices shown in FIG. 16 are connected to the image processing section 72 via the signal line 111Ha and also connected to the SIO 142 and the PIO 143 of the main control section 75.

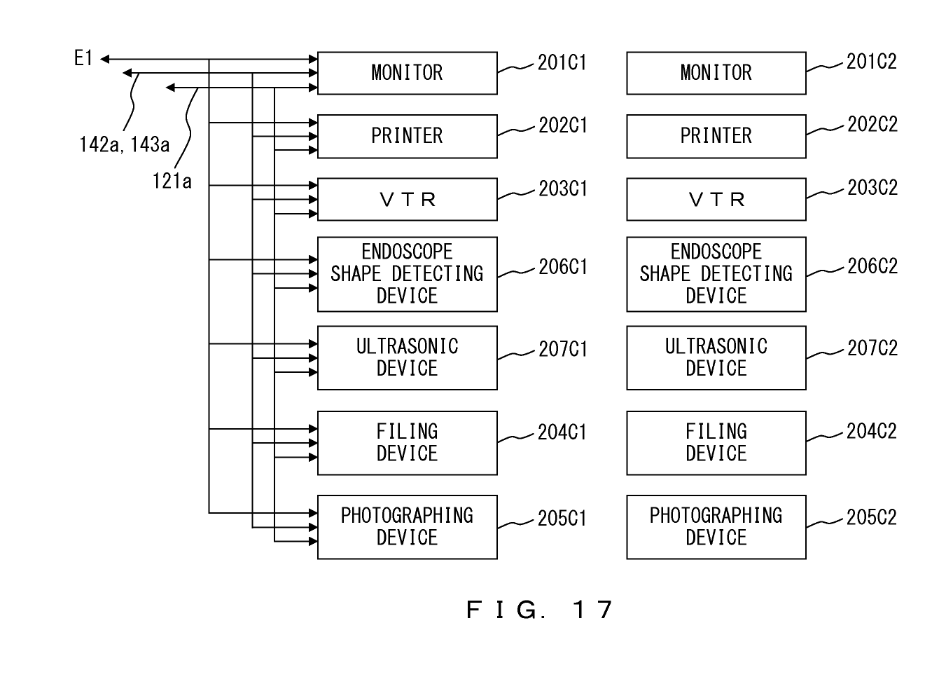

Among the peripheral devices shown in FIG. 17, a monitor 201C1, a printer 202C1, a VTR 203C1, a filing device 204C1, a photographing device 205C1, an endoscope shape detecting device 206C1, and an ultrasonic device 207C1 are devices that can perform at least one of input and output, recording, and the display of an analog signal (or a digital signal) in the SDTV system and the HDTV system and are adapted to only the display size 4:3. Among the peripheral devices shown in FIG. 17, a monitor 201C2, a printer 202C2, a VTR 203C2, a filing device 204C2, a photographing device 205C2, an endoscope shape detecting device 206C2, and an ultrasonic device 207C2 are devices that can perform at least one of input and output, recording, and the display of an analog signal (or a digital signal) in the SDTV system and the HDTV system and are adapted to both the display sizes 16:9 and 4:3. The peripheral devices shown in FIG. 17 are connected to the image processing section 72 via the signal line 121a and also connected to the SIO 142 and the PIO 143 of the main control section 75. Further, the peripheral devices shown in FIG. 17 can be connected to the controller 164 of the extension control section 77A through connection of a signal line indicated by E1 in the figure.

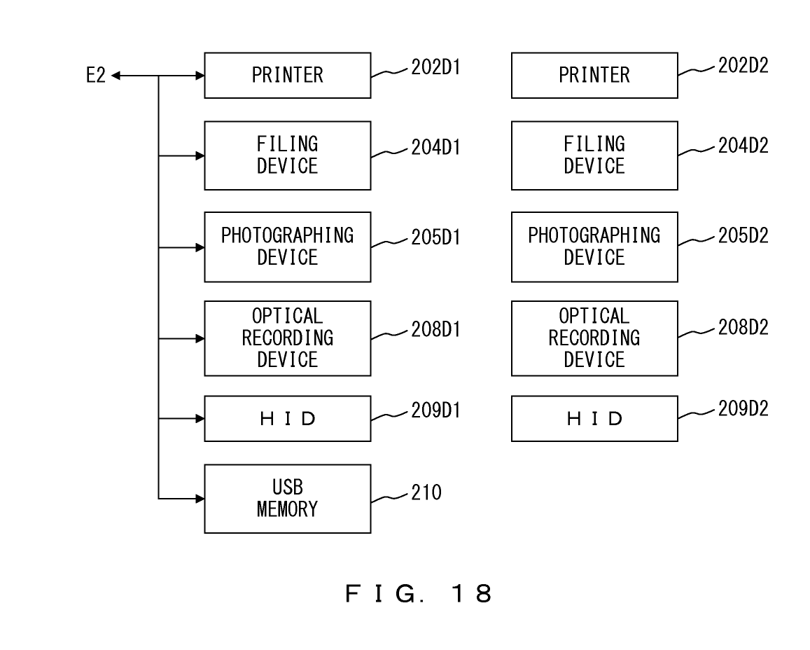

Among the peripheral devices shown in FIG. 18, a printer 202D1, a filing device 204D1, a photographing device 205D1, an optical recording device 208D1, and an HID 209D1 are devices that can perform at least one of input and output, recording, and display by a USB (registered trademark) interface and are adapted to only the size 4:3. Among the peripheral devices shown in FIG. 18, a printer 202D2, a filing device 204D2, a photographing device 205D2, an optical recording device 208D2, and an HID 209D2 are devices that can perform at least one of input and output, recording, and display by a USB (registered trademark) interface and are adapted to both the display sizes 16:9 and 4:3. The USB memory 210 is a nonvolatile memory that can record data transmitted from a signal line indicated by E2 in the figure via the USB (registered trademark) interface. Further, the peripheral devices shown in FIG. 18 can be connected to the controller 164 of the extension control section 77A through connection of the signal line indicated by E2 in the figure. It is assumed that the optical recording devices 208D1 and 208D2 include any one of an MO, a DVD (including blu-ray and HDDVD), a CD±R/W, and the like. It is assumed that the HIDs 209D1 and 209D2 are operation devices including a keyboard, a mouse, a wheel, or the like.

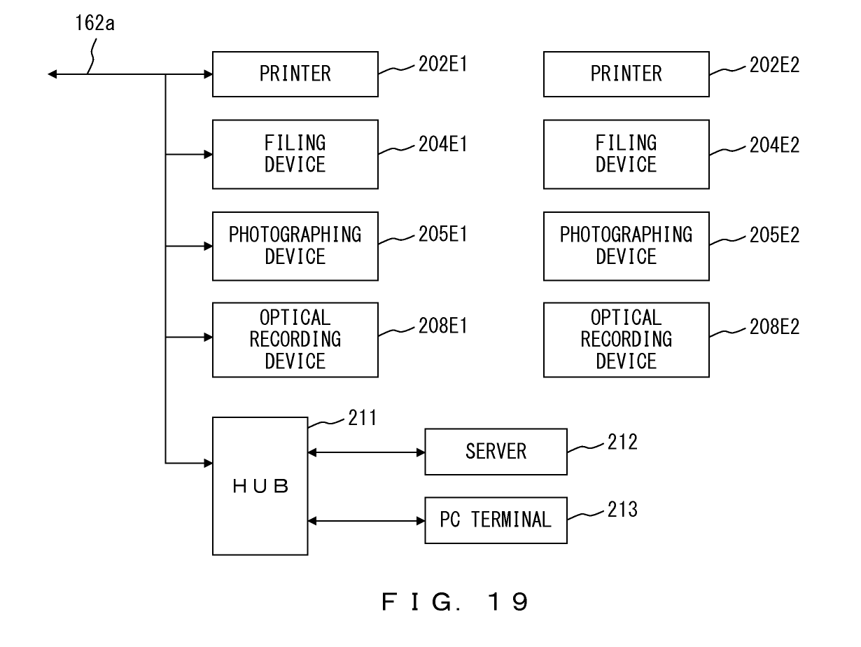

Among the peripheral devices shown in FIG. 19, a printer 202E1, a filing device 204E1, a photographing device 205E1, an optical recording device 208E1, and a HUB 211 are devices that can perform at least one of input output, recording, and display by an Ethernet (registered trademark) interface and are adapted to only the display size 4:3. Among the peripheral devices shown in FIG. 19, a printer 202E2, a filing device 204E2, a photographing device 205E2, an optical recording device 208E2, and a HUB 211 are connected to the processor 4 via a network by a network communication function of the extension control section 77A. The printer 202E2, the filing device 204E2, the photographing device 205E2, the optical recording device 208E2, and the HUB 211 are devices that can perform at least one of, for example, input output, recording, and display by the Ethernet (registered trademark) interface and are adapted to both the display sizes 16:9 and 4:3. Further, the peripheral devices shown in FIG. 19 can be connected to the HUB 162 of the extension control section 77A via the signal line 162a. It is assumed that the optical recording devices 208E1 and 208E2 include any one of an MO, a DVD, a CD±R/W, and the like.

The HUB 211 is connected to the server 212 or a PC terminal 213 via a network such as a LAN.

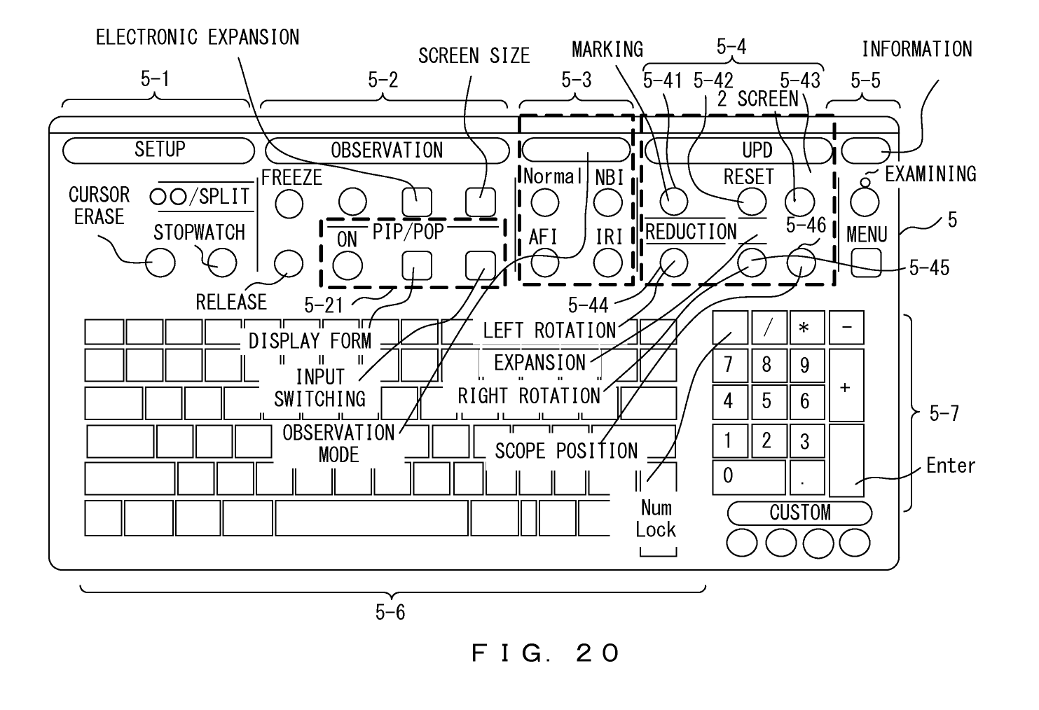

The keyboard 5 shown in FIG. 20 mainly includes a setup section 5-1, an observing section 5-2, an RGB filter 52, an observation mode section 5-3, a UPD section 5-4, an “EXAM” switch and information section 5-5, a key input section 5-6, and a ten key section 5-7. The setup section 5-1 performs setting concerning setup of the processor 4. The observing section 5-2 performs control concerning an observation environment. The observation mode section 5-3 cuts a wavelength of a predetermined band in white light emitted from the RGB filter 52 and the lamp 51 to thereby control plural (e.g., three) special light filters 53A, 53B, and 53C that generate narrow-band lights (NBI, AFI, and IRI). The RGB filter 52 converts white light (Normal) of the light source device 3 for switching an observation mode into surface sequential light of RGB. The UPD section 5-4 performs control of the endoscope shape detecting device (UPD). The information section 5-5 includes an “EXAM” switch, which is a switch for notifying the server 212 of the start and the end of an examination, and a menu switch for displaying a menu screen.

The UPD section 5-4 includes a marking switch 5-41, a reset button 5-42, a one-screen/two-screen button 5-43, a left rotation button 5-44, a right rotation button 5-45, and a scope position button 5-46. The reset button 5-42 performs reset operation. The one-screen/two-screen button 5-43 performs instruction for displaying one screen and two screens. The left rotation button 5-44 rotates an endoscope insertion shape to the left to change a view angle. The right rotation button 5-45 rotates the endoscope insertion shape to the right to change the view angle. The scope position button 5-46 performs setting of a start position of the display of the endoscope insertion shape. When the operator presses the left rotation button 5-4 while pressing a shift key, the operator can perform a reduction of the endoscope insertion shape. When the operator presses the right rotation button 5-45 while pressing the shift key, the operator can perform an expansion of the endoscope insertion shape.

In this way, by using the UPD section 5-4, it is possible to remotely operate the endoscope shape detecting device using the keyboard 5. When the endoscope shape detecting device is connected, an LED in a button portion of the UPD section 5-4 is lit. When the endoscope shape detecting device is unconnected, the LED in the button portion of the UPD section 5-4 is lit out. This indicates that the endoscope shape detecting device cannot be controlled using the keyboard 5.

Details are as described in Japanese Patent No. 3971422.

FIG. 23 shows an example of the configuration of the image compressing and expanding section 73. First, recording of an image is explained. An HD image signal output from the mask processing circuit 611H and transmitted via the signal line 125a is diverted. One diverted HD image signal is output to an arbiter 633 via an FIFO 634H. The other diverted HD image signal is output to a thumbnail image generating circuit 635H.

The thumbnail image generating circuit 634H generates a thumbnail image on the basis of the HD image signal output from the mask processing circuit 611H and transmitted via the signal line 125a. The thumbnail image generating circuit 634H outputs the thumbnail image stored in an image memory 654 every time a recording instruction for release, capture to a printer, or the like is performed in the operation devices.

An SD image signal output from the mask processing circuit 611S and transmitted via the signal line 124a is diverted. One diverted SD image signal is output to the arbiter 633 via an FIFO 634S. The other diverted SD image signal is output to a thumbnail image generating circuit 635S.

The thumbnail image generating circuit 635S generates a thumbnail image on the basis of the SD image signal output from the mask processing circuit 611S and transmitted via the signal line 124a. The thumbnail image generating circuit 635S outputs the thumbnail image stored in an image memory 654 every time a recording instruction for release, capture to a printer, or the like is performed in the operation devices.

Image signals output from the frame synchronizing and RGB conversion circuits 613 and 613′ and transmitted via the signal lines 607 and 607′ are respectively output to the arbiter 633 via FIFOs 640 and 640′.

The arbiter 633 outputs the image signal input to the arbiter 633 to sections on the outside in a round-robin system or in a priority order corresponding to processing.

These image signals output to the arbiters 633 are once stored in the image memory 654. Thereafter, these image signals are output to a JPEG encode/decode circuit 647, a TIFF/BMP conversion circuit 647, or a YUV-RGB conversion circuit 651 via the arbiter 633 and FIFOs 644, 646, 648, and 650.

The JPEG encode/decode circuit 645 applies JPEG encode/decode processing to the image signals input via the FIFO 644 (can simultaneously execute YUV-RGB conversion).

The TIFF/BMP conversion circuit 647 encodes (or converts) the image signals input via the FIFO 646 into format of TIFF or BMP.

An expanding and reducing circuit 649 applies image expansion processing or reduction processing to the image signals input via the FIFO 648.

The YUV-RGB conversion circuit 651 applies YUV-RGB conversion processing to the image signals input via the FIFO 650.

The FIFOs 644, 646, 648, 650, 652, and 653, the JPEG encode/decode circuit 645, the TIFF/BMP conversion circuit 647, or the YUV-RGB conversion circuit 651 is controlled by a control signal CTL1 based on an internal clock.

The image signals processed by the JPEG encode/decode circuit 645, the TIFF/BMP conversion circuit 647, the expanding and reducing circuit 649, or the YUV-RGB conversion circuit 651 are stored in the image memory 654 via the FIFOs 644, 646, 648, and 650 and via the arbiter 633.

The image signals stored in the image memory 654 are output to the bus bridge 163 via the arbiter 633 and the FIFO 652 and via the signal line C1 according to the control by the CPU 151 explained later.

Reproduction of an image is explained. The recorded image signals are output to the image memory 564 via the bus bridge 163, the signal line C3, and the arbiter 633 according to the control by the CPU 151. The image signals output to the image memory 654 are output to the JPEG encode/decode circuit 645, the TIFF/BMP conversion circuit 647, the expanding and reducing circuit 649, or the YUV-RGB conversion circuit 651 via the arbiter 633 and the FIFOs 644, 646, 648, and 650.

The image signals processed by the JPEG encode/decode circuit 645, the TIFF/BMP conversion circuit 647, the expanding and reducing circuit 649, or the YUV-RGB conversion circuit 651 are stored in the image memory 654 via the FIFOs 644, 646, 648, and 650 and via the arbiter 633.

The image signals stored in the image memory 654 are output to a signal line F1 via an FIFO 642 and to a signal line F2 via an FIFO 643. The signals output to the signal lines F1 and F2 are output to the combining circuit 108H or 108S.

The influence of external noise or the like is removed from a signal from the SSG 123 by a synchronization signal check circuit 631. The signal is input to a control for image capture/combination 632. At this point, the control for image capture/combination 632 generates an HDTV image control signal 660H and an SDTV image control signal 660S on the basis of the input signal.

One of the HDTV image control signal 660H and the SDTV image control signal 660S is selected by a selector 641 on the basis of the SD/HD discrimination signal 615 (the selected control signal is represented as control signal 661). One of the HDTV image control signal 660H and the SDTV image control signal 660S is selected by a selector 641′ on the basis of the SD/HD discrimination signal 615′ (the selected control signal is represented as control signal 661′).

A memory controller 655 outputs a control signal 662 on the basis of the HDTV image control signal 660H, the SDTV image control signal 660S, the control signal CTL1, the control signal 661, or the control signal 661′.

The HDTV image control signal 660H is output to the FIFO 634H, the thumbnail image generating circuit 635H, the FIFO 636H, the FIFO 642, and the memory controller 655.

The SDTV image control signal 660S is output to the FIFO 634S, the thumbnail image generating circuit 635S, the FIFO 636S, the FIFO 643, and the memory controller 655.

The control signal 661 is output to the FIFO 640 and the memory controller 655. The control signal 661′ is output to the FIFO 640′ and the memory controller 655.

The control signal 662 is output to the arbiter 633, the FIFOs 634H, 636H, 634S, 636S, 640, 640′, 642, 643, 644, 646, 648, 650, 652, and 653.

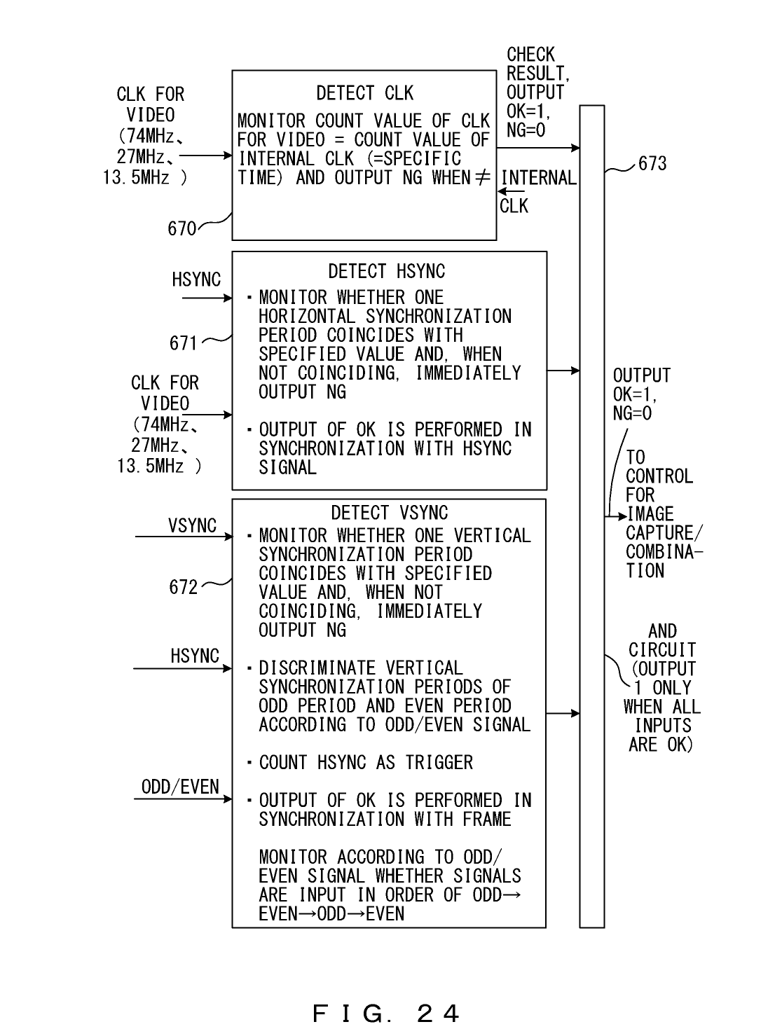

FIG. 24 shows a configuration example of the synchronization signal check circuit 631. The synchronization signal check circuit 631 applies synchronization signal check explained below to HDTV and SDTV.

A video clock (74 MHz or 27 MHz), which is a signal from the SSG 123, and an internal clock are input to a CLK detecting section 670. The CLK detecting section 670 monitors a count value of the video clock=a count value (=specific time) of the internal clock and outputs NG when the count value of the video clock≠the count value of the internal clock.

A horizontal synchronization signal (HSYNC), which is a signal from the SSG 123, and a video clock (e.g., 74 MHz, 27 MHz, or 13.5 MHz) are input to an HSYNC detecting section 671. The HSYNC detecting section 671 monitors whether one horizontal synchronization period coincides with a specified value and immediately outputs NG when the one horizontal synchronization period does not coincide with the specified value. The HSYNC detecting section 671 performs output of OK in synchronization with an HSYNC signal.

A vertical synchronization signal (VSYNC), a horizontal synchronization signal (HSYNC), and an ODD/EVEN discrimination signal, which are signals from the SSG 123, are input to a VSYNC detecting section 672. The VSYNC detecting section 672 monitors whether one vertical synchronization period coincides with a specified value and immediately outputs NG when the one vertical synchronization period does not coincide with the specified value (determines vertical synchronization periods of an ODD period and an EVEN period according to the ODD/EVEN discrimination signal). The VSYNC detecting section 672 counts HSYNC as a trigger. The VSYNC detecting section 672 performs output of OK in synchronization with a frame. The VSYNC detecting section 672 also monitors, according to the ODD/EVEN discrimination signal, whether signals are input in the order of ODD→EVEN→ODD→EVEN.

Results output from the CLK detecting section 670, the HSYNC detecting section 671, and the VSYNC detecting section 672 are input to an AND circuit 673. The AND circuit 673 outputs “1” to the control for image capture/combination 632 only when all inputs from the CLK detecting section 670, the HSYNC detecting section 671, and the VSYNC detecting section 672 are OK.

At this point, during a release operation flow, when a synchronization signal is disordered because of the influence of the noise or the like and a check result is NG, storage in the image memory 654 is suspended until the synchronization signal returns to normal and the check result changes to OK. Since a check result signal (OK) is output at a period of the synchronization signal (a frame period), it is possible to perform the return to the storage in the image memory 654 from the head of the frame (since NG is output at once, the storage processing is immediately suspended). The release operation means an operation for storing an HDTV freeze image and a thumbnail image from the signal line 125a in the image memory 654 and setting a display position of the thumbnail image. The release operation also means an operation for storing an SDTV freeze image and a thumbnail image from the signal line 124a in the image memory 654 and setting a display position of the thumbnail image.

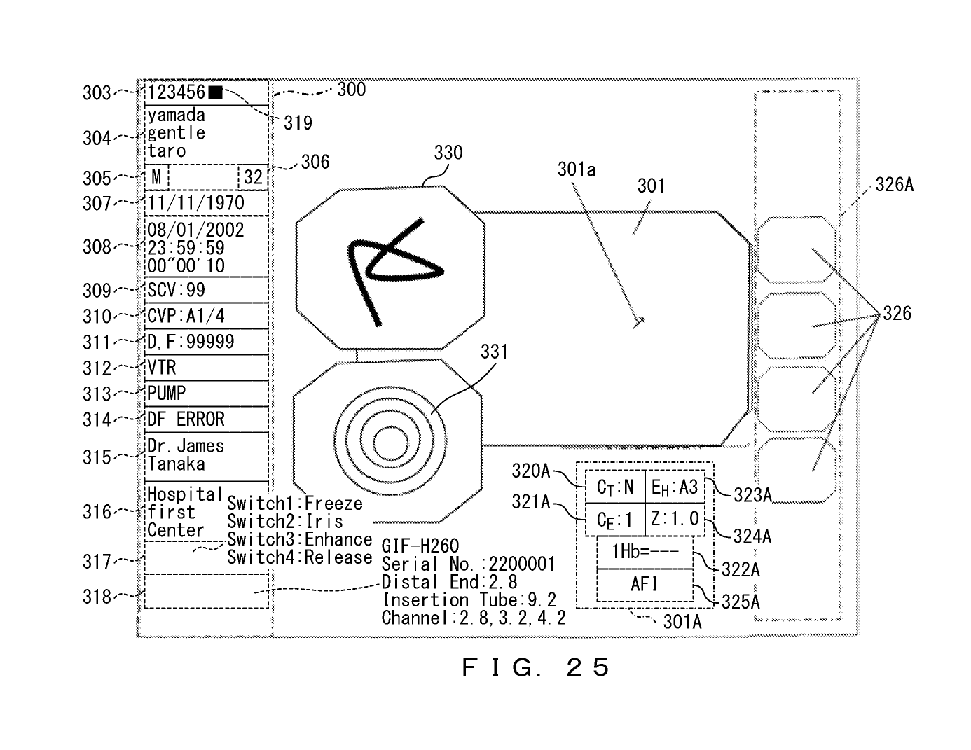

FIG. 25 is a diagram showing an example of an endoscopic combined image generated in the combining circuit 108H or 108S. Components shown in FIG. 25 are explained in items 1) to 27) below.

1) An endoscopic image 301 is always displayed when the endoscope 2A (or the endoscope 2B or the endoscope 2C) is connected (not displayed when the endoscope is not connected).

The image size of the endoscopic image 301 is changed according to, for example, operation of an image size change key allocated to the operation device.

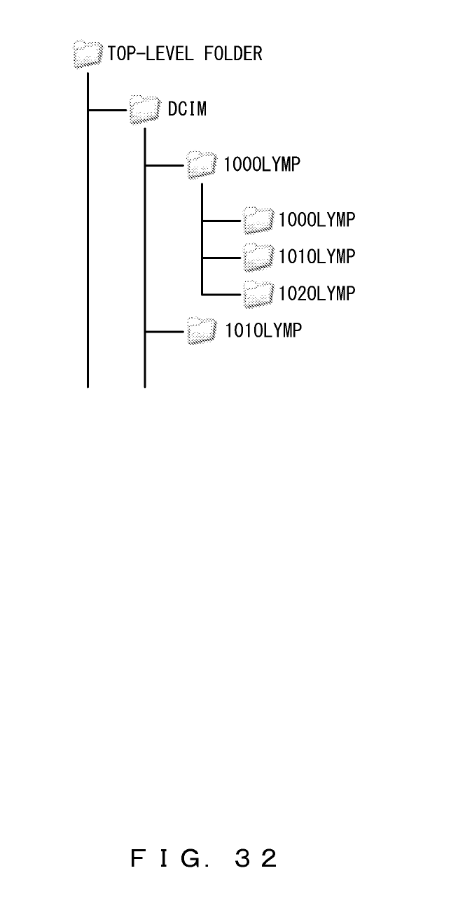

2) Display examples of images of A3, A4, A3′, and A4′ input from the A/D or DECs 612 and 612′ and combined by the combining circuit 108S and 108H are shown in 330 and 331. (In this example, an image of the endoscope shape detecting device is displayed as 330 and an image of the ultrasonic device is displayed as 331.) The image 330 of the endoscope shape detecting device and the image 331 of the ultrasonic device are recorded as an external image 1 and an external image 2 shown in FIGS. 32 to 38 explained later during a release instruction explained later only when the images 330 and 331 are displayed on a screen as endoscopic combined images as shown in FIG. 25. The image 330 of the endoscope shape detecting device and the image 331 of the ultrasonic device may be not recorded as external images during a release instruction when the images 330 and 331 are not displayed as endoscopic combined images (are erased).

3) An arrow pointer 301a is displayed in a color (easily distinguished from a color of a subject in a living body) such as green.

The arrow pointer 301a is displayed with relative positions of output of an image of SDTV (output via, for example, the signal line 111Sa) and output of an image of HDTV (output via, for example, the signal line 111Ha) aligned.

The arrow pointer 301a can perform display, erasing, and a change of the direction of the distal end side according to key inputs in the keyboard 5 (e.g., combinations of a “SHIFT” key and cursor keys (“↑”, “↓”, “←”, and “→” keys).

The arrow pointer 301a can be moved on an image according to operation of the cursor keys included in the keyboard 5.

The arrow pointer 301a is not displayed when predetermined operation (or operation of a key or the like having an examination end notification function) in the keyboard 5 is performed.

The arrow pointer 301a can select one of the images and display, erase, and move the images independently from each other according to operation of predetermined keys included in the keyboard 5.

4) In an ID No. (patient ID) 303, an item name (ID No.) is displayed when data is not input or when the key or the like having the examination end notification function is operated. The item name is automatically erased and input data up to fifteen characters is displayed according to the input of data by the keyboard 5 or the like.

In a state in which data is not input, when the cursor is moved by key input of the cursor key or the like included in the keyboard 5, the item name is erased.

When patient ID data is received from a peripheral device, the received ID data is displayed.

5) In a Name (patient name) 304, an item name (Name) is displayed when data is not input or when the key or the like having the examination end notification function is operated. The item name is automatically erased and input data up to twenty characters is displayed according to the input of data by the keyboard 5 or the like.

When there is a space in the data, a new line is started in the position of the space. (E.g., in FIG. 25, since a space is present between “yamada” and “gentle”, “gentle” is displayed on a lower line.)

In a state in which data is not input, when the cursor is moved by key input of the cursor key or the like included in the keyboard 5, the item name is erased.

When patient name data is received from a peripheral device, the received patient name data is displayed.

6) In a Sex (patient name) 305, an item name (Sex) is displayed when data is not input or when the key or the like having the examination end notification function is operated. The item name is automatically erased and input data up to one character is displayed according to the input of data by the keyboard 5 or the like.

In a state in which data is not input, when the cursor is moved by key input of the cursor key or the like included in the keyboard 5, the item name is erased.

When patient name data is received from a peripheral device, the received patient name data is displayed.

7) In an Age (patient age) 306, an item name (Age) is displayed when data is not input or when the key or the like having the examination end notification function is operated. The item name is automatically erased and input data up to three characters is displayed according to the input of data by the keyboard 5 or the like.

When D. O. Birth is input, age calculation by the CPU 131 is performed and an age is automatically input and displayed.

In a state in which data is not input, when the cursor is moved by key input of the cursor key or the like included in the keyboard 5, the item name is erased. When patient age data is received from a peripheral device, the received patient age data is displayed.

8) In a D. O. Birth (patient date of birth) 307, an item name (D. O. Birth) is displayed when data is not input or when the key or the like having the examination end notification function is operated. The item name is automatically erased and input data is displayed according to the input of data by the keyboard 5 or the like.

In a state in which data is not input, when the cursor is moved by key input of the cursor key or the like included in the keyboard 5, the item name is erased.

It is assumed that, in the case of the Western calendar indication, it is possible to input up to eight characters. In the case of the Japanese calendar indication, it is possible to input up to seven characters (M: Meiji, T: Taisho, S: Showa, and H: Heisei). It is possible to set a display format on the setting screen of the processor 4.

When patient date of birth data is received from a peripheral device, the received patient date of birth is displayed.

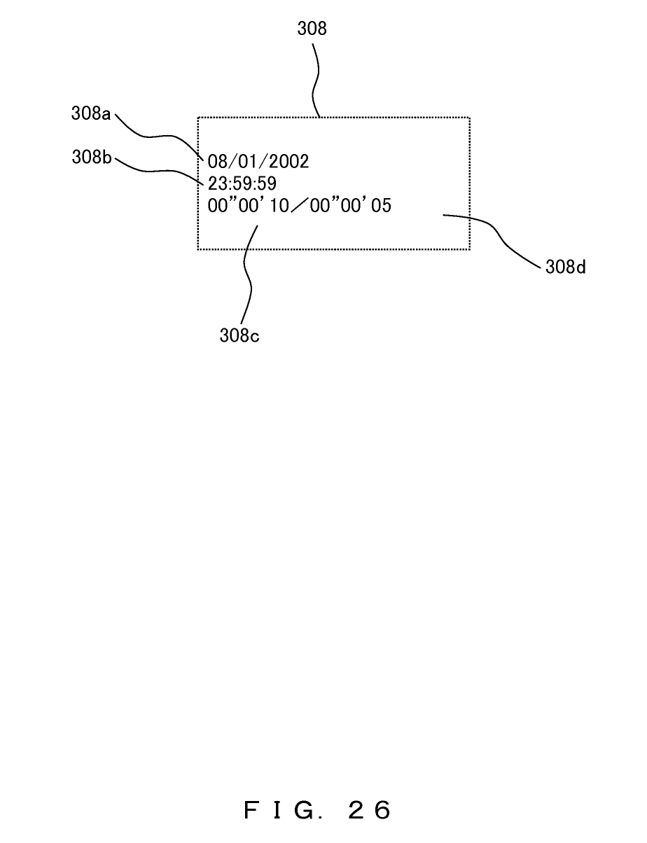

9) In a time information 308, the present date and time and a stopwatch are displayed. It is possible to set date and time on the setting screen of the processor 4. This is explained with reference to FIG. 26. As shown in FIG. 26, in the time information 308, the present date (308a) and time (308b), measurement time and pause time (308c) of the stopwatch, and split time (308d) of the stopwatch are displayed. A split function can be realized by depressing a stopwatch key and a shift key included in the keyboard in combination.

The time information 308 may be displayed in an abridged form. In the abridged display, only last two digits of date and time may be displayed not to overlap an endoscopic image.

A display position of the stopwatch may be different depending on a system (SDTV or HDTV) of an image to be output.

In SDTV output, date may be not displayed during a stopwatch operation.

For example, it is assumed that the stopwatch is displayed in a display format of HH″ MM′SS (hour″ minute′ second).

In the case of freeze by the freeze key, the time information 308 is not frozen (excluding the stopwatch).

10) In an SCV 309, an item (“SCV:”) and a count value of a Release operation in a photographing device (any one of the photographing devices 205A, 205B1, 205B2, 205C1, 205C2, 205D1, 205D2, 205E1, and 205E2) selected on the setting screen of the processor 4 are displayed. (The item and the count value are not displayed when the SCV 309 is set to OFF on the setting screen of the processor 4.)

When communication with the photographing device is established, a count value output from the photographing device is displayed. Except when the communication with the photographing device is established, a count value of a Release operation counted by the CPU 131 of the main control section 75 is displayed.

11) In a CVP 310, when communication with a printer (any one of the printers 202A, 202B1, 202B2, 202C1, 202C2, 202D1, 202D2, 202E1, and 202E2) selected on the setting screen of the processor 4 is established, an item (“CVP:”), the number of captures, the number of divisions, and a memory page are displayed.

12) In a D.F 311, when communication with a filing device (any one of the filing devices 204A, 204B1, 204B2, 204C1, 204C2, 204D1, 204D2, 204E1, and 204E2) selected on the setting screen of the processor 4 is established, an item (“D.F:”) and a count value of a Release operation are displayed. (The count value is a value based on a count command output from the filing device.)

13) A VTR 312 is displayed when communication with a VTR (any one of the VTRs 203A, 203B1, 203B2, 203C1, and 203C2) selected on the setting screen of the processor 4 is established and recording of a moving image by the VTR or the like or reproduction of a moving image recorded in the VTR or the like is being executed.

14) A PUMP 313 is displayed when communication with a not-shown forward circulating pump is established and the forward circulating pump is driven.

15) In a peripheral device area 314, reception data such as error information from a peripheral device is displayed by maximum twenty characters (ten characters/one row).

16) In a Physician (physician name) 315, an item name (Physician) is displayed when data is not input or when the key or the like having the examination end notification function is operated (the item may be erased when the key or the like having the examination end notification function is operated). The item name is automatically erased and input data up to twenty characters is displayed according to the input of data by the keyboard 5 or the like.

In a state in which data is not input, when the cursor is moved by key input of the cursor key or the like included in the keyboard 5, the item name is erased.

When physician name data is received from a peripheral device, the received physician name data is displayed.

17) In a Comment 316, an item name (Comment) is displayed when data is not input (the item name may be displayed when operation of the key or the like having the examination end notification function is operated). The item name is automatically erased and input data up to thirty-seven characters is displayed according to the input of data by the keyboard 5 or the like.

When comment data is received from a peripheral device, the received comment data is displayed.

18) In an endoscope switch information 317, functions allocated to the operation switch section 28a (28B) of the endoscope 2A (2B) are displayed for each switch.

19) In an endoscope related information 318, information concerning the endoscope 2A (2B or 2C) stored in the memory 30A (30B or 30C) of thee endoscope 2A (2B or 2C) is displayed.

20) In a cursor 319, in a character insertion mode, for example, “I” is displayed (when an “INS” key or an “Insert” key of the keyboard 5 is off).

In a character overwrite mode, for example, a square painted out in a predetermined color is displayed (when the “INS” key or the “Insert” key of the keyboard 5 is off).

In a Roman alphabet input mode, for example, “I” of a color (light blue, etc.) different from the color in the character insertion mode is displayed (when a “Roman alphabet” key of the keyboard 5 is on).

When a “CAPS LOCK” key of the keyboard 5 is on, the input of capital letters is possible.

When the “CAPS LOCK” key of the keyboard 5 is off, the height of the cursor is reduced to a half of the height during the “CAPS LOCK” key on. The input of small characters can be performed.

The cursor 319 is blinked.

21) In a contrast (CT) 320A, contrast setting set by a contrast key allocated to the operation device is displayed. (Display examples: “N” . . . Normal, “L” . . . Low, “H” . . . High, and “4” . . . no correction).

22) In a chroma enhancement (CE) 321A, setting of chroma enhancement set by a chroma enhancement key allocated to the operation device is displayed.

23) In a hemoglobin index (IHb) 322A, an IHb value obtained when the freeze switch is operated and a freeze image is output is displayed in the IHb 322A.

When freeze is not instructed, “- - -” is displayed.

When “AFI” is displayed in a light source filter type 325A explained later, the hemoglobin index (IHb) 322A may be not displayed.

24) In a structure enhancement (EH)/contour enhancement 323A, setting of structure enhancement or contour enhancement set by an enhancement key allocated to the operation device is displayed.

“EH:A*” indicating structure enhancement A or “EH:B*” indicating structure enhancement B is displayed during the structure enhancement (both *'s are numerical values).

Any one of three type of “ED:O”, “ED:L”, and “ED:H” or any one of three types of “ED:L”, “ED:M”, and “ED:H” is displayed during the contour enhancement.

25) In an expansion ratio 324A, setting of electronic expansion set by an electronic expansion key allocated to the operation device is displayed.

The expansion ratio 324A is displayed only when an endoscope including a CCD adapted to electronic expansions is connected to the processor 4.

26) In a light source filter type 325A, a type of a filter set to be used according to contents of an observation among the special light filters included in the light source device 3 is displayed.

When a filter adapted to a normal light observation is set to be used (or no special light filter is used), “Normal (or Nr)” is displayed.

When a filter adapted to a narrow-band light observation is set to be used, “NBI” is displayed.

When a filter adapted to a fluorescence observation is set to be used, “AFI” is displayed.

When a filter adapted to an infrared observation is set to be used, “IRI” is displayed.

27) In thumbnail images 326, maximum four images (for thumbnail images) are displayed. (The display may be able to be set to OFF. After the key or the like having the examination end notification function is operated, the images may be erased when a key or a switch to which a release function is allocated is first input.) The thumbnail images 326 may be not updated or may be black images during menu display.

In the following explanation, for simplicity of the explanation, the elements of the items from the items 4) to 20), i.e., the elements from the ID No. 303 to the cursor 319 are represented as observation information group 300. The elements from the contrast 320A to the light source filter type 325A, which are information concerning the endoscopic image 301, are represented as image related information group 301A. The plural thumbnail images 326 are represented as thumbnail image group 326A.

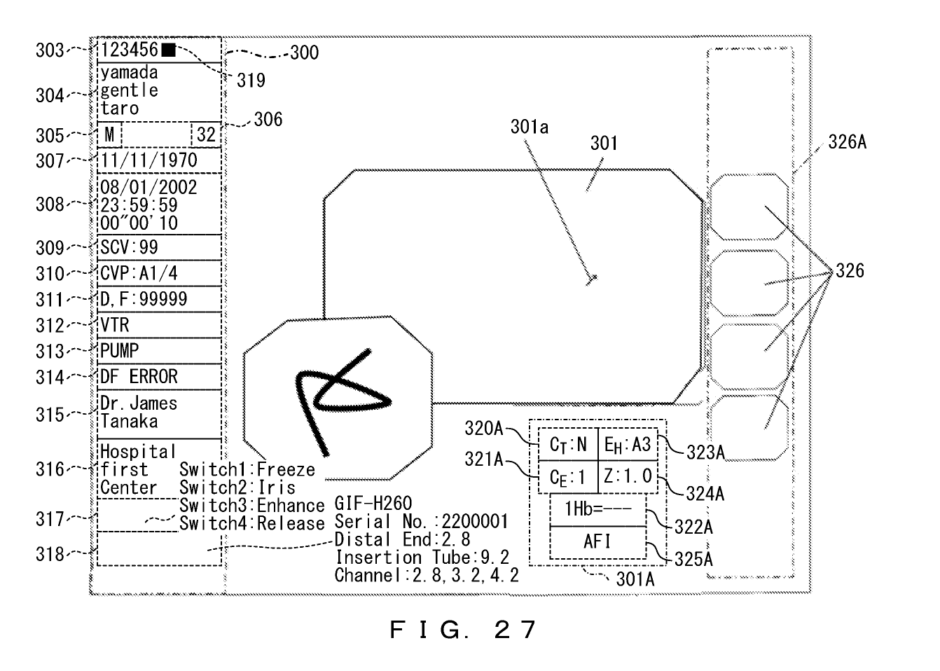

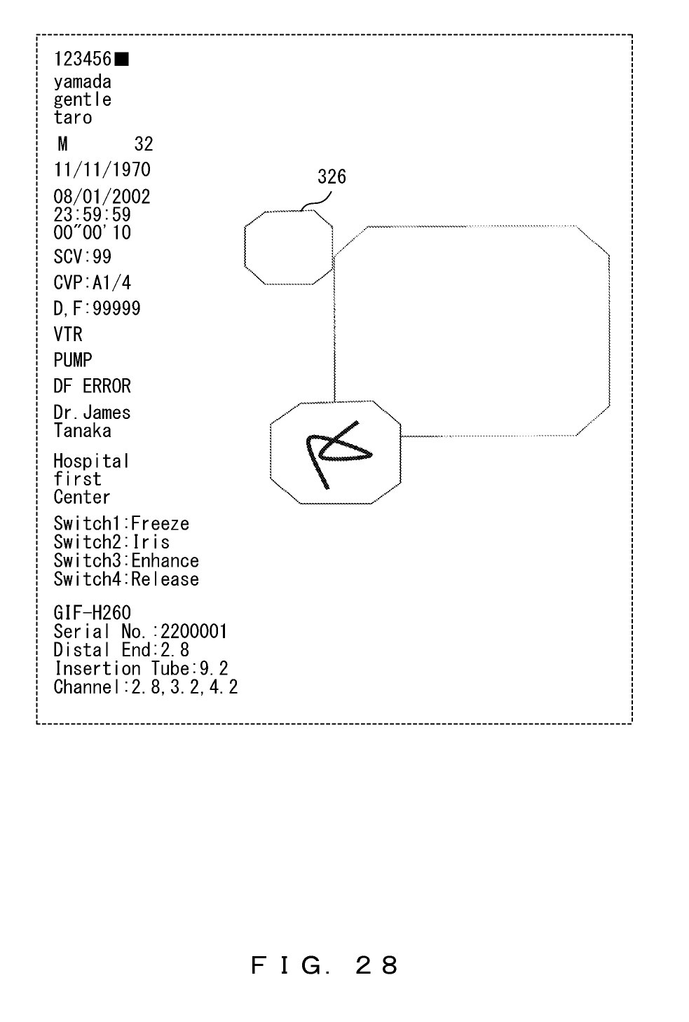

As shown in FIG. 27, when there is a space in a display area as in HDTV, four thumbnail images 326 may be displayed. As shown in FIG. 28, when there is no space in a display area as in SDTV, first one thumbnail image 326 may be displayed.

Normal display, time-limited display, and non-display may be able to be set by a menu concerning connection states (the SCV 309, the CVP 310, the D. F 311, the VTR 312, and the PUMP 313) with the peripheral devices.

FIG. 29 is a diagram showing an example of the setting screen of the processor 4. Items that can be set on the setting screen and functions related to the items are explained. It is assumed that the setting screen of the processor 4 shown in FIG. 29 is generated in, for example, the graphic circuit 106S (106H) of the image processing section 72.

An item “thumbnail” is an item in which it is possible to set whether creation of a thumbnail image is performed. When the item “thumbnail” is set to “ON”, the CPU 131 of the main control section 75 performs processing explained below. The CPU 131 of the main control section 75 controls the arbiter 633 to output an output image via the thumbnail image generating circuits 635H and 635S of the image compressing and expanding section 73. When the item “thumbnail” is set to “OFF”, the CPU 131 of the main control section does not cause the thumbnail image generating circuits 635H and 635S to operate.

An item “Scope Switch” is an item in which functions allocated by the CPU 131 of the main control section to switches included in the operation switch section 28A of the endoscope 2A functioning as the operation device, the operation switch section 28B of the endoscope 2B functioning as the operation device, and the operation switch section 28C of the endoscope 2C functioning as the operation device can be set. Details of the functions that can be allocated to the switches are explained later.

An item “Foot Switch” is an item in which functions allocated by the CPU 131 of the main control section 75 to switches included in the foot switch 6 functioning as the operation device can be set. Details of the functions that can be allocated to the switches are explained later.

An item “Keyboard” is an item in which functions allocated by the CPU 131 of the main control section to one or plural of keys included in the keyboard 5 functioning as the operation device can be set. Details of the functions that can be allocated to the one or plural keys are explained later.

An item “Front Panel” is an item in which functions allocated by the CPU 131 of the main control section 75 to one or plural of switches included in the front panel 76 functioning as the operation device can be set. Details of the functions that can be allocated to the one or plural switches are explained later.

Items “Release1”, “Release2”, “Release3”, and “Release4” in an “SDTV” space are a part of functions concerning recording of a still image in the SDTV system among the functions that can be allocated to any one of the items “Scope Switch”, “Foot Switch”, “Keyboard”, and “Front Panel”. In the items “Release1”, “Release2”, “Release3”, and “Release4”, recording conditions, a recording target device, and the like for the still image can be set according to sub-items explained below. Contents that can be set in the sub-items included in the items “Release1”, “Release2”, “Release3”, and “Release4” in the “SDTV” space are the same. Therefore, in the following explanation, only the sub-items of “Release1” are explained.

“Peripheral device”, which is one of the sub-items of the item “Release”, is an item in which a recording target device for a still image of the SDTV system can be set. The recording target device indicates any one of the filing devices (excluding the filing devices 204B1 and 204B2), the photographing devices (excluding the photographing devices 205B1 and 205B2), the optical recording devices, the PC card 167, and the memory card 168 shown in FIGS. 15 to 19. By setting the item “peripheral device” to “OFF”, it is possible to set a state without the recording target device, i.e., a state in which recording of a still image of the SDTV system is not performed even if the key or the switch to which the function of “Release1” is allocated is operated.

“Encode”, which is one of the sub-items of the item “Release1”, is an item in which a format used in recording a still image of the SDTV system can be set. A format that can be set as the format is any one of, for example, JPEG, JPEG2000, TIFF, and BMP. When any one of the formats is selected and set in the item “Encode”, the CPU 131 of the main control section 75 performs processing explained below. The CPU 131 controls the arbiter 633 to output an output image via the JPEG encode/decode circuit 645 and the TIFF/MBP conversion circuit 647 of the image compressing and expanding section 73. When “OFF” is selected in the item “Encode”, the CPU 131 of the main control section controls the arbiter 633 to output an output image not via the JPEG encode/decode circuit 645 and the TIFF/MBP conversion circuit 647 of the image compressing and expanding section 73.

“Signal”, which is one of the sub-items of the item “Release1”, is an item in which a signal form of an output image can be set to a YCrCb signal or an RGB signal. When “YCrCb” is selected and set in the item “Signal”, the CPU 131 of the main control section 75 controls the arbiter 633 to output an output image via the YUV-RGB conversion circuit 651 of the image compressing and expanding section 73. When “RGB” is selected in the item “Signal”, the CPU 131 of the main control section controls the arbiter 633 to output an output image via the YUV-RGB conversion circuit 651 of the image compressing and expanding section 73.

“Format”, which is one of the sub-items of the item “Release1”, is an item in which the format of the YCrCb signal or the RGB signal set in the item “Signal” can be set. It is assumed that a format that can be set as the format is any one or plural of 4:2:0, 4:1:1, 4:2:2, 4:4:4, Sequential, Spectral Selection (a frequency division type), Successive Approximation (an approximation accuracy improving type), DPCM (a reversible type), Interleave, and Non-Interleave. When any one of the formats is selected and set in the item “Format”, the CPU 131 of the main control section 75 causes the JPEG encode/decode circuit 645 and the TIFF/BMP conversion circuit 647 of the image compressing and expanding section 73 to perform compression/conversion processing corresponding to the format. It is assumed that, when “OFF” is selected in the item “Format”, the CPU 131 of the main control section 75 does not change the format for the YCrCb signal or the RGB signal set in the sub-item “Signal” of the item “Release1” in the “SDTV” space.

“Dot”, which is one of the sub-items of the item “Release1”, is an item in which quantization accuracy of the YCrCb signal (component) or the RGB signal (component) set in the sub-item “Signal” of the item “Release1” in the “SDTV” space can be set to either of number of dots of 8 bits or 10 bits. The CPU 131 of the main control section causes the JPEG encode/decode circuit 647 and the TIFF/BMP conversion circuit 647 of the image compressing and expanding section 73 to perform processing assuming that an input signal (component) is a signal quantized according to the number of dots.

“Level”, which is one of the sub-items of the item “Release1”, is an item in which a compression level of an output image can be set. As the compression level, for example, it is possible to select three levels of “High” in which image quality is high and an image size is large, “Normal” in which the image quality is low and the image size is small compared with setting of the “High”, and “Low” in which the image quality is low and the image size is small compared with setting of the “Normal”. The CPU 131 of the main control section 75 causes the JPEG encode/decode circuit 645 and the TIFF/BMP conversion circuit 647 of the image compressing and expanding section 73 to perform compression/conversion processing corresponding to the three levels. For example, in the case of the JPEG format, the settings of “High”, “Normal”, and “Low” can be realized by using a quantization table, a Huffman table, or the like set in advance.

Among the items in the “SDTV” space, the items “Encode”, “Signal”, “Format”, “Dot”, and “Level” is effective (can be set and changed) only when any one of the filing devices shown in FIGS. 18 and 19, the photographing devices shown in FIGS. 18 and 19, the optical recording devices shown in FIGS. 18 and 19, the PC card 167, and the memory card 168 is selected in the sub-item “peripheral device” of the item “Release1” in the “SDTV” space. When the items “Encode”, “Signal”, “Format”, “Dot”, and “Level” are ineffective (cannot be set and changed), for example, the items are displayed in a color such as dark gray.

The items “Release1”, “Release2”, “Release3”, and “Release4” in the “HDTV” space are a part of functions concerning recording of a still image of the HDTV system among functions that can be allocated to any one of the items “Scope Switch” “Foot Switch”, “Keyboard”, and “Front Panel”. In “Release1”, “Release2”, “Release3”, and “Release4”, recording conditions, a recording target device, and the like for the still image can be set according to sub-items explained below. Since contents that can be set in the sub-items included in “Release1”, “Release2”, “Release3”, and “Release4” in the “HDTV” space are the same, in the following explanation, only the sub-items of “Release1” are explained.

“Peripheral device”, which is one of the sub-items of the item “Release1”, is an item in which a recording target device for a still image of the HDTV system can be set. The recording target device indicates any one of the filing devices (excluding the filing device 204A), the photographing devices (excluding the photographing device 205A), the optical recording devices, the PC card 167, and the memory card 168 shown in FIGS. 15 to 19. By setting the item “peripheral device” to “OFF”, it is possible to set a state without the recording target device, i.e., a state in which recording of a still image of the HDTV system is not performed even if the key or the switch to which the function of “Release1” is allocated is operated.

“Encode”, which is one of the sub-items of the item “Release1”, is an item in which a format used in recording a still image of the HDTV system can be set. A format that can be set as the format is any one of, for example, JPEG JPEG2000, TIFF, and BMP. When any one of the formats is selected and set in the item “Encode”, the CPU 131 of the main control section performs processing explained below. The CPU 131 controls the arbiter 633 to output an output image via the JPEG encode/decode circuit 645 and the TIFF/MBP conversion circuit 647 of the image compressing and expanding section 73. When “OFF” is selected in the item “Encode”, the CPU 131 of the main control section does not drive the JPEG encode/decode circuit 645 and the TIFF/MBP conversion circuit 647 of the image compressing and expanding section 73.

“Signal”, which is one of the sub-items of the item “Release1”, is an item in which a signal form of an output image can be set to a YCrCb signal or an RGB signal. When “YCrCb” is selected and set in the item “Signal”, the CPU 131 of the main control section 75 controls the arbiter 633 to output an output image via the YUV-RGB conversion circuit 651 of the image compressing and expanding section 73. When “RGB” is selected in the item “Signal”, the CPU 131 of the main control section controls the arbiter 633 to output an output image via the YUV-RGB conversion circuit 651 of the image compressing and expanding section 73.

“Format”, which is one of the sub-items of the item “Release1”, is an item in which the format of the YCrCb signal or the RGB signal set in the sub-item “Signal” of the item “Release1” in the “HDTV” space can be set. It is assumed that a format that can be set as the format is any one or plural of 4:2:0, 4:1:1, 4:2:2, 4:4:4, Sequential, Spectral Selection (a frequency division type), Successive Approximation (an approximation accuracy improving type), DPCM (a reversible type), Interleave, and Non-Interleave. When any one of the formats is selected and set in the item “Format”, the CPU 131 of the main control section 75 causes the JPEG encode/decode circuit 645 and the TIFF/BMP conversion circuit 647 of the image compressing and expanding section 73 to perform compression/conversion processing corresponding to the format. It is assumed that, when “OFF” is selected in the item “Format”, the CPU 131 of the main control section does not change the format for the YCrCb signal or the RGB signal set in the sub-item “Signal” of the item “Release1” in the “HDTV” space.

“Dot”, which is one of the sub-items of the item “Release1”, is an item in which quantization accuracy of the YCrCb signal (component) or the RGB signal (component) set in the sub-item “Signal” of the item “Release1” in the “HDTV” space can be set to either of number of dots of 8 bits or 10 bits. The CPU 131 of the main control section causes the JPEG encode/decode circuit 645 and the TIFF/BMP conversion circuit 647 of the image compressing and expanding section 73 to perform compression/conversion processing assuming that an input signal (component) is a signal quantized according to the number of dots.

“Level”, which is one of the sub-items of the item “Release1”, is an item in which a compression level of an output image can be set. As the compression level, for example, it is possible to select three levels of “High” in which image quality is high and an image size is large, “Normal” in which the image quality is low and the image size is small compared with setting of the “High”, and “Low” in which the image quality is low and the image size is small compared with setting of the “Normal”. The CPU 131 of the main control section 75 causes the JPEG encode/decode circuit 645 and the TIFF/BMP conversion circuit 647 of the image compressing and expanding section 73 to perform compression/conversion processing corresponding to the three levels. For example, in the case of the JPEG format, the settings of “High”, “Normal”, and “Low” can be realized by using a quantization table, a Huffman table, or the like set in advance.

Among the items in the “HDTV” space, the items “Encode”, “Signal”, “Format”, “Dot”, and “Level” is effective (can be set and changed) only when any one of the filing devices shown in FIGS. 18 and 19, the photographing devices shown in FIGS. 18 and 19, the optical recording devices shown in FIGS. 18 and 19, the PC card 167, and the memory card 168 is selected in the sub-item “peripheral device”. When the items “Encode”, “Signal”, “Format”, “Dot”, and “Level” are ineffective (cannot be set and changed), for example, the items are displayed in a color such as dark gray.

The setting of the items included in the “SDTV” space and the “HDTV” space is not limited to setting by the user on the setting screen shown in FIG. 29. For example, when the processor 4 is connected to a predetermined peripheral device and the predetermined peripheral device is selected in the item “peripheral device” in the “SDTV” space or the “HDTV” space, a predetermined item may be automatically set as a predetermined setting content.

Items “NETWORK”, “UPD”, and “ZOOM Controller” included in the “Board” space are items in which setting concerning the extension control section 77 can be performed.

The item “NETWORK” is an item in which, when the extension control section 77A is connected as the extension control section 77, setting of display or non-display of (an image based on) network related information output from the extension control section 77A and a display position of (the image based on) the network related information can be performed.

The item “UPD” is an item in which, when the extension control section 77B including a part of functions of an endoscope shape detecting device is connected as the extension control section 77, setting of display or non-display of an endoscope shape image output from the extension control section 77B and a display position of the endoscope shape image can be performed.

The item “ZOOM Controller” is an item in which, when the extension control section 77B having the zoom control function is connected as the extension control section 77, setting of display or non-display of zoom control information output from the extension control section 77B and a display position of the zoom control information can be performed.

The items “NETWORK”, “UPD”, and “ZOOM Controller” include items “PinP” and “Position” as sub-items.

The sub-item “PinP” of the item “NETWORK” is set to “ON”, whereby (the image based on) the network related information is displayed by PinP. “PinP” is set to “OFF”, whereby (the image based on) the network related information is not displayed. The setting of “ON” or “OFF” is not limited to setting performed on the setting screen shown in FIG. 29. For example, the setting of “ON” or “OFF” may be performed by operation of a key or a switch to which a function of “NET” explained later is allocated.

The sub-item “Position” of the item “NETWORK” is an item in which a display position of (the image based on) the network related information displayed by PinP can be selected out of upper left, lower left, upper right, and lower right.

The sub-item “PinP” of the item “UPD” is set to “ON”, whereby the endoscope shape detection image is displayed by PinP. “PinP” is set to “OFF”, whereby the endoscope shape detection image is not displayed. The setting of “ON” or “OFF” is not limited to setting performed on the setting screen shown in FIG. 29 and may be performed by operation of a key or a switch to which a function of “UPD” explained later is allocated, for example.

The sub-item “Position” of the item “UPD” is an item in which a display position of the endoscope shape detection image displayed by PinP can be selected out of upper left, lower left, upper right, and lower right.

The sub-item “PinP” of the item “ZOOM Controller” is set to “ON”, whereby the zoom control information is displayed by PinP. “PinP” is set to “OFF”, whereby the zoom control information is not displayed. The setting of “ON” or “OFF” is not limited to setting performed on the setting screen shown in FIG. 29. For example, the setting of “ON” or “OFF” may be performed by operation of a key or a switch to which a function of “ZScale” explained later is allocated.

The sub-item “Position” of the item “ZOOM Controller” is an item in which a display position of the zoom control information displayed by PinP can be selected out of upper left, lower left, upper right, and lower right.

The items “SDTV” and “HDTV” in the “Release Time” space are items in which time for continuously displaying a still image can be set after a release instruction (a recording instruction) is performed. The time for continuously displaying the still image can be selected out of, for example, 0.1 seconds, 0.5 seconds, 1 second, 2 seconds, 3 seconds, 4 seconds, 5 second, 6 seconds, 7 seconds, 8 seconds, and 9 seconds.

The setting of the items “SDTV” and “HDTV” in the “Release Time” space is not limited to setting performed by the user on the setting screen shown in FIG. 29. For example, when the processor 4 is connected to a predetermined peripheral device and the predetermined peripheral device is selected in the item “peripheral device”, the setting of the “SDTV” space or the “HDTV” space may be automatically set as a predetermined setting content.

An item “Mon size” is an item in which the size of screen display can be selected from 16:9 and 4:3 and set.

An item “encryption” is an item in which it is possible to set whether encryption processing and decryption processing in the encryption processing circuit 170 of the extension control section 77A are performed.

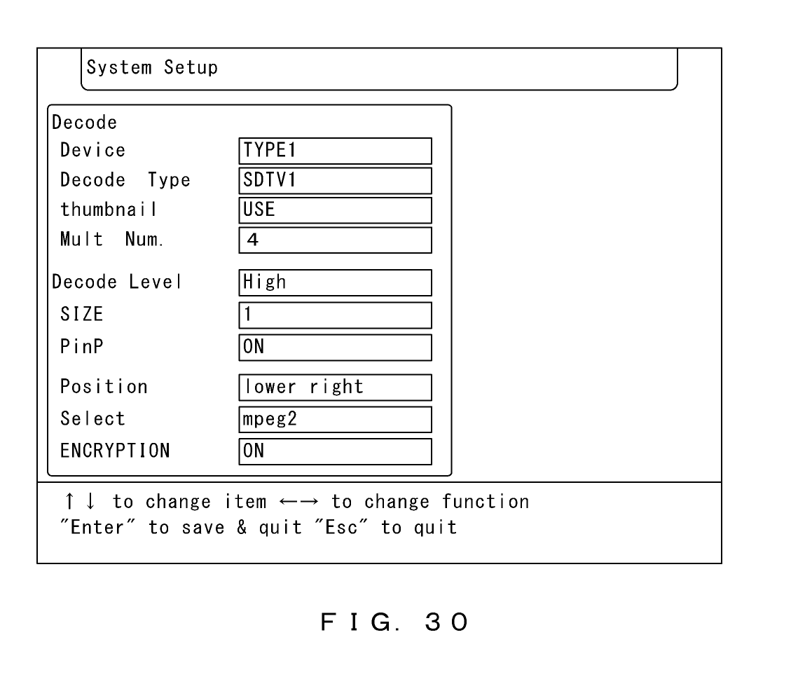

FIG. 30 is a diagram showing an example of another setting screen, which is a screen after transition from the setting screen shown in FIG. 29 by the operation of the keyboard 5 or the like in the setting screen of the processor 4. Items that can be set on the setting screen and functions related to the items are explained. It is assumed that, for example, a setting screen of the processor 4 shown in FIG. 30 is generated in the graphic circuit 106S (106H) of the image processing section 72.

Items included in the “Decode” space are items in which setting concerning the display of a still image and a moving image is possible.

An item “Device” in the “Decode” space is an item in which a peripheral device in which a desired image desired to be displayed is recorded among the peripheral devices connected to the processor 4 can be selected. When “TYPE1” is selected in the item “Device”, the CPU 131 of the main control section 75 reads an image recorded in the optical recording device 208E1 or 208E2 among the peripheral devices connected to the processor 4. When “TYPE2” is selected in the item “Device”, the CPU 131 of the main control section 75 reads an image recorded in the filing device 204E1 or 204E2 among the peripheral devices connected to the processor 4. When “TYPE3” is selected in the item “Device”, the CPU 131 of the main control section 75 reads an image recorded in the optical recording device 208D1 or 208D2 among the peripheral devices connected to the processor 4. When “TYPE4” is selected in the item “Device”, the CPU 131 of the main control section 75 reads an image recorded in the filing device 204D1 or 204D2 among the peripheral devices connected to the processor 4. When “TYPE5” is selected in the item “Device”, the CPU 131 of the main control section 75 reads an image recorded in the USB (registered trademark) memory 210 connected to the controller 164 among the peripheral devices connected to the processor 4. When “TYPE6” is selected in the item “Device”, the CPU 131 of the main control section 75 reads an image recorded in the PC card 167 among the peripheral devices connected to the processor 4. When “TYPE7” is selected in the item “Device”, the CPU 131 of the main control section 75 reads an image recorded in the memory card 168 among the peripheral devices connected to the processor 4. When “TYPE8” is selected in the item “Device”, the CPU 131 of the main control section 75 reads an image recorded in the server 212 among the peripheral devices connected to the processor 4.

An item “Decode Type” in the “Decode” space is an item in which a type of an endoscopic combined image to be displayed can be selected from SDTV and HDTV and set.

An item “thumbnail” in the “Decode” space is an item in which it is possible to set whether multi-image generation using a thumbnail image file is performed. When “USE” is selected in the item “thumbnail”, the expanding and reducing circuit 649 performs processing for generating a multi-image from the thumbnail image file. When “NO” is selected in the item “thumbnail”, the expanding and reducing circuit 649 performs processing for generating thumbnail images on the basis of an output image to be input and generating a multi-image in which the thumbnail images can be displayed as a list.

An item “Mult Num.” in the “Decode” space is an item in which the number of images displayed in the multi-image display can be set, for example, between one and thirty-two. The CPU 131 of the main control section 75 applies control to the expanding and reducing circuit 649 of the image compressing and expanding section 73 such that images are displayed by the number set in the item “Mult Num” in the multi-image display. The item “Mult Num” may be disabled to be set by half-tone dot meshing display or the like when it is set in the item “thumbnail” of the “Decode” space that a thumbnail file is used.

Next, functions that can be allocated to any one of the items “Scope Switch”, “Foot Switch”, “Keyboard”, and “Front Panel” among the items explained above and operations performed by, for example, the sections of the processor 4 in order to realize the functions are explained. It is assumed that operations performed in keys and switches to which the functions are allocated are detected by the CPU 131 via the SIO 142 or the PIO 143 and the system bus 131a.

“Freeze”, which is one of selectable functions, is a function that can perform a freeze instruction for outputting a freeze image. When a key or a switch to which such a freeze function is allocated is operated, the CPU 131 performs processing explained below. The CPU 131 controls the freeze circuit 96 and the memory 97 via the BUF 139 to perform control for outputting a freeze image. In this embodiment, the key or the switch to which the freeze function is allocated is referred to as freeze switch.

“Release1”, which is one of the selectable functions, is a function that can perform a release instruction for causing a peripheral device (a recording target device) or the like to record a still image. When a key or a switch to which such a release function is allocated is operated, the CPU 131 controls the graphic circuit 106S or (and) 106H. The CPU 131 outputs values respectively obtained by adding 1 to a value of the SCV 309 and a value of the D. F 311 of the screen shown in FIG. 25. When the key or the switch to which the release function is allocated is operated, the CPU 131 performs processing explained below. The CPU 131 causes a peripheral device or the like set in “peripheral device”, which is one of sub-items of the item “Release1” in the “SDTV” space, on the setting screen to record an output image of the SDTV system. At this point, the CPU 131 causes the peripheral device or the like set in “peripheral device”, which is one of sub-items of the item “Release1” of the “HDTV” space, to record an output image of the HDTV system.

In this embodiment, a function same as the function of the “Release1” can be allocated to maximum four keys or switches as “Release2”, “Release3”, and “Release4”.

Details of control performed by the CPU 131 in order to cause the recording target device to record an output image when any one of the keys or switches to which the release functions of the “Release1” to the “Release4” are allocated is operated are explained. Since all of the “Release1” to the “Release4” have the same function, in the following explanation, only the “Release1” is explained.

For example, when at least one of the filing devices and the photographing devices shown in FIGS. 15, 16, and 17 is selected as a recording target device in the “Release1” on the setting screen shown in FIG. 29, the CPU 131 performs processing explained below. The CPU 131 performs control for causing the at least one device to record an output image via the SIO 142 or the PIO 143.

For example, when at least one of the filing devices, the photographing devices, the optical recording devices, and the USB memory shown in FIG. 18 is selected as the recording target device in the “Release1” on the setting screen shown in FIG. 29, the CPU 131 performs processing explained below. The CPU 131 performs control for causing the at least one device to record an output image, which is output from the arbiter 633 of the image compressing and expanding section 73, via the controller 164 or the like of the extension control section 77A.

For example, when at least one of the PC card 167 and the memory card 168 shown in FIG. 10 is selected as the recording target device in the “Release1” on the setting screen shown in FIG. 29, the CPU 131 performs processing explained below. The CPU 131 performs control for causing the one device to record an output image, which is output from the arbiter 633 of the image compressing and expanding section 73, via the card controller 165 or the like of the extension control section 77A.

For example, when at least one of the filing devices, the photographing devices, the optical recording devices, and the server 212 shown in FIG. 19 is selected as the recording target device in the “Release1” on the setting screen shown in FIG. 29 and recording of an image having a high compression ratio is set to be recorded, the CPU 131 performs processing explained below. The CPU 131 causes the at least one device to record an output image, which is output from the arbiter 633 of the image compressing and expanding section 73, via the HUB 162, the signal line 162a, and the like. At this point, the CPU 131 performs control for also causing the buffer 166 to record the output image as an image for backup. For example, when at least one of the filing devices, the photographing devices, the optical recording devices, and the server shown in FIG. 19 is selected as the recording target device in the “Release1” on the setting screen shown in FIG. 29 and recording of an image having a low compression ratio is set to be recorded, the CPU 131 performs processing explained below. The CPU 131 performs control for causing the buffer 166 to record an output image, which is output from the arbiter 633 of the image compressing and expanding section 73. Thereafter, for example, the key having the examination end notification function is operated, whereby the end of the examination is notified. Then, a part or all of the output images recorded in the buffer 166 are recorded in at least one of the filing devices, the photographing devices, the optical recording devices, and the server shown in FIG. 19.

“Iris”, which is one of the selectable functions, is a function that can select and switch a photometry (dimming) system from peak, average, and automatic. A key or a switch to which such a photometry switching function is allocated is operated. Then, the CPU 131 outputs a dimming signal generated on the basis of an instruction corresponding to the operation to the light source device 3 via the signal lines 59a and 58a or the like.

“Enhance”, which is one of the selectable functions, is a function that can select enhanced display of an image from structure enhancement or contour enhancement and switch the enhanced display. When a key or a switch to which such an enhancement switching function is allocated is operated, the CPU 131 controls the graphic circuit 106S or (and) 106H to change and output display contents of the structure enhancement/contour enhancement 323A on the screen shown in FIG. 25. When the key or the switch to which the enhancement switching function is allocated is operated, the CPU 131 controls the expanding/enhancing circuit 99H or (and) 99S via the BUF 139 to output an output image in an enhanced state.

“Contrast”, which is one of the selectable functions, is a function that can select contrast of an image from, for example, “Low” (low contrast), “Normal” (medium contrast), “High” (high contrast), and no correction and switch the contrast of the image. A key or a switch to which such a contrast switching function is allocated is operated. Then, the CPU 131 controls the graphic circuit 106S or (and) 106H to change and output display contents of the contrast 320A on the screen shown in FIG. 25. When the key or the switch to which the contrast switching function is allocated is operated, the CPU 131 controls the pre-stage image processing circuit 95 via the BUF 139 to perform γ conversion based on an instruction corresponding to the operation.

“Img. Size”, which is one of the selectable functions, is a function that can switch an image size of an output image. A key or a switch to which such an image size switching function is allocated is operated. Then, the CPU 131 controls the expanding/enhancing circuit 99H or (and) 99S via the BUF 139 to change the image size of the output image and outputs the output image (an expanded image). When the key or the switch to which the image size switching function is allocated is operated, the CPU 131 controls the combining circuit 108H or (and) 108S via the BUF 139. Consequently, the CPU 131 causes the combining circuit 108H or (and) 108S to combine the image, the image size of which is changed, with an image signal subjected to mask processing and output the combined image.

“VTR”, which is one of the selectable functions, is a function that can switch, according to the toggle operation, recording of a moving image in a VTR among the peripheral devices connected to the processor 4 and a pause of the recording of the moving image. A key or a switch to which such a VTR recording function is allocated is operated. Then, the CPU 131 controls the graphic circuit 106S or (and) 106H to change a display state of the VTR 312 on the screen shown in FIG. 25 and output the moving image (the “VTR” is displayed during the recording of the moving image and the “VTR” is not displayed during the pause). The CPU 131 performs the processing explained below every time the key or the switch to which the VTR recording function is allocated is operated. The CPU 131 alternately outputs an instruction for causing one (or plural) VTR of the peripheral devices connected to the processor 4, for example, among the VTRs 203A, 203B1, 203B2, 203C1, and 203C2 to perform the recording of the moving image and an instruction for causing the VTR to pause the recording of the moving image. It is assumed that, when the key or the switch to which the VTR recording function is allocated is operated during reproduction of one moving image from the VTR, the CPU 131 suspends the reproduction of the one moving image. The CPU 131 performs processing explained below every time the key or the switch to which the VTR recording function is allocated is operated. It is assumed that the CPU 131 alternately outputs an instruction for causing the VTR to perform recording of another moving image different from the one moving image and an instruction for causing the VTR to pause the recording of the other moving image. The instruction for causing, with the VTR recording function, the VTR to perform recording of a moving image and the instruction for causing the VTR to pause the recording of the moving image may be output to the filing devices 204C1 and 204C2 other than the VTRs. Switches or the like having the VTR recording function and independent from the allocation of the function by the processor 4 may be provided in the VTRs shown in FIGS. 15 to 17.

“Capture”, which is one of the selectable functions, is a function that can perform capture of a still image in a printer among the peripheral devices connected to the processor 4. When a key or a switch to which such a capture function is allocated is operated, the CPU 131 controls the graphic circuit 106S or (and) 106H to change display contents (a count value, a memory page, etc.) of the CVP 310 on the screen shown in FIG. 25 and output the display contents. When the key or switch to which the capture function is allocated is operated, the CUP 131 outputs an instruction for performing capture of an output image and the output image to the printer among the peripheral devices connected to the processor 4.

Details of control performed by the CPU 131 for causing a target device to capture an output image when any one of keys or switches to which the capture function by the “Capture” is allocated is operated are explained.

For example, when the capture for an output image is performed in at least one of the printers shown in FIGS. 15, 16, and 17, the CPU 131 performs, via the SIO 142 or the PIO 143, control for causing the one printer to capture an output image.

For example, when at least one of the printers shown in FIG. 18 is selected, the CPU 131 performs, via the controller 164 or the like of the extension control section 77A, control for causing the one printer to capture an output image output from the arbiter 633 of the image compressing and expanding section 73.

For example, when at least one of the printers shown in FIG. 19 is selected and capture of an image having a high compression ratio is set to be performed, the CPU 131 performs processing explained below. The CPU 131 performs, via the HUB 162, the signal line 162a, and the like, control for causing the one printer to capture an output image output from the arbiter 633 of the image compressing and expanding section 73 and causing the buffer 166 to record the output image. For example, when at least one of the printers shown in FIG. 19 is selected and recording of an image having a low compression ratio is set to be performed, the CPU 131 performs processing explained below. The CPU 131 performs control for causing the buffer 166 to record an output image output from the arbiter 633 of the image compressing and expanding section 73. Thereafter, for example, the key having the examination end notification function is operated, whereby the end of the examination is notified. Then, a part or all of the output images recorded in the buffer 166 are captured in at least one of the printers shown in FIG. 19.

The selection of a printer may be performed on the setting screen shown in FIG. 29.

“Print”, which is one of the selectable functions, is a function that can cause the printer among the peripheral devices connected to the processor 4 to print and output a still image. When a key or a switch to which such a print function is allocated is operated, the CPU 131 outputs an instruction for causing the printer among the peripheral devices connected to the processor 4 to perform printing of an output image.

Details of control performed by the CPU 131 for causing a target device to print an output image when any one of keys or switches to which the print function by the “Print” is allocated is operated are explained.

For example, when printing of an output image is performed in at least one of the printers shown in FIGS. 15, 16, and 17, the CPU 131 performs, via the SIO 142 or the PIO 143, control for causing the one printer to print a still image captured in the one printer.

For example, when at least one of the printers shown in FIG. 18 is selected, the CPU 131 performs, via the controller 164 or the like of the extension control section 77A, control for causing the one printer to print a still image captured in the one printer.

For example, when at least one of the printers shown in FIG. 19 is selected, the CPU 131 performs, via the HUB 162, the signal line 162a, and the like, control for causing the one printer to print a still image captured in the one printer.

“Stop W.”, which is one of the selectable functions, is a function that can switch a display state and an operation state of the stopwatch in the time information 308 on the screen shown in FIG. 25. When a key or a switch to which such a stopwatch function is allocated is operated, the CPU 131 performs processing explained below. The CPU 131 controls the graphic circuit 106S or (and) 106H on the basis of time indicated by the RTC 134 and switches a display state of the stopwatch in the time information 308 on the screen shown in FIG. 25. In this embodiment, it is assumed that, as the display state of the stopwatch, stopwatch display and operation start, stopwatch pause, and stopwatch non-display are sequentially switched every time the key to which the stopwatch function is allocated is operated.

“UPD”, which is one of the selectable functions, is a function that can switch, according to the toggle operation, the display and non-display of an endoscope shape image generated and output in the graphic circuit 169 of the extension control section 77B. When a key or a switch to which such a UPD image switching function is allocated is operated, the CPU 131 performs processing explained below. The CPU 131 controls, on the basis of an instruction corresponding to the operation, whether endoscope shape images output from the graphic circuit 169 of the extension control section 77B are combined and output in the combining circuit 108H or (and) 108S. (Concerning processing involved in the control, see the section described as the explanation of the processing shown in step DDDFLW4 to step DDDFLW7 in FIG. 12.)

“ZScale”, which is one of the selectable functions, is a function that can switch, according to the toggle operation, the display and non-display of zoom control information output from the extension control section 77B. When a key or a switch to which such a ZScale image switching function is allocated is operated, the CPU 131 causes, on the basis of an instruction corresponding to the operation, the graphic circuit 106S and 106H to convert zoom control information into an image. At the same time, the CPU 131 controls whether to cause the combining circuit 108H and the combining circuit 108S to mask-combine and output the zoom control information. (Concerning processing involved in the control, see the section described as the explanation of the processing shown in step DDDFLW4 to step DDDFLW7 in FIG. 12.)

“Zoom”, which is one of the selectable function, is a function that can switch the magnification of electronic expansion processing for an output image. When a key or a switch to which such an electronic expansion magnification function is allocated is operated, the CPU 131 controls the expanding/enhancing circuit 99H or (and) 99S via the BUF 139 to perform electronic expansion processing by a magnification based on an instruction corresponding to the operation.

“IHb”, which is one of the selectable functions, is a function that can switch a degree of chroma enhancement corresponding to a hemoglobin index. When a key or a switch to which such a hemoglobin index chroma enhancing function is allocated is operated, the CPU 131 performs processing explained below. The CPU 131 controls the graphic circuit 106S or (and) 106H to change and output display contents of the chroma enhancement 321A on the screen shown in FIG. 25. When the key or the switch to which the hemoglobin index chroma enhancing function is allocated is operated, the CPU 131 performs processing explained below. The CPU 131 applies, via the BUF 139, control concerning a degree of IHb chroma enhancement processing, which is chroma enhancement processing corresponding to a hemoglobin index, to the post-stage image processing circuit 98.

“PUMP”, which is one of the selectable functions, is a function that can switch, according to the toggle operation, ON and OFF of water supply performed by a (not-shown) forward circulating pump. When a key or a switch to which such a forward water supply switching function is allocated is operated, the CPU 131 performs processing explained below. The CPU 131 applies control for executing or stopping forward water supply to the (not-shown) forward circulating pump. When the key or the switch to which the forward water supply switching function is allocated is operated, the CPU 131 controls the graphic circuit 106S or (and) 106H to change and output display contents of the PUMP 313 on the screen shown in FIG. 25.

“Exam End”, which is one of the selectable functions, is a function that can notify the peripheral devices and the like connected to the processor 4 of the end of the examination. When a key or a switch to which such an examination end notifying function is allocated is operated, the CPU 131 performs processing explained below. The CPU 131 controls the graphic circuit 106S or (and) 106H to clear a part of information included in the observation information group 300 displayed as the screen shown in FIG. 25 (and displays an item name instead of the part of the information). When the key or the switch to which the examination end notifying function is allocated is operated, the CPU 131 outputs a signal indicating the end of the examination to the sections of the processor 4.

“M-REC”, which is one of the selectable functions, is a function that can switch, according to the toggle operation, recording of a moving image in the optical recording device and the filing device among the peripheral devices connected to the processor 4 and pause of the recording of the moving image. When a key or a switch to which such a moving image recording function is allocated is operated, the CPU 131 performs processing explained below. The CPU 131 controls the graphic circuit 106S or (and) 106H to change and output a display state of the VTR 312 on the screen shown in FIG. 25 (the “VTR” is displayed during the moving image recording and the “VTR” is not displayed during the pause). The CPU 131 performs processing explained below every time the key or the switch to which the moving image recording function is allocated is operated. Specifically, the CPU 131 alternately outputs, to one (or plural) device of, for example, the filing devices 204D1, 204D2, 204E1, and 204E2 and the optical recording devices 208D1, 208D2, 208E1, and 208E2, which are the peripheral devices connected to the processor 4, an instruction for causing the device to perform recording of a moving image and an instruction for causing the device to pause the recording of the moving image. Switches or the like including the moving image recording function and independent from the allocation of the function by the processor 4 may be provided in the filing devices and (or) the optical recording devices shown in FIGS. 18 and 19.

“Special light”, which is one of the selectable functions, is a function that can switch and switch, according to the toggle operation, a filter arranged on an optical path of the lamp 51 among the special light filters 53A, 53B, and 53C included in the light source device 3. When a key or a switch to which such a special light filter switching function is allocated is operated, the CPU 131 controls the graphic circuit 106S or (and) 106H to change and output a display state of the light source filter type 325 on the screen shown in FIG. 25. When the key or the switch to which the special light filter switching function is allocated is operated, the CPU 131 performs processing explained below. The CPU 131 performs control based on an instruction corresponding to the operation via the signal lines 59a and 58a and the like to thereby change the filter arranged on the optical path of the lamp 51 of the light source device 3. Further, when the key or the switch to which the special light filter switching function is allocated is operated, the CPU 131 performs processing explained below. The CPU 131 controls the sections of the pre-stage image processing circuit 95, the post-stage processing circuit 98, the expanding/enhancing circuit 99H, and the expanding/enhancing circuit 99S to applies image processing corresponding to the type of the filter arranged on the optical path of the lamp 51 to the sections.

“P-VTR”, which is one of the selectable functions, is a function that can switch, according to the toggle operation, reproduction of a moving image recorded in the VTR among the peripheral devices connected to the processor 4 and a pause of the reproduction of the moving image. When a key or a switch to which such a VTR reproducing function is allocated is operated, the CPU 131 performs processing explained below. The CPU 131 controls the graphic circuit 106S or (and) 106H to change and output a display state of the VTR 312 on the screen shown in FIG. 25 (the “VTR” is displayed during the moving image reproduction and the “VTR” is not displayed during the pause). The CPU 131 performs processing explained below every time the key or the switch to which the VTR reproducing function is allocated is operated. The CPU 131 alternately outputs, to one of, for example, the VTRs 203A, 203B1, 203B2, 203C1, and 203C2 among the peripheral devices connected to the processor 4, an instruction for causing the VTR to perform reproduction of a moving image and an instruction for causing the VTR to pause the reproduction of the moving image. When the key or the switch to which the VTR reproducing function is allocated is operated while recording of the moving image is performed, while fast-forward of the moving image is performed, or when rewinding of the moving image is performed in the VTR, the CPU 131 performs processing explained below. The CPU 131 suspends processing concerning the recording, the fast-forward, and the rewinding of the moving image and alternately outputs, every time the key or the switch is operated, the instruction for causing the VTR to perform reproduction of the moving image and an instruction for causing the VTR to pause the reproduction of the moving image. The instruction for causing the VTR to perform reproduction of the moving image and the instruction for causing the VTR to pause the reproduction of the moving image with the VTR reproducing function may be output to the filing devices 204C1 and 204C2 other than the VTRs.

“M-PLY”, which is one of the selectable functions, is a function that can switch, according to the toggle operation, reproduction of a moving image in the optical recording device and the filing device among the peripheral devices connected to the processor 4 and a pause of the reproduction of the moving image. When a key or a switch to which such a moving image reproducing function is allocated is operated, the CPU 131 performs processing explained below. The CPU 131 controls the graphic circuit 106S or (and) 106H to change and output a display state of the VTR 312 on the screen shown in FIG. 25 (the “VTR” is displayed during the moving image reproduction and the “VTR” is not displayed during the pause). The CPU 131 performs processing explained below every time the key or the switch to which the moving image reproducing function is allocated is operated. The CPU 131 alternately outputs, to one of, for example, the filing devices 24D1, 204D2, 204E1, and 204E2 and the optical recording devices 208D1, 208D2, 208E1, and 208E2, which are peripheral devices connected to the processor 4, an instruction for causing the device to perform reproduction of a moving image and an instruction for causing the device to pause the reproduction of the moving image. Switches or the like including the moving image reproducing function and independent from the allocation of the function by the processor 4 may be provided in the filing devices and (or) the optical recording devices shown in FIGS. 18 and 19.

“NET”, which is one of the selectable functions, is a function that can switch, according to the toggle operation, the display and non-display of (an image based on) network related information output from the extension control section 77A. When a key or a switch to which such a network related information image switching function is allocated is operated, the CPU 131 controls, on the basis of an instruction corresponding to the operation, whether to cause the combining circuit 108H or (and) 108S to combine and output (the image based on) the network related information output from the extension control section 77A. (Concerning processing involved in the control, see the section described as the explanation of the processing in step DDFLW4 to step DDDFLW7 in FIG. 12.)

“TELE”, which is one of the selectable functions, is a function that can move the optical system 22A (22B) included in the endoscope 2A (2B) in an expanding (tele) direction. While a key or a switch to which such a tele function is allocated is continuously operated, the CPU 131 drives the actuator 23A (23B) of the endoscope 2A (2B) via the driving circuit 186 of the extension control section 77B. Consequently, the CPU 131 moves the object optical system 22A (22B) in the expanding (tele) direction, which is the axis direction and the distal end side direction of the insertion section 21A (21B). When the key or the switch to which the tele function is allocated is operated, the CPU 131 controls the graphic circuit 106S or (and) 106H to thereby change display contents of zoom control information to contents corresponding to expansion (tele) and outputs the contents.

“WIDE”, which is one of the selectable functions, is a function that can move the object optical system 22A (22B) included in the endoscope 2A (2B) in a wide angle (wide) direction. While a key or a switch to which such a wide function is allocated is continuously operated, the CPU 131 drives the actuator 23A (23B) of the endoscope 2A (and 2B) via the driving circuit 186 of the extension control section 77B. Consequently, the CPU 131 moves the object optical system 22A (22B) in the wide angle (wide) direction, which is the axis direction and the proximal end side direction of the insertion section 21A (21B). When the key or the switch to which the wide function is allocated is operated, the CPU 131 performs processing explained below. The CPU 131 controls the graphic circuit 106S or (and) 106H to thereby change display contents of zoom control information to contents corresponding to the wide angle (wide) and output the contents.

“OFF”, which is one of the selectable functions, is setting for allocating none of the functions explained above. When a key or a switch set to “OFF” is operated, the processor 4 performs no processing.

The CPU 131 may select only a part of the functions according to, for example, a detection result of the connection states of the extension control sections 77A and 77B. Specifically, the CPU 131 may perform processing for, for example, disabling the functions concerning unconnected one (or one that cannot be detected) of the extension control sections 77A and 77B to be selected or displayed.

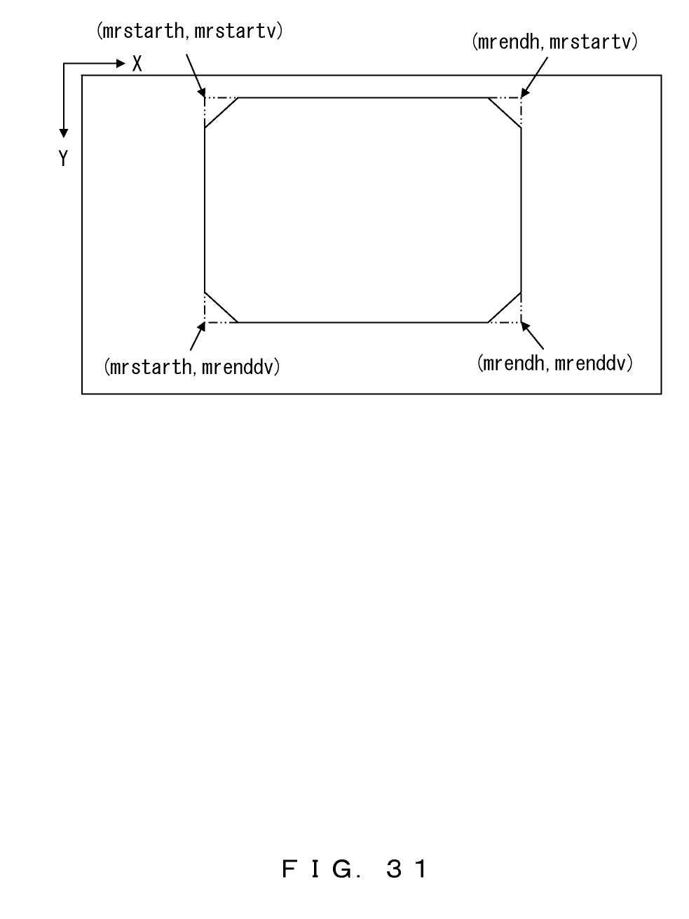

FIG. 31 is a diagram for explaining storage of an image according to a display size, an image size, and a type of an endoscope (an endoscope connection detection signal). Coordinate values (mrstarth, mrstartv, mrendh, and mrendv) of an image change according to the display size, the image size, and the type of an endoscope (the endoscope connection detection signal). Therefore, the display size, the image size, and the type of an endoscope (the endoscope connection detection signal) are stored as parameters and the coordinate values (mrstarth, mrstartv, mrendh, and mrendv) are stored as table values in a program ROM or the backup RAM 155. Consequently, only the endoscopic image 301 can be cut and recorded. The endoscopic image 301 recorded here is equivalent to an image based on a video signal from the signal line 124a or 125a.

An image input from the signal lines 607 and 607′ is an image before expansion and reduction/image arrangement is performed as shown in FIGS. 7A-7C. Therefore, the size and the position of the image are determined according to a type of a connecting device and a video format (HDTV/SDTV, etc.) of the image. Therefore, the type of the connecting device and the video format (HDTV/SDTV, etc.) of the image are discriminated on the basis of the SD/HD discrimination signals 615 and 615′. As a result of the discrimination, the type of the connecting device and the video format of the image are stored as parameters and coordinate values of the image are stored as table values in the program ROM or the backup RAM 155. An image of the endoscope shape detecting device/an image portion of the ultrasonic device can be cut and recorded on the basis of the table values.

An example of a directory structure used in recording an image in the filing devices and the optical recording devices, the PC card 167, the memory card 168 and the USB (registered trademark) memory, the buffer 166, and the server 212 shown in FIGS. 15 and 19 is shown in FIG. 32.

Data created by the processor 4 is transferred to the filing devices and the optical recording devices, the PC card 167, and the memory card 168 and the USB (registered trademark) memory by an Ethernet (registered trademark), a USB interface, or the like to configure a folder and a file as shown in FIG. 32.

A DCIM folder conforming to a DCM standard same as that for a digital camera is present under a top-level folder. An examination information storage folder is present under the DCIN folder. In the example shown in FIG. 32, the examination information storage folder is equivalent to 100OLYMP and 101OLYMP. As the examination information storage folder, for example, folders may be created in serial numbers in this way to store data.

An annotation storage folder is present under the examination information storage folder. Annotation data using an image in examination is stored in an annotation storage folder. In the example shown in FIG. 32, the annotation storage folder is equivalent to 100OLYMP, 101OLYMP, and 102OLYMP. When plural pieces of annotation data are created, folders may be created in serial numbers to store the data.

Consequently, for example, it is possible to generate a display image optimum for the user by correcting data of a server in a terminal. It is possible to reproduce the display image optimum for the user in a video processor as well by transmitting the data to the video processor.

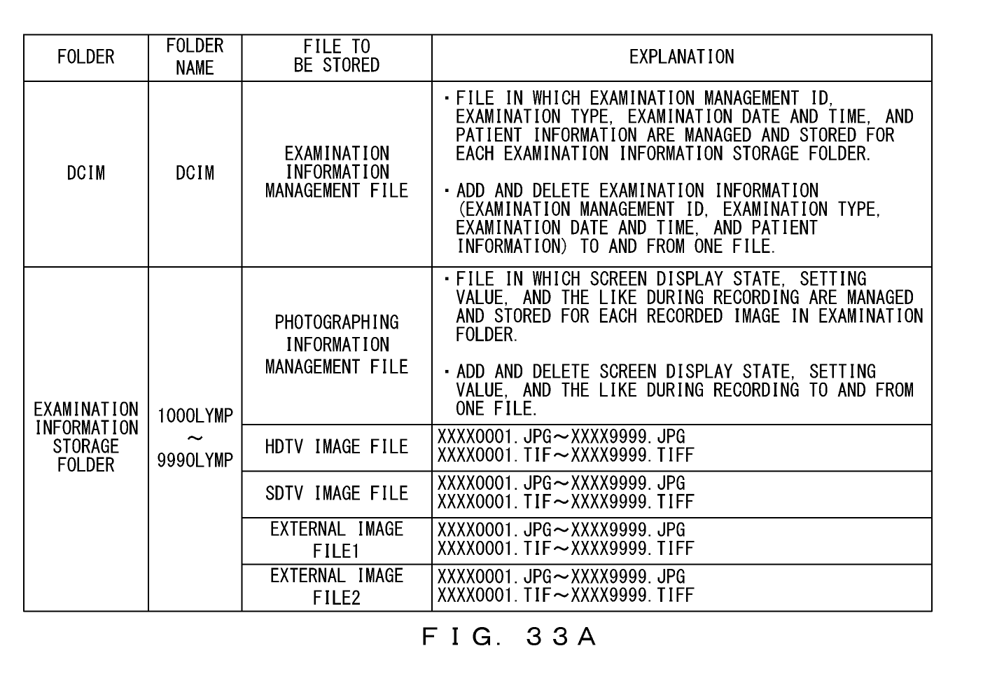

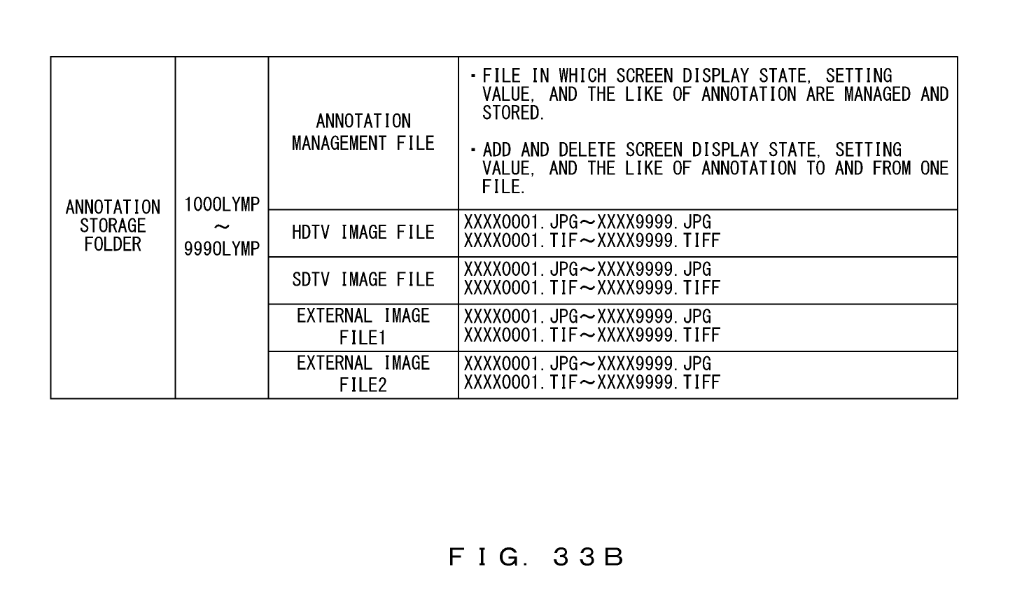

FIGS. 33A and 33B are a diagram for explaining the DCIM folder, the examination information storage folder, the annotation storage folder shown in FIG. 32.

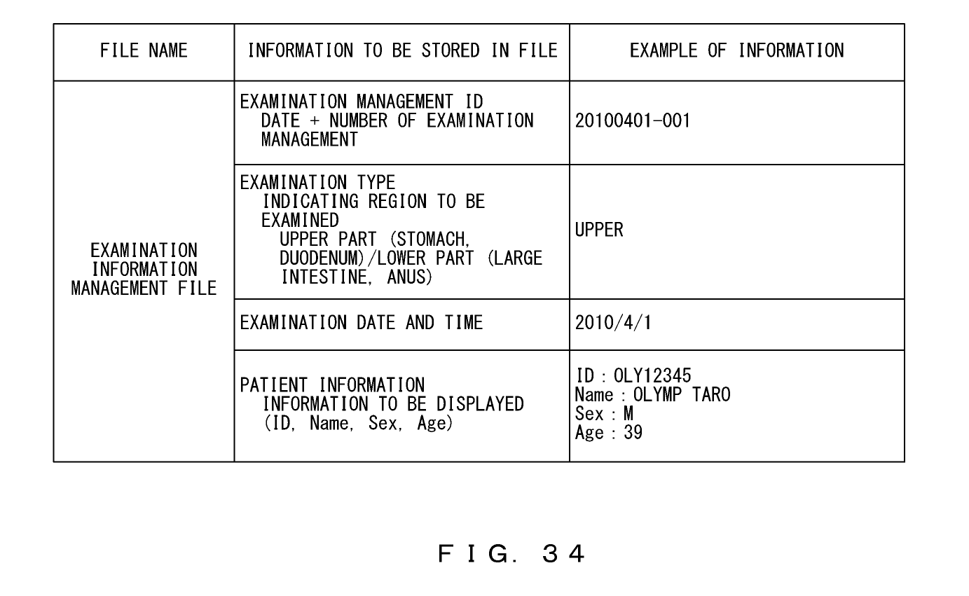

An examination information storage file is stored in the DCIM folder. The examination information storage file is a file in which an examination management ID, an examination type, examination date and time, and patient information are managed and stored for each examination information storage folder. Examination information (the examination management ID, the examination type, the examination date and time, and the patient information) is added and deleted to and from one examination information storage file. Details of the examination information storage file are explained in FIG. 34.

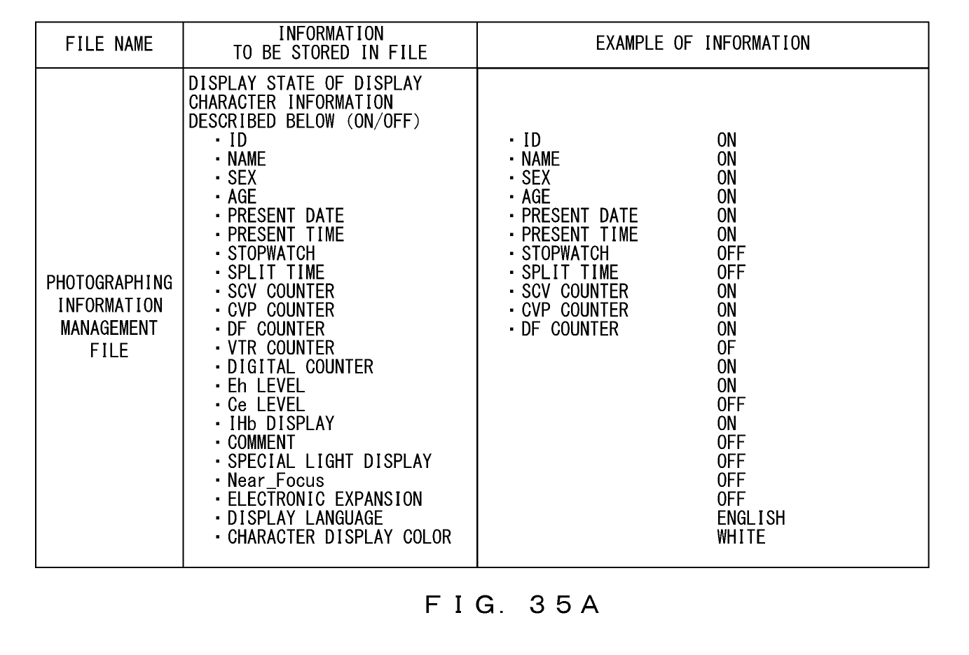

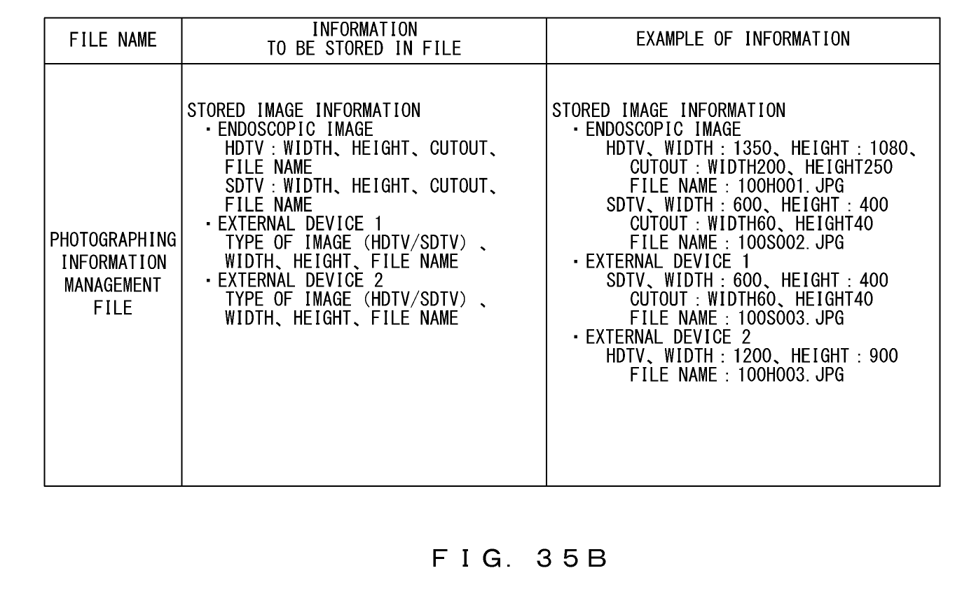

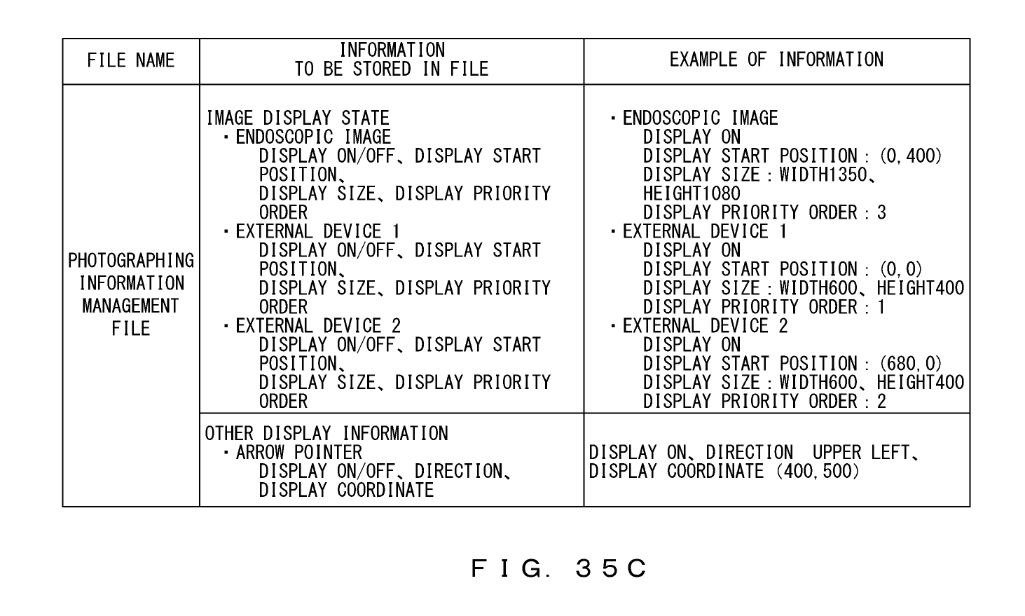

In the examination information storage folder, a photographing information management file, an HDTV image file, an SDTV image file, an external image file 1, and an external image file 2 are stored. The photographing information management file is a file in which a screen display state, a setting value, and the like during recording are managed and stored for each recorded image in the examination information storage folder. The screen display state, the setting value, and the like during recording are added and deleted to and from one photographing information management file. An image file of the HDTV endoscopic image 301 recorded as shown in FIGS. 47 to 51 and 17 via, for example, 125a, an image file of the SDTV endoscopic image 301 recorded as shown in FIGS. 47 to 51 and 17 via, for example, 124a, an external image file 1 of an external image 1 (330) recorded as shown in FIGS. 47 to 51 and 17 via, for example, 607, and an external image file 2 of an external image 2 (331) recorded as shown in FIGS. 47 to 51 and 17 via, for example 607′ are respectively, for example, JPEG image data files of XXXX0001.JPG to XXXX9999.JPG and, for example, TIFF image data files of XXXX0001.TIF to XXXX9999.TIFF. Details of the photographing information management file are explained with reference to FIGS. 35A-35C.

In the annotation storage folder, an annotation management file, an HDTV image file, an SDTV image file, an external image file 1, and an external image file 2 are stored. The annotation management file is a file in which a screen display state, a setting value, and the like of annotation are managed and stored. The screen display state, the setting value, and the like of annotation are added and deleted to and from one annotation management file. The HDTV image file, the SDTV image file, the external image file 1, and the external image file 2 are respectively, for example, JPEG image data files of XXXX0001.JPG to XXXX9999.JPG and, for example, TIFF image data files of XXXX0001.TIF to XXXX9999.TIFF.

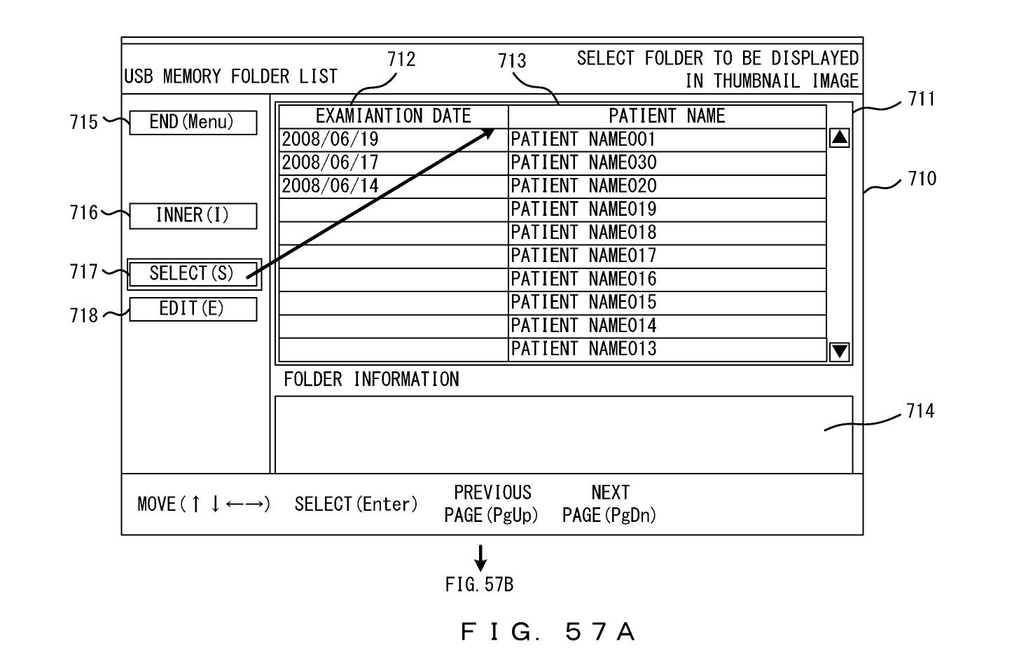

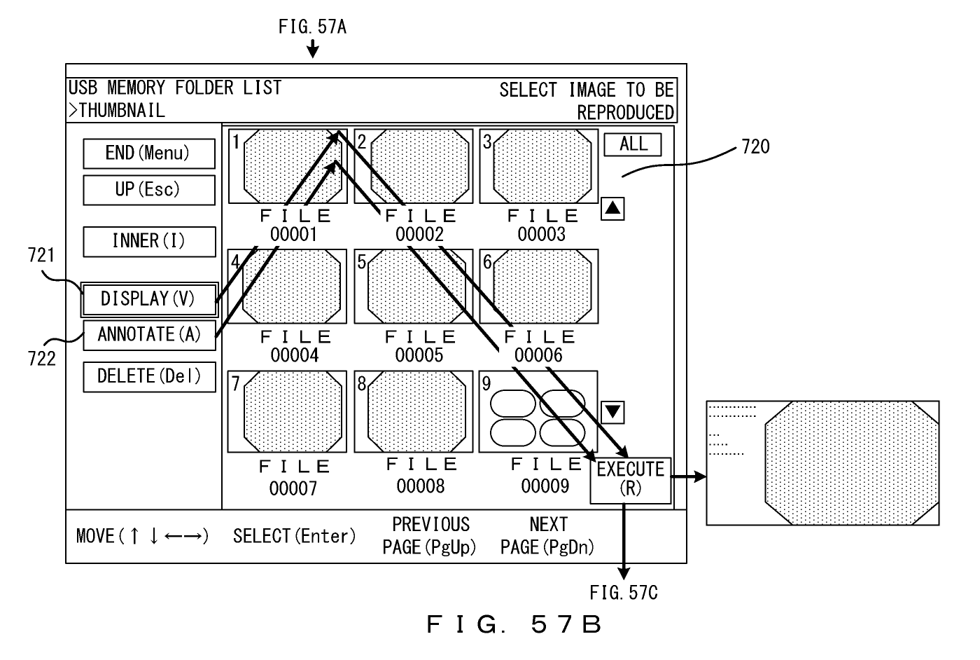

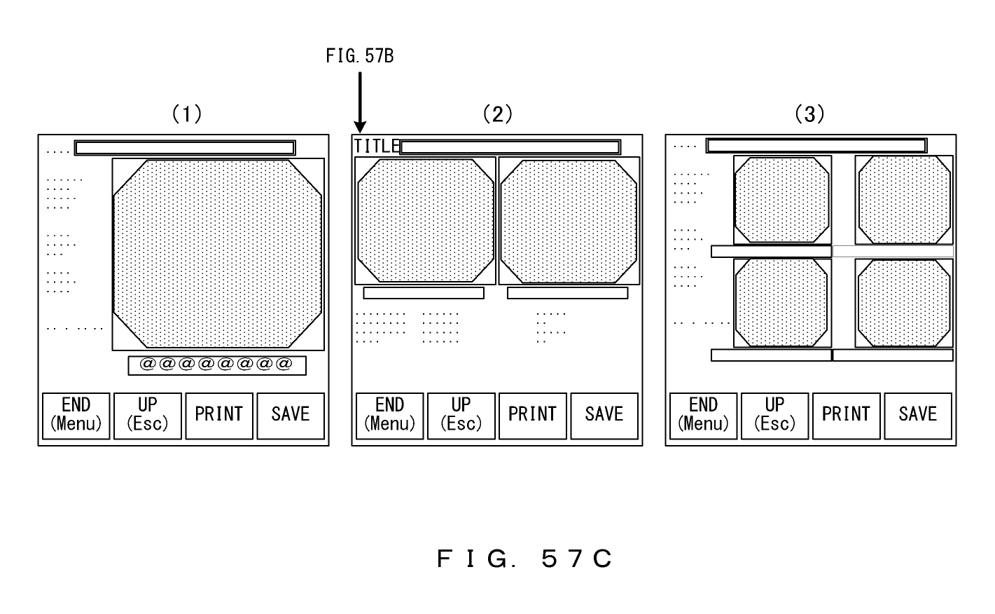

Annotation display examples are (1), (2), and (3) in FIG. 57C.

FIG. 34 is a diagram for explaining details of the examination information storage file. The examination information storage file includes the information described in FIG. 25 and items of “examination management ID”, “examination type”, “examination date and time”, and “patient information”. The “examination management ID” includes a date and an examination management number. The “examination type” indicates a region to be examined such as an upper part (stomach and duodenum)/a lower part (large intestine, small intestine, and anus). The “examination date and time” indicates data and time when an examination is performed. The “patient information” includes a patient ID, a patient name (Name), sex (Sex), and age (Age).

FIGS. 35A-35C are a diagram for explaining details of the setting screen items and the photographing information management file shown in FIG. 29. The photographing information management file includes items of “display state of display character information”, “stored image information”, “image display state”, and “other display information”.

The “display state of display character information” is an item for setting a display state of characters displayed in the endoscopic combined image 300-1 generated in the combining circuit 108H or 108S. In the “display state of display character information”, for example, concerning “ID”, “NAME”, “SEX”, “AGE”, “present data”, “present time”, “stopwatch”, “split time”, “SCV counter”, “CVP counter”, “DF counter”, “VTR counter”, “digital counter”, “Eh level”, “Ce level”, “IHb display”, “comment”, “special light display”, “Near_Focus”, and “electronic expansion”, display(ON)/non-display (OFF) can be set, for example, English can be set concerning “display language”, and for example, “white” can be set concerning “character display color”.

In the “stored image information”, when the endoscopic combined image 300-1 generated in the combining circuit 108H or 108S is stored, information concerning images included in the endoscopic combined image 300-1 is stored. For example, in the case of an endoscopic image (an HDTV image/an SDTV image), the width, the height, cutout, and a file name of the HDTV image are stored. For example, in the case of external devices (1 and 2), the type (HDTV/SDTV), the width, the height, and a file name of an image are stored.

In the “image display state”, concerning the display of an endoscopic image, ON (display)/OFF (non-display), a display start position (a coordinate in the endoscopic combined image 300-1), a display size, and display priority order are stored. Concerning the display of the external devices (1 and 2), ON (display)/OFF (non-display), a display start position (a coordinate in the endoscopic combined image 300-1), a display size, and display priority order are stored.

In the “other display information”, concerning the display of an arrow pointer (the display of an arrow in the endoscopic combined image 300-1), ON (display)/OFF (non-display), the direction of the arrow pointer, and a display coordinate of the arrow pointer (a coordinate of the arrow in the endoscopic combined image 300-1) are stored.

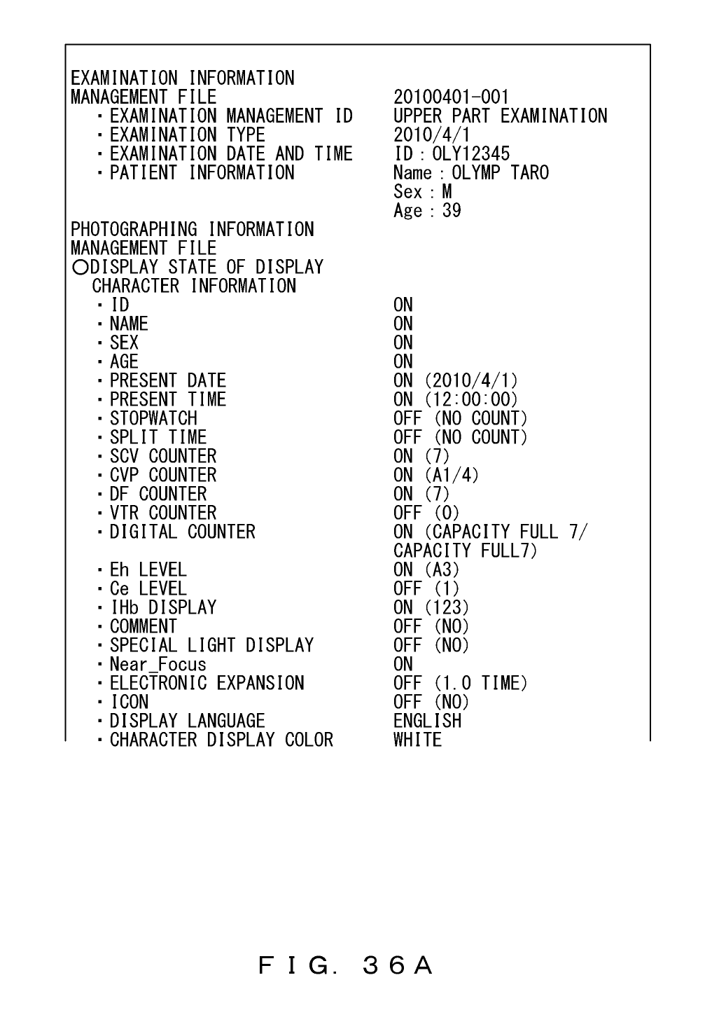

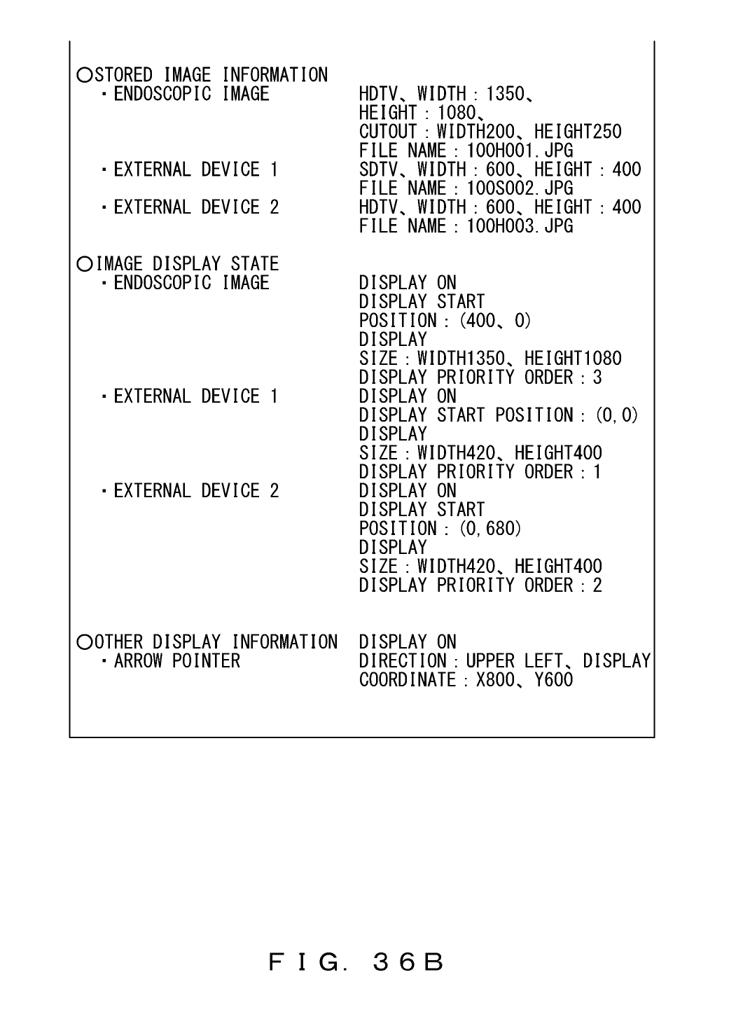

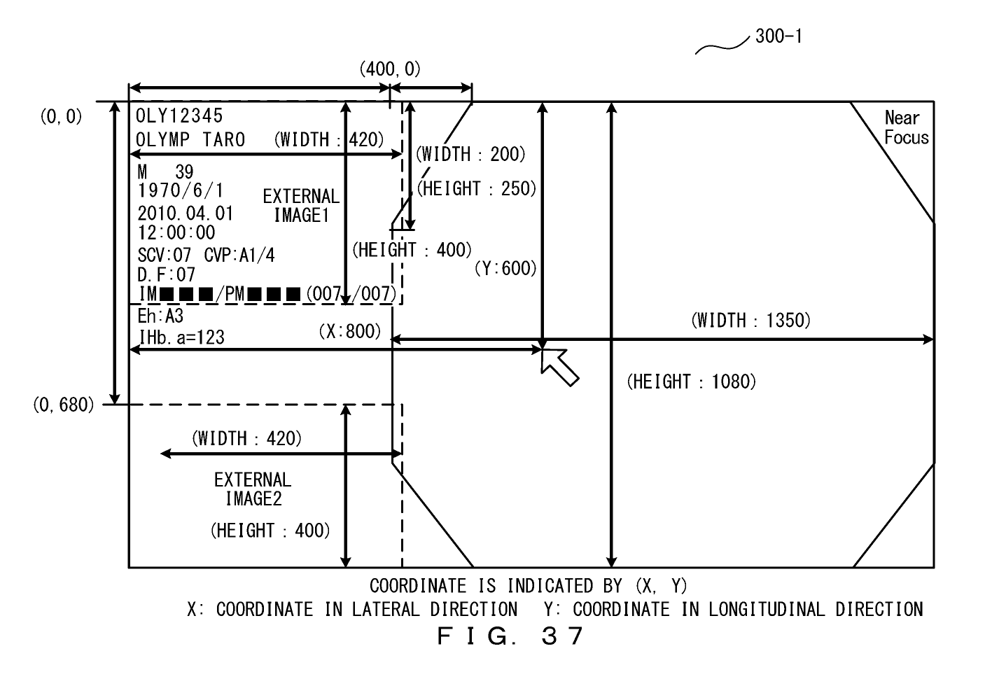

FIGS. 36A and 36B shows an example of an examination information management file and a photographing information management file concerning the endoscopic combined image 300-1 generated in the combining circuit 108H or 108S. FIG. 37 shows the endoscopic combined image 300-1 corresponding to the examination information management file and the photographing information management file shown in FIGS. 36A and 36B. For example, in the case of the endoscopic combined image 300-1 on the right side of FIG. 37, the examination information management file and the photographing information management file have contents shown on the left side of FIGS. 36A and 36B.

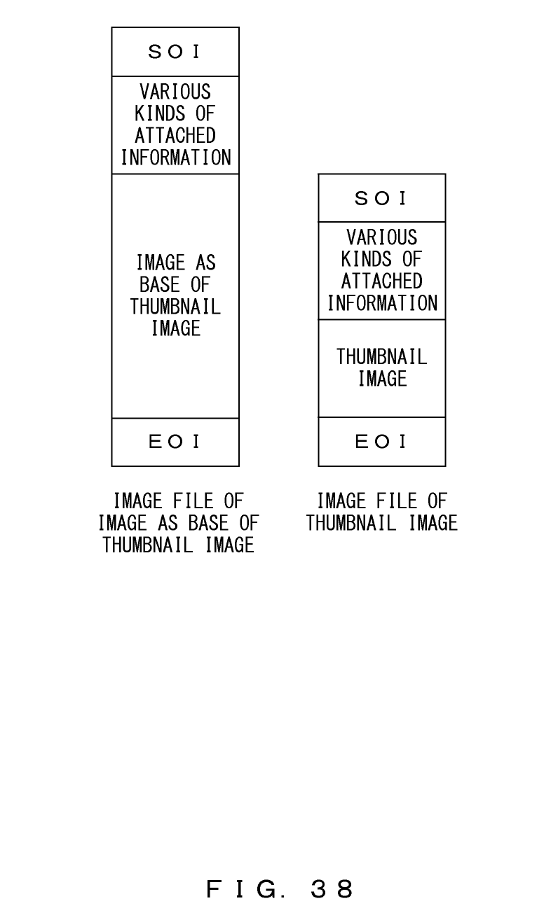

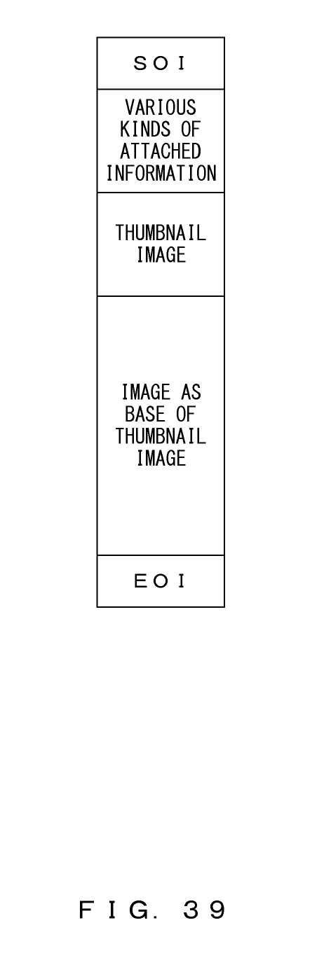

An image file of a thumbnail image and an image file of an image as a base of the thumbnail image may be separate image files as shown in FIG. 38 or may be configured as one image file in which the image files are combined as shown in FIG. 39. In FIGS. 38 and 39, “SOI” is information indicating a start portion of file data. “EOI” is information indicating an end portion of the file data.

At least one kind of information or the like among kinds of information and the like listed in items a) to z) described below may be added to images (moving images and still images) recorded in files shown in FIGS. 32 to 39, the peripheral devices, and the like.

a) The observation information group 300 shown in FIG. 25 and setting information concerning the observation information group 300

b) The image related information group 301A and setting information concerning the image related information group 301A.

c) Connection information of the peripheral devices (the number of recorded sheets, a recording state, presence or absence of connection, a power supply state, and a communication state, a division mode and the number of prints of a printer or the like, and an operation state (reproduction, recording, or stop) of a VTR)).

d) Information (a display are of an IHb pseudo color, an image size (any one of Medium, Semi-Full, and Full), setting of monochrome, etc.) concerning the endoscopic image 301 other than the image related information group 301A.

e) Functions allocated to the operation switch section 28A (or 28B or 28C) of the endoscope 2A (or 2B or 2C), the keyboard 5, and the front panel 76 (Caps Lock, Insert, and character input setting in the keyboard 5, etc.).

f) A display state of the arrow pointer 301a.

g) An operation state (operating or stopping) of the stopwatch included in the time information 308.

h) Information concerning whether the time information 308 is displayed in abbreviation.

i) Messages displayed in an endoscopic combined image.

j) A display size (a screen aspect ratio) of the endoscopic combined image.

k) The number of thumbnail images 326 included in the thumbnail image group 326A.

l) Display states (displayed or erased) of kinds of information on the endoscopic combined image.

m) Information stored in the memory 30A (or 30B or 30C) of the endoscope 2A (or 2B or 2C).

n) A serial number of the processor 4.

o) The number of times the power supply for the processor 4 is turned on.

p) Date and time when an image is recorded.

q) The type of the endoscope 2A (or 2B or 2C).

r) A setting state (peak, average, or automatic) of photometry (dimming).

s) A MAC address and an IP address of an Ethernet (registered trademark).

t) A data size of the image.

u) A reduction ratio of the image.

v) A color space (sRGB, etc.) of the image.

w) Identification information of the image.

x) Setting contents in the setting screens (FIGS. 29 and 30, etc.)

y) A header file, a marker, etc. of a format.

z) A serial number and a product name of a device in which the image is recorded.

It is assumed that the image size (any one of Medium, Semi-Full, and Full) in item d) above can be changed by, for example, the operation of the key or the switch to which the image size switching function is allocated.

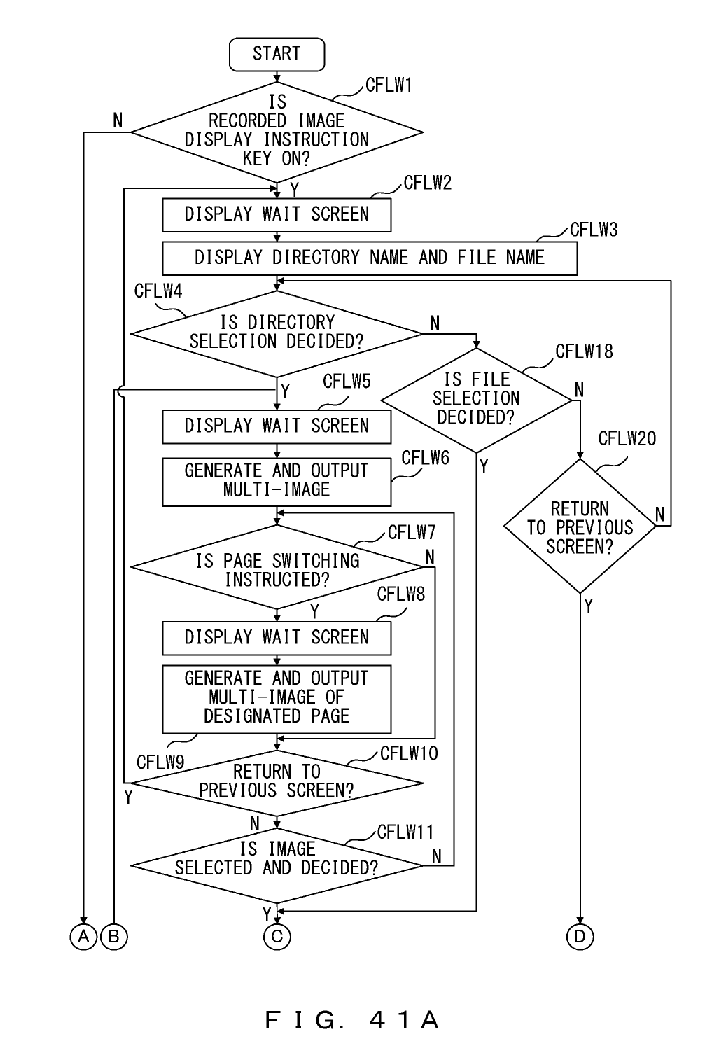

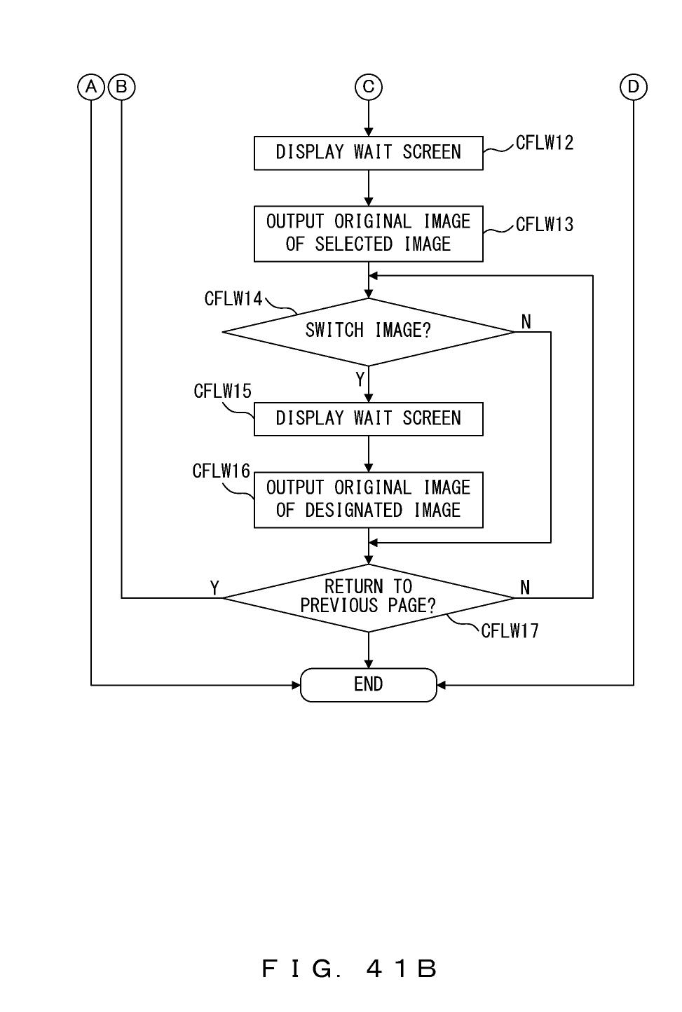

Control and processing performed by the CPU 131 of the main control section 75 when a still image recorded in the peripheral device or the like is displayed are explained with reference to flowcharts of FIGS. 41A and 41B.

First, the CPU 131 of the main control section 75 detects, via the SIO 142 or the PIO 143, whether the input of, for example, a recorded image display instruction key provided in the operation device is performed (step CFLW1 in FIGS. 41A and 41B). Detection concerning whether the recorded image display instruction key included in the HIDs 209D1 and 209D2 is input is not limited to the detection performed by the CPU 131. For example, the CPU 151 of the extension control section 77A may detect whether the recorded image display instruction key is input and input a result of the detection to the CPU 131 via the SIO 159, the SIO 142, and the like.

Thereafter, when the CPU 131 detects that the recorded image display instruction key is input, the CPU 131 performs, in any one of the graphic circuit 106H, the graphic circuit 106S, and the graphic circuit 169, control for generating and outputting a message (a message such as “Please Wait”) or an image (an image such as a black screen or a color bar) indicating that the display of a still image is being prepared (step CFLW2 in FIGS. 41A and 41B). The message or the image indicating that the display is being prepared is hereinafter (and in the figures) referred to as wait screen. It is assumed that processing performed in displaying the wait screen is processing same as the processing in step CFLW2 in FIGS. 41A and 41B.

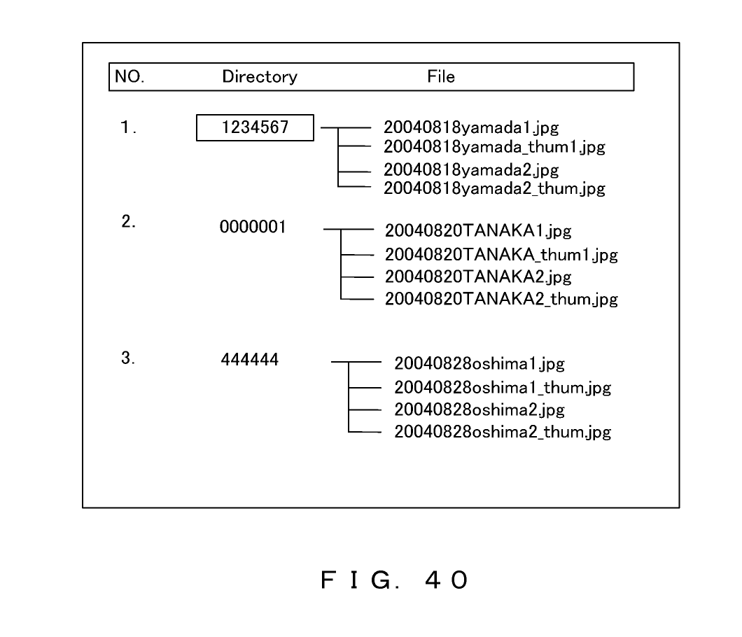

Thereafter, the CPU 131 reads a directory name and an image file name stored in the peripheral device or the like and performs control for, for example, displaying a directory structure concerning the read directory name and file name as shown in FIG. 40 (step CFLW3 in FIGS. 41A and 41B). It is assumed that the peripheral device that the CPU 131 refers to in the processing in step CFLW3 in FIGS. 41A and 41B is the device set in the item “Device” of the “Decode” space on the setting screen shown in FIG. 30.

The CPU 131 is not limited to the use of the display method shown in FIG. 40 in displaying a directory name and an image file name stored in the peripheral device referred to (the device set in the item “Device” of the “Decode” space on the setting screen shown in FIG. 30). For example, the CPU 131 may display, on the basis of information such as size information, identification information, a reduction ratio, and (or) a data size, only an image and a thumbnail of a type (SDTV or HDTV) set in the item “Decode Type” of the “Decode” space on the setting screen shown in FIG. 30. The CPU 131 may display, in displaying the directory name and the image file name stored in the peripheral device or the like referred to, only the directory name first and display, only when the CPU 131 detects that one directory is selected and a predetermined key (or switch) is input (e.g., right click of a mouse, which is one of HIDs), an image file name stored in the one directory. Further, it is assumed that the directory name and the image file name selected by the operation of the operation device can be changed by predetermined keys (e.g., character key included in the keyboard 5 or the HIDs 209D1 and 209D2). When there are a large number of directories and (or) image files, the CPU 131 may perform display by plural pages.

When a directory is selected by the input of a predetermined key included in the operation device (e.g., an arrow key included in the keyboard 5) and one directory is decided by the input of a decision key (e.g., an ENTER key included in the keyboard 5) (step CFLW4 in FIGS. 41A and 41B), the CPU 131 performs processing explained below. The CPU 131 performs processing for displaying the wait screen (step CFLW5 in FIGS. 41A and 41B) and generates and outputs a multi-image during the display of the wait screen (step CFLW6 in FIGS. 41A and 41B).

Details of the processing in step CFLW6 in FIGS. 41A and 41B are explained.

After reading image files in the directory stored in the peripheral device referred to (the device set in the item “Device” of the “Decode” space on the setting screen shown in FIG. 30), the CPU 131 causes, via the bus bridge 163 and the arbiter 633, the image memory 654 to store the image files. The image files stored in the image memory 654 in this processing are not limited to all the image files in the directory and may be, for example, only thumbnail image files. When encryption processing is applied to the image files in the directory stored in the peripheral device or the like referred to, after decrypting the image files with the encryption processing circuit 170, the CPU 131 causes the image memory 654 to store the image files.

Thereafter, the CPU 131 causes the image compressing and expanding section 73 to sequentially output the image files stored in the image memory 654. The CPU 131 controls the arbiter 633 on the basis of information added to the image files stored in the image memory 654 such that expansion/conversion processing and RGB conversion processing are appropriately performed according to a format or the like of the image files. The CPU 131 controls the arbiter 633 such that an image file output from the image memory 654 is output via the expanding and reducing circuit 649.

When the “USE” is selected in the item “thumbnail” of the “Decode” space on the setting screen shown in FIG. 30, the expanding and reducing circuit 649 performs, on the basis of an image size of a thumbnail image file, processing for generating a multi-image corresponding to the image size. Specifically, when a thumbnail image of the SDTV system having a size of 180×120 is input, the expanding and reducing circuit 649 generates and outputs a multi-image in which sixteen images are arranged on one screen.

When “NO” is selected in the item “thumbnail” of the “Decode” space on the setting screen shown in FIG. 30, the expanding and reducing circuit 649 performs processing for generating a multi-image from an input image file. Specifically, the expanding and reducing circuit 649 generates thumbnail images by a number set in the item “Mult Num.” of the “Decode” space on the setting screen shown in FIG. 30 and generates and outputs a multi-image in which the thumbnail images are arranged on one screen.

The multi-image generated in the expanding and reducing circuit 649 is sequentially output as F1 or F2 from the FIFO 642 or 643 frame by frame on the basis of the frequency of a clock signal. Specifically, when the multi-image generated in the expanding and reducing circuit 649 is an image of the SDTV system, the multi-image is output to the combining circuit 108S via the image memory 654 and the FIFO 642 or 643 at timing synchronizing with a clock signal of 13.5 MHz. When the multi-image generated in the expanding and reducing circuit 649 is an image of the HDTV system, the multi-image is output to the combining circuit 108H via the image memory 654 and the FIFO 642 or 643 at timing synchronizing with a clock signal of 74 MHz.

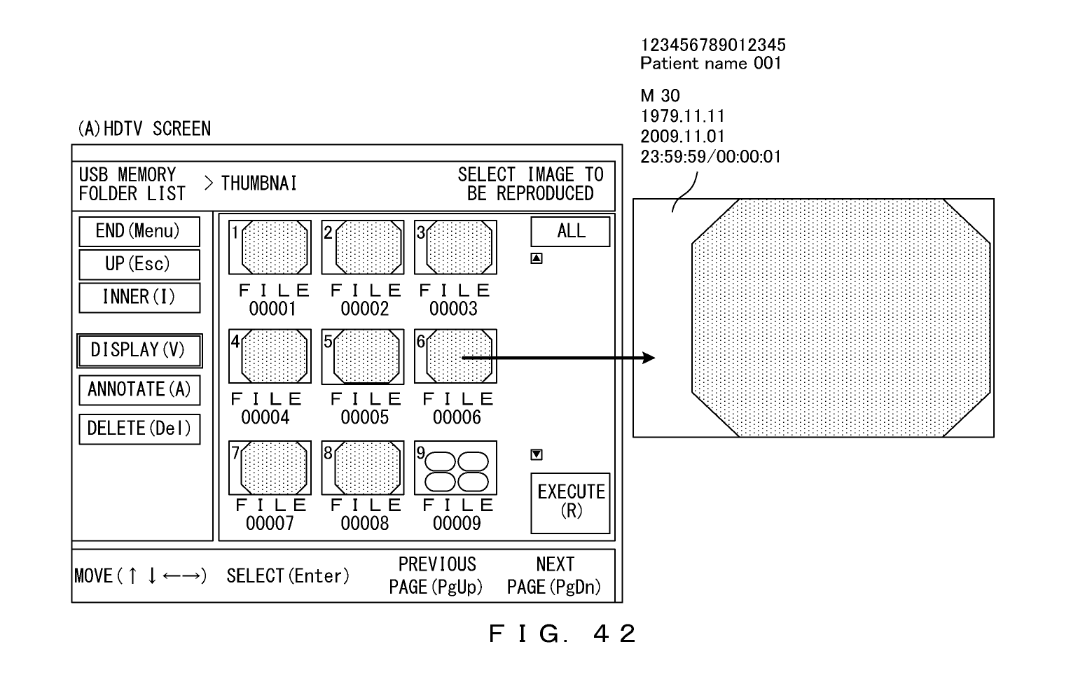

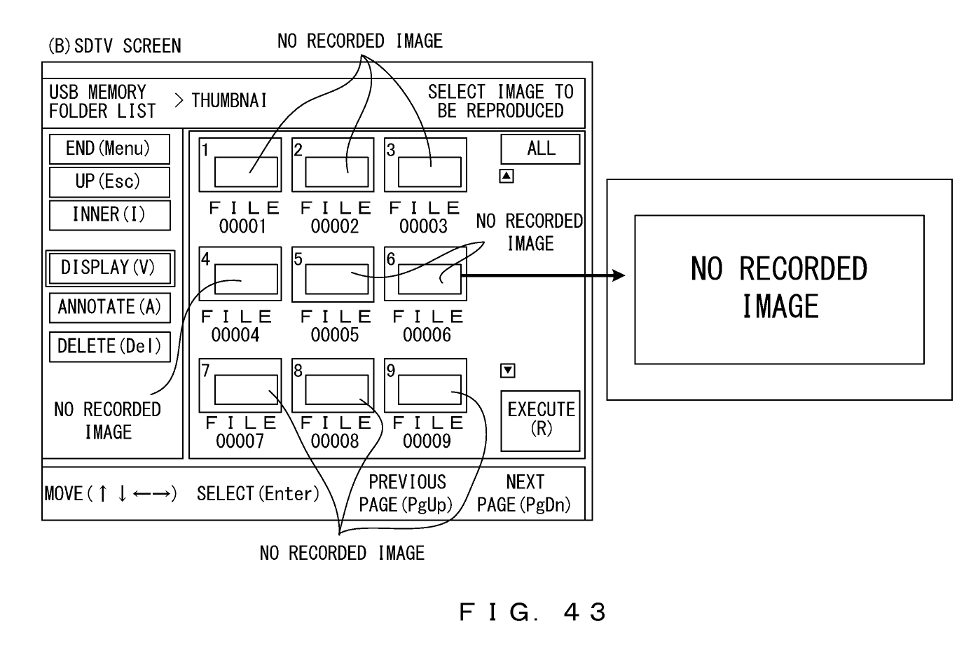

The CPU 131 may perform control for displaying only a multi-image of a type (SDTV or HDTV) set in the item “Decode Type” of the “Decode” space on the setting screen shown in FIG. 30. Specifically, the CPU 131 displays, according to setting (SDTV or HDTV) performed in the item “Decode Type” of the “Decode” space on the setting screen shown in FIG. 30, only one multi-image output from one of the combining circuit 108H and the combining circuit 108S that matches the setting. At the same time, the CPU 131 may perform control to not display another multi-image output from the other that does not match the setting and to display a predetermined image such as a black screen or a blue screen or error indication as shown in FIGS. 42 and 43 instead of the other multi-image. FIGS. 42 and 43 are explained.

FIG. 42 shows a display example of a screen displayed when an HDTV image is stored. FIG. 43 is a diagram showing that error display indicating that there is no recorded image concerning an SDTV image when only the HDTV image is recorded. Multi-images shown in FIGS. 42 and 43 are generated in the processing in step CFLW6 in FIGS. 41A and 41B.

For example, as explained later, it is assumed that the multi-images are recorded in the USB memory 210. When only the HDTV image is recorded, only the HDTV image is recorded in the USB memory 210. At this point, when any one of the multi-images stored in the USB memory 210 is selected, the selected HDTV image can be reproduced as shown in FIG. 42. However, in this case, since an SDTV image is not recorded, the SDTV image cannot be reproduced. Therefore, on a screen for managing contents of SDTV image data, as shown in FIG. 43, error display indicating “no recorded image” is displayed.

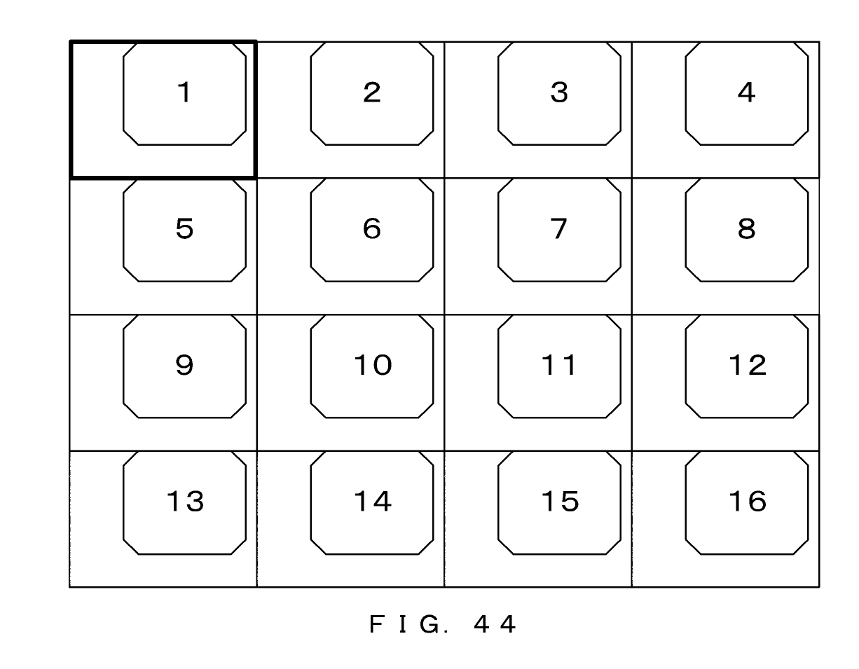

A multi-image is generated and output, for example, in a state shown in FIG. 44 by the processing in step CFLW6 in FIGS. 41A and 41B.

A frame of a thick line in the multi-image shown in FIG. 44 is a selection frame indicating a currently-selected image among images included in the multi-image. The frame can be moved by the input of predetermined key included in the operation device (e.g., arrow key included in the keyboard 5 or the like). After the selection frame is generated in the graphic circuit 106H, the selection frame is combined by the combining circuit 108H. After the selection frame is generated in the graphic circuit 106S, the selection frame is combined by the combining circuit 108S. The selection frames are output. The selection frame may be generated in the graphic circuit 169.

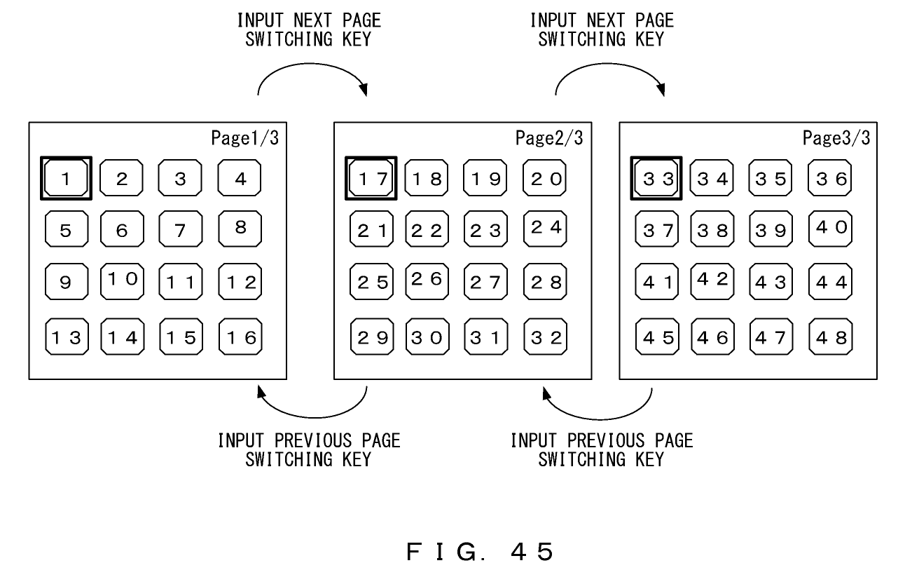

As shown in FIG. 45, the multi-images can be switched and displayed for each page (multi-image one screen) by, for example, the input of a next page switching key included in the operation device (e.g., an PageUP key included in the keyboard 5 or the like) or a previous page switching key (a PageDown key included in the keyboard 5 or the like). When the CPU 131 detects a page switching instruction for the multi-images by the input of the next page switching key or the previous page switching key (step CFLW7 in FIGS. 41A and 41B), the CPU 131 performs processing for displaying the wait screen (step CFLW8 in FIGS. 41A and 41B). At the same time, the CPU 131 generates and outputs a multi-image of a designated page during the display of the wait screen (step CFLW9 in FIGS. 41A and 41B). The CPU 131 is not limited to generating multi-images of designated pages one by one as in the processing shown in step CFLW9 in FIGS. 41A and 41B. For example, when a page of one multi-image already generated is designated, the CPU 131 may directly output the one multi-image. The selection frame indicating a currently-selected image may be displayed in a state in which a top left image in a multi-image is selected during page switching. When the CPU 131 detects that page switching is instructed regardless of the fact that there is only one page, previous page switching is instructed regardless of the fact there is no previous page, or the next page is instructed regardless of the fact that there is no next page, the CPU 131 may perform processing explained below. The CPU 131 may disable the input of keys included in the keyboard 5 or the like and perform a warning such as error sound or error display. In plural multi-images, the CPU 131 may display the number of pages at the upper right corner or the like (of each of the plural multi-images).

When the CPU 131 detects that an instruction for returning to the previous screen is performed by the input of a predetermined key of the operation device (e.g., a Back space key or an ESC key included in the keyboard 5 or the like) (step CFLW10 in FIGS. 41A and 41B), the CPU 131 performs processing explained below. After displaying the wait screen according to the processing in step CFLW2 in FIGS. 41A and 41B, the CPU 131 performs the control for displaying a directory name and an image file name again according to the processing in step CFLW3 in FIGS. 41A and 41B.

When the CPU 131 detects that one image in the multi-image is selected by the selection frame and the selection of the one image is decided by the input of the decision key of the operation device (e.g., the ENTER key included in the keyboard 5 or the like) (step CFLW11 in FIGS. 41A and 41B), the CPU 131 performs processing explained below. The CPU 131 performs processing for displaying the wait screen (step CFLW12 in FIGS. 41A and 41B) and, at the same time, outputs an original image of the one image serving as a thumbnail image during the display of the wait screen (step CFLW13 in FIGS. 41A and 41B).

Details of the processing in step CFLW13 in FIGS. 41A and 41B are explained.

The CPU 131 reads an image file corresponding to the original image of the selected thumbnail image from the device set in the item “Device” of the “Decode” space on the setting screen shown in FIG. 30 (the device referred to in the processing in step CFLW6 in FIGS. 41A and 41B). The CPU 131 causes, via the bus bridge 163 and the arbiter 633, the image memory 654 to store the image file (including the HDTV image file, the SDTV image file, the external image file 1, and the external file 2 of the endoscopic image 301 shown in FIGS. 32 to 39). When all the image files recorded in the device set in the item “Device” of the “Decode” space on the setting screen shown in FIG. 30 are stored in the image memory 654 in advance (by the processing in step CFLW6 in FIGS. 41A and 41B), the CPU 131 may perform processing for extracting the image file corresponding to the original image from the image files stored in the image memory 654.

Thereafter, the CPU 131 controls the arbiter 633 on the basis of information added to the original image file while causing the image compressing and expanding section 73 to output the original image file stored in the image memory 654 such that expansion/conversion processing and RBG conversion processing are appropriately performed according to a format or the like of the original image file. The CPU 131 controls the arbiter 633 such that the original image file output from the image memory 654 is output not via the expanding and reducing circuit 649. According to such processing in the image compressing and expanding section 73, the original image file in a compressed state is output from the arbiter 633 as the original image in an expanded state.

After being input to the FIFO 642 or 643, the original image output from the arbiter 633 is output on the basis of the frequency of a clock signal. Specifically, when the original image is an image of the SDTV system, the FIFO 642 or 643 outputs the original image to the combining circuit 108S at timing synchronizing with a clock signal of 13.5 MHz. When the original image is an image of the HDTV system, the FIFO 642 or 643 outputs the original image to the combining circuit 108H at timing synchronizing with a clock signal of 74 MHz.

The CPU 131 may perform control for displaying only an original image of a type (SDTV or HDTV) set in the item “Decode Type” of the “Decode” space on the setting screen shown in FIG. 30 among original images output from the FIFO 642 or 643. Specifically, the CPU 131 may display, according to setting (SDTV or HDTV) performed in the item “Decode Type” of the “Decode” space on the setting screen shown in FIG. 30, only one original image output from one of the combining circuit 108H and the combining circuit 108S that matches the setting. At the same time, the CPU 131 may perform control to not display another original image output from the other that does not match the setting and to display a predetermined image such as a black screen or a blue screen or error indication shown in FIGS. 42 and 43 instead of the another original image.

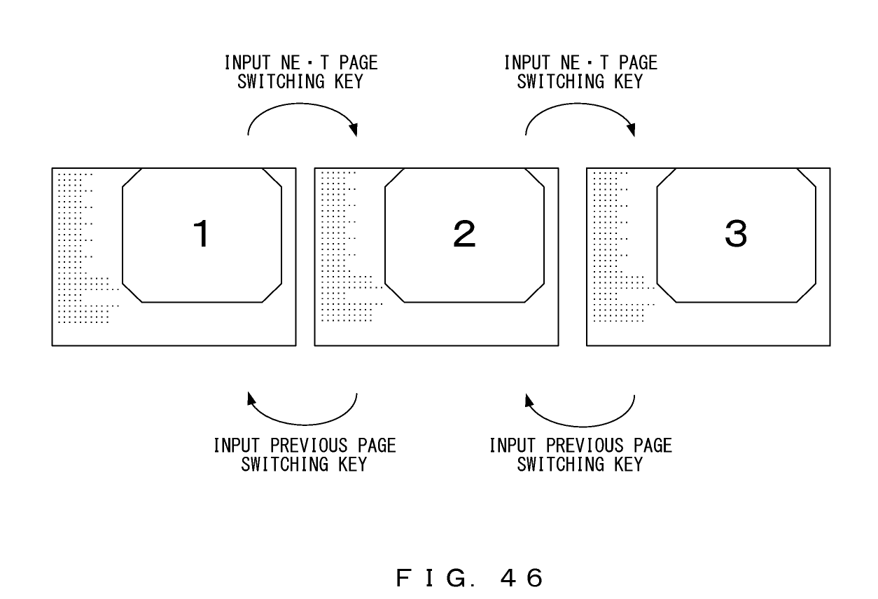

According to the processing in step CFLW13 in FIGS. 41A and 41B, for example, an original image is output in a state shown in FIG. 46. When the original image is displayed, the CPU 131 may perform, by, for example, lighting a predetermined LED provided in the operation device or displaying a message indicating that the original image is displayed, processing for informing that an image recorded in the peripheral device or the like is displayed (rather than an image being observed). Consequently, the user can easily recognize that the image recorded in the peripheral device or the like is displayed (on the display section of the monitor or the like).

As shown in FIG. 46, the original images can be switched and displayed for each page (one screen of an original image) by the input of, for example, the next page switching key included in the operation device (e.g., the PageUp key included in the keyboard 5 or the like) or the previous page switching key (e.g., the PageDown key included in the keyboard 5 or the like).

The CPU 131 detects a page switching instruction for the original image by the input of the next page switching key or the previous page switching key (step CFLW14 in FIGS. 41A and 41B). Then, the CPU 131 performs processing for displaying the wait screen (step CFLW15 in FIGS. 41A and 41B) and, at the same time, generates and outputs an original image of a designated page during the display of the wait page (step CFLW16 in FIGS. 41A and 41B). The CPU 131 is not limited to generating original images of designated pages one by one as in the processing shown in step CFLW9 in FIGS. 41A and 41B. For example, when a page of one original image already generated is designated, the CPU 131 may directly output the one original image. Further, when the CPU 131 detects that page switching is instructed regardless of the fact that there is only one page, previous page switching is instructed regardless of the fact there is no previous page, or the next page is instructed regardless of the fact that there is no next page, the CPU 131 may perform processing explained below. The CPU 131 may disable the input of keys included in the keyboard 5 or the like and perform a warning such as error sound or error display. In plural original images, the CPU 131 may display the number of pages at the upper right corner or the like (of each of the plural original images).

When the CPU 131 detects that an instruction for returning to the previous screen is performed by the input of the predetermined key of the operation device (e.g., the Back space key or the ESC key included in the keyboard 5 or the like) (step CFLW17 in FIGS. 41A and 41B), the CPU 131 performs processing explained below. After displaying the wait screen according to the processing in step CFLW5 in FIGS. 41A and 41B, the CPU 131 performs the control for displaying a multi-image again according to the processing in step CFLW6 in FIGS. 41A and 41B.

The CPU 131 detects that one image file is directly selected and decided by the input of a predetermined key of the operation device (e.g., an arrow key included in the keyboard 5) and the decision key (e.g., the ENTER key included in the keyboard 5) in the processing in step CFLW4 in FIGS. 41A and 41B (step CFLW18 in FIGS. 41A and 41B). Then, the CPU 131 performs processing for displaying the wait screen according to the processing in step CFLW12 in FIGS. 41A and 41B and, at the same time, outputting an original image of the one image file according to the processing in step CFLW13 in FIGS. 41A and 41B).

When the CPU 131 detects that an instruction for returning to the previous screen is performed by the input of the predetermined key of the operation device (e.g., the Back space key or the ESC key included in the keyboard 5 or the like) in a state in which a directory name and a file name are not selected and decided while being kept displayed (step CFLW20 in FIGS. 41A and 41B), the CPU 131 ends the series of processing for displaying a still image recorded in the peripheral device or the like.

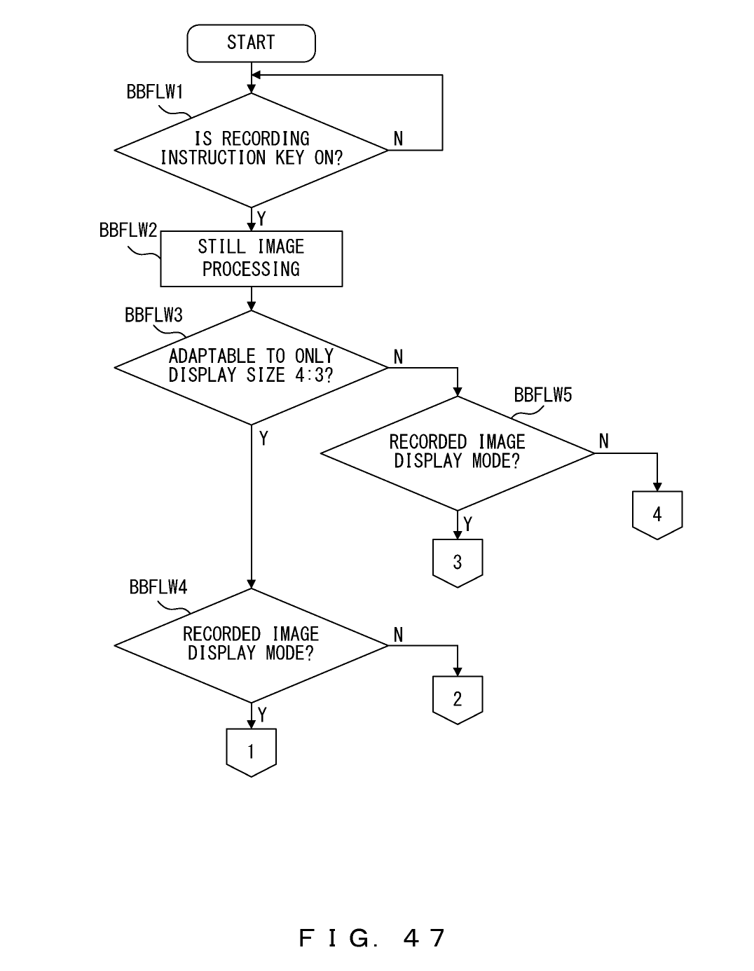

Processing performed when a key or a switch supplemented with a release function or a capture function (these are hereinafter referred to as recording instruction key) among the keys, the switches, and the like included in the operation devices is input is explained. In the following explanation, it is assumed that recording of an endoscopic combined image (e.g., the image shown in FIG. 25) with a display size (“Mon size” on the setting screen shown in FIG. 29) set to 16:9 is performed. Further, in the following explanation referring to FIGS. 47 to 51, processing and operation performed when the key or the switch to which any one of the “Release1” to the “Release4” is allocated is input as the recording instruction key are mainly explained.

First, the CPU 131 of the main control section 75 detects whether the recording instruction key of the operation device is input. When the CPU 131 detects the input of the recording instruction key of the operation device (step BBFLW1 in FIG. 47), the CPU 131 performs processing for bringing an image to a standstill and still image processing, which is processing further applied to the image brought to a standstill by the processing (step BBFLW2 in FIG. 47).

Specifically, as the still image processing in step BBFLW2 in FIG. 47, the CPU 131 causes the freeze circuit 96 to generate a freeze image and perform freeze processing. Thereafter, the CPU 131 controls the post-stage image processing circuit 98 to calculate an average of IHb in a still image. The CPU 131 controls the graphic circuit 106H to temporarily change display contents of the hemoglobin index 322A according to a result of the calculation. The CPU 131 controls the graphic circuit 106H to temporarily fix (freeze) the display of the time information 308. The CPU 131 controls the graphic circuit 106H to temporarily erase the cursor 319. The CPU 131 controls the graphic circuit 169 of the extension control sections 77A and 77B to temporarily fix (freeze) or erase and image or the like. The CPU 131 controls the combining circuits 108H and 108S to perform processing for temporarily erasing the thumbnail image group 326A. According to such control and processing, both of an endoscopic combined image of SDTV output from the combining circuit 108S and an endoscopic combined image of HDTV output from the combining circuit 108H change to a standstill state. When a freeze image is already displayed as the endoscopic image 301 by the switch having the freeze function allocated to the operation device, in the processing in step BBFLW2 in FIG. 47, the processing other than the processing concerning the time information 308, the processing concerning the cursor 319, the control for the graphic circuit 169, and the processing concerning the thumbnail image group 326A is omitted. In the figures and the following explanation, the processing performed in step BBFLW2 in FIG. 47 is referred to as still image processing.

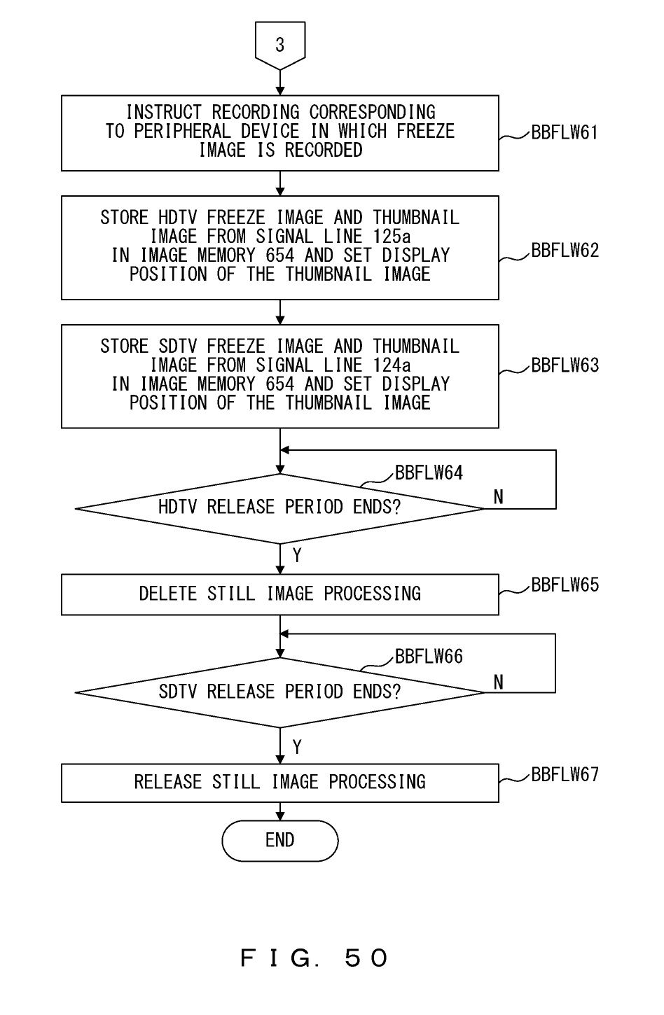

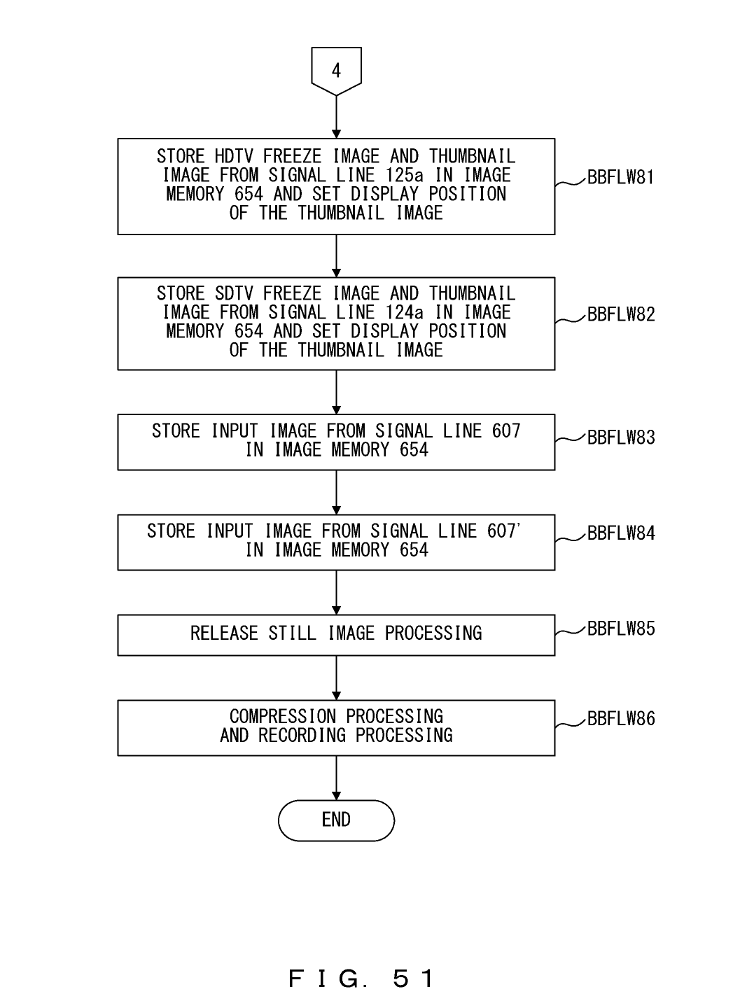

When a peripheral device adaptable to images having both the display sizes 4:3 and 16:9 is set in the item “peripheral device” (step BBFLW3 in FIG. 47), the CPU 131 further performs processing explained below. The CPU 131 detects whether the peripheral device is adapted to a recorded image display mode, which is a mode in which an image substantially coinciding with a still image displayed on the monitor when a recording instruction is performed can be recorded. When a peripheral device adaptable to the images having both the display sizes 4:3 and 16:9 and adapted to the recorded image display mode is set in the item “peripheral device” (step BBFLW5 in FIG. 47), the CPU 131 performs control and processing shown in FIG. 50 explained later. When a peripheral device adaptable to the images having both the display sizes 4:3 and 16:9 and not adapted to the recorded image display mode is set in the item “peripheral device” (step BBFLW5 in FIG. 47), the CPU 131 performs control and processing shown in FIG. 51 explained later. The control and the processing shown in FIG. 50 or 51 performed after step BBFLW5 in FIG. 47 may be performed together rather than being alternatively performed as shown in FIG. 47.

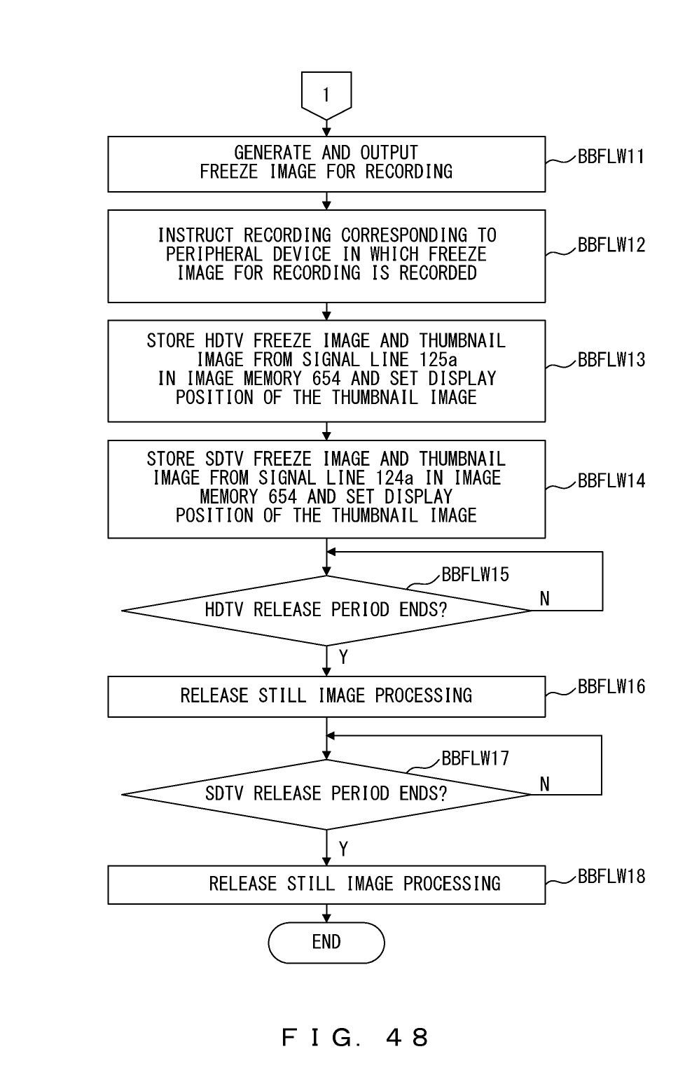

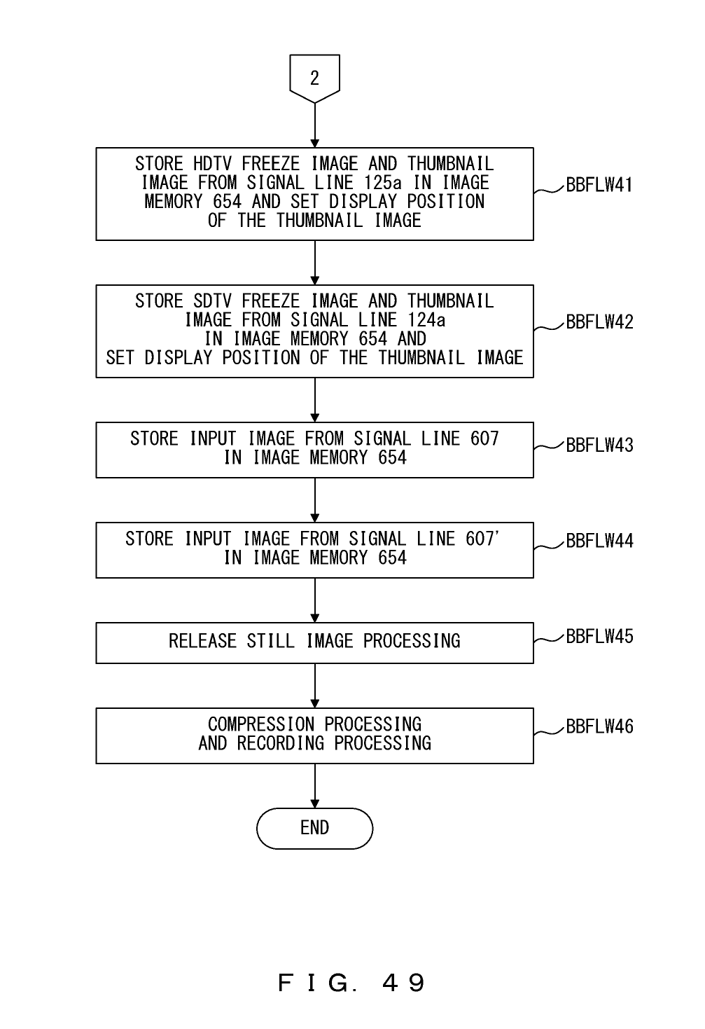

When a peripheral device adaptable to an image having only the display size 4:3 is set in the item “peripheral device” (step BBFLW3 in FIG. 47), the CPU 131 further detects whether the peripheral device is adapted to the recorded image display mode. When a peripheral device adaptable to the image having only the display size 4:3 and adapted to the recorded image display mode is set in the item “peripheral device” (step BBFLW4 in FIG. 47), the CPU 131 performs control and processing shown in FIG. 48 explained later. When a peripheral device adaptable to the image having only the display size 4:3 and not adapted to the recorded image display mode is set in the item “peripheral device” (step BBFLW4 in FIG. 47), the CPU 131 performs control and processing shown in FIG. 49 explained later. The control and the processing shown in FIG. 48 or 49 performed after step BBFLW4 in FIG. 47 may be performed together rather than being alternatively performed as shown in FIG. 47.

Among the peripheral devices shown in FIGS. 15 to 19, the printer 202B1, the VTR 203B1, the filing device 204B1, and the photographing device 205B1 shown in FIG. 16 are devices adaptable to the image having only the display size 4:3 and devices adapted to the recorded image display mode (devices that can record an image substantially coinciding with a still image displayed on the monitor 201B1 or the monitor 201C1). Therefore, when any one of the printer 202B1, the VTR 203B1, the filing device 204B1, and the photographing device 205B1 is selected and set in the “peripheral device”, which is one of the sub-items respectively included in the items “Release1”, “Release2”, “Release3”, and “Release4” of the “HDTV” space on the setting screen shown in FIG. 29, the CPU 131 performs the control and the processing shown in FIG. 48 explained later.

Among the peripheral devices shown in FIGS. 15 to 19, the printer 202B2, the VTR 203B2, the filing device 204B2, the photographing device 205B2, the USB memory 210, and the server 212 shown in FIG. 16 are devices adaptable to the images having both the display sizes 4:3 and 16:9 and adapted to the recorded image display mode (devices that can record an image substantially coinciding with a still image displayed on the monitor 201B2 or the monitor 201C2). Therefore, when any one of the printer 202B2, the VTR 203B2, the filing device 204B2, the photographing device 205B2, the USB memory 210, and the server 212 shown in FIG. 16 is selected and set in the “peripheral device”, which is one of the sub-items respectively included in the items “Release 1”, “Release2”, “Release3”, and “Release4” of the “HDTV” space on the setting screen shown in FIG. 29, the CPU 131 performs the control and the processing shown in FIG. 50 described later.

Among the peripheral devices shown in FIGS. 15 to 19, the printer 202C1, the VTR 203C1, the filing device 204C1, the photographing device 205C1, the endoscope shape detecting device 206C1, and the ultrasonic device 207C1 shown in FIG. 17 are devices adaptable to the image having only the display size 4:3 and devices adapted to the recorded image display mode (devices that can record an image substantially coinciding with a still image displayed on the monitor 201C1 or the monitor 201B1). When any one of the printer 202C1, the VTR 203C1, the filing device 204C1, the photographing device 205C1, the endoscope shape detecting device 206C1, and the ultrasonic device 207C1 shown in FIG. 17 is selected and set in the “peripheral device”, which is one of the sub-items respectively included in the items “Release1”, “Release2”, “Release3”, and “Release4” of the “HDTV” space on the setting screen shown in FIG. 29, the CPU 131 performs control and processing shown in FIG. 48 explained later.

Among the peripheral devices shown in FIGS. 15 to 19, the printer 202C2, the VTR 203C2, the filing device 204C2, the photographing device 205C2, the endoscope shape detecting device 206C2, the ultrasonic device 207C2, the USB memory 210, and the server 212 shown in FIG. 17 are devices adaptable to the images having both the display sizes 4:3 and 16:9 and devices adapted to the recorded image display mode (devices that can record an image substantially coinciding with a still image displayed on the monitor 201C2 or the monitor 201B2). Therefore, when any one of the printer 202C2, the VTR 203C2, the filing device 204C2, the photographing device 205C2, the endoscope shape detecting device 206C2, the ultrasonic device 207C2, the USB memory 210, and the server 212 shown in FIG. 17 is selected and set in the “peripheral device”, which is one of the sub-items respectively included in the items “Release1”, “Release2”, “Release3”, and “Release4” of the “HDTV” space on the setting screen shown in FIG. 29, the CPU 131 performs the control and the processing shown in FIG. 50 explained later.

Among the peripheral devices shown in FIGS. 15 to 19, the printer 202D1, the filing device 204D1, the photographing device 205D1, the optical recording device 208D1, and the HID 209D1 shown in FIG. 18 are devices adaptable to the image having only the display size 4:3 and devices not adapted to the recorded image display mode. Therefore, when any one of the printer 202D1, the filing device 204D1, the photographing device 205D1, the optical recording device 208D1, and the HID 209D1 shown in FIG. 18 is selected and set in the “peripheral device”, which is one of the sub-items respectively included in the items “Release1”, “Release2”, “Release3”, and “Release4” of the “HDTV” space on the setting screen shown in FIG. 29, the CPU 131 performs the control and the processing shown in FIG. 49 explained later.

Among the peripheral devices shown in FIGS. 15 to 19, the printer 202D2, the filing device 204D2, the photographing device 205D2, the optical recording device 208D2, the HID 209D2, the USB memory 210, and the server 212 shown in FIG. 18 are devices adaptable to the images of both the sizes 4:3 and 16:9 and devices not adapted to the recorded image display mode. Therefore, when any one of the printer 202D2, the filing device 204D2, the photographing device 205D2, the optical recording device 208D2, the HID 209D2, the USB memory 210, and the server 212 shown in FIG. 18 is selected and set in the “peripheral device”, which is one of the sub-items respectively included in the items “Release1”, “Release2”, “Release3”, and “Release4” of the “HDTV” space on the setting screen shown in FIG. 29, the CPU 131 performs the control and the processing shown in FIG. 51 explained later. The PC card 167 and the memory card 168 shown in FIG. 10 are also devices adaptable to the images having both the display sizes 4:3 and 16:9 and devices not adapted to the recorded image display mode. Consequently, when the PC card 167 or the memory card 168 is selected and set in the “peripheral device”, which is one of the sub-items respectively included in the items “Release1”, “Release2”, “Release3”, and “Release4” of the “HDTV” space on the setting screen shown in FIG. 29, the CPU 131 performs the control and the processing shown in FIG. 51 explained later.

Among the peripheral devices shown in FIGS. 15 to 19, the printer 202E1, the filing device 204E1, the photographing device 205E1, and the optical recording device 208E1 shown in FIG. 19 are devices applicable to the image having only the display size 4:3 and devices not adapted to the recorded image display mode. Therefore, when any one of the printer 202E1, the filing device 204E1, the photographing device 205E1, and the optical recording device 208E1 shown in FIG. 19 is selected and set in the “peripheral device”, which is one of the sub-items respectively included in the items “Release 1”, “Release2”, “Release3”, and “Release4” of the “HDTV” space on the setting screen shown in FIG. 29, the CPU 131 performs the control and the processing shown in FIG. 49 explained later.

Among the peripheral devices shown in FIGS. 15 to 19, the printer 202E2, the filing device 204E2, the photographing device 205E2, and the optical recording device 208E2, the USB memory 210, and the server 212 shown in FIG. 19 are devices adaptable to the images having both the display sizes 4:3 and 16:9 and devices not adapted to the recorded image display mode. Therefore, when any one of the printer 202E2, the filing device 204E2, the photographing device 205E2, and the optical recording device 208E2, the USB memory 210, and the server 212 shown in FIG. 19 is selected in the “peripheral device”, which is one of the sub-items respectively included in the items “Release1”, “Release2”, “Release3”, and “Release4” of the “HDTV” space on the setting screen shown in FIG. 29, the CPU 131 performs the control and the processing shown in FIG. 51 explained later.

Respective kinds of processing (and processing incidental to the respective kinds of processing) shown in FIG. 48, which are processing performed following the respective kinds of processing shown in FIG. 47, are explained.

The CPU 131 controls the combining circuit 108, the freeze circuit 96, and the synchronizing circuits 101H and 101S to thereby generate a freeze image for recording having the display size 4:3 (hereinafter referred to as freeze image for recording). The CPU 131 controls the graphic circuit 106H to change the positions of characters and graphic information indicating information related to an image corresponding to an image signal (hereinafter referred to as endoscope related information) to positions in the display sizes of 4:3 as shown in FIG. 22. Then, the CPU 131 causes the D/A 110H or the image output section 121 to output the characters and the graphic information, the positions of which are changed (step BBFLW11 in FIG. 48).

The graphic circuit 106H generates and outputs characters and graphic information indicating information related to an image corresponding to an image signal (hereinafter referred to as endoscope related information) subjected to mask processing by the mask processing circuit 611H.

The CPU 131 outputs a recording instruction signal or a recording instruction command to the peripheral device set in the “peripheral device”, which is one of the sub-items respectively included in the items “Release1”, “Release2”, “Release3”, and “Release4” of the “HDTV” space on the setting screen shown in FIG. 29, and causes the peripheral device to record the freeze image (step BBFLW12 in FIG. 48).

The CPU 131 causes the image memory 654 to store an HDTV freeze image and a thumbnail image from the signal line 125a and sets the thumbnail image in display positions of the thumbnail images 326 in the thumbnail image group 326A (BBFLW13 in FIG. 48).

Subsequently, the CPU 131 causes the image memory 654 to store an SDTV freeze image and a thumbnail image from the signal line 124a and sets the thumbnail image in the display positions of the thumbnail images 326 in the thumbnail group 326A (BBFLW14 in FIG. 48).

Further, the CPU 131 detects whether time set in the item “HDTV” of the “Release Time” space on the setting screen shown in FIG. 29 elapses.

When the CPU 131 detects that the time set in the item “HDTV” of the “Release Time” space on the setting screen shown in FIG. 29 elapses (step BBFLW15 in FIG. 28), the CPU 131 continues to perform processing shown in step BBFLW16 in FIG. 48 explained later. When the CPU 131 detects that the time set in the item “HDTV” of the “Release Time” space on the setting screen shown in FIG. 29 does not elapse (step BBFLW15 in FIG. 48), the CPU 131 repeatedly detects whether the time set in the item “HDTV” of the “Release Time” space (an HDTV release period) elapses (step BBFLW15 in FIG. 48).

Thereafter, the CPU 131 releases the still image processing according to processing explained later and controls the combining circuit 108H to generate and output an endoscopic combined image of the HDTV (step BBFLW16 in FIG. 48).

Specifically, the CPU 131 performs control for suspending the freeze processing by the freeze circuit 96 and the synchronizing circuit 101H as explained later to thereby output a moving image as the endoscopic image 301. The CPU 131 performs processing for outputting, for example, the thumbnail images generated in step BBFLW13 and step BBFLW14 in FIG. 48 among the thumbnail images as the thumbnail images 326 anew.

When the CPU 131 detects that an image or the like is output from the graphic circuit 169 of the extension control section 77A and (or) 77B when the recording instruction key is input, the CPU 131 controls the graphic circuit 169 of the extension control section 77A and (or) 77B to perform, together with the processing explained above, processing for resuming a part or all of output of the image or the like. Further, the CPU 131 controls the graphic circuit 106H to add 1 to a value of the D. F 311 (or the SCV 309 or the CVP 310) of the observation information group 300 and display the value. The CPU 131 changes display contents of the hemoglobin index 322A (to, for example, “IHb=- - -”), releases the fixing of the display of the time information 308, and performs, together with the processing explained above, processing for displaying the cursor 319 again. The CPU 131 causes the freeze circuit 96 and the synchronizing circuit 101H to suspend the generation of a freeze image and performs, together with the processing explained above, processing for causing the combining circuit 108H to output a moving image. The CPU 131 controls the synchronizing circuit 101S and the memory 104S to generate a freeze image and performs, together with the processing explained above, processing for causing the combining circuit 108S to output the freeze image. Consequently, the CPU 131 continuously outputs a still image of the SDTV.

The CPU 131 controls the graphic circuit 106H to change the positions of the characters and the graphic information indicating the position related to the image corresponding to the image signal (hereinafter referred to as endoscope related information) to the positions of the original display size of 16:9 as shown in FIG. 21.

When the CPU 131 detects that a period set in the item “SDTV” of the “Release Time” space elapses (step BBFLW17 in FIG. 48), the CPU 131 releases the still image processing according to processing same as the processing in step BBFLW16 in FIG. 48 (step BBFLW18 in FIG. 48). At the same time, the CPU 131 controls the synchronizing circuit 101S and the memory 104S to thereby perform processing for suspending the generation of a freeze image.

According to the series of processing shown in (FIG. 47 and) FIG. 48 explained above, a screen displayed on the monitor or the like transitions.

Respective kinds of processing (and processing incidental to the respective kinds of processing) in FIG. 49, which are processing performed following the respective kinds of processing in FIG. 47, are explained.

The CPU 131 causes the image memory 654 to store an HDTV freeze image and a thumbnail image from the signal line 125a and sets the thumbnail image in the display positions of the thumbnail images 326 in the thumbnail group 326A (BBFLW41 in FIG. 49).

Subsequently, the CPU 131 causes the image memory 654 to store an SDTV freeze image and a thumbnail image based on a signal from the signal line 124a and sets the thumbnail image in the display positions of the thumbnail images 326 in the thumbnail group 326A (BBFLW42 in FIG. 49).

Subsequently, the CPU 131 causes the image memory 654 to store an input image from the signal line 607 (BBFLW43 in FIG. 48).

Subsequently, the CPU 131 causes the image memory 654 to store an input image from the signal line 607′ (BBFLW44 in FIG. 48).

The CPU 131 releases the still image processing according to processing same as the processing in step BBFLW16 and step BBFLW18 in FIG. 48 (step BBFLW45 in FIG. 49). Consequently, the CPU 131 outputs a moving image as the endoscopic image 301.

Thereafter, the CPU 131 (and the CPU 151) performs processing for compressing and recording the freeze image for recording, the external images of the signal lines 607 and 607′ input from the peripheral devices via the A/D or DECs 612 and 612′, and the thumbnail image, which are stored in the image memory 654 (step BBFLW46 in FIG. 49). Details of the processing in step BBFLW46 in FIG. 49 are explained later as explanation concerning processing in step BBFLW86 in FIG. 51. At this point, arrangement information (coordinate information of components displayed on a screen) in the case of the display size (the output size) 4:3 may be recorded.

According to the series of processing shown in (FIG. 47 and) FIG. 49 explained above, a screen displayed on the monitor or the like transitions.

Respective kinds of processing (and processing incidental to the respective kinds of processing) in FIG. 50, which are processing performed following the respective kinds of processing in FIG. 47, are explained.

The CPU 131 outputs, via the signal line 142a or 143a, a recording instruction signal or a recording instruction command to the peripheral device set in the “peripheral device”, which is one of the sub-items respectively included in the items “Release1”, “Release2”, “Release3”, and “Release4” of the “HDTV” space on the setting screen shown in FIG. 29, and causes the peripheral device to record the freeze image (step BBFLW61 in FIG. 50).

The CPU 131 causes the image memory 654 to store an HDTV freeze image and a thumbnail image from the signal line 125a and sets the thumbnail image in display positions of the thumbnail images 326 in the thumbnail image group 326A (BBFLW62 in FIG. 50).

Subsequently, the CPU 131 causes the image memory 654 to store an SDTV freeze image and a thumbnail image from the signal line 124a and sets the thumbnail image in the display positions of the thumbnail images 326 in the thumbnail group 326A (BBFLW63 in FIG. 50).

When the CPU 131 detects that the time set in the item “HDTV” of the “Release Time” space on the setting screen shown in FIG. 29 elapses (step BBFLW64 in FIG. 50), the CPU 131 continues to perform processing shown in step BBFLW65 in FIG. 50 explained later. When the CPU 131 detects that the time set in the item “HDTV” of the “Release Time” space on the setting screen shown in FIG. 29 does not elapse (step BBFLW64 in FIG. 50), the CPU 131 repeatedly detects whether the time set in the item “HDTV” of the “Release Time” space on the setting screen shown in FIG. 29 (an HDTV release period) elapses (step BBFLW64 in FIG. 50).

Thereafter, the CPU 131 releases the still image processing by perform processing same as the processing in steps BBFLW16, step BBFLW17, and the step BBFLW18 in FIG. 48 (step BBFLW65, step BBFLW66, and step BBFLW67 in FIG. 50).

According to the series of processing shown in (FIG. 47 and) FIG. 50 explained above, a screen displayed on the monitor or the like transitions.

Respective kinds of processing (and processing incidental to the respective kinds of processing) in FIG. 51, which are processing performed following the respective kinds of processing in FIG. 47, are explained.

The CPU 131 causes the image memory 654 to store an HDTV freeze image and a thumbnail image based on a signal from the signal line 125a. At the same time, the CPU 131 sets the thumbnail image in the display positions of the thumbnail images 326 in the thumbnail group 326A (BBFLW81 in FIG. 51).

Subsequently, the CPU 131 causes the image memory 654 to store an SDTV freeze image and a thumbnail image from the signal line 124a. At the same time, the CPU 131 sets the thumbnail image in the display positions of the thumbnail images 326 in the thumbnail group 326A (BBFLW82 in FIG. 51).

Subsequently, the CPU 131 causes the image memory 654 to store an input image from the signal line 607 (BBFLW83 in FIG. 51).

Subsequently, the CPU 131 causes the image memory 654 to store an input image from the signal line 607′ (BBFLW84 in FIG. 51).

Thereafter, the CPU 131 releases the still image processing according to processing same as the processing in step BBFLW45 in FIG. 49 (step BBFLW85 in FIG. 51). Consequently, the CPU 131 outputs a moving image as the endoscopic image 301.

The CPU 131 (and the CPU 151) performs, according to processing substantially the same as the processing in step BBFLW46 in FIG. 49, processing for compressing and recording the endoscopic combined image having the display size 16:9 and the thumbnail images stored in the image memory 654 (step BBFLW86 in FIG. 51).

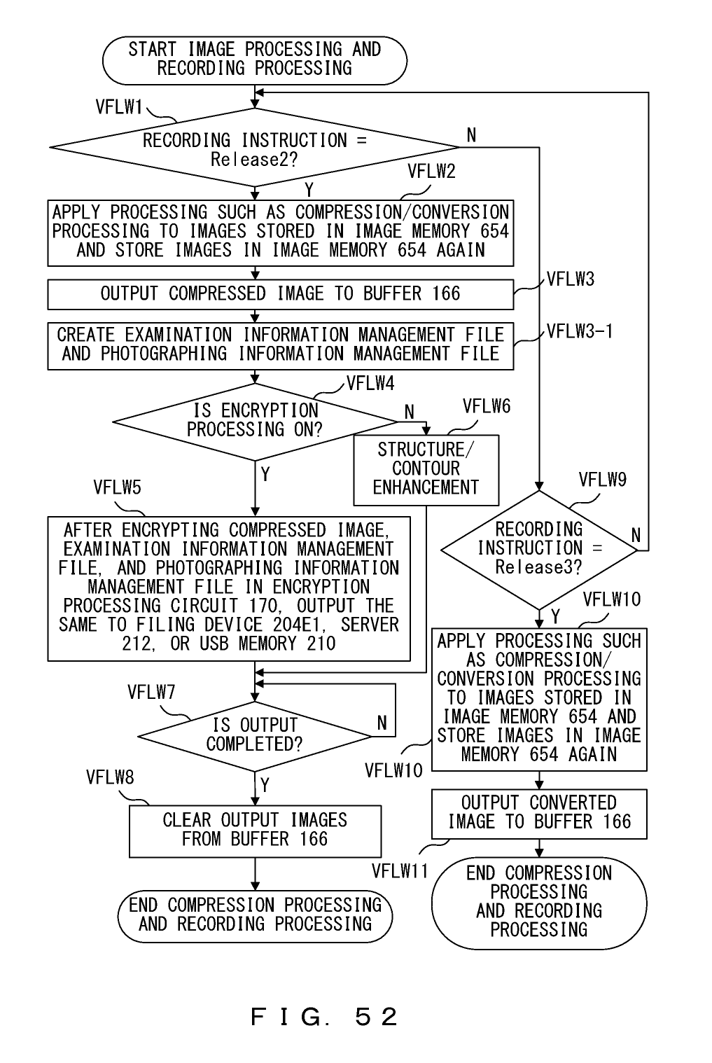

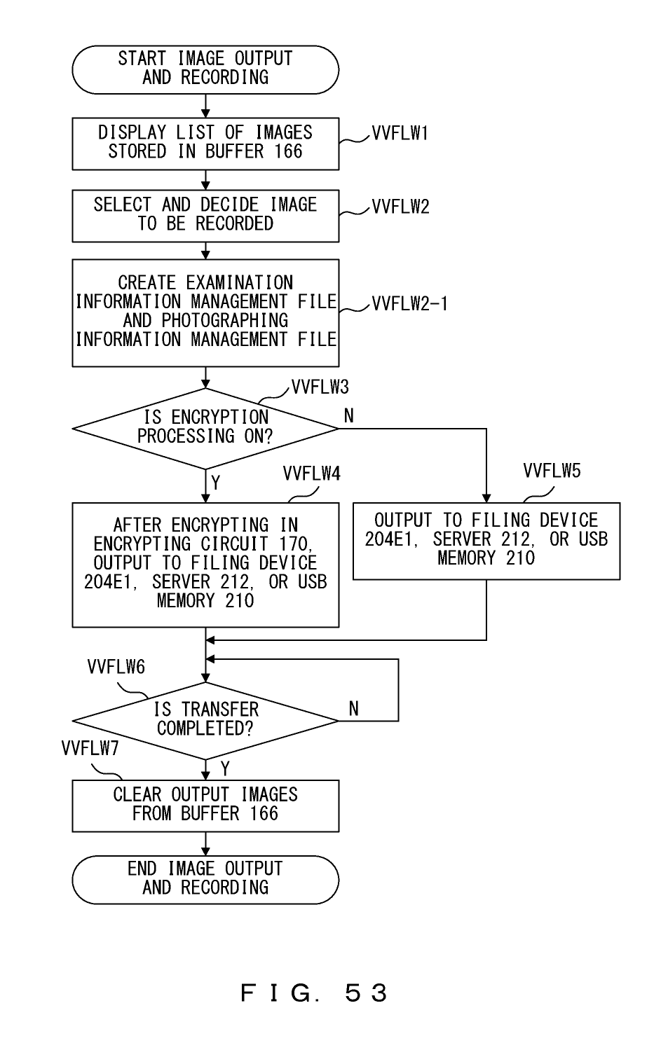

Details of the processing in step BBFLW86 in FIG. 51 are explained with reference to flowcharts of FIGS. 52 and 53. The flowcharts of FIGS. 52 and 53 are explained on condition that, on the setting screen shown in FIG. 29, the items “Release2” and “Release3” of the “SDTV” space and the “HDTV” space are set as recording instruction keys of the operation device, the item “thumbnail” is set to “ON”, the sub-item “peripheral device” of the items “Release2” and “Release3” is set to a peripheral device at an output destination (the filing device 204E1, the server 212, the USB memory 210, etc.), the sub-item “Encode” of the item “Release2” is set to (a format of a relatively high compression ratio such as) JPEG and the sub-item “Encode” of the item “Release3” is set to (an uncompressed format or a format of a relatively low compression ratio such as) TIFF.

First, the CPU 131 detects whether the operation of the recording instruction key performed in step BBFLW1 in FIG. 47 is operation by a key or a switch to which the release function of the “Release2” is allocated or operation by a key or a switch to which the release function of the “Release3” is allocated.

When the CPU 131 detects that the operation of the recording instruction key performed in step BBFLW1 in FIG. 47 is the operation by the key or the switch to which the release function of the “Release2” is allocated (step VFLW1 in FIG. 52), the CPU 131 applies processing such as compression/conversion processing to the images stored in the image memory 654 and causes the image memory 654 to store the images again (step VFLW2 in FIG. 52). Thereafter, the CPU 131 outputs the freeze image for recording stored in the image memory 654 again, causes the expanding and reducing circuit 649 to generate thumbnail images of the respective images, and, after causing the JPEG encode/decode circuit 647 to apply compression/conversion processing of a JPEG format to the images, causes the image memory 654 to store the images after the compression/conversion processing (step VFLW2 in FIG. 52). It is assumed that, in the processing in step VFLW2 in FIG. 52, the CPU 131 causes the YUV-RGB conversion processing circuit 651 to perform the processing as appropriate according to contents set on the setting surface shown in FIG. 29.

The CPU 131 (or the CPU 151) outputs the freeze image for recording of the JPEG format stored in the image memory 654 to the buffer 166 of the extension control section 77A (step VFLW3 in FIG. 52). In the processing in step VFLW3 in FIG. 52, the CPU 131 (or the CPU 151) outputs the thumbnail images to the buffer 166 together with the freeze image for recording of the JPEG format. The buffer 166 is, for example, a nonvolatile memory on the inside of the processor 4. In the processing in step VFLW3 in FIG. 52, a not-shown USB (registered trademark) memory connected to the controller 164 may be used instead of the buffer 166.

As explained in FIGS. 33 to 35 and FIGS. 36 and 37, the CPU 151 creates an examination information management file and a photographing information management file concerning an endoscopic combined image including, as component images, the images stored in the image memory 654 (VFLW3-1).

Thereafter, the CPU 151 of the extension control section 77A detects to which of ON and OFF the item “encryption” on the setting screen shown in FIG. 29 is set. The CPU 151 detects that the item “encryption” on the setting screen shown in FIG. 29 is ON (step VFLW4 in FIG. 52). Then, the CPU 131 causes the encryption processing circuit 170 to apply encryption to the freeze image for recording of the JPEG format, the thumbnail images, the examination information management file, and the photographing information management file. Thereafter, the CPU 131 outputs the freeze image for recording of the JPEG format, the thumbnail images, the examination information management file, and the photographing information management file after the encryption to the peripheral device at the output destination (the filing device 204E1, the server 212, the USB memory 210, etc.) (step VFLW5 in FIG. 52). Concerning the USB memory 210, when the USB memory 210 is connected to the processor 4, these kinds of information may be automatically recorded in the USB memory 210 irrespective of the setting menus shown in FIGS. 29 and 30.

The CPU 151 detects that the item “encryption” on the setting screen shown in FIG. 29 is OFF (step VFLW4 in FIG. 52). Then, the CPU 131 outputs the freeze image for recording of the JPEG format, the thumbnail images, the examination information management file, and the photographing information management file to the peripheral device at the output destination (the filing device 204E1, the server 212, the USB memory 210, etc.) (step VFLW6 in FIG. 52). When the USB memory 210 is connected to the processor 4, these kinds of information may be automatically recorded in the USB memory 210.

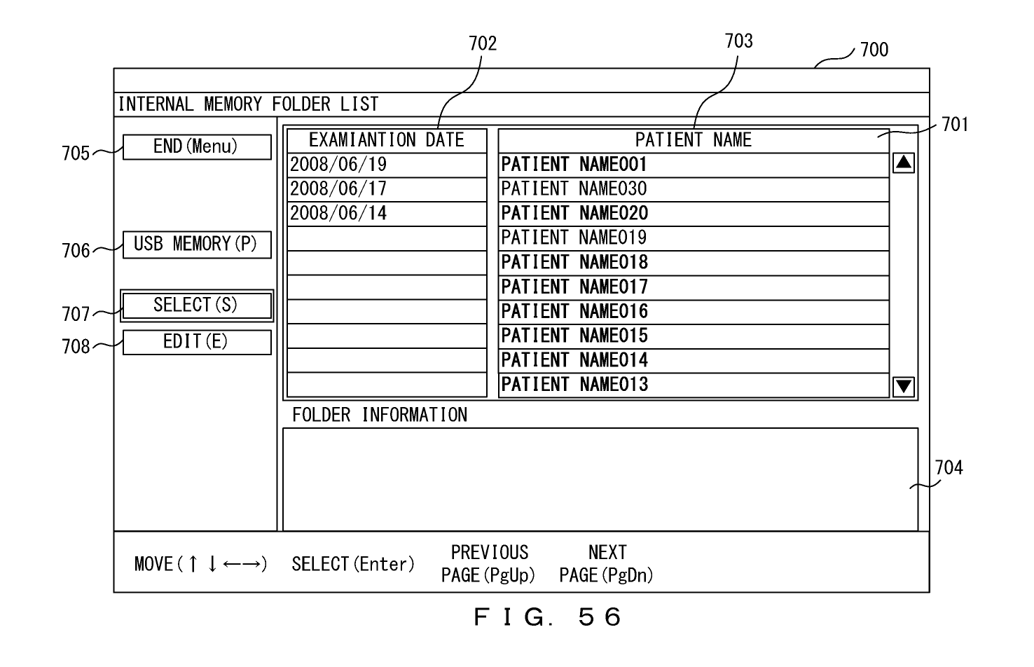

When the CPU 151 detects that the output of the images to the peripheral device at the output destination (the filing device 204E1, the server 212, the USB memory 210, etc.) is completed (step VFLW7 in FIG. 52), the CPU 151 ends the processing after clearing the images, the output of which is completed, from the buffer 166 (step VFLW8 in FIG. 52). The images, the output of which is completed, may be changed to a state in which the images are already transferred from the buffer. This is explained with reference to FIG. 56.

FIG. 56 shows a screen example for managing contents of image data stored in the buffer 166. A screen 700 shown in FIG. 56 is a screen displayed when the contents of the image data stored in the buffer 166 are referred to.

An image folder list 701 of the screen 700 includes an examination date selection space 702 and a patient name selection space 703. In the examination date selection space 702, an examination date of image folders stored in the buffer 166 can be selected. In the patient name selection space 703, an image folder of a specific patient among the image folders in the examination date selected in the examination date selection space 702 can be selected. Folder information can be input to an input space 704. If an “End (Menu)” button 705 is pressed, the screen 700 is closed. If a “USB memory (P)” button 706 is pressed, the screen transitions to a screen for managing contents of image data stored in the USB memory 210. If a “Select (S)” button 707 is pressed, an image folder of a specific patient can be selected from the examination date list 702 and the patient name selection space 703. If an “Edit (E)” button 708 is pressed, editing of an image folder can be performed.

In the patient name selection space 703, “Patient Name 030” and “Patient Name 019” are displayed in a font thinner than a font of the other patient names in FIG. 56. The display indicates that image folders (or image data) corresponding to the “Patient Name 030” and the “Patient Name 019” are already transferred from the buffer 166 to the peripheral device at the output destination (the filing device 204E1, the server 212, the USB memory 210, etc.). In this case, the image folder (or the image data) may be not transferred again and may be sequentially erased in a ring buffer. When a free space of the buffer 166 decreases to be equal to or smaller than a predetermined amount, the processing in VFLW3 may be omitted without performing the storage in the buffer 166.

When the CPU 131 detects that the operation of the recording instruction key performed in step BBFLW1 in FIG. 47 is operation by the key or the switch to which the release function of the “Release3” is allocated (steps VFLW1 and VFLW9 in FIG. 52), the CPU 131 applies processing such as compression/conversion processing to the images stored in the image memory 654 and causes the image memory 654 to store the images again (VFLW10 in FIG. 52). Thereafter, the CPU 131 outputs the freeze image for recording stored in the image memory 654 again. The CPU 131 causes the expanding and reducing circuit 649 to generate thumbnail images of the respective images. The CPU 131 causes the TIFF/BMP conversion circuit 647 to apply compression/conversion processing of the TIFF format. Thereafter, the CPU 131 causes the image memory 654 to store the images after the compression/conversion processing (step VFLW10 in FIG. 52). It is assumed that, in the processing in step VFLW9 in FIG. 52, the CPU 131 causes the YUV-RGB conversion processing circuit 651 to perform processing as appropriate according to contents set on the setting screen shown in FIG. 29.

After outputting the freeze image for recoding of the TIFF format stored in the image memory 654 to the buffer 166 of the extension control section 77A (step VFLW11 in FIG. 52), the CPU 131 ends the processing.

In step VFLW3 in FIG. 52 and step VFLW11 in FIG. 52, the CPU 131 may perform, in outputting the images to the buffer 166, processing for adding at least one of the kinds of information listed in the items a) to z) to the images to thereby output the information together with the images. Details of processing performed when the images stored in the buffer 166 are output to the peripheral device at the output destination (the filing device 204E1, the server 212, the USB memory 210, etc.) after the processing in step VFLW11 in FIG. 52 are explained later.

Details of processing performed when the images stored in the buffer 166 in the processing in step VFLW11 in FIG. 52 are output to the peripheral device at the output destination (the filing device 204E1, the server 212, the USB memory 210, etc.), for example, when the key having the examination end notification function is input is explained with reference to a flowchart of FIG. 53.

When the CPU 151 of the extension control section 77A detects the input of the key having the examination end notification function, the CPU 151 reads the images stored in the buffer 166. Thereafter, the CPU 151 performs processing for causing the expanding and reducing circuit 649 of the image compressing and expanding section 73 to generate and output a multi-image for displaying the images as a list (step VVFLW1 in FIG. 53).

A specific example of the processing in step VVFLW1 in FIG. 53 is as explained below.

The CPU 151 of the extension control section 77A reads the images stored in the buffer 166 and causes the image memory 654 to store the images via the bus bridge 163 and the arbiter 633 of the image compressing and expanding section 73.

The CPU 151 controls the arbiter 633 on the basis of, for example, information added to the images stored in the image memory 654. Consequently, the CPU 151 causes the expanding and reducing circuit 649 and the YUV-RGB conversion circuit 651 to respectively apply the expansion and reduction processing and the RGB conversion processing to the images as appropriate according to a format or the like of the images.

The CPU 151 controls the arbiter 633 such that the images output from the arbiter 633 are output via the expanding and reducing circuit 649.

The expanding and reducing circuit 649 sets the number of thumbnail images displayed as a list in one screen according to, for example, the size of the images output from the arbiter 633. At the same time, the expanding and reducing circuit 649 generates and outputs a multi-image corresponding to the number of the thumbnail images (e.g., sixteen thumbnail images are displayed as a list in one screen).

The multi-image generated by the expanding and reducing circuit 649 is output (to the display section of the monitor or the like) via the FIFO 642 or 643 and the combining circuit 108H or 108S.

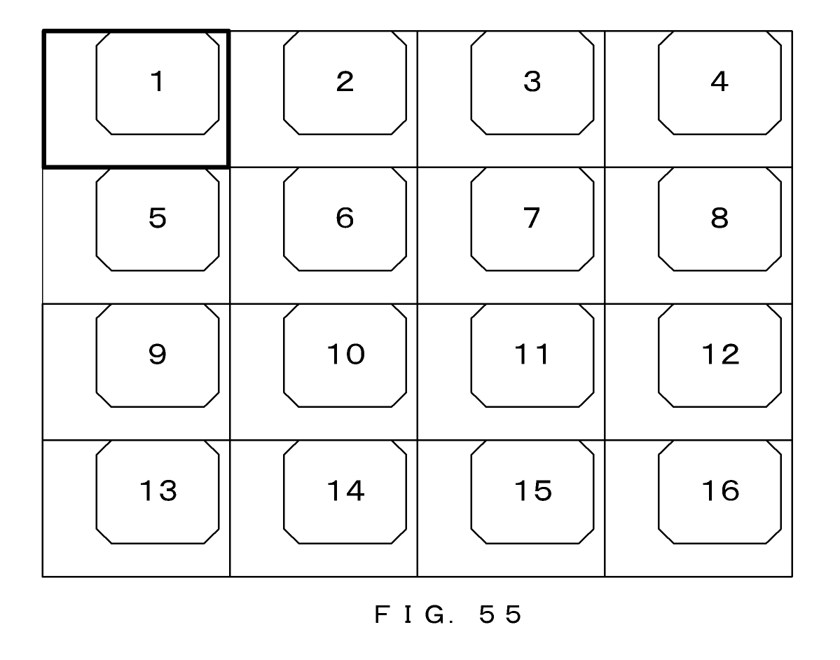

According to the processing in step VVFLW1 in FIG. 53 explained above, for example, a multi-image shown in FIG. 55 is generated and output.

In the multi-image shown in FIG. 55, the observation information group 300 and the image related information group 301A may be displayed.

A frame of a thick line in the multi-image shown in FIG. 55 is a selection frame indicating a currently selected image among the images included in the multi-image. For example, the selection frame can be moved by the input of the predetermined key of the operation device (e.g., the arrow key included in the keyboard 5 or the like). After the selection frame is generated in the graphic circuit 106H, the selection frame is combined by the combining circuit 108H. After the selection frame is generated in the graphic circuit 106S, the selection frame is combined by the combining circuit 108S. The selection frames are output. The selection frame may be generated in the graphic circuit 169.

The CPU 151 detects that one or plural thumbnail images are selected in the multi-image shown in FIG. 55 and decided by the input of the decision key (e.g., the ENTER key included in the keyboard 5 or the like) (step VVFLW2 in FIG. 53).

As explained with reference to FIGS. 33 to 35 and FIGS. 36 and 37, the CPU 151 creates an examination information management file and a photographing information management file concerning an endoscopic combined image including, as component images, the images stored in the image memory 654 (VVFLW2-1). Further, the CPU 151 detects to which of “ON” and “OFF” the item “encryption” on the setting screen shown in FIG. 29 is set.

When the CPU 151 detects that the item “encryption” on the setting screen shown in FIG. 29 is ON (step VVFLW3 in FIG. 53), the CPU 151 causes the encryption processing circuit 170 to apply encryption to the freeze image for recording of the TIFF format, the thumbnail images, the examination information management file, and the photographing information management file. Thereafter, the CPU 151 outputs the freeze image for recording of the TIFF format, the thumbnail images, the examination information management file, and the photographing information management file after the encryption to the peripheral device at the output destination (the filing device 204E1, the server 212, the USB memory 210, etc.) (step VVFLW4 in FIG. 53). When the USB memory 210 is connected to the processor 4, these kinds of information may be automatically recorded in the USB memory 210.

When the CPU 151 detects that the item “encryption” on the setting screen shown in FIG. 29 is OFF (step VVFLW3 in FIG. 53), the CPU 151 outputs the freeze image for recording of the WEG format, the thumbnail images, the examination information management file, and the photographing information management file to the peripheral device at the output destination (the filing device 204E1, the server 212, the USB memory 210, etc.) (step VVFLW5 in FIG. 53). When the USB memory 210 is connected to the processor 4, these kinds of information may be automatically recorded in the USB memory 210.

When the CPU 151 detects that the output of the image to the peripheral device at the output destination (the filing device 204E1, the server 212, the USB memory 210, etc.) is completed (step VVFLW6 in FIG. 53), the CPU 151 ends the processing after clearing the images, the output of which is completed, from the buffer 166 (step VVFLW7 in FIG. 53). As explained with reference to FIG. 56, the images, the output of which is completed, may be changed to a state in which the images are already transferred from the buffer. In this case, the image data may be sequentially erased in a ring buffer without transferring the image data again.

The CPU 151 may output all the images recorded in the buffer 166 to the peripheral device at the output destination (the filing device 204E1, the server 212, the USB memory 210, etc.), for example, without performing the processing in step VVFLW1 and step VVFLW2 in FIG. 53.

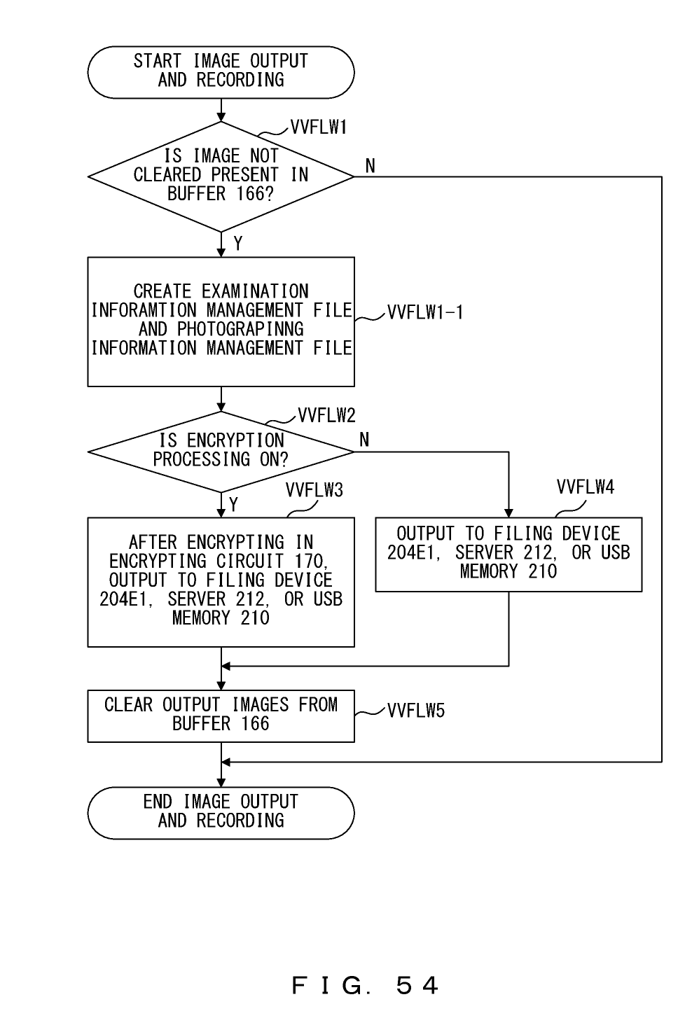

Details of processing performed when the images stored in the buffer 166 in the processing in step VFLW11 in FIG. 52 are output to the filing device 204B1, for example, when the power supply for the processor 4 is switched from OFF to ON are explained with reference to a flowchart of FIG. 54.

The CPU 151 detects whether an un-cleared image is stored in the buffer 166 when the power supply for the processor 4 is switched from OFF to ON. When the CPU 151 detects that an un-cleared image is not stored in the buffer 166 when the power supply for the processor 4 is switched from OFF to ON (step VVVFLW1 in FIG. 54), the CPU 151 ends the processing.

The CPU 151 detects that an un-cleared image is stored in the buffer 166 when the power supply for the processor 4 is switched from OFF to ON (step VVVFLW1 in FIG. 54).

Then, as explained with reference to FIGS. 33 to 35 and FIGS. 36 and 37, the CPU 151 creates an examination information management file and a photographing information management file concerning an endoscopic combined image including, as component images, the images stored in the image memory 654 (VVVFLW1-1). Further, the CPU 151 detects to which of ON and OFF the item “encryption” on the setting screen shown in FIG. 29 is set.

When the CPU 151 detects that the item “encryption” on the setting screen shown in FIG. 29 is ON (step VVVFLW2 in FIG. 54), the CPU 151 causes the encryption processing circuit 170 to apply encryption to the freeze image for recording of the TIFF format, the thumbnail images, the examination information management file, and the photographing information management file. Thereafter, the CPU 151 outputs the freeze image for recording of the TIFF format, the thumbnail images, the examination information management file, and the photographing information management file after the encryption to the peripheral device at the output destination (the filing device 204E1, the server 212, the USB memory 210, etc.) (VVVFLW3 in FIG. 54). When the USB memory 210 is connected to the processor 4, these kinds of information may be automatically recorded in the USB memory 210.

When the CPU 151 detects that the item “encryption” on the setting screen shown in FIG. 29 is OFF (VVVFLW2 in FIG. 54), the CPU 151 outputs the freeze image for recording of the JPEG format, the thumbnail images, the examination information management file, and the photographing information management file to the peripheral device at the output destination (the filing device 204E1, the server 212, the USB memory 210, etc.) (VVVFLW4 in FIG. 54). When the USB memory 210 is connected to the processor 4, these kinds of information may be automatically recorded in the USB memory 210.

Thereafter, the CPU 151 clears the images, the output of which is completed, from the buffer 166 (step VVVFLW5 in FIG. 54) and ends the processing.

After the processing in step VVVFLW1 in FIG. 54, the CPU 151 may perform processing for generating a multi-image for showing a list of images not cleared from the buffer 166, for example, according to processing same as the processing in step VVFLW1 in FIG. 53.

As the processing in step VVVFLW1 in FIG. 54, the processing in VVVFLW1-1, VVVFLW2, VVVFLW3, and VVVFLW4 may be applied to the images, the output of which is uncompleted, explained with reference to FIG. 56. The processing in step VVVFLW5 may be processing for changing the images, the output of which is completed, to a state in which the images are already transferred from the buffer as explained with reference to FIG. 56. In this case, the image folder may be not transferred again and may be sequentially erased in a ring buffer.

According to the series of processing shown in (FIG. 47 and) FIG. 51 explained above, a screen displayed on the monitor or the like transitions.

When plural devices including devices adapted to the recorded image display mode and devices not adapted to the recorded image display mode are set in the “peripheral device”, which is one of the sub-items of items “Release1” to “Release4” on the setting screen shown in FIG. 29, the CPU 131 may further perform compression processing and recording processing same as the processing shown in FIG. 52 after performing, for example, the processing in step BBFLW18 in FIG. 48 or step BBFLW67 in FIG. 50.

Next, reproduction of the endoscopic image 301 and the external images 330 and 331 (the image 330 of the endoscope shape detecting device and the image 331 of the ultrasonic device) different from those shown in FIGS. 42 and 43, FIGS. 44 to 46, and FIGS. 52 to 55 is explained. When the “USB memory (P)” button 706 is pressed on the screen 700 shown in FIG. 56, as shown in FIG. 57A, a screen 710 for managing contents of image data stored in the USB memory 210 is displayed. When an “Inner (I)” button 711 on the screen 710 shown in FIG. 57A is pressed, the screen 710 returns to the screen 700 shown in FIG. 56. An image folder list 711 (an examination date selection space 712 and a patient name selection space 713), an input space 714, an “End (Menu)” button 715, a “USB memory (P)” button 716, a “Select (S)” button 717, and an “Edit (E)” button 718, which are components of the screen 710 shown in FIG. 57A, are respectively the same as the image folder list 701 (the examination date selection space 702 and the patient name selection space 703), the input space 704, the “End (Menu)” button 705, the “USB memory (P)” button 706, the “Select (S)” button 707, and the “Edit (E)” button 708, which are components of the screen 700 shown in FIG. 56, except a difference between the “USB memory (P)” button 706 and the “Inner (I)” button 711. Therefore, explanation thereof is omitted.

In FIG. 57A, the user selects a target examination date from the examination date selection space 712, selects a target patient name folder from the patient name selection space 713, and presses the “Select (S)” button 717. Then, a thumbnail image group corresponding to an image group included in the selected image folder is displayed as a multi-image 720.

When the user selects any one of the thumbnail images from the multi-image 720 and presses a “Display (v)” button 721, an image corresponding to the selected thumbnail image is reproduced.

On the other hand, when the user selects n (n≧1) thumbnail images from the thumbnail image list 720 and presses an “Annotate (A)” button 722, the screen is divided into n and n images corresponding to the selected thumbnail images are reproduced. In the case of (1) in FIG. 57B, the user selects one thumbnail image from the multi-image 720 and presses the “Annotate (A)” button 722. In the case of (2) of FIG. 57B, the user selects two thumbnail images from the multi-image 720 and presses the “Annotate (A)” button 722. In the case of (3), the user selects four thumbnail images from the thumbnail image list 720 and presses the “Annotate (A)” button 722.

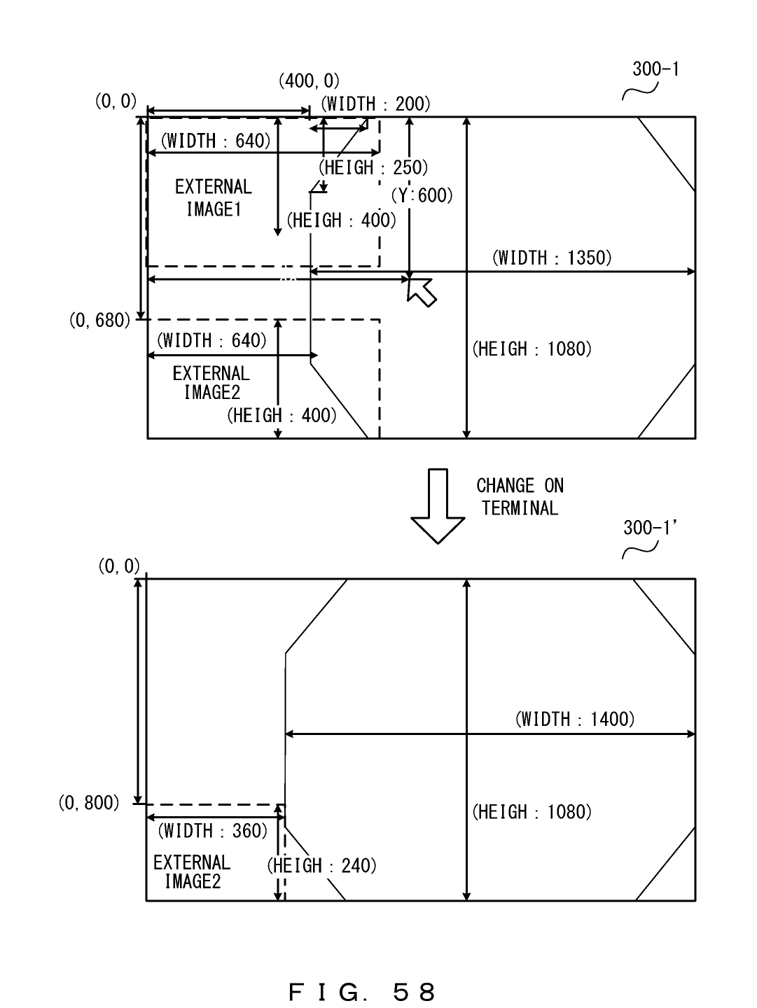

The image data of the folder having the directory structure shown in FIG. 32 can be output to the signal line 162 via the controller 161 and the HUB 162, sent to the server 212 via the HIB 211, and stored in a large-capacity storage device in the server 212 by the processor 4. The folder data stored in the large-capacity storage device in the server 212 can be accessed via the HUB 211 using the processor 4 or the PC terminal 213. The endoscopic combined image 300-1 can be displayed on a display device of the processor 4 or the PC terminal 213. A display form of the endoscopic combined image 300-1 displayed on the display device of the processor 4 or the PC terminal 213 can be changed, for example, the size of component images can be changed as shown in FIG. 58. A layout change of an endoscopic combined image on the PC terminal 213 is explained below. However, a layout change for an endoscopic combined image on the processor 4 may be performed.

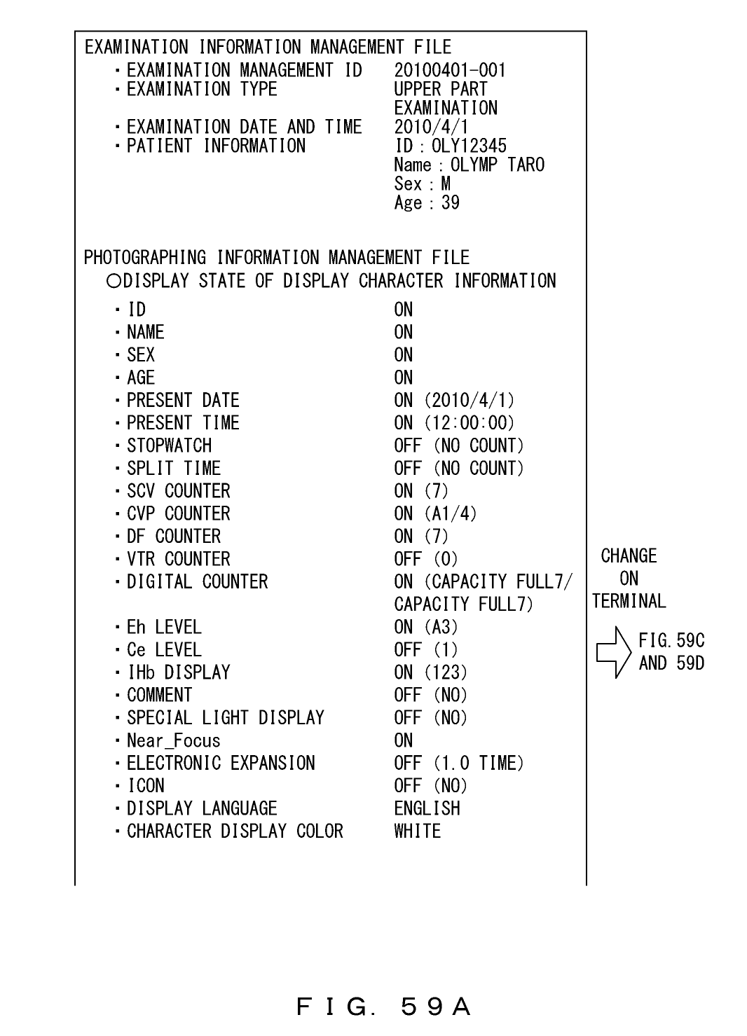

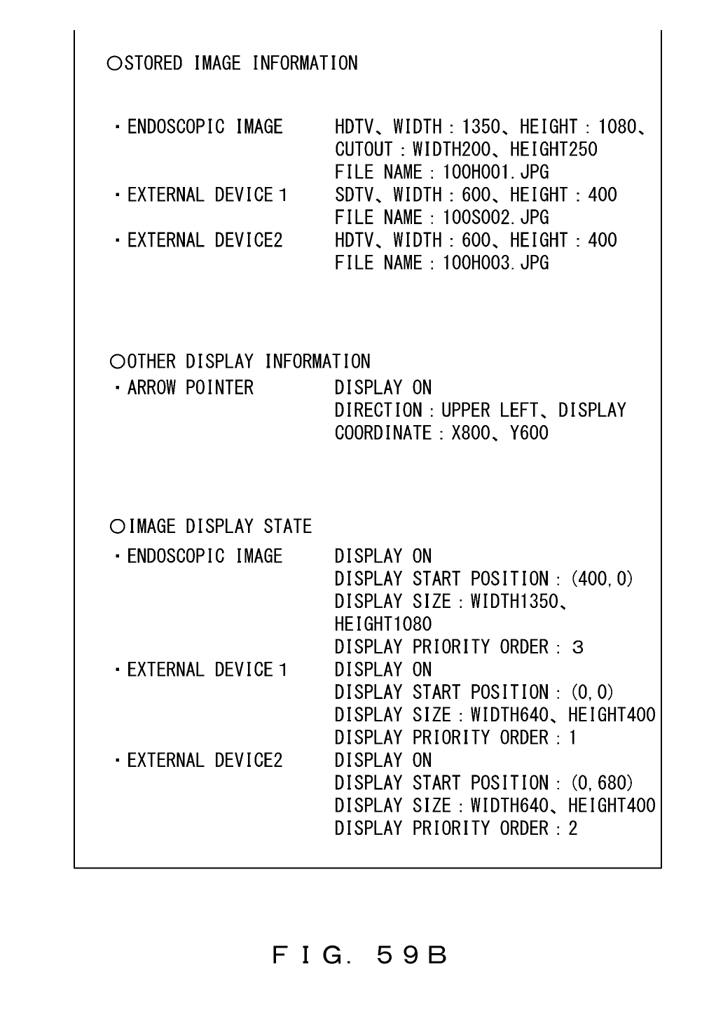

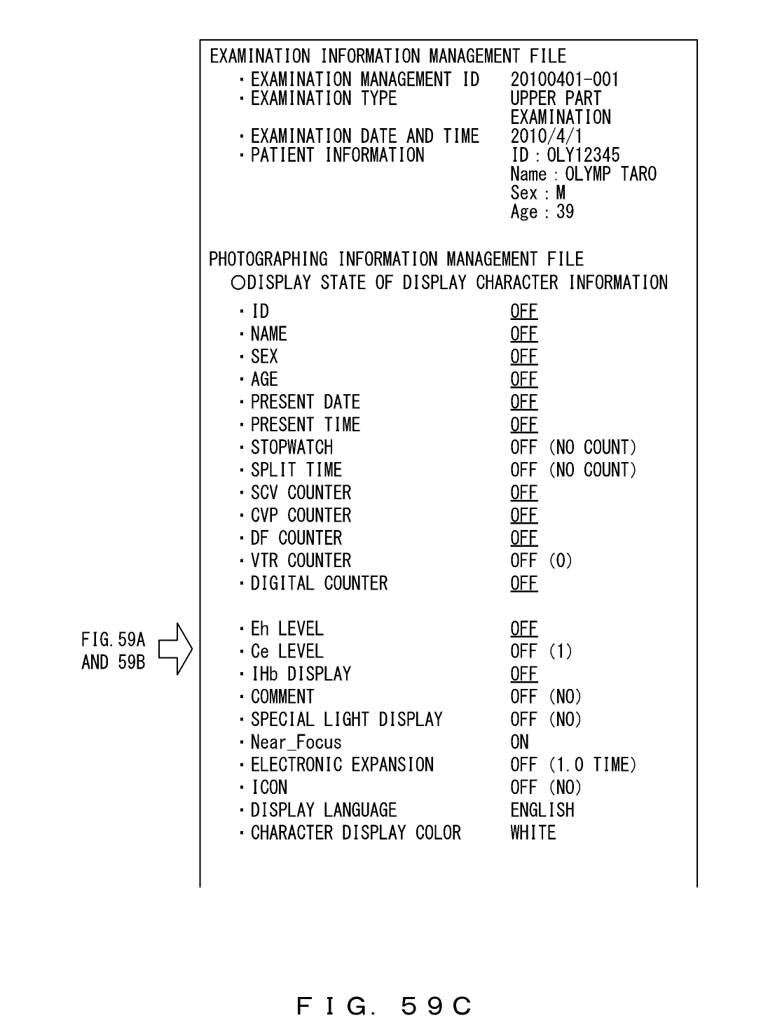

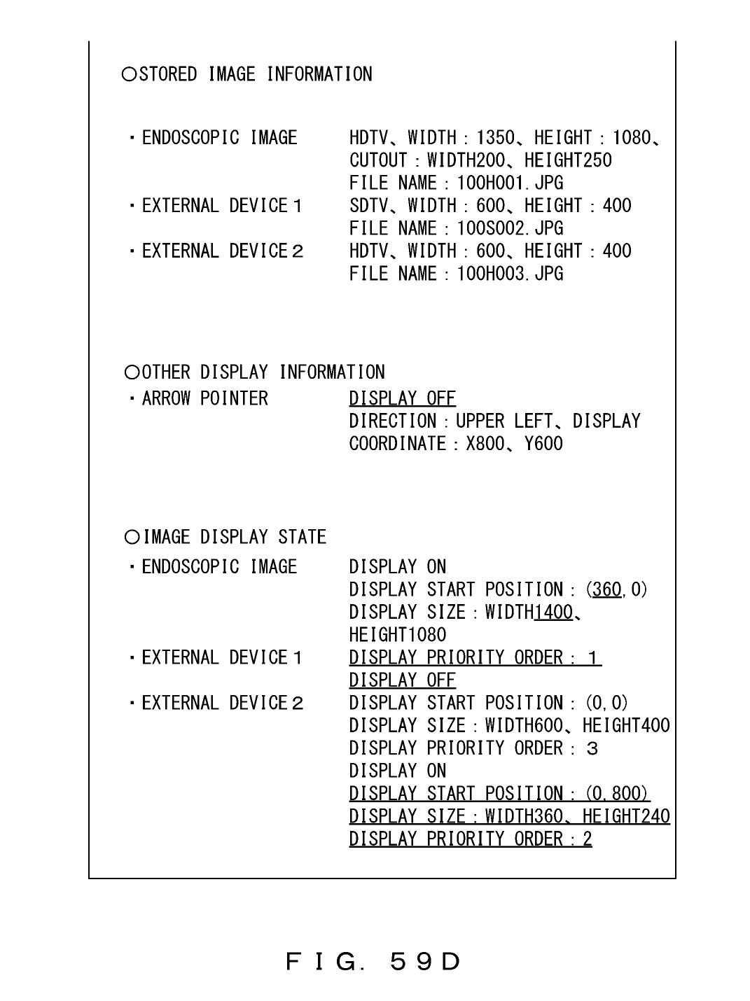

An image on the upper side in FIG. 58 is the endoscopic combined image 300-1 displayed on the display device of the PC terminal 213. An examination information management file and a photographing information management file concerning the endoscopic combined image 300-1 are a file shown in FIGS. 59A and 59B. In the PC 213, a change of a layout of the endoscopic combined image 300-1 can be performed.

For example, the external image 1 present on the upper left can be deleted from the endoscopic combined image 300-1 to reduce the lateral width of the endoscopic image 300, reduce the size of the external image 2 present on the lower left, and change the endoscopic combined image 300-1 to an endoscopic combined image 300-1′ on the lower side of FIG. 58. According to this change, contents of the examination information management file and the photographing information management file stored in the large-capacity storage in the server 212 are updated as shown in FIGS. 59C and 59D (in FIGS. 59C and 59D, portions changed from the file in FIGS. 59A and 59 B are indicated by underlines).

In this way, it is possible to access the server 212, correct, on the PC terminal 212, the endoscopic combined image 300-1 displayed on the PC terminal 213, and store the endoscopic combined image 300-1 on the PC terminal 213 or the server 213. At this point, the data of the examination information management file and the photographing information management file is automatically rewritten as shown in FIGS. 59C and 59D. Therefore, it is possible to generate a file of images optimum for the user. The user can reproduce the optimum images by transmitting the examination information management file and the photographing information management file updated in this way to the processor 4.

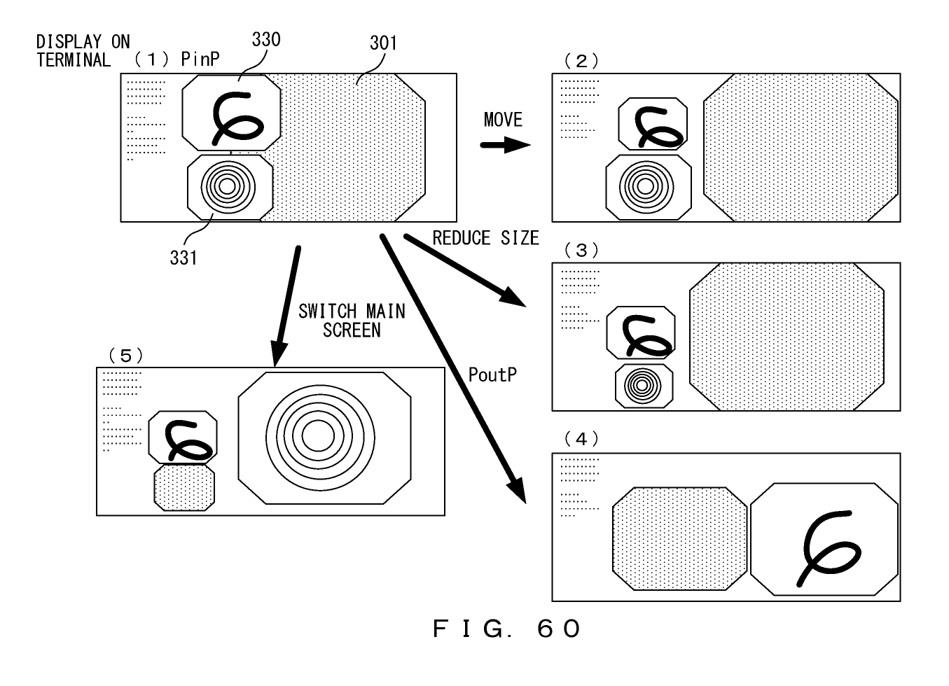

Further, a change of a display form of an endoscopic combined image on the PC terminal 213 is explained. For example, as shown in FIG. 60, the image 330 of the endoscope shape detecting device and the image 331 of the ultrasonic device, which are component images of the endoscopic combined image 300-1, can be moved in the endoscopic combined image 300-1 (FIG. 60 (2)). The size of the image 330 can be reduced in size (FIG. 60 (3)). The image 330 can be PoutP-displayed (FIG. 60 (4)). A main screen for the image 330 can be switched (FIG. 60 (5).

Specifically, in FIG. 60, in the endoscopic combined image 300-1 before the change of the display form displayed on a display of the PC terminal 213, the endoscopic image 301 is displayed as a main screen and the image 330 of the endoscope shape detecting device and the image 331 of the ultrasonic device are displayed as sub-screens in a PinP form (FIG. 60 (1)).

FIG. 60 (2) shows a state in which the PC terminal 213 is operated to move the image 330 of the endoscope shape detecting device and the image 331 of the ultrasonic device from the state shown in FIG. 60 (1).

FIG. 60 (3) shows a state in which the PC terminal 213 is operated to reduce the sizes of the image 330 of the endoscope shape detecting device and the image 331 of the ultrasonic device from the state shown in FIG. 60 (1).

FIG. 60 (4) shows a state in which the PC terminal 213 is operated to display the image 330 of the endoscope shape detecting device and the endoscopic image 301 in a PoutP form from the state shown in FIG. 60 (1).

FIG. 60 (5) is a state in which the main screen is switched to the image 331 of the ultrasonic device and the sub-screen is switched to the endoscopic image 301 from the state shown in FIG. 60 (1).

When the arrangement and the sizes of the images are changed as shown in FIGS. 60 (2) to 60 (4), as explained with reference to FIGS. 59A-59D, the arrangement and the size information of the images can be changed to an optimum size not to overlap each other and stored in the storage device of the PC terminal 213 or the server 212. Therefore, it is possible to form the images as images optimum for diagnosis of the user.

The arrangement information and the size information of the images stored in the PC terminal 213 and the server 212 can be transmitted to the processor 4. Consequently, on the processor 4 side, it is possible to easily reproduce the images with information same as the information in the PC terminal 213.

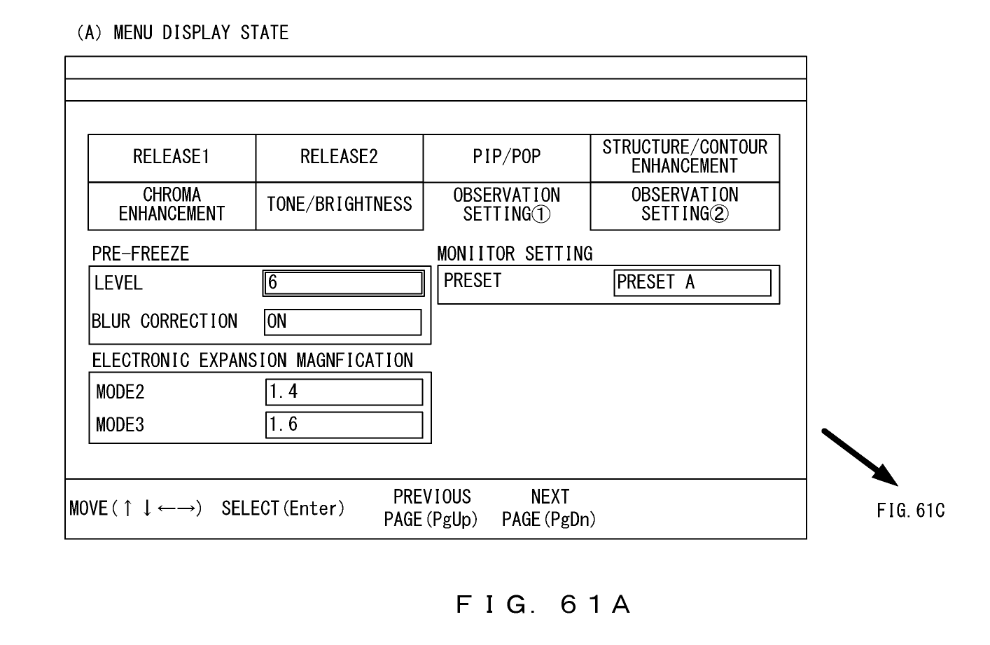

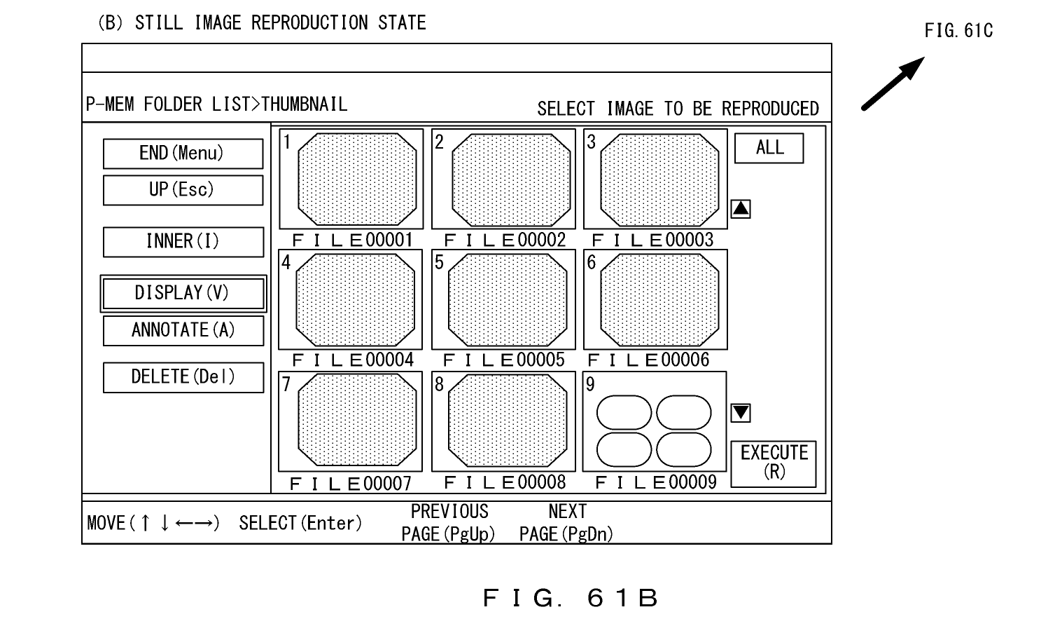

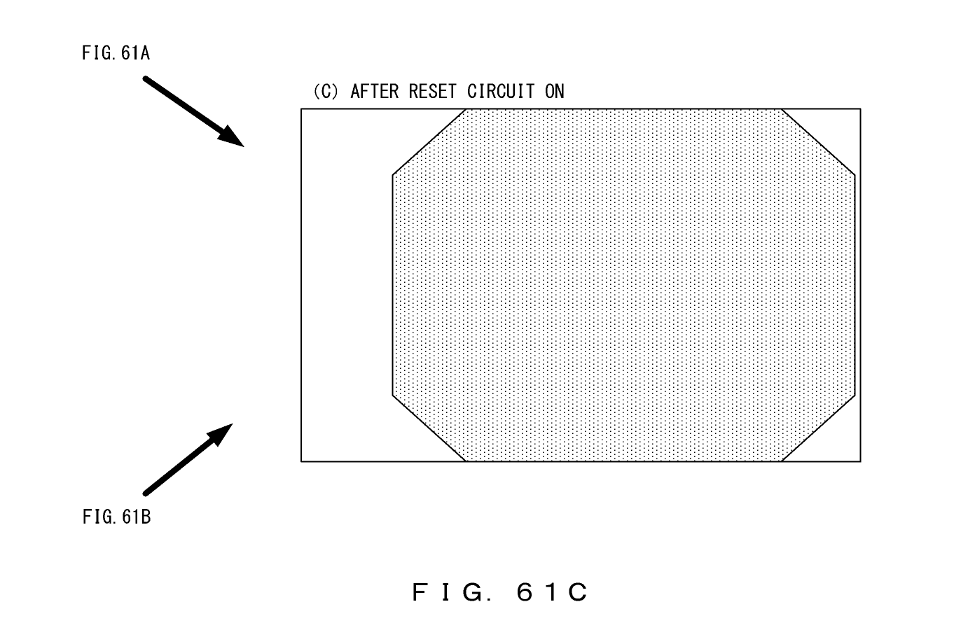

Next, the start of the reset circuit 140 by the watchdog timer and the initialization of a part of the image processing are explained with reference to FIGS. 61A-61C. An output of the reset circuit 140 is input to the image processing section 72.

When the CPU 131 normally operates (before hung-up), it is assumed that, on an image obtained by the CPU 131 controlling the combining circuits 108H and 108S (e.g., in a screen of the monitor 201A, 201B1, 201B2, 201C2, or 201C2), a menu screen generated by the graphic circuits 106H and 106S as shown in FIG. 61A or a multi-image formed from a signal of the graphic circuit 106H, 106S, A5, A6, F1, F2, A3, A4, A3′, or A4′ is displayed as shown in FIG. 61B.

In a state of FIG. 61A or FIG. 61B, when the CPU 131 is hung up, the watchdog timer works and reset by the reset circuit 140 is turned on. When the reset by the reset circuit 140 is turned on, the combining circuits 108H/108S perform control such that only the endoscopic image 301 from the synchronizing circuits 101H/101S is surely output as shown in FIG. 61C.

Consequently, even if the CPU 131 is hung up, the endoscopic image 301 is displayed such that the user does not perform wrong operation and wrong diagnosis.

As the blocks in the image processing section 72, blocks that are initialized and blocks that are not initialized when the reset of the reset circuit 140 is turned on are prepared. For example, when the output of the image input and output processing section 121 is connected to a monitor adapted to only the HDMI, the CPU 131 sets a setting value with which the output of the image input and output processing section 121 changes to an HDMI (High-Definition Multimedia Interface) output. However, the setting value (HDMI) may be maintained to prevent the setting value of the image input and output processing section 121 from changing to an initial value, which is not the HDMI even if the reset of the reset circuit 140 is turned on.

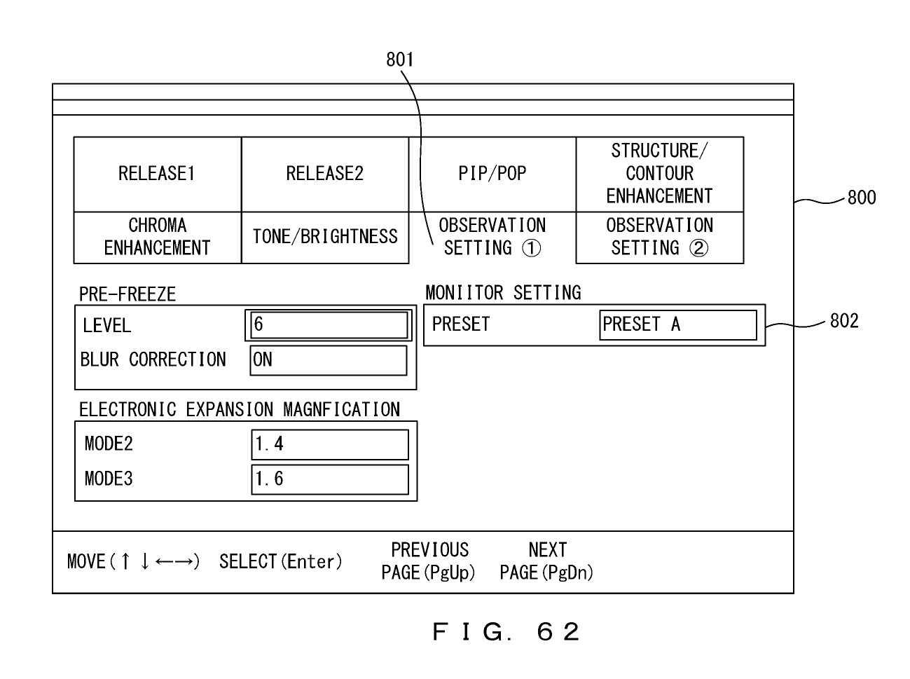

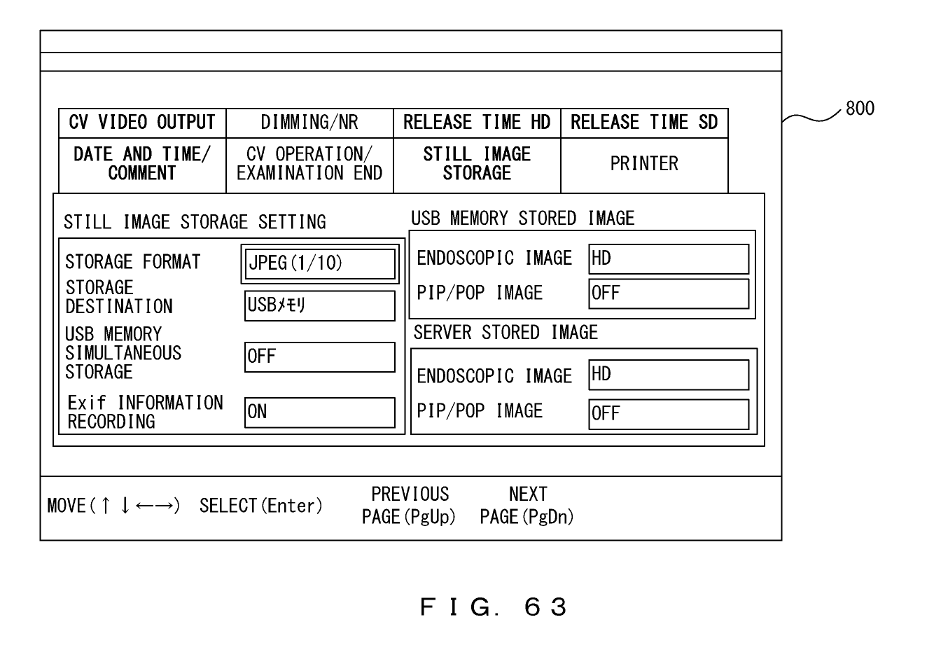

Next, an example of setting contents of the menu screen in the processor 4 is shown in FIGS. 62 and 63. The example of the setting screen is explained with reference to FIGS. 29 and 30. However, the layout of the screen is not limited to FIGS. 29 and 30. For example, a tab form may be used as shown in FIGS. 62 and 63.

In FIGS. 62 and 63, a menu can be switched by a tab on a menu screen 800. In FIG. 62, tabs of “release 1”, “release 2”, “PIP/POP”, “structure/contour enhancement”, “chroma enhancement”, “tone/brightness”, “observation setting (1)”, and “observation setting (2)” are provided. When a tag of a menu desired to be set is selected, details of the selected menu are displayed.

In FIG. 62, a tab “observation setting (1)” 801 is selected. In “motor setting” 802 of the tab “observation setting (1)”, setting of the monitor can be performed. Therefore, setting of the monitors 201A, 201B1, and 201C1 can be performed according to a menu of the processor 4. At this point, information set in the “monitor setting” 802 may be stored in the backup ROM 137 or 155. When the power supply for the processor 4 is on or when the setting is changed, the CPU 131 of the processor 4 may read out the set information from the backup RAM 137 or 155 and, for example, transmit the information to the monitors 201A, 201B1, 201B2, 201C1, and 201C2 via 142a and 143a.

In FIG. 63, tabs of “CV video output”, “dimming/NR”, “release time SD”, “date and time/comment”, “CV operation/experiment end”, “still image storage”, and “printer” are provided.

When the tab “still image storage” is selected, as shown in FIG. 63, setting spaces of “still image storage setting”, “USB memory stored image”, and “server stored image” are provided.

The setting space “still image storage setting” includes setting items of “storage format”, “storage destination”, “USB memory synchronous storage”, and “Exif information recording”.

In the setting item “storage format”, a change of a format of a still image to be stored (e.g., JPEG (including a compression ratio), TIFF, RAW, BMP, etc.) can be set. In the item “storage format” is equivalent to the sub-item “Encode” of Release1 to Release4 shown in FIG. 29.

In the setting item “storage destination”, a device at a storage destination of a still image can be set. At this point, as the storage destination, devices such as the filing devices and the optical recording devices, the PC card 167, the memory card 168, the USB memory 210, and the server 212 shown in FIGS. 15 to 19 can be set. The item “storage destination” is equivalent to the sub-item “peripheral device” of Release1 to Release4 shown in FIG. 29.

When the setting item “USB memory synchronous storage” is set to ON, storage in the USB memory 210 can be performed simultaneously with storage of image data in the device set in the item “storage destination”.

In the setting item “Exif information recording”, it is possible to select whether an image is stored in an Exif form or a DCF form, which is the standard of digital cameras and the like.

The setting space “USB memory storage image” includes setting items concerning the “endoscopic image” and the “PIP/POP”.

In the setting item “endoscopic image”, it is possible to set whether an HDTV image from the signal line 125a is stored or an SDTV image from the signal line 124a is stored as an endoscopic image stored in the USB memory 210.

In the setting item “PIP/POP”, it is possible to set whether an image from the signal lines 607 and 607′ is stored as an image of a PinP/PoutP display target to be stored in the USB memory 210.

The setting space “server stored image” includes setting items concerning “endoscopic image” and “PIP/POP”.

In the setting item “endoscopic image”, it is possible to set whether an HDTV image from the signal line 125a or an SDTV image from the signal line 124a is stored as an endoscopic image to be stored in the server 212.

In the setting item “PIP/POP”, it is possible to set whether an image signal from the signal lines 607 and 607′ is stored as an image of a PinP/Pout display target stored in the server 212.

The switching of PinP/PoutP can be set by a menu. In FIG. 20, an item “PIP/POP” section 5-21 for performing control of PinP/PoutP is provided in the observing section 5-2 of the keyboard 5. An “ON” key, a “display form” key, and an “input switching” key are provided in the “PIP/POP” section 5-21.

ON/OFF of the PinP/PoutP display can be switched by turning on and off the “ON” key. When the “ON” key is turned on, a message indicating “no input” is displayed and a black screen is output to PIP display when an external video signal is not input to an input terminal of a display target.

Every time the “input switching” key is pressed, for example, an external video (a terminal) of a display target to be displayed can be switched in such a manner as (1) the endoscope shape detecting device image 330→(2) the ultrasonic device image 331→(3) both of the endoscope shape detecting device image 330 and the ultrasonic device image 331→(1)→(2)→(3)→(1) and the like.

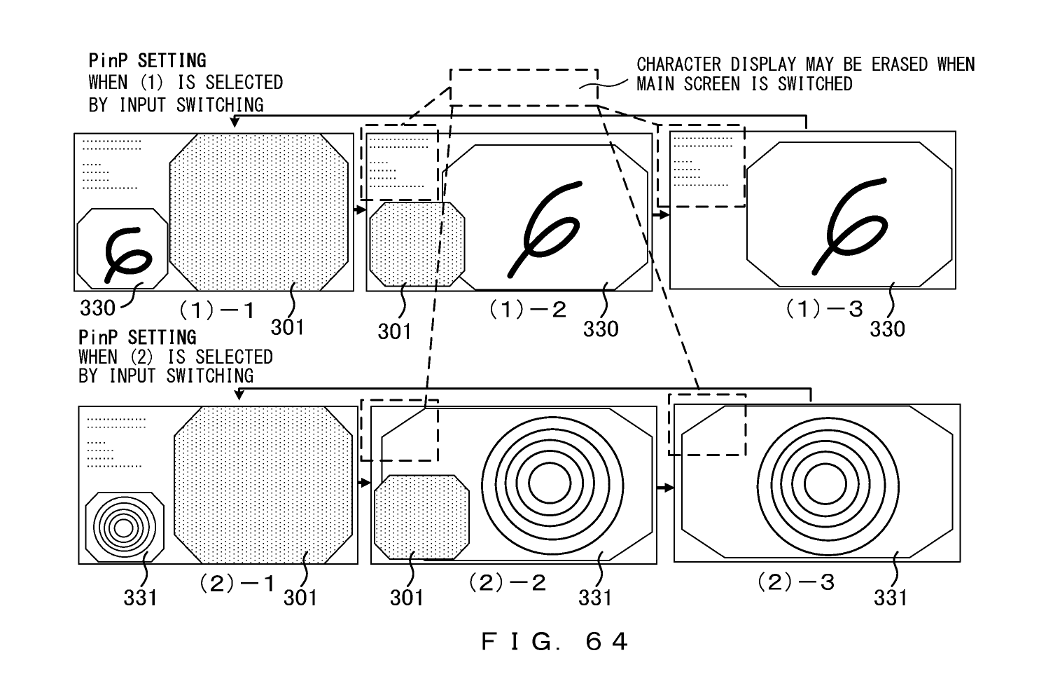

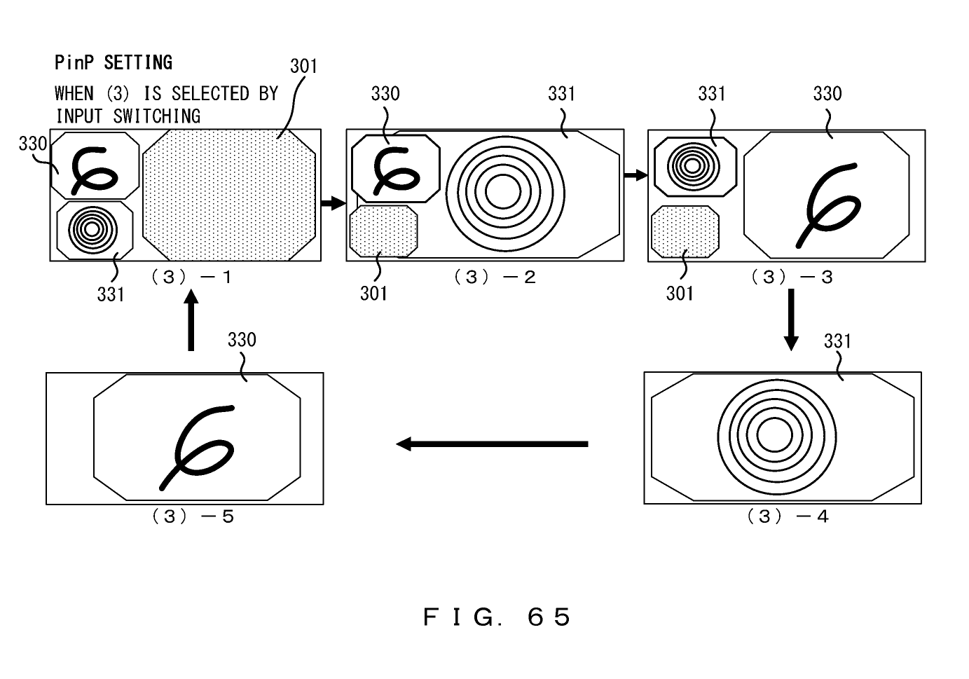

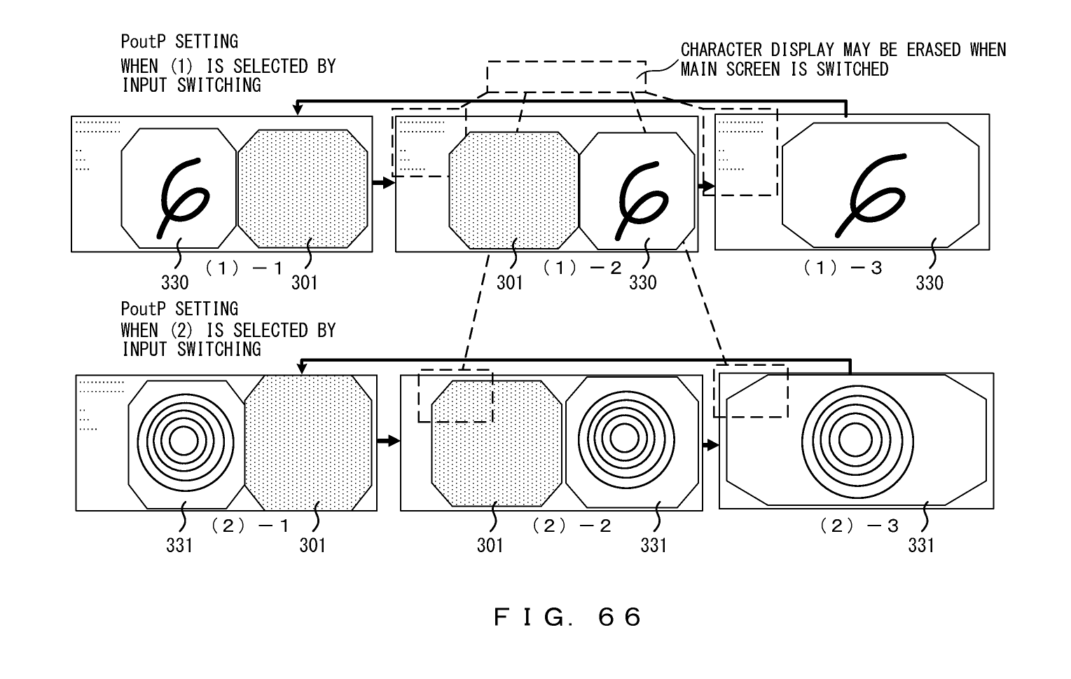

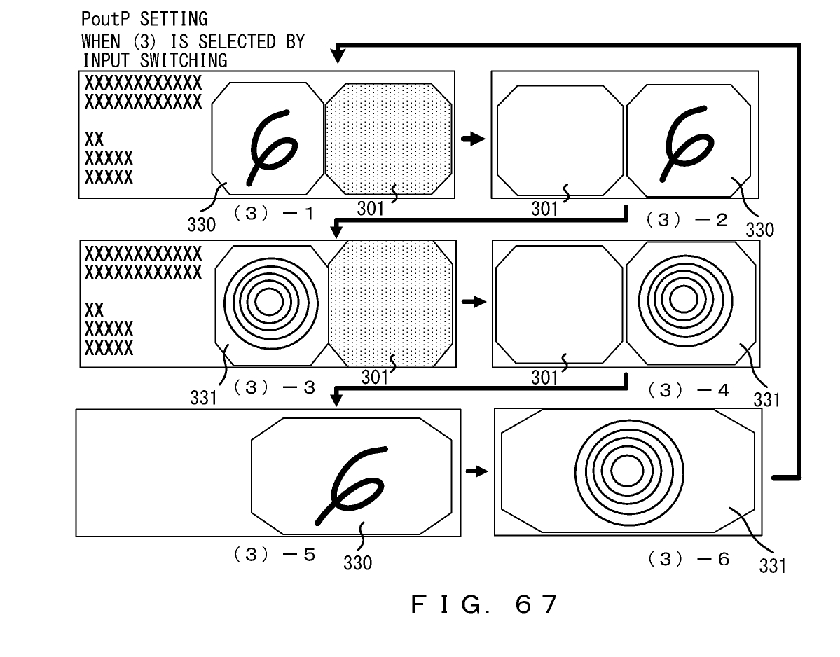

Every time the “display form” key is pressed, in the case of PinP, a display form (a display mode) can be switched in order shown in FIGS. 64 and 65 and, in the case of PoutP, the display form (the display mode) can be switched in order shown in FIGS. 66 and 67.

In the PinP setting, when “(1)the endoscope shape detecting device image” is selected by the “input switching” key, for example, as shown in FIG. 64 (1)-1, the image 330 of the endoscope shape detecting device is PIP-displayed together with the endoscopic image 301 (the main screen).

When the “display form” key is pressed in the state of FIG. 64 (1)-1, the main screen is switched to the image 330 of the endoscope shape detecting device as shown in FIG. 64 (1)-2. When the “display form” key is pressed in the state of FIG. 64 (1)-2, as shown in FIG. 64 (1)-3, only the image 330 of the endoscope shape detecting device is displayed as the main screen. When the “display form” key is pressed in the state of FIG. 64 (1)-3, the display returns to the state of FIG. 64 (1)-1.

In the PinP setting, when “(2) the ultrasonic device image” is selected by the “input switching” key, for example, as shown in FIG. 64 (2)-1, the image 331 of the ultrasonic device is PinP-displayed together with the endoscopic image 301 (the main screen).

When the “display form” key is pressed in the state of FIG. 64 (2)-1, as shown in FIG. 64 (2)-2, the main screen is switched to the image 331 of the ultrasonic device. When the “display form” key is pressed in the state of FIG. 64 (2)-2, as shown in FIG. 64 (2)-3, only the image 330 of the endoscope shape detecting device is displayed as the main screen. When the “display form” key is pressed in the state of FIG. 64 (2)-3, the display returns to the state of FIG. 64 (2)-1.

In the PinP setting, when “(3) the endoscope shape detecting device image and the ultrasonic device image” is selected by the “input switching” key, for example, as shown in FIG. 65 (3)-1, the image 330 of the endoscope shape detecting device and the image 331 of the ultrasonic device are PinP-displayed together with the endoscopic image 301 (the main screen).

When the “display form” key is pressed in the state of FIG. 65 (3)-1, as shown in FIG. 65 (3)-2, the main screen is switched to the image 331 of the ultrasonic device and the endoscopic image 301 is displayed as a screen on the lower left. When the “display form” key is pressed in the state of FIG. 65 (3)-2, as shown in FIG. 65 (3)-3, the main screen is switched to the image 330 of the endoscope shape detecting device and the image 331 of the ultrasonic device is displayed as a sub-screen on the upper left. When the “display form” key is pressed in the state of FIG. 65 (3)-3, as shown in FIG. 65 (3)-4, only the image 331 of the ultrasonic device is displayed as the main screen. When the “display form” key is pressed in the state of FIG. 65 (3)-4, as shown in FIG. 65 (3)-5, only the image 330 of the endoscope shape detecting device is displayed as the main screen. When the “display form” key is pressed in the state of FIG. 65 (2)-3, the display returns to the state of FIG. 65 (3)-1.

Next, in the PoutP setting, when “(1) the endoscope shape detecting device image” is selected by the “input switching” key, for example, as shown in FIG. 66 (1)-1, the image 330 of the endoscope shape detecting device is PoutP-displayed together with the endoscopic image 301.

When the “display form” key is pressed in the state of FIG. 66 (1)-1, as shown in FIG. 66 (1)-2, the display positions of the endoscopic image 301 and the image 330 of the endoscope shape detecting device are interchanged. When the “display form” key is pressed in the state of FIG. 66 (1)-2, as shown in FIG. 66 (1)-3, only the image 330 of the endoscope shape detecting device is displayed. When the “display form” key is pressed in the state of FIG. 66 (1)-3, the display returns to the state of FIG. 66 (1)-1.

In the PoutP setting, when “(2) the ultrasonic device image” is selected by the “input switching” key, for example, as shown in FIG. 66 (2)-1, the image 331 of the ultrasonic device is PoutP-displayed together with the endoscopic image 301.

When the “display form” key is pressed in the state of FIG. 66 (2)-1, as shown in FIG. 66 (2)-2, the display positions of the endoscopic image 301 and the image 331 of the ultrasonic device are interchanged. When the “display form” key is pressed in the state of FIG. 66 (2)-2, as shown in FIG. 66 (2)-3, only the image 331 of the ultrasonic device is displayed. When the “display form” key is pressed in the state of FIG. 66 (2)-3, the display returns to the state of FIG. 66 (2)-1.

In the PoutP setting, when “(3) the endoscope shape detecting device image and the ultrasonic device image” is selected by the “input switching” key, for example, as shown in FIG. 67 (3)-1, the image 330 of the endoscope shape detecting device is PoutP-displayed together with the endoscopic image 301.

When the “display form” key is pressed in the state of FIG. 67 (3)-1, as shown in FIG. 67 (3)-2, the display positions of the endoscopic image 301 and the image 330 of the endoscope shape detecting device are interchanged. When the “display form” key is pressed in the state of FIG. 67 (3)-2, as shown in FIG. 67 (3)-3, the image 331 of the ultrasonic device is PoutP-displayed together with the endoscopic image 301. When the “display form” key is pressed in the state of FIG. 67 (3)-3, as shown in FIG. 67 (3)-4, the display positions of the endoscopic image 301 and the image 331 of the ultrasonic device are interchanged. When the “display form” key is pressed in the state of FIG. 67 (3)-4, as shown in FIG. 67 (3)-5, only the image 330 of the endoscope shape detecting device is displayed. When the “display form” key is pressed in the state of FIG. 67 (3)-5, as shown in FIG. 67 (3)-6, only the image 331 of the ultrasonic device is displayed. When the “display form” key is pressed in the state of FIG. 67 (2)-6, the display returns to the state of FIG. 67 (3)-1.

In the PinP/PoutP display switching, when the endoscopic image 301 is not displayed (i.e., when only the image 330 of the endoscope shape detecting device is displayed, only the image 331 of the ultrasonic device is displayed, or the image 330 of the endoscope shape detecting device and the image 331 of the ultrasonic device are displayed) or the endoscopic image 301 is not displayed as the main screen, for example, as shown in FIGS. 64 and 65, the character information may be erased during the main screen switching. Not only the character information but also the color bar and the like may be erased during the main screen switching.

When the power supply for the processor 4 is on, the PinP/PoutP display may be operated when the power supply is turned off. The selection information of (1)/(2)/(3) selected by the “input switching” key may be stored in the backup RAM 137 or 155. When the power supply is turned on again, when the PinP/PoutP display is turned on, the CPU 131 of the processor 4 may read out the selection information from the backup RAM 137 or 155 to display an image selected last time. The state switched by the “display form” key may be stored in the backup RAM 137 or 155. After the power supply is turned on again, when the PinP/PoutP display is turned on, the CPU 131 of the processor 4 reads out the state from the backup RAM 137 or 155 to display the state in the last state.

The processing by the “PIP/POP” section 5-21 has been performed in the processor 4. However, the monitors 201A, 201B1, 201B2, 201C1, and 201C2 may have a processing function same as that of the “PIP/POP” section 5-21. In this case, the processor 4 may perform remote control of operation information of the observing section 5-2 of the keyboard 5 using, for example, 142a and 143a and perform processing of PinP/PoutP in the monitors 201A, 201B1, 201B2, 201C1, and 201C2.

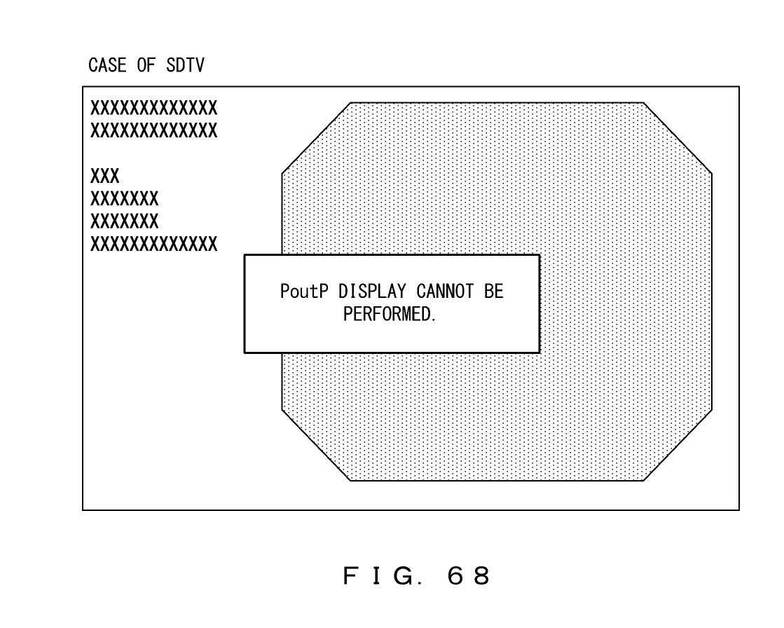

The PoutP display can be performed only in the case of an HDTV image. If the PoutP display is turned on in an SDTV image, since a display range is narrow, as shown in FIG. 68, the processor 4 warns, as an error, that the PoutP display cannot be performed.

As explained above, the images included in the endoscopic combined image generated by the processor 4 are stored in the server 212. The layout of the images can be changed on the processor 4 or on the PC terminal 213. This is explained in detail below.

As a first example, the processor 4 outputs the images included in the endoscopic combined image 300-1 (e.g., the endoscopic image 301, the image 330 of the endoscope shape detecting device, and the image 331 of the ultrasonic device), the observation information group 300, and the image data group including the layout information such as the coordinates of the component images on the basis of processing in step VFLW5 and step VFLW6 in FIG. 52, step VVFLW4 and step VVFLW5 in FIG. 53, and step VVVFLW3 and step VVVFLW4 in FIG. 54.

The combined image data group output from the processor 4 is transmitted to the server 212. When the server 212 receives the combined image data group, the server 212 stores the combined image data group in the storage device on the inside of the server 212.

When at least one or more component images forming a reproduction image are designated in the processor 4, the processor 4 can set reproduction image designation information (e.g., a photographing information management file) including information for identifying an image designated for performing reproduction and display (e.g., an image file name), information related to the reproduction image (e.g., the examination information management file shown in FIG. 34 and the data items “display state of display character information” and “stored image information” shown in FIGS. 35A-35C), and image layout information of the reproduction image (e.g., the data item “image display state” shown in FIGS. 35A-35C). The processor 4 transmits the set reproduction image designation information to the server 212.

The server 212 receives the reproduction image designation information transmitted from the processor 4. Then, the server 212 forms, on the basis of the reproduction image designation information, a reproduction image from the combined image data group stored in the storage device on the inside of the server 212. Thereafter, the server 212 outputs the formed reproduction image.

When the processor 4 receives the reproduction image output from the server 212, the processor 4 reproduces the received image.

As a second example, the processor 4 outputs the images included in the endoscopic combined image 300-1 (e.g., the endoscopic image 301, the image 330 of the endoscope shape detecting device, and the image 331 of the ultrasonic device), the observation information group 300, and the image data group including the layout information such as the coordinates of the component images on the basis of processing in step VFLW5 and step VFLW6 in FIG. 52, step VVFLW4 and step VVFLW5 in FIG. 53, and step VVVFLW3 and step VVVFLW4 in FIG. 54.

The combined image data group output from the processor 4 is transmitted to the server 212. When the server 212 receives the combined image data group, the server 212 stores the combined image data group in the storage device on the inside of the server 212.

The user accesses, with the PC terminal 213, the combined image data group stored in the storage device on the inside of the server 212 and causes the PC terminal 213 to display the endoscopic combined image 300-1. The user changes the layout of the images included in the endoscopic combined image 300-1 on the PC terminal 213. Consequently, the PC terminal 213 can set, as shown in FIGS. 59A-59D, reproduction image designation information (e.g., a photographing information management file) including information for identifying an image designated for performing reproduction and display (e.g., an image file name), information related to the reproduction image (e.g., the examination information management file shown in FIG. 34 and the data items “display state of display character information” and “stored image information” shown in FIGS. 35A-35C), and image layout information of the reproduction image (e.g., the data item “image display state” shown in FIGS. 35A-35C). The PC terminal 213 transmits the set reproduction image designation information to the server 212.

The server 212 receives the reproduction image designation information transmitted from the PC terminal 213. Then, the server 212 forms, on the basis of the reproduction image designation information, a reproduction image from the combined image data group stored in the storage device on the inside of the server 212. Thereafter, the server 212 outputs the formed reproduction image.

When the PC terminal 213 receives the reproduction image output from the server 212, the PC terminal 213 reproduces the received image.

According to this embodiment, the image recording and reproducing system that records and reproduces a combined image (e.g., the endoscopic combined image 300-1) of images input from plural input sources includes the combined image data group output section, the combined image data group recording section, the reproduction image designation information setting section, the reproduction image forming section, the reproduction image output section, and the reproducing section.

The combined image data group output section outputs a combined image data group including component images (e.g., the endoscopic image 301, the image 330 of the endoscope shape detecting device, and the image 331 of the ultrasonic device) forming the combined image, information (e.g., the observation image group 300) related to the combined image, and image layout information (e.g., the coordinate information of the endoscopic image 301, the image 330 of the endoscope shape detecting device, and the image 331 of the ultrasonic device) of the combined image. The combined image data group output section is equivalent to, for example, in this embodiment, the processor 4 and, more specifically, to the processing in step VFLW5 and step VFLW6 in FIG. 52, step VVFLW4 and step VVFLW5 in FIG. 53, and step VVVFLW3 and step VVVFLW4 in FIG. 54 performed by the CPU 151.

The combined image data group recording section records the output combined image data group. The combined image data group recording section is equivalent to, for example, in this embodiment, the server 212.

The reproduction image designation information changing section performs operation for changing reproduction image designation information (e.g., the photographing information management file) including information (e.g., an image file name for identifying a designated image) for designating at least one or more component images forming a reproduction image, information (e.g., the examination information management file shown in FIG. 34 and the data items “display state of display character information” and “stored image information” shown in FIGS. 35A-35C) related to the reproduction image, and image layout information (e.g., the data item “image display state” shown in FIGS. 35A-35C) of the reproduction image. The reproduction image designation information setting section is equivalent to, for example, in this embodiment, the processor 4 or the PC terminal 213.

The reproduction image forming section forms a reproduction image from the recorded combined image data group on the basis of the changed reproduction image designation information. The reproduction image forming section is equivalent to, for example, in this embodiment, the server 212.

The reproduction image output section that outputs the formed reproduction image. The reproduction image output section is equivalent to, for example, in this embodiment, the server 212.

The reproducing section receives the output reproduction image and reproduces the reproduction image. The reproducing section is equivalent to, for example, in this embodiment, the processor 4 or the PC terminal 213.

By configuring the image recording and reproducing system as explained above, it is possible to individually record components forming an endoscopic combined image and reproduce an image obtained by reforming the respective components in a desired layout. Further, it is possible to perform such a layout change not only in a processor but also in a device other than the processor.

The image recording and reproducing system includes the endoscope system (e.g., the processor 4) connected to the external device for inputting an external image and connected to the endoscope and the image recording apparatus (e.g., the server 212). The endoscope system (e.g., the processor 4) includes the combined image data group output section, the reproduction image designation information changing section, the transmitting section that transmits the reproduction image designation information, and the reproducing section. The image recording apparatus (e.g., the server 212) includes the combined image data group recording section, the receiving section that receives the reproduction image designation information, the reproduction image forming section, and the reproduction image output section.

By configuring the image recording and reproducing system as explained above, it is possible to perform, on the server side, a change of a layout of an endoscopic combined image generated by the processor 4.

The image recording and reproducing system includes the endoscope system (e.g., the processor 4) connected to the external device for inputting an external image and connected to the endoscope, the image recording apparatus (e.g., the server 212), and the image reproducing apparatus (e.g., the PC terminal 213).

The endoscope system (e.g., the processor 4) includes the combined image data group output section. The image recording apparatus (e.g., the server 212) includes the combined image data group recording section, the receiving section that receives the reproduction image designation information, the reproduction image forming section, and the reproduction image output section. The image reproducing apparatus (e.g., the PC terminal 213) includes the reproduction image designation information changing section, the transmitting section that transmits the reproduction image designation information, and the reproducing section.

By configuring the image recording and reproducing system as explained above, it is possible to perform, on the PC terminal 213 side, a change of a layout of an endoscopic combined image generated by the processor 4 and stored in the server 213.

The information related to the combined image and the information related to the reproduction image include at least one of a number for examination management, an examination region, examination date and time, a patient ID, a patient name, a patient sex, and a patient age. The image layout information of the combined image and the image layout information of the reproduction image include at least one of a type of an image, the width of the image, and the height of the image.

The image layout information of the reproduction image further includes at least one of information for discriminating, concerning each image, whether to display the image and a display disclosure position of the image.

The component images forming the combined image and the information related to the combined image included in the combined image data group are independent from each other.

As explained above, even when an image having the display size 16:9 is displayed on the monitor or the like and when the image is recorded in a device not adapted to the display size, the processor 4 of the endoscope system 1 can output an image suitable for recording. Consequently, the processor 4 of the endoscope system 1 can reduce a burden on the user in performing recording of an endoscopic image.

As explained above, the processor 4 of the endoscope system 1 includes the configuration in which peripheral devices in which an image is recorded when the key (or the switch) having the release function is input on the setting screen shown in FIG. 29, a format used in subjecting the image to compression processing, and the like can be set for each key (or switch) to which the release function is allocated. Therefore, for example, as shown in FIG. 52, the processor 4 of the endoscope system 1 performs recording of an image while properly using, as the key or the switch having the release function, a key or a switch for recording an image of a format having a high compression ratio and a key or a switch for recording of an image of an un-compressed format or a format having a low compression ratio. Therefore, even while the user is performing an observation, the processor 4 makes it possible to perform selection of an image format and a compression ratio easily and in a short time without interrupting the observation. The processor 4 of the endoscope system 1 can cause the peripheral device or the like to record an image continuously and on a real time basis when the format having the high compression ratio is selected.

As explained above, for example, as shown in FIG. 53, the processor 4 of the endoscope system 1 has a function of outputting, at predetermined timing, only an image selected by the user while storing an image of the format having the low compression ratio in the buffer 166. Therefore, the processor 4 of the endoscope system 1 can reduce a transmission load applied when the image of the format having the low compression ratio is transmitted on a network.

As explained above, the processor 4 of the endoscope system 1 can automatically detect that the extension control sections 77A and 77B formed as extension boards are connected and can display, on the basis of a result of the detection, an image or information concerning a function of the connected extension boards immediately after the connection of the extension control sections 77A and 77B. As a result, the processor 4 of the endoscope system 1 can reduce time consumed by the user for an observation compared with the past.

As explained above, since the processor 4 of the endoscope system 1 can apply encryption processing to an image to be recorded, for example, in an apparatus not including a function of decryption, it is possible to disable display of the image. As a result, the user can surely take security measures for patient information and perform protection of personal information.

It goes without saying that the present invention is not limited to the embodiments explained above and various changes and applications are possible without departing from the spirit of the invention.

The present invention enables a layout change of an endoscopic combined image displayed on a display device and enable such a layout change not only in a processor but also in devices other than the processor.

What is claimed is:

1. An image recording and reproducing system that records and reproduces a combined image of images input from plural input sources, the image recording and reproducing system comprising:
a combined image data group output section that outputs a combined image data group including component images forming the combined image, information related to the combined image, and image layout information of the combined image;
a combined image data group recording section that records the output combined image data group;
a reproduction image designation information changing section that performs operation for changing reproduction image designation information, the image designation information includes information for designating at least one or more component images forming a reproduction image, information related to the reproduction image, and image layout information of the reproduction image;
a reproduction image forming section that forms a reproduction image from the recorded combined image data group on the basis of the changed reproduction image designation information;
a reproduction image output section that outputs the formed reproduction image; and
a reproducing section that receives the output reproduction image and reproduces the reproduction image.

2. The image recording and reproducing system according to claim 1, further comprising: an endoscope system connected to an external device for inputting an external image and connected to an endoscope; and an image recording apparatus, wherein
the endoscope system includes:
the combined image data group output section;
the reproduction image designation information changing section;
a transmitting section that transmits the reproduction image designation information; and
the reproducing section, and
the image recording apparatus includes:
the combined image data group recording section;
a receiving section that receives the reproduction image designation information;
the reproduction image forming section; and
the reproduction image output section.

3. The image recording and reproducing system according to claim 1, further comprising: an endoscope system connected to an external device for inputting an external image and connected to an endoscope; an image recording apparatus; and an image reproducing apparatus, wherein
the endoscope system includes the combined image data group output section,
the image recording apparatus includes:
the combined image data group recording section;
a receiving section that receives the reproduction image designation information;
the reproduction image forming section; and
the reproduction image output section, and
the image reproducing apparatus includes:
the reproduction image designation information changing section;
a transmitting section that transmits the reproduction image designation information; and
the reproducing section.

4. The image recording and reproducing system according to claim 1, wherein the information related to the combined image and the information related to the reproduction image include at least one of a number for examination management, an examination region, examination date and time, a patient ID, a patient name, a patient sex, and a patient age.

5. The image recording and reproducing system according to claim 1, wherein the image layout information of the combined image and the image layout information of the reproduction image include at least one of a type of an image, a width of the image, and a height of the image.

6. The image recording and reproducing system according to claim 1, wherein the image layout information of the reproduction image further includes at least one of information for discriminating, concerning each image, whether to display the image and a display disclosure position of the image.

7. The image recording and reproducing system according to claim 1, wherein the component images forming the combined image and the information related to the combined image included in the combined image data group are independent from each other.
